(19) United States
(12) Patent Application Publication
(10) Pub. No.: US 2015/0310497 A1
(43) Pub. Date: Oct. 29, 2015

(54) Method and process for registration, creation and management of micro shares of real or intangible properties and advertisements in a network system

(71) Applicants: David Valin, Concord, CA (US); Alex Socolof, Briarcliff Manor, NY (US)

(72) Inventors: David Valin, Concord, CA (US); Alex Socolof, Briarcliff Manor, NY (US)

(21) Appl. No.: 14/611,172

(22) Filed: Jan. 31, 2015

Related U.S. Application Data
(63) Continuation-in-part of application No. 13/171,746, filed on Jun. 29, 2011, now Pat. No. 8,818,850.
Application No. 13/171,746 is a continuation-in-part of application No. 13/282,730, filed on Oct. 27, 2011, now Pat. No. 8,972,282.
Application No. 13/282,730 is a continuation-in-part of application No. 13/357,029, filed on Jan. 24, 2012.
Application No. 13/357,029 is a continuation-in-part of application No. 13/360,670, filed on Jan. 28, 2012.
Application No. 13/360,670 is a continuation-in-part of application No. 12/860,936, filed on Aug. 23, 2010, now abandoned.
Application No. 12/860,936 is a continuation-in-part of application No. 12/653,749, filed on Dec. 17, 2009, now abandoned.

(51) Int. Cl. G06Q 30/02; G06Q 40/04; G06Q 40/02; G06Q 30/00; G06Q 10/10; G06Q 30/06; G06Q 40/00; H04L 12/58

(52) U.S. Cl. CPC G06Q 30/0269; G06Q 40/00; G06Q 40/04; H04L 51/08; G06Q 30/018; G06Q 10/107; G06Q 30/0609; G06Q 40/025; G06Q 30/0279; G06Q 30/0282

(57) ABSTRACT

A method for real or intangible divided and transformed property or properties or advertising sponsor user, using a client computer, or mobile device to be able to register, login and create zip code related local sponsor real or intangible divided and transformed property or properties or advertisements, with small real or intangible divided and transformed property or properties or advertisements for creating interest in the offers, that link to bigger real or intangible divided and transformed property or properties or advertisements with an embedded shopping cart. When a user creates the real or intangible divided and transformed property or properties or advertisements, they can upload their images, and create their type for the offers in the same interface form and the real or intangible divided and transformed property or properties or advertisements are instantly created and able to be published immediately throughout a network.

### CROSS REFERENCE TO RELATED APPLICATIONS

This application claims priority from and is a continuation in part of U.S. patent application Ser. No. 13/282,730, entitled “Method for Transformation of a Website”, filed on Oct. 27, 2011, which is incorporated by reference in its entirety for all purposes as if fully set forth herein.

This application claims priority from and is a continuation in part of U.S. patent application Ser. No. 13/171,746, entitled “Method and process for registration, creation and management of campaigns and advertisements in a network system”, filed on Jun. 29 2011, and is a granted now U.S. Pat. No. 8,818,850 which has an issue date of Aug. 26, 2014 which is incorporated by reference in its entirety for all purposes as if fully set forth herein.

This application claims priority from and is a continuation in part of U.S. patent application Ser. No. 13/357,029, entitled “Apparatus for connecting a human key identification to objects and content for identification, tracking, delivery, advertising, and marketing”, filed on 24 Jan. 2012, which is incorporated by reference in its entirety for all purposes as if fully set forth herein.

This application claims priority from and is a continuation in part of U.S. patent application Ser. No. 13/360,670, entitled “Method for connecting a human key identification to objects and content for identification, tracking, delivery, advertising, and marketing”, filed on 28 Jan. 2012, which is incorporated by reference in its entirety for all purposes as if fully set forth herein.

This application claims priority from and is a continuation in part of U.S. patent application Ser. No. 12/860,936, entitled “A method for connecting a human key identification to objects and content or identification, tracking, delivery, advertising, and marketing”, filed on 23 Aug. 2010, which is incorporated by reference in its entirety for all purposes as if fully set forth herein.

This application claims priority from and is a continuation in part of U.S. patent application Ser. No. 12/653,749, entitled “Method and Mechanism for identifying protecting, requesting, assisting and managing information”, filed on 17 Dec. 2009, which is incorporated by reference in its entirety for all purposes as if fully set forth herein.

This application claims priority from and is a continuation of U.S. patent application Ser. No. 13/332,173, entitled “Method for identifying and protecting, information”, filed on 12 Dec. 2011, which is incorporated by reference in its entirety for all purposes as if fully set forth herein.

This application claims priority from and is a continuation in part of U.S. patent application Ser. No. 12/459,353, entitled “Method and mechanism for protection, sharing, storage, accessing, authentication, certification, attachment and tracking anything in an electronic network”, filed on Jun. 29, 2009, which is incorporated by reference in its entirety for all purposes as if fully set forth herein.

### SEQUENCE LISTING OR PROGRAM

Not Applicable

### FEDERALLY SPONSORED RESEARCH

Not Applicable

### TECHNICAL FIELD OF THE INVENTION

The present invention generally relates to a method, executed on a computer system, for the creation and management of micro shares of real or intangible properties, campaigns and advertisements in a network system related to dividing real or intangible properties into fractions or pieces for the purpose of monetizing, creating liquidity and trading fractional properties. More specifically the present invention relates to a method and process for registration, securing, identifying, trading and creation, of new properties by dividing properties into pieces that can be traded and provided management of campaigns and advertisements for said divisions of properties in a network system.

### BACKGROUND OF THE INVENTION

In registration systems and mechanisms currently being used, real or intangible properties representational information is submitted simply into a database without any additional activities, such as dividing the property at the time of registration for the purpose to create new markets for the original undivided property. The present invention enables users to do multiple useful tasks to original real or intangible properties, involving transforming and dividing properties at the onset of registration.

The present invention further provides real or intangible property advertisers and businesses to connect to users, easily with these registration methods created, for requests for transactions, products and services. Commerce can be conducted between users, and real or intangible property campaigns benefit because a portion of advertisers revenues goes to designated campaigns, and divided properties can be monetized better, enabling everyone who participates to make money. The present invention further utilizes methods to determine Fair Value, Fair Share, Fair Deal, Fair Price, Fair Division and Fair Placement of tangible and intangible property, objects, and content at the time of registration that enable secure tracking, fulfillment, and collaboration of transactions.

In U.S. patent application Ser. No. 13/282,730, entitled “Method for Transformation of a Website”, filed on Jun. 29, 2011 real properties such as Websites, and Advertisements were transformed and re-purposed, so here in this invention we are taking Real or intangible properties and we are giving users the ability to upload their properties and then the method provides the taking of those properties images, videos, audios, text, data and media references and divides them into pieces that can be sold, traded, bartered or transacted as a limited edition, secured, and tracked piece of the original property.

### DEFINITIONS

Unless stated to the contrary, for the purposes of the present disclosure, the following terms shall have the following definitions:

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“Netbot” is an automated or semi-automated tool that can carry out repetitive and mundane tasks.

“NFC” is an acronym for “Near Field Communication” which allows for simplified transactions, data exchange, and wireless connections between two devices in proximity to each other, usually by no more than a few centimeters. NFC is expected to become a widely used system for making payments by smartphone in the United States. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than using the actual credit card.

A “PortalBot” is an automatic aggregator of specific semantic, keyword, or human key information from targeted interne web portals, for the purpose of finding, searching, identifying, and managing intellectual property, copyrighted material, or media in a network like the Internet or world wide web (WWW).

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

URL is an abbreviation of Uniform Resource Locator (URL), it is the global address of documents and other resources on the World Wide Web (also referred to as the “Internet”).

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “virtual world” or “virtual world place” is an online community that often takes the form of a computer-based simulated environment through which users can interact with one another and use and create objects. The term has become largely synonymous with interactive 3D virtual environments, where the users take the form of avatars visible to others. These avatars usually appear as textual, two-dimensional, or three-dimensional representations, although other forms are possible (auditory and touch sensations for example). Some, but not all, virtual worlds allow for multiple users. The computer accesses a computer-simulated world and presents perceptual stimuli to the user, who in turn can manipulate elements of the modeled world and thus experience a degree of tele-presence. Such modeled worlds and their rules may draw from the reality or fantasy worlds.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

“WHOIS” is an Internet service that finds information about a domain name or IP address. If you enter a domain name in a WHOIS search engine, it will scour a huge database of domains and return information about the one you entered. This information typically contains the name, address, and phone number of the administrative, billing, and technical contacts of the domain name. WHOIS can also be used to simply check if a certain domain name is available or if it has already been registered.

A module in software is a part of a program. Programs are composed of one or more independently developed modules that are not combined until the program is linked. A single module can contain one or several routines or steps.

A module in hardware, is a self-contained component.

An advertisement creator module is defined as a software module that is engaged by a user through a computer or other equivalent electronic device to upload media such as images and video to create advertisements which follow a predetermined process or protocol.

QR code module is an abbreviation for Quick response code. A QR code module is a specific matrix barcode (or two-dimensional code) that is readable by dedicated QR barcode readers and camera telephones. The code consists of black modules arranged in a square pattern on a white background. The information encoded may be text, URL, or other data. QR codes are automatically created by the QR code module when a user registers, and also are created when a user creates or uploads an advertisement to the system, and are also created when a user creates a campaign in the system, so that each user, advertisement and campaign has attached its own QR code, for use in the system. Also scan able data embedded for decoding in the QR code attached to Users, Advertisements and Campaigns can be changed for the purpose of marketing, relating information, and tracking as the user needs to change it with a QR code administration dashboard editor function. In this invention QR codes are also issued, used and linked to color bands to identify which property the color band is attached to, and what original property it came from.

Payment module is defined as software module that is engaged by a user through a computer or other equivalent electronic device to pay bills, pay other users, move funds from one registered users bank account or virtual bank account to another users bank account or virtual bank account, or to outside bank accounts.

A software module is defined as a series of process steps stored in an electronic memory of an electronic device and executed by the processor of an electronic device such as a computer, pad, smart phone, or other equivalent device known in the prior art.

A Digital Semantic Agent can perform any action a person, user or automated mechanism can perform. The digital semantic agent is a set of instructions executed by a machine, such as computer, which is equivalent to a software module, or equivalent method or software structure for identifying, determining, and effectuating a purchase or sale of a property or any agent or module for making value determinations as taught and claimed by the present invention.

The Digital Semantic Agent is provided as a set of instructions executed by a machine, such as computer and made available by a display screen of such as device. A user then interacts with the machine/computer, and the digital semantic agent running the set of instructions as a method performs the steps claimed. We use a Digital Semantic Agents as related to semantic keywords processing and phrase analysis transformations in the presented method and mechanism of the invention.

The Adopt Anything portal is a digital semantic agent web entity. Which means that the functions of the portal, or website, were created, and invented to perform any action a person, user or automated mechanism can perform. Actions such as aggregation, storing data in databases, and folders, and creating digital semantic agent decisions, content, transformations of content, security and page creations are performed by the Adopt Anything digital semantic agent. In the presented invention we are adding additional new functions for aggregation, creating digital semantic agent decisions, content, transformations of content, security and page creations.

Also the Adopt Anything portal is a digital semantic agent web entity. Which means that the functions of the portal, or website, were created, and invented to perform any action a person, user or automated mechanism can perform. Actions such as aggregation, storing data in databases, and folders, and creating digital semantic agent decisions, content, transformations of content, security and page creations are performed by the Adopt Anything digital semantic agent. In the presented invention we are adding additional new functions for aggregation, creating digital semantic agent decisions, content, transformations of content, security and page creations.

These are the modules we are using with the Digital Semantic Agent for dividing properties and making divided property transactions.

A Fair Value module, calculates the amount of money that something is worth the price or cost of something, in a fair way to all users.

A Fair Share module, calculates a portion belonging to, due to, or contributed by an individual or group. And what their ownership, contribution, loan, donation or labor value is.

A Fair Deal module, calculates how to give (something or an amount of something) to someone, to buy and sell as a business, and additionally to reach or try to reach a state of acceptance or reconciled agreement about real tangible or intangible object transactions.

A Fair Price module, calculates the amount of money that you pay for something or that something costs, and calculates the thing that is lost, damaged, or given up in order to get or do something, and additionally calculates the amount of money needed to persuade someone to do something, and calculates the quantity of one thing that is exchanged or demanded in barter or sale for another thing, and additionally calculates the amount of money given or set as consideration for the sale of a specified thing all in a fair way to the users in the network.

A Fair Division module, calculates how a real or intangible property should be divided for immediate trading, and sales.

A Fair Placement module, calculates putting something in a particular place, and finding an appropriate place for someone to live, work, or learn, or placing an object, advertisement, or website in a strategic location for best possible results, in a fair way to users in a network. So the more value a user adds to properties being placed, moves them to a more advantageous position in the crowd, cloud, group of users, Internet, search engine or network position.

A Micro Share Request Module, that calculates small shares of things, objects, real or intangible properties and makes an offer for a user in a network, for a fraction of the item. This is accomplished through a previously programmed Digital Semantic Agent, from a user submitting a form for a request to divide a property and make it available to the user so they can purchase a portion of a real or intangible property in a transaction. It is a proposal to divide a property, that can be submitted to a single or plurality of people.

A Fractional Request Module, that calculates separating components of a transaction, real or intangible property, or object through differences, determined by using all the modules including Fair Modules, and Micro Share Request Module in the system to create potential deals, suggestions, motivations to play, and potential transactions combined with the function of asking for collaborations related to the dividing of properties in a network for the benefit of the individual users. So this module takes properties aggregated data in the Fair “Value, Share, Deal, Price and Placement,” modules and creates divided fractional pieces of properties, and then using the Digital Semantic Agent creates Requests through the Fair Deal Module. So properties can be divided by user owners, and Requests for people to share, buy, sell, collaborate, or provide business, services, or products can be publicized to users in a network.

A Change Request Search Module, that allows users to change other users content, websites, objects, real or intangible properties utilizing functions, utilizing the following modules aggregated data.

A Random and/or Specified, Generating Objects Function Module utilizing the digital semantic agent for aggregation of new or existing images, videos, shapes, ideas, and structures to create and modify old properties into new properties.

A Random and/or Specified, Subjects, Thoughts and Goals Module that aggregates data for modifications of properties. We use the following aggregation steps: User submits keywords specified in a form and Digital Semantic Agent selects similar keywords, related to submission in specific aggregation areas.

A Random and/or Specified, Facts Module that aggregates facts for use in modifications of properties.

A Random and/or Specified, Emotional Module, that aggregates how a user feels at the moment of, and all through the process of modification of properties. User submits keywords specified in a form and Digital Semantic Agent matches and selects similar keywords, related to submission in the specified aggregation areas.

A Random and/or Specified, Current News Module, that aggregates news for modification of properties. User submits keywords specified in a form and Digital Semantic Agent selects and matches similar keywords, related to submission in specified aggregation areas.

A Random and/or Specified, Potential Negative Results (Adverse Reactions) Module, that calculates adverse reactions to the changed property.

A Random and/or Specified, Potential Positive Results (Benefits) Module that calculates beneficial reactions to changed properties. In this invention this works within the Request module.

A Random and/or Specified, Provocative Keywords, Images, and Videos converted into Text Module, that converts graphical objects and keywords into text, sentences, and phrases.

A Random and/or Specified, Provocative Text converted into Keywords, Images, and Videos Module that converts text, sentences, and phrases into other text, images and videos.

A Random and/or Specified, transformation module that transforms, re-purposes, and/or reformats all Random and/or Specified aggregated data into brand new divided, and/or Color Banded Property.

A Self Publishing Publicity module takes newly created, transformed and re-purposed web pages, images, videos, text, IP, and/or real tangible or intangible properties, and creates press release, and distributes the materials utilizing Digital Semantic Agent, and aggregated data in the presented invention.

Color Banded Property is a property that has been digitally transformed and registered utilizing a Digital Semantic Agent in the method and mechanism invention. It utilizes 52 color band designated pixel areas, that are converted into 4 wave forms, and 13 levels of lightness and darkness are aggregated in the transformations, for the purpose of precisely identifying objects and humans.

We use Algorithmic Mechanism Design for the functions related to the Digital Semantic Agent in the presented invention method and mechanism.

Algorithmic mechanism design (AMD) lies at the intersection of economic game theory and computer science. It combines ideas such as utility maximization and mechanism design from economics, rationality and Nash equilibrium from game theory, with such concepts as complexity and algorithm design from discrete mathematics and theoretical computer science. Examples of topics include networking, peering, online auctions and exchanges, online advertising, and search engine's page ranking. Algorithmic mechanism design differs from classical economic mechanism design in several respects. It typically employs the analytic tools of theoretical computer science, such as worst case analysis and approximation ratios, in contrast to classical mechanism design in economics which often makes distributional assumptions about the agents. It also considers computational constraints to be of central importance: mechanisms that cannot be efficiently implemented in polynomial time are not considered to be viable solutions to a mechanism design problem.

### SUMMARY OF THE INVENTION

The presented invention is a method for a real or intangible property owner, user, or an advertising sponsor user, using a client computer, or mobile device to be able to register, login and divide their real or intangible property into fractions or pieces, for the purpose of creating new transact-able identifiable micro properties and create zip code related local sponsor advertisements, with small advertisements for creating interest in the offers, that link to bigger advertisements with an embedded shopping cart. When a user creates the micro transact-able property advertisements, they can upload their images, and create fractional divided micro offers in the same interface form and the advertisements are instantly created and able to be published immediately throughout an exchange network.

Utilizing zip codes allows the system to use an intelligent smart decision engine, to make decisions of where advertisements and campaigns should be displayed as related to registered users locations for marketing and targeting. Also past performance of the main property and the fractional properties created and past advertisement information is utilized by the present invention to make appraisal value judgments as to the value of real or intangible property pieces divided and advertisements for sale, and collaboration micro property piece campaign values for sale.

When a user creates property fraction campaigns that have transformed the real or intangible property into pieces or shares, a real bank account and a virtual bank account is created with credit card, debit card, coupon and/or voucher payments connected to the user account and a financial institution of their choosing, or designated financial institution by the system.

All transactions from the property fraction campaigns and advertisements are associated with bar codes that are in the possession of the merchant business, or property right full owner which can be scanned at point of purchase. The fractional pieces of the real property divisions with accounting and discounts are automatically applied to the incentive management system in the main invention server location. By having advertisements linked to embedded shopping carts the users can purchase new pieces of property or previously used pieces of property, items, products or services and can lock in coupons, offers and discounts for future uses and merchant location fulfillments.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a Registration, Aggregation, Fractional Request Module, and Search Application Module;

FIG. 2 illustrates a Registration Module Creation Identification Functions;

FIG. 3 illustrates a Registration Module Fractional and Divided Property Identification Functions;

FIG. 4 illustrates the Human Key with additional pattern extractor identification device, 3D object measurement Device, And Spatial Point Verification Device of the present invention;

FIG. 5 illustrates a Digital Semantic Agent functions and aggregation RSS News Feeds;

FIG. 6 illustrates a Digital Semantic Agent functions and aggregation Flow Chart Mysql database;

FIG. 7 illustrates a Digital Semantic Agent functions and aggregation pay portal;

FIG. 8 illustrates a Digital Semantic Agent functions and aggregation pay functions;

FIG. 9 illustrates a Digital Semantic Agent functions and aggregation human response statements;

FIG. 10 illustrates a Adopt Anything Digital Semantic Agent functions;

FIG. 11 illustrates a Digital Semantic Agent functions and aggregation;

FIG. 12 illustrates a Digital Semantic Agent functions and aggregation;

FIGS. 13-21 illustrate a Digital Semantic Agent functions and aggregation;

FIGS. 22-32 illustrate an Aggregation of data for digital semantic agent, functions;

FIG. 33 illustrates a Digital Semantic Agent functions and aggregation advertising;

FIG. 34 illustrates a Digital Semantic Agent functions and aggregation presented web page;

FIG. 35 illustrates a Digital Semantic Agent functions and aggregation presented admin page;

FIG. 36 illustrates a Digital Semantic Agent functions;

FIG. 37 illustrates a Digital Semantic Agent functions;

FIG. 38 illustrates a Adopt Anything Digital Semantic Agent functions and aggregation widget;

FIG. 39 illustrates a Digital Semantic Agent functions and aggregation created results;

FIG. 40 illustrates a Digital Semantic Agent form functions;

FIG. 41 illustrates a Digital Semantic Agent storage functions and aggregation;

FIG. 42 illustrates a Digital Semantic Agent functions and aggregation portal bot is another Digital Semantic Agent;

FIG. 43 illustrates a Digital Semantic Agent functions and aggregation;

FIGS. 44-47 illustrate a Digital Semantic Agent functions and aggregation;

FIG. 48 illustrates a Digital Semantic Agent Adopt Anything functions and aggregation;

FIG. 49 illustrates a Digital Semantic Agent functions and aggregation;

FIG. 50 illustrates a Digital Semantic Agent functions and aggregation user criteria for data desired;

FIG. 51 illustrates a Digital Semantic Agent functions and aggregation user form;

FIG. 52 illustrates a CODEFA object registry functions;

FIG. 53 illustrates a Digital Semantic Agent, protect Anything Human key aggregation functions;

FIG. 54 illustrates a Digital Semantic Agent functions and aggregation;

FIG. 55 illustrates a Digital Semantic Agent Protect Anything functions, user interface and aggregation widget;

FIG. 56 illustrates a Digital Semantic Agent mobile phone aggregation functions and aggregation;

FIG. 57 illustrates a CODEFA object registry functions;

FIGS. 58-59 illustrate a Digital Semantic Agent Request search engine functions and aggregation;

FIG. 60 illustrates a Digital Semantic Agent search edit form functions and aggregation;

FIG. 61 illustrates a Digital Semantic Agent search edit form functions and aggregation;

FIG. 62 illustrates a Digital Semantic Agent search edit form certification functions and aggregation;

FIG. 63 illustrates a Digital Semantic Agent video edit form functions and aggregation;

FIGS. 64-66 show an Independent Clearing House Agent which is a Digital Semantic Agent, and the World Bot Agent making deals for the user;

FIGS. 67-68 shows pre and post phrase human semantic processors;

FIG. 69 shows form for semantic keyword aggregation;

FIG. 70 shows CODEFA using human key functions;

FIG. 71 shows Fair value share aggregation steps;

FIGS. 72-79 shows a semantic keyword balance with relevance, semantic natural inferences bot, semantic terms, human semantic comparisons, semantic processor, human phrase semantic comparisons, semantic evaluations, “G” processor;

FIGS. 80-104 shows the human key redundancies and tests for identification of humans and objects, utilizing Digital Semantic Agents;

FIG. 105 shows color band human key creation and authorization;

FIG. 106 shows color band encryption and de encryptions;

FIG. 107 shows spatial point targeting;

FIG. 108 shows pixel wave form color band encryptions;

FIG. 109 shows human key functions;

FIG. 110 shows aggregation of human semantic keywords;

FIG. 111 shows digital semantic agent automatic reminders;

FIG. 112 shows measurements and spatial point targeting with Human Key functions;

FIG. 113 Digital Semantic Agent semantic keyword balance with relevance;

FIG. 114 Digital Semantic Agent semantic steps and functions, semantic natural inference bot;

FIG. 115 Compares Digital Semantic Agent semantic sources and semantic terms;

FIG. 116 Semantic Keyword search Functions;

FIG. 117 Digital Semantic Agent semantic functions, aggregated comparing semantic search terms;

FIG. 118 Semantic Search reasoning engine;

FIG. 119 CODEFA Human Semantics Processor;

FIG. 120 Human Semantics Comparison;

FIG. 121 Human Key Semantic processor generator;

FIG. 122 Pre Post phrase semantic comparison;

FIG. 123 Email used with semantic processor;

FIG. 124 Semantic Phrase Comparative Analysis “G” processor mechanism;

FIGS. 125-140 shows a Digital Semantic Agent for transformations and re purposing of properties;

FIG. 141 shows Digital Semantic Agent advertising maker front end form;

FIG. 142 shows software module determining value of a campaign which is a digital semantic agent;

FIG. 143 shows functions, of digital semantic agent advertisement creator;

FIG. 144 shows an apparatus that shows all methods, functions, and mechanisms and digital semantic agents, working under one system;

FIG. 145 shows managements of creations transforms and processes;

FIG. 146 shows digital semantic agent steps to valuation, and ownership of intellectual property;

FIGS. 147-151 show Human Key functions;

FIG. 152 shows Digital Semantic Agent semantic keyword steps to aggregation;

FIG. 153 shows Digital Semantic Agent semantic steps and functions;

FIG. 154 shows Digital Semantic Agent semantic steps for semantic evaluation for content provider;

FIGS. 155-156 show Human Key Functions;

FIG. 157 Digital Semantic Agent semantic functions, steps appraisals, and virtual cash deposited in bank at time of registration;

FIG. 158 Digital Semantic Agent semantic keyword steps used with human key in processing;

FIG. 159 Digital Semantic Agent semantic keyword steps with virtual cash disbusal and human key steps to authentication;

FIG. 160 shows Translations methods;

FIG. 161-162 shows Human Key functions, analysis of humans versus objects, edge shape analysis;

FIG. 163 shows Spatial Point Targeting method used in invention; and

FIG. 164 shows Measurements of forward focused objects, and audio distance measurement method.

### DETAILED DESCRIPTION OF THE INVENTION

A human key, human identification key or human key module is defined as a collection of processor steps, within a computer server, and/or networked to other computer servers, that processes, facial and voice data, in a method where a person looking at the cam and talking or saying a phrase is identified, in a computer that work in real time to store and cross reference data for identification and security, as related to using an individual unique human being as a user name, password, key or any other unique identifier of that unique human being, a Human Key can be attached to and/or substituted for QR code uses throughout the invention.

The “Human Key” server is a computer/machine that uses Human Key software and modules to identify a specific individual human, by first taking and aggregating information using a camera or plurality of cameras, with audio voice recording, combined with other aggregated data to show unique human aspects for identification, then uses this same data to verify identity of the human when called for by the machine server.

When addressing the functions of this invention of “Connecting a human key to objects and content for identification” we must first provide processes for registration of humans, and registration of objects in the system. Then after the registration we can attach, connect, and show rightful identification of humans and objects. So what we are presenting here is the processes a programmer skilled in the art can use to Register, encrypt de-encrypt, use, connect, attach files, objects, and humans for rightful ownership and use in networks.

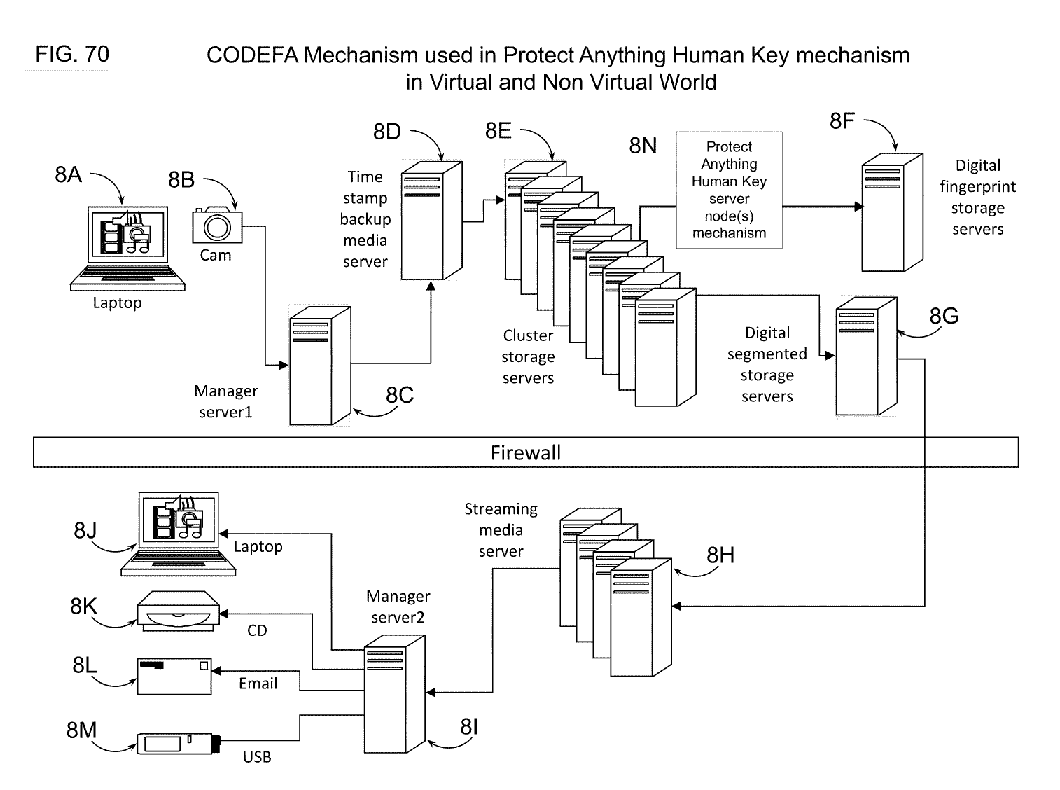

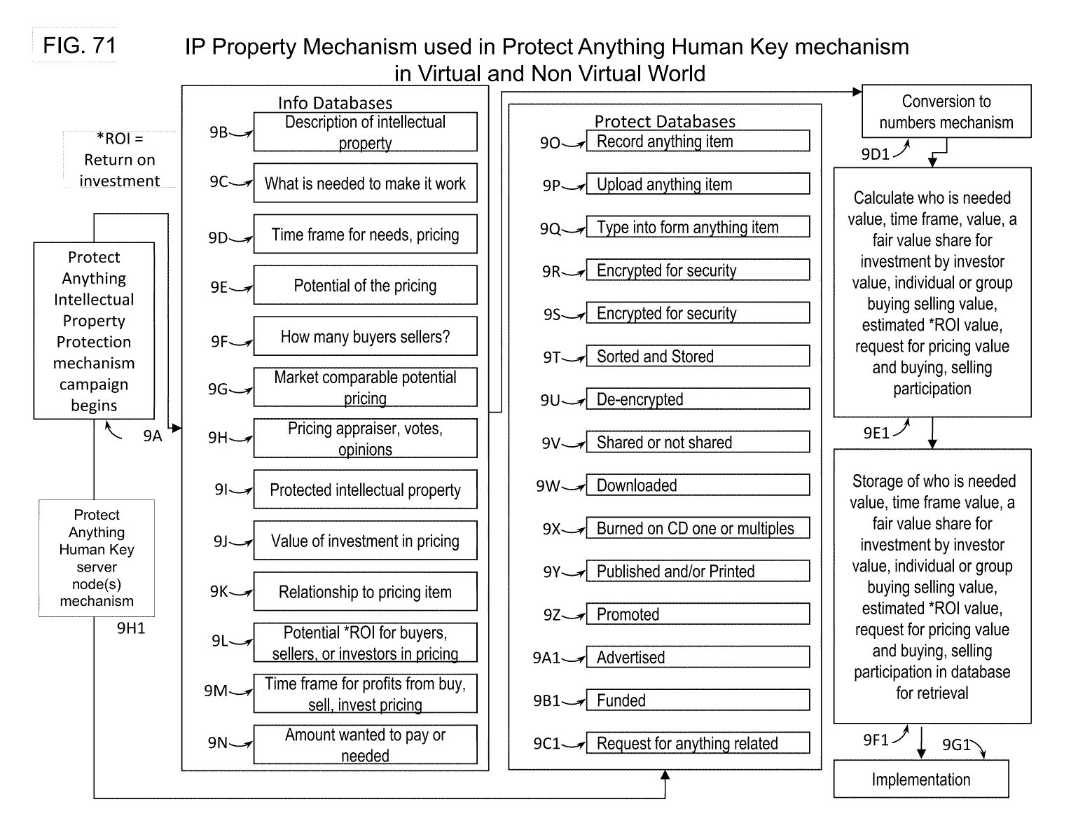

To accomplish these processes we show using a “Human Key” human registration system and a “CODEFA” object registration system. These processes are clearly shown in FIGS. 70-71 which shows how Human Key works, and steps related to taking files and creating a unique CODEFA number to identify an object from video, or images.

By having a Human Key that identifies humans and having a CODEFA number registered for identification of objects you have the human key attached, connected and provided to an Object by way of CODEFA encryption number for identification.

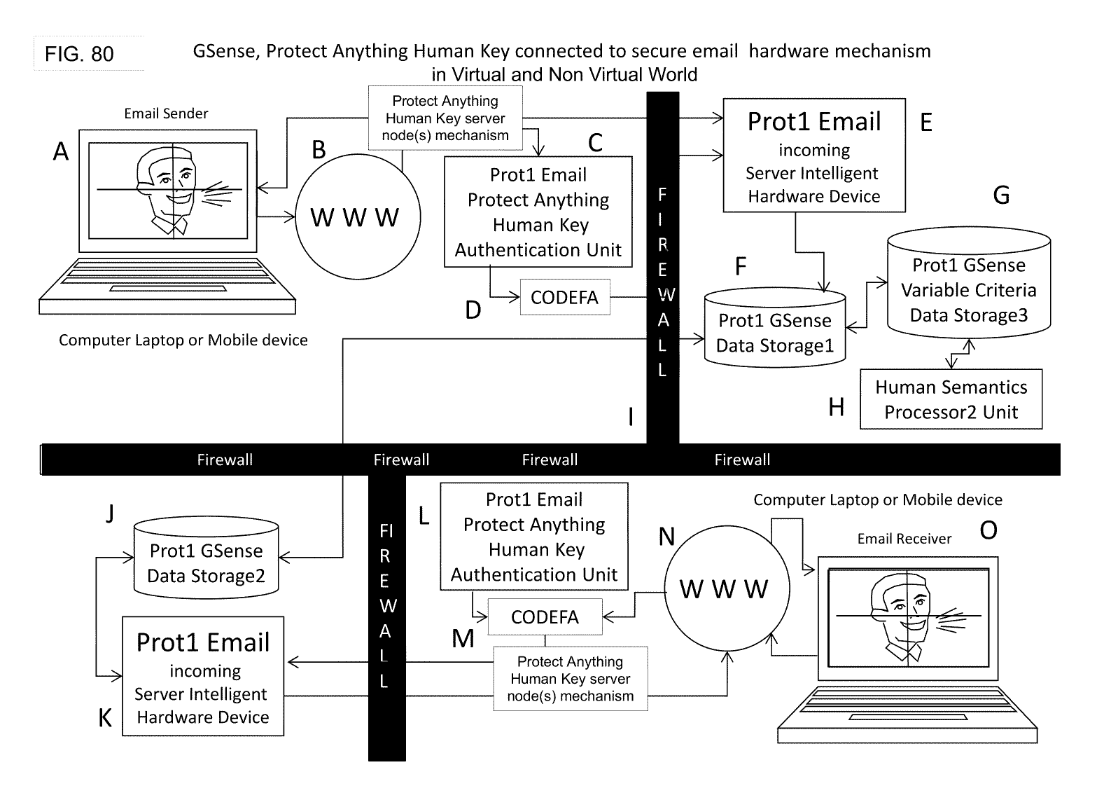

FIG. 80-104 show the individual processing methods used in a processor in a computer, that are used by the human key as steps to providing multiple redundant identification processes aggregated at the time of registration of a human or an object in the invention. Any programmer with average skills could take these steps and create the human key registration system.

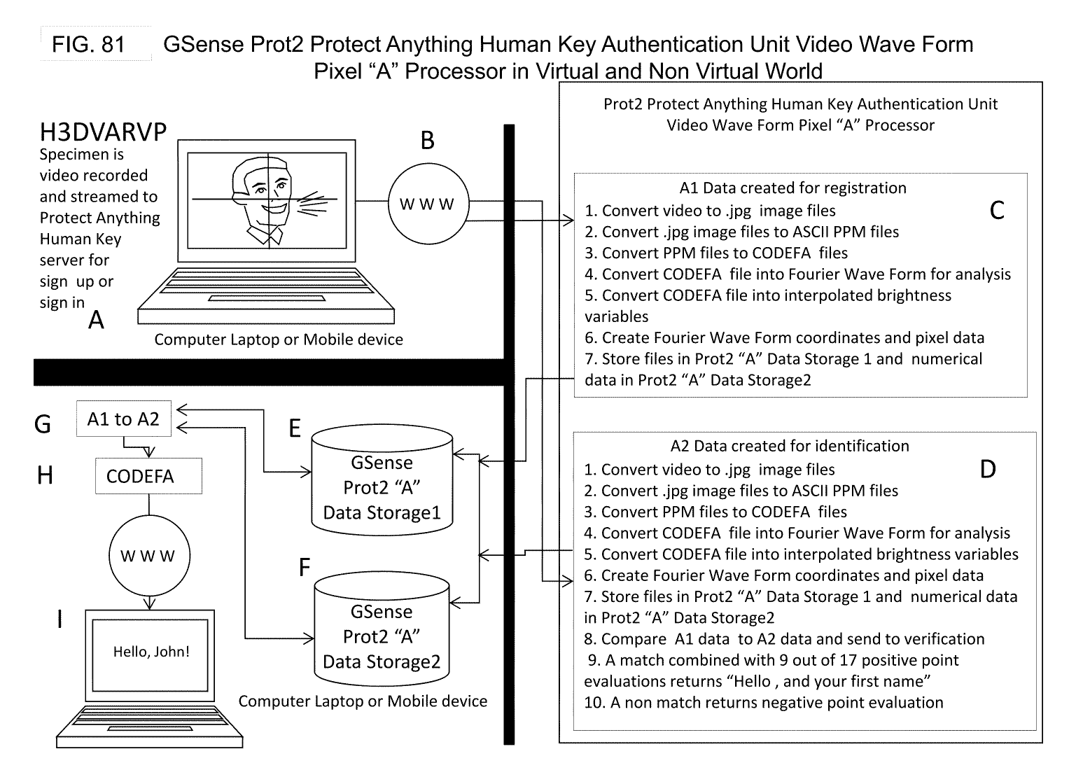

FIG. 81 “A” Processor which converts video and images to Wave Form for analysis, for as demonstrated in C registration and a separate process method for D identification. Then it shows where the CODEFA object identification registration system is added at the end of the process. CODEFA takes an objects video or image and breaks it down to a file that can not be used, or encrypts it, and assigns it a number. Then CODEFA reassembles the object identification file for use later on by de-encrypting it.

A plurality of individual registration processes, steps, for encrypting and de-encrypting and future identification are carried out at the time of registration of humans, and objects in the invention. A programmer with skill in the art would be able to create these video, audio, image, and measurement processes with the information provided in this invention.

The word “fair” is used in the invention with the context of, treating people or users in a way that does not favor some over others. A Fair Value module, calculates the amount of money that something is worth: the price or cost of something, in a fair way to all users.

To calculate fair value of a property we need these steps utilizing number, and currency values, aggregated into data for processing into the Fair Value amount: future growth rates of property in percentages (exp. 10% 20%); profit margins (already profitable); loss margins (already losing money); risk factors (current similar issues publicized or published); Days to expiration of property (does it have a life span exp. −10 weeks not so good +10 weeks better); amount of items that make up property (pieces, components, parts how many); price total value of items that make up property; (total of the pieces cost, value) amount of properties (how many properties being valued); Fair Division of property calculated FDP; contributions to properties (how much was added to the value); cost of making a property (how much to make another similar property); who owns property or pieces of property (does someone notable own property being valued); what have other similar properties been valued at (requires aggregating all properties similar, and getting data about those properties publicized); how is property stored and protected (warehouse, insurance costs); where is property located (location based pricing); how much is the maintenance of the property (people related to maintaining property costs); what would the property bring at auction (estimate of auction value from previously similar auctioned property); how many places has the property been publicized (public familiarity data); how much was spent on creating the property (amounts time funds, real funds, virtual funds spent to create property); how much credit funds (was credit used for funding); how fast do the items that make up the property lose value (is there a depreciation factor amount); how much outstanding loans on property; then all of the above aggregated data is calculated to get a final CV Calculated Value; then take CV value and search for similar properties; add up the value of 4 CV equal priced similar properties which becomes X; then where X=what ever reliable information was aggregated about similar properties, and calculated into one value by adding them; where 1/4 of X=FV is dividing X by 4=FV;

where as FV is the resulting Fair Value of a property; then we add the price of X similar properties and divide by ¼ of X=FV Fair Value or FVP Fair Value of Property. where also FDP can also be divided between set specified numbers of users.

A Fair Share module, calculates a portion belonging to, due to, or contributed by an individual or group. And what their ownership, contribution, loan, donation or labor value is. And we use the following steps in aggregation by the method used in a processor on a computer for the calculation; calculate and determine Fair Value of Property FVP; calculate Fair Division of Property; FDP how many users are sharing property US; how many users are contributing to the property TUC Total User Contribution; how much is each user contributing UC User Contribution what is the total users combined contributing value UCV; how much is the divided property pieces owned by the sharing users Price Per User PPU how much % is time contribution worth TC how much % is funding contribution worth FC then calculate percentage by dividing FVP/US−UC=PPU then calculate user fair share percentage FS % FVP/US+ or −TUC, UC, TC, FC=X then divide FVP/X=FS %

A Fair Deal module, calculates how to give (something or an amount of something) to someone, to buy and sell as a business, and additionally to reach or try to reach a state of acceptance or reconciled agreement about real tangible or intangible object transactions.

Micro Share Request is calculated and performed by these steps; we take Fair Share Percentage FS %;

we utilize Digital Semantic Agent to send email with FS % request to potential deal user participant; we receive additional value added by user data; we evaluate that data, for value; we receive counter offer FS %; we send counter offer to owner of property with new additional data; we take acceptance or denial of counter offer, and forward to user to make and confirm deal or to take new counteroffer for deal; after sharing user and owner user agree to Fair Deal deal is transacted.

A Fair Price module, calculates the amount of money that you pay for something or that something costs, and calculates the thing that is lost, damaged, or given up in order to get or do something, and additionally calculates the amount of money needed to persuade someone to do something, and calculates the quantity of one thing that is exchanged or demanded in barter or sale for another thing, and additionally calculates the amount of money given or set as consideration for the sale of a specified thing all in a fair way to the users in the network.

Fair price is the same as Fair Value except damage variables, and transaction costs, exchange value, barter or sale value, fees set for transaction are added to the calculation.

A Fair Division module, calculates how a real or intangible property should be divided for immediate trading, and sales, taking into account; participations of users; contributions of users; surface imaging of real properties; file encryptions and de-encryption of non tangible files and transactions; colors; sizes; shapes; and main whole evaluation of the value of the property assembled or made whole by rightful owners in a fair way to users in a network.

A Fair Placement module, calculates putting something in a particular place, and finding an appropriate place for someone to live, work, or learn, or placing an object, advertisement, or website in a strategic location for best possible results, in a fair way to users in a network. So the more value a user adds to properties being placed, moves them to a more advantageous position in the crowd, cloud, group of users, Internet, search engine or network position.

Any programmer skilled in the art could take the aggregated data specified, keywords and semantic phrases, and rules utilizing an Open Source search application designed for relational searches such as the open source Nutch search engine, in the method presented, and create relational database decisions, and suggestions for Fair Value, Share, Deal, Price, Division, and Placement in the present invention.

A Micro Share Request Module, that calculates small shares of things, objects, real or intangible properties and makes an offer for a user in a network, for a fraction of the item. This is accomplished through a previously programmed Digital Semantic Agent, from a user submitting a form for a request to divide a property and make it available to the user so they can purchase a portion of a real or intangible property in a transaction. It is a proposal to divide a property, that can be submitted to a single or plurality of people.

A Digital Semantic Agent can perform any action a person, user or automated mechanism can perform. The digital semantic agent is a set of instructions executed by a machine, such as computer, which is equivalent to a software module, or equivalent method or software structure for identifying, determining, and effectuating a purchase or sale of a property or any agent or module for making value determinations as taught and claimed by the present invention. The digital semantic agent is provided as a set of instructions executed by a machine, such as computer and made available by a display screen of such as device. A user then interacts with the machine/computer, and the digital semantic agent running the set of instructions as a method performs the steps claimed.

Digital” (adj.) Describes any system based on discontinuous data or events. Computers are digital machines because at their most basic level they can distinguish between just two values, 0 and 1, or off and on. There is no simple way to represent all the values in between, such as 0.25. All data that a computer processes must be encoded digitally, as a series of zeroes and ones. See http://www.webopedia.com

“Semantic Web application” is a term used to describe Web-based applications that incorporates principles or technologies of the W3C Semantic Web, such as RDF, OWL and other metadata standards. See http://www.webopedia.com

“Semantics” in linguistics, the study of meanings. In computer science, the term is frequently used to differentiate the meaning of an instruction from its format. The format, which covers the spelling of language components and the rules controlling how components are combined, is called the language's syntax. For example, if you misspell a command, it is a syntax error. If, on the other hand, you enter a legal command that does not make any sense in the current context, it is a semantic error. See http://www.webopedia.com

An “agent” is defined as (n.) A program that performs some information gathering or processing task in the background. Typically, an agent is given a very small and well-defined task. Although the theory behind agents has been around for some time, agents have become more prominent with the growth of the Internet. Many companies now sell software that enables you to conFig. an agent to search the Internet for certain types of information. See http://www.webopedia.com

In computer science, there is a school of thought that believes that the human mind essentially consists of thousands or millions of agents all working in parallel. To produce real artificial intelligence, this school holds, we should build computer systems that also contain many agents and systems for arbitrating among the agents' competing results.

A “user agent”, in Google Analytics, a user agent is a term used to mean any program used for accessing a Web site. This includes browsers, robots, spiders and any other program that was used to retrieve information from the site. A “Semantic Web application” is a term used to describe Web-based applications that incorporates principles or technologies of the W3C Semantic Web, such as RDF, OWL and other metadata standards.

In the patent application Ser. No. 12/459,353 specification, when “Adopt Anything” is referenced it is defined as a “Digital Semantic Agent”. The agent of the present invention aggregates data by itself, to enable a machine to intelligently make decisions, transform things, communicate with other machines, and create forms, questions, and other different content.

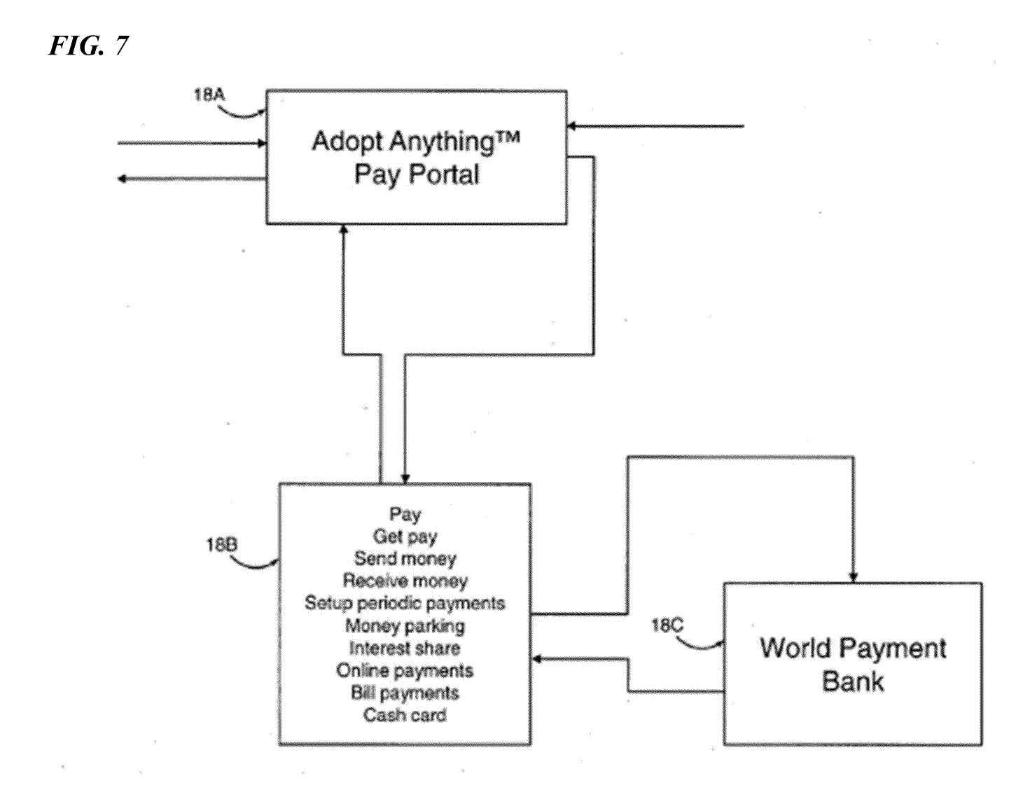

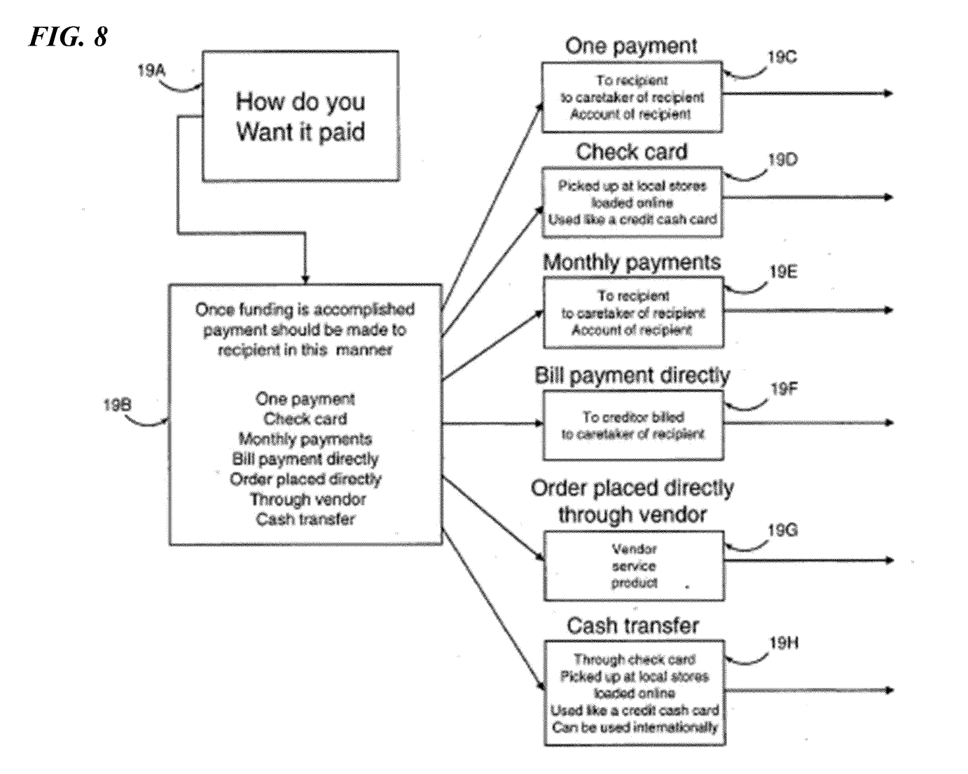

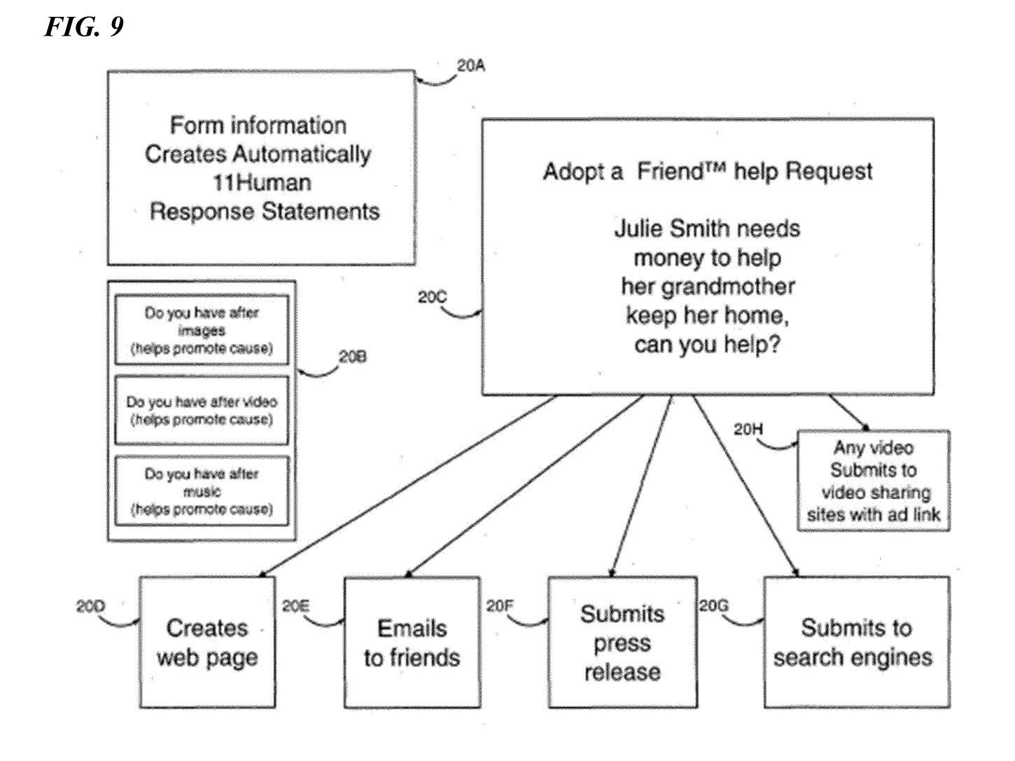

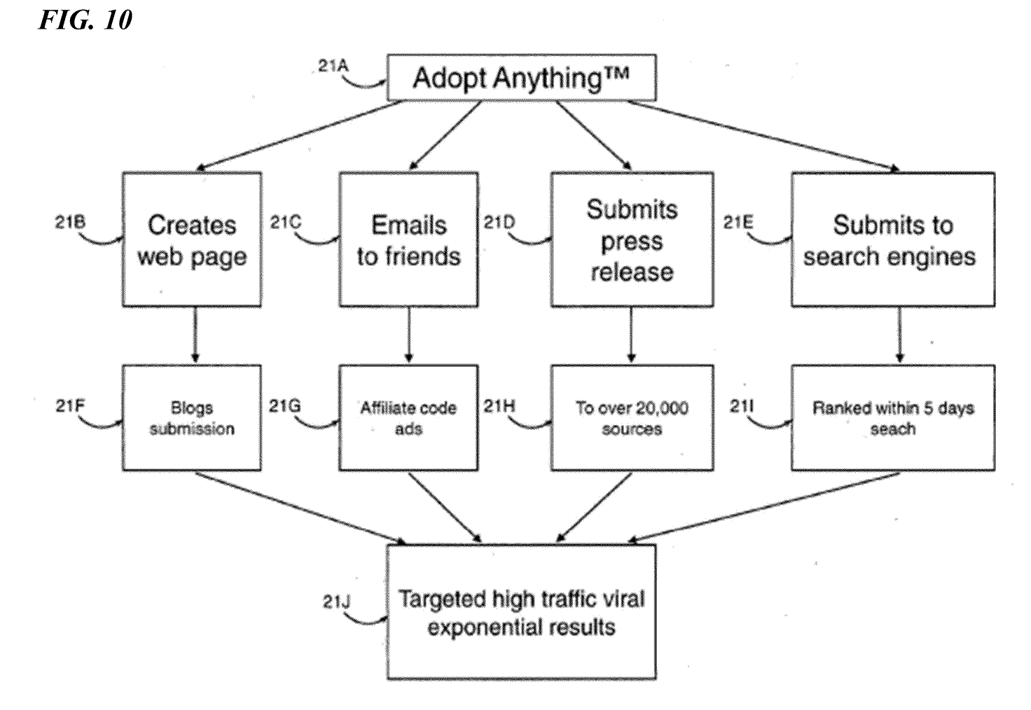

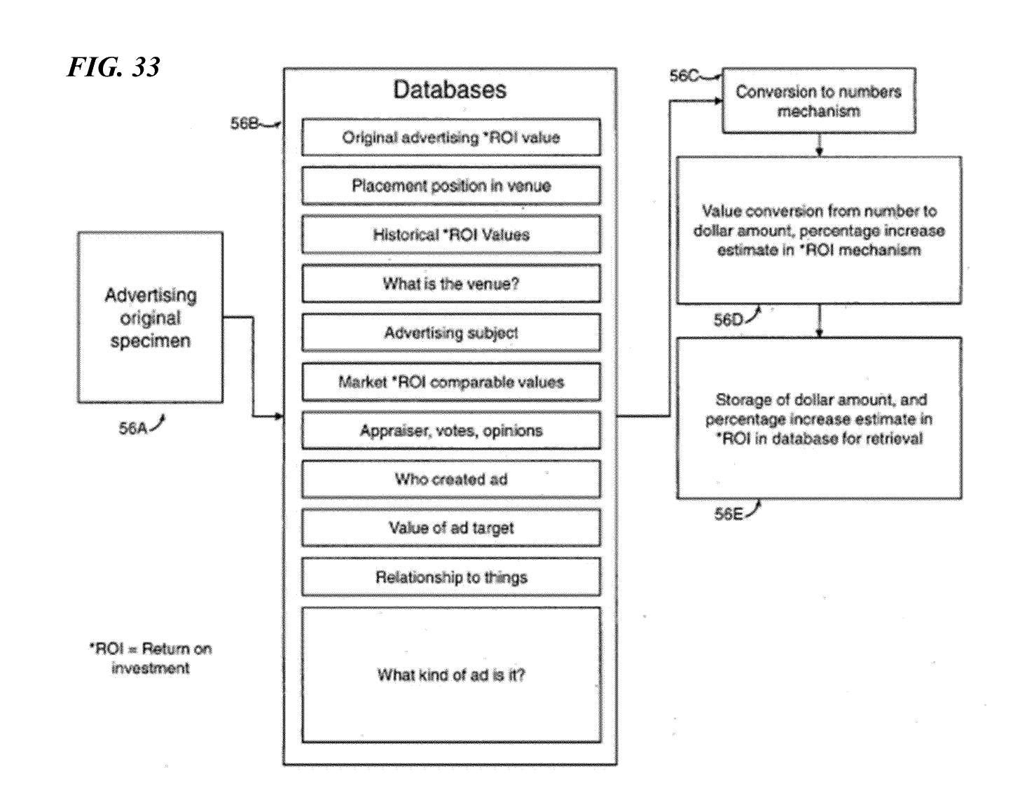

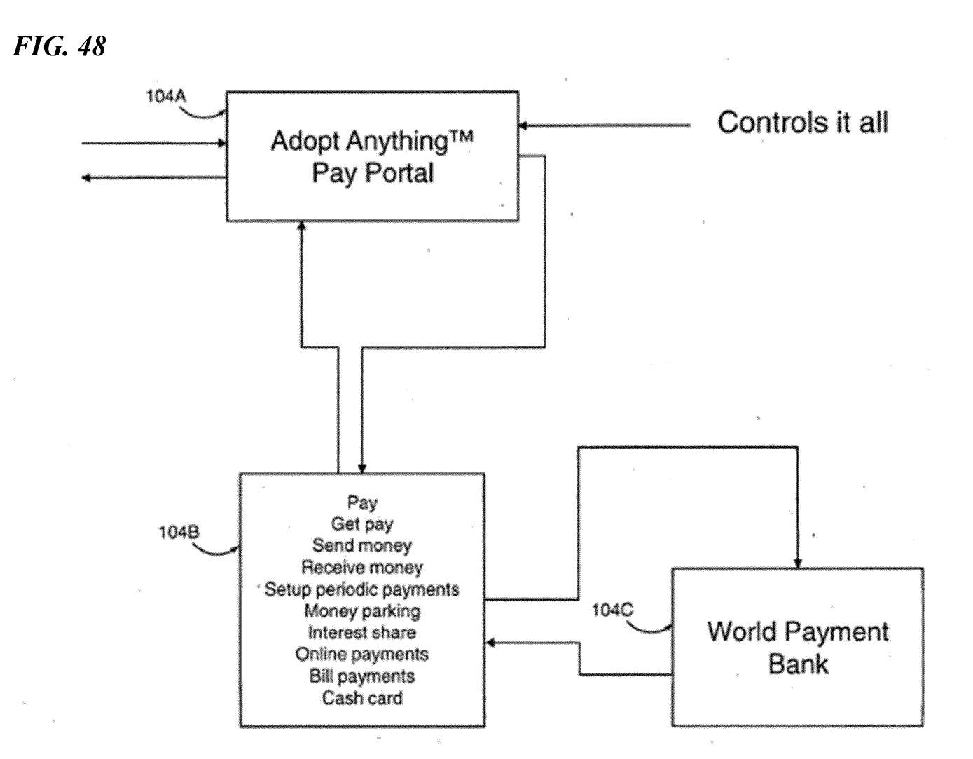

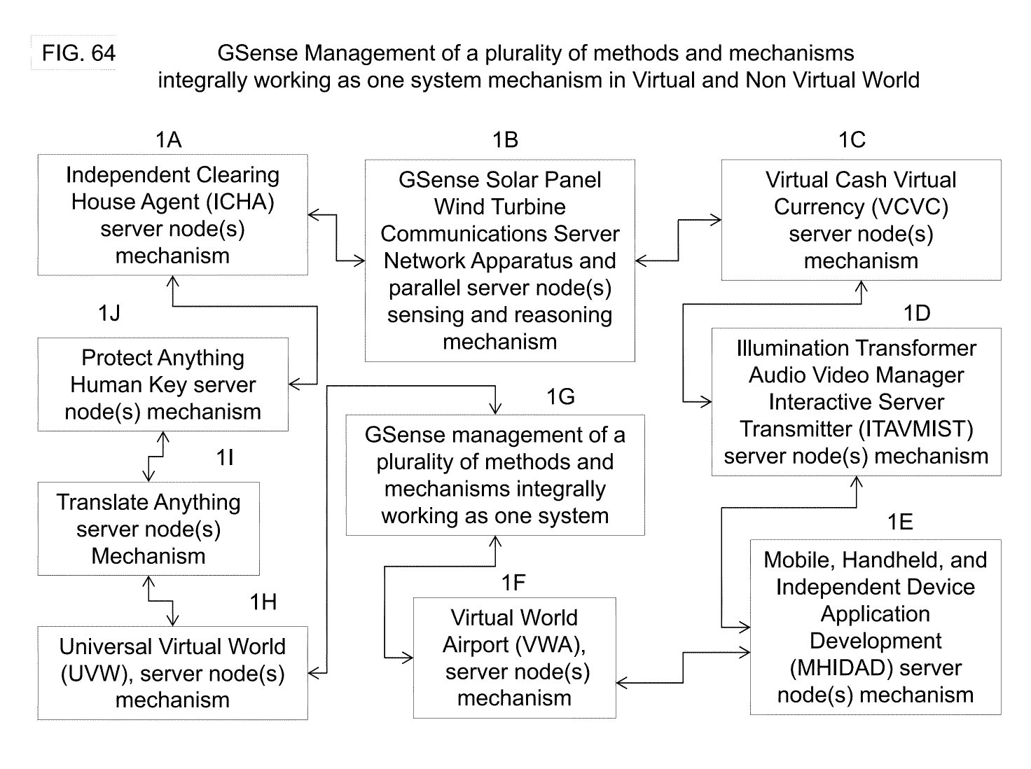

FIG. 7 in the specifications drawings of Ser. No. 12/459,353 shows the “Digital Semantic Agent” Adopt Anything aggregating data. FIG. 8 shows the “Digital Semantic Agent” Adopt Anything transformation of data. FIG. 9 shows another process by the “Digital Semantic Agent” Adopt Anything. FIG. 10-32 shows aggregation processes by the “Digital Semantic Agent” Adopt Anything. FIG. 33-39 Show results created by the “Digital Semantic Agent” Adopt Anything. FIGS. 48, 49, 50, 51 and 55 show more aggregation created by the “Digital Semantic Agent” Adopt Anything. FIG. 64, 65, 66 show the automatic generation of request for proposals and decisions created by the “Digital Semantic Agent” Adopt Anything.

Semantic agent systems are about the integration of the semantic Web, software agents, and multi-agent systems technologies. Like in the past (e.g. biology and informatics yielding bioinformatics) a whole new perspective is emerging with semantic agent systems. In this context, the semantic Web is a Web of semantically linked data which aims to enable man and machine to execute tasks in tandem. Here, software agents in a multi-agent system as delegates of humans are endowed with power to use semantically linked data. This edited book “Semantic Agent Systems: Foundations and Applications” proposes contributions on a wide range of topics on foundations and applications written by a selection of international experts. It first introduces in an accessible style the nature of semantic agent systems. Then it explores with numerous illustrations new frontiers in software agent technology. “Semantic Agent Systems: Foundations and Applications” is recommended for scientists, experts, researchers, and learners in the field of artificial intelligence, the semantic Web, software agents, and multi-agent systems technologies.

In computing, a user agent is software (a software agent) that is acting on behalf of a user. For example, an email reader is a Mail User Agent, and in the Session Initiation Protocol (SIP), the term user agent refers to both end points of a communications session.

In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

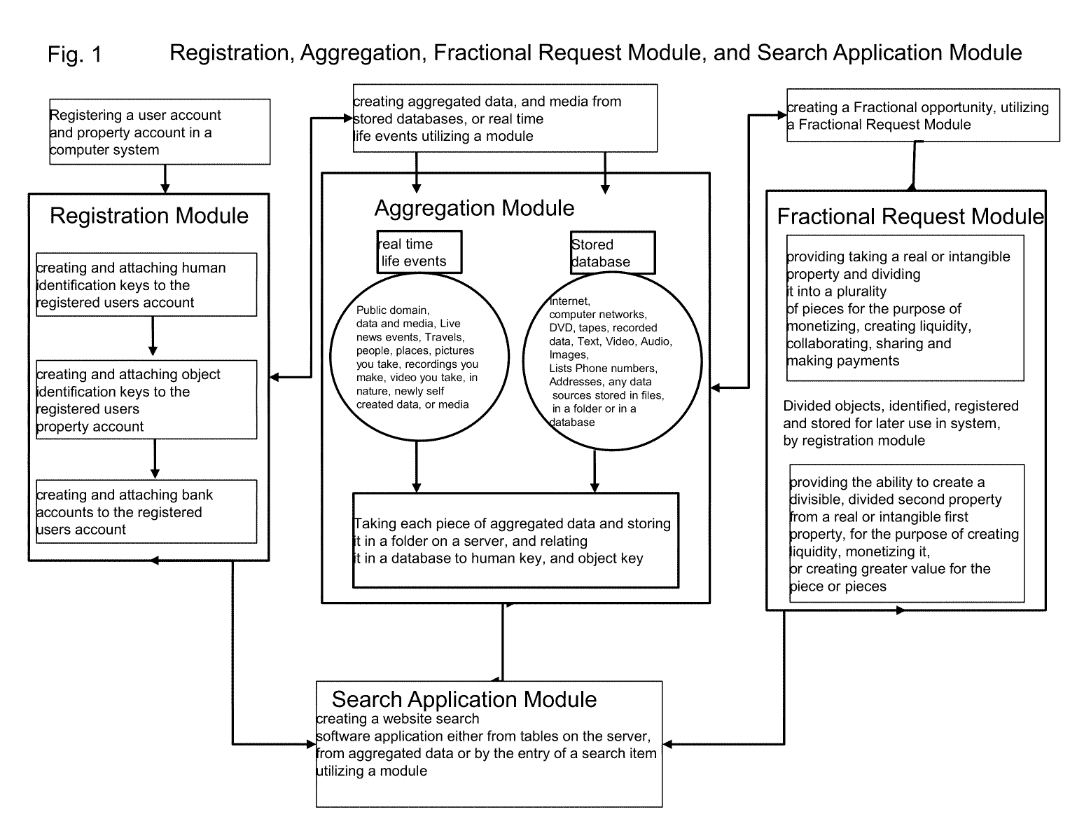

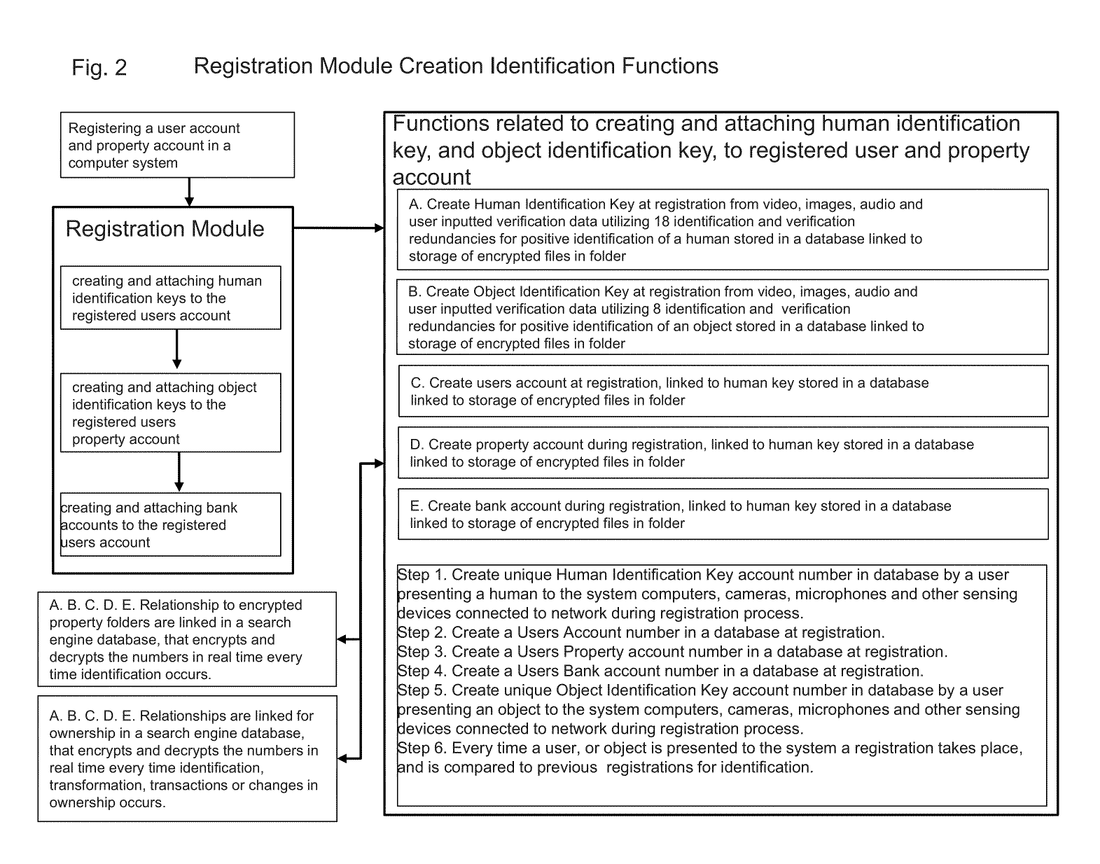

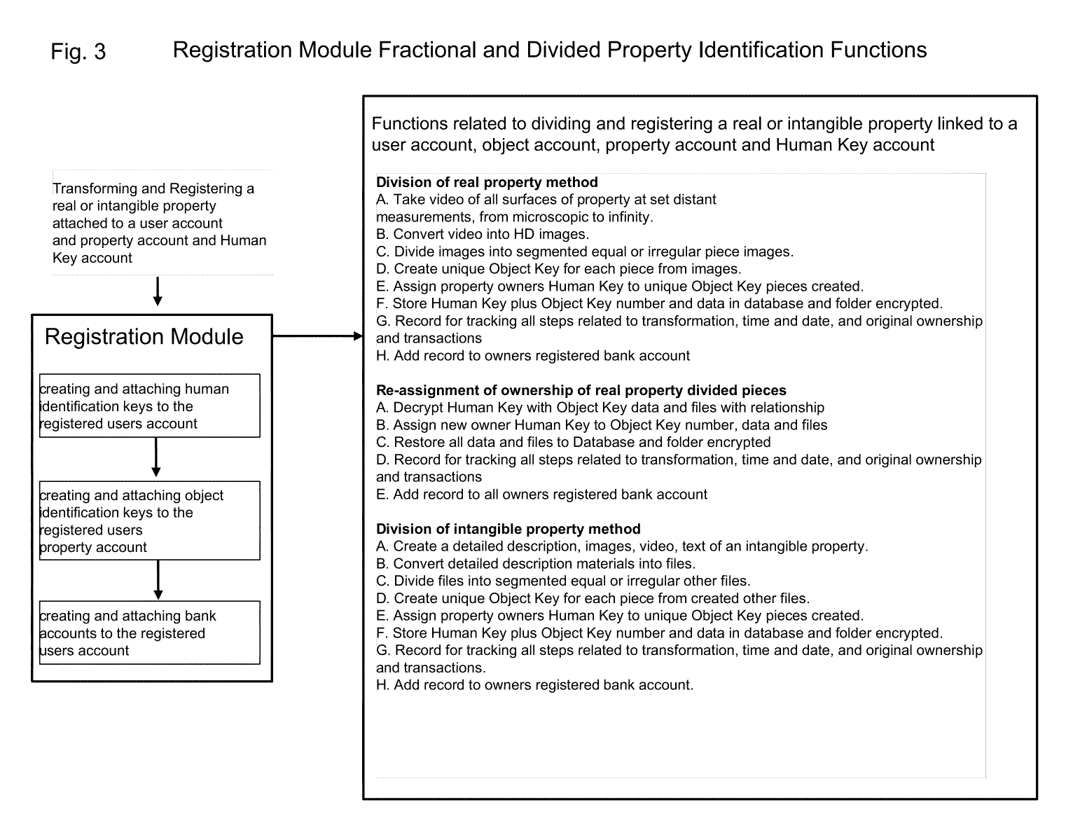

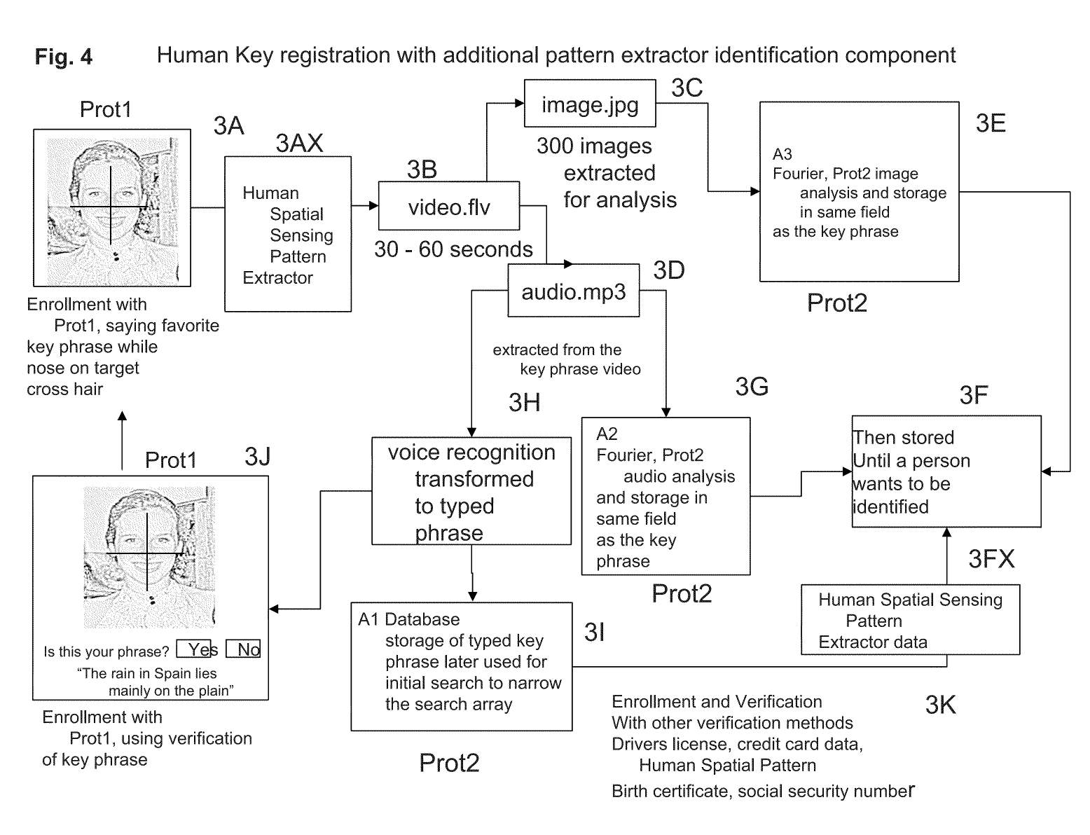

Now referring to FIGS. 1-3. a Fractional Request Module, that calculates separating components of a transaction, real or intangible property, or object through differences, determined by using all the modules including Fair Modules, and Micro Share Request Module in the system to create potential deals, suggestions, motivations to play, and potential transactions combined with the function of asking for collaborations related to the dividing of properties in a network for the benefit of the individual users. So this module takes properties aggregated data in the Fair “Value, Share, Deal, Price and Placement,” modules and creates divided fractional pieces of properties, and then using the Digital Semantic Agent creates Requests through the Fair Deal Module. So properties can be divided by user owners, and Requests for people to share, buy, sell, collaborate, or provide business, services, or products can be publicized to users in a network.

The steps are: Owner user uses form to submit files, text, images, video, and information to the system; System modules divide the property for transactions; Property is valued; determining the market value of a property; determining the value of an intellectual property; determining ownership and control of a subsequent properties; calculating an ownership percentage that is protected between two or more owners in relation to a shared and protected property; calculating advertising rates and valuations of a property; Deals are determined; Potential deals are solicited to related users for participation in transactions; arbitrating a deal; suggesting and negotiating a deal between a two or more users; requesting proposals and prices; providing an advertising system for buying, selling, targeting, and placing advertisements, individually, in groups, or through the automatic digital semantic agent.

A Property is something that is owned by a person, business, government etc. and in most aspects of the invention, a property is something owned by a person that is changed or transformed by the invention.

A Change Request Search Module, that allows users to change other users content, objects, real or intangible properties utilizing functions, such as: A Random and/or Specified, Generating Objects Function Module utilizing the digital semantic agent for aggregation of new or existing images, videos, shapes, ideas, and structures to create and modify old properties into new properties. Utilizing the following steps; we take form submitted semantic keywords; we search outside of web forms through shell the Internet utilizing multiple different search engines; In the Random and/or Specified, Subjects, Thoughts and Goals Module that aggregates data for modifications of properties. We use the following aggregation steps: User submits keywords specified in a form and Digital Semantic Agent selects similar keywords, related to submission in these aggregation areas; subjects from the Internet related; thoughts submitted by users related; and user goals that are related; and aggregates data to be used by the system.

Digital Semantic Agent creates random keywords, and inputs them in a form and selects similar keywords, related to; subjects from the Internet related; thoughts submitted by users related; and user goals that are related; and aggregates data to be used by the system.

A Random and/or Specified, Facts Module that aggregates facts for use in modifications of properties. And works with the following steps: User submits keywords specified in a form and Digital Semantic Agent selects similar keywords, related to submission in these aggregation areas; facts related subjects from the Internet related; facts related thoughts submitted by users related; and user facts related goals that are related; and aggregates data to be used by the system.

Digital Semantic Agent creates random keywords, and inputs them in a form and selects similar keywords, related to; facts related subjects from the Internet related; facts related thoughts submitted by users related; and user facts related goals that are related; and aggregates data to be used by the system.

A Random and/or Specified, Emotional Module, that aggregates how a user feels at the moment of, and all through the process of modification of properties.

User submits keywords specified in a form and Digital Semantic Agent selects similar keywords, related to submission in these aggregation areas; user emotional facts related subjects from the Internet related; user emotional facts related thoughts submitted by users related; and user emotional facts related goals that are related;
and aggregates data to be used by the system.

Digital Semantic Agent creates random keywords, and inputs them in a form and selects similar keywords, related to; user emotional facts related subjects from the Internet related; user emotional facts related thoughts submitted by users related; and user emotional facts related goals that are related; and aggregates data to be used by the system.

A Random and/or Specified, Current News Module, that aggregates news for modification of properties. User submits keywords specified in a form and Digital Semantic Agent selects similar keywords, related to submission in these aggregation areas; news related subjects from the Internet related; user news related thoughts submitted by users related; and user news related goals that are related; and aggregates data to be used by the system.

Digital Semantic Agent creates random keywords, and inputs them in a form and selects similar keywords, related to; news related subjects from the Internet related; user news related thoughts submitted by users related; and user news related goals that are related; and aggregates data to be used by the system.

A Random and/or Specified, Potential Negative Results (Adverse Reactions) Module, that calculates adverse reactions to the changed property.

User submits keywords specified in a form and Digital Semantic Agent selects similar keywords, related to submission in these aggregation areas; Potential Negative Results (Adverse Reactions) related subjects from the Internet related; user Potential Negative Results (Adverse Reactions) related thoughts submitted by users related; and user Potential Negative Results (Adverse Reactions) related goals that are related; and aggregates data to be used by the system.

Digital Semantic Agent creates random keywords, and inputs them in a form and selects similar keywords, related to; Potential Negative Results (Adverse Reactions) related subjects from; the Internet related; user Potential Negative Results (Adverse Reactions) related thoughts submitted by users related; and user Potential Negative Results (Adverse Reactions) related goals that are related; and aggregates data to be used by the system.

A Random and/or Specified, Potential Positive Results (Benefits) Module that calculates beneficial reactions to changed properties. In this invention this works within the Request module.

User submits keywords specified in a form and Digital Semantic Agent selects similar keywords, related to submission in these aggregation areas; Potential Positive Results (Benefits) related subjects from the Internet related; user Potential Positive Results (Benefits) related thoughts submitted by users related; and user Potential Positive Results (Benefits) related goals that are related and aggregates data to be used by the system.

Digital Semantic Agent creates random keywords, and inputs them in a form and selects similar keywords, related to; Potential Positive Results (Benefits) related subjects from the Internet related; user Potential Positive Results (Benefits) related thoughts submitted by users related; and user Potential Positive Results (Benefits) related goals that are related; and aggregates data to be used by the system.

A Random and/or Specified, Provocative Keywords, Images, and Videos converted into Text Module, that converts graphical objects and keywords into text, sentences, and phrases.

User submits keywords specified in a form and Digital Semantic Agent selects similar keywords, related to submission in these aggregation areas; Provocative Keywords, Images, and Videos converted into Text related subjects from the Internet related; user Provocative Keywords, Images, and Videos converted into Text related thoughts submitted by users related; and user Provocative Keywords, Images, and Videos converted into Text related goals that are related; and aggregates data to be used by the system.

Digital Semantic Agent creates random keywords, and inputs them in a form and selects similar keywords, related to; Provocative Keywords, Images, and Videos converted into Text related subjects from the Internet related; user Provocative Keywords, Images, and Videos converted into Text related thoughts submitted by users related; and user Provocative Keywords, Images, and Videos converted into Text related goals that are related; and aggregates data to be used by the system.

A Random and/or Specified, Provocative Text converted into Keywords, Images, and Videos Module that converts text, sentences, and phrases into other text, images and videos.

User submits keywords specified in a form and Digital Semantic Agent selects similar keywords, related to submission in these aggregation areas; Provocative Text converted into Keywords, Images, and Videos related subjects from the Internet related; user Provocative Text converted into Keywords, Images, and Videos related thoughts submitted by users related; and user Provocative Text converted into Keywords, Images, and Videos related goals that are related; and aggregates data to be used by the system.

Digital Semantic Agent creates random keywords, and inputs them in a form and selects similar keywords, related to; Provocative Text converted into Keywords, Images, and Videos related subjects from the Internet related; user Provocative Text converted into Keywords, Images, and Videos related thoughts submitted by users related; and user Provocative Text converted into Keywords, Images, and Videos related goals that are related; and aggregates data to be used by the system.

A Random and/or Specified, transformation module that transforms, re-purposes, and/or reformats all Random and/or Specified aggregated data into brand new divided, and/or color banded property.

User submits keywords specified in a form and Digital Semantic Agent selects similar keywords, related to submission in these aggregation areas; transforms, re-purposes, and/or reformats related subjects from the Internet related; user transforms, re-purposes, and/or reformats related thoughts submitted by users; and user Transforms, re-purposes, and/or reformats related goals; and aggregates data to be used by the system.

Digital Semantic Agent creates random keywords, and inputs them in a form and selects similar keywords, related to; transforms, re-purposes, and/or reformats related subjects from the Internet; user Transforms, re-purposes, and/or reformats related thoughts, submitted by users; and user Transforms, re-purposes, and/or reformats related goals; and aggregates data to be used by the system.

A Self Publishing Publicity module takes newly created, transformed and re-purposed web pages, images, videos, text, IP, and/or real tangible or intangible properties, and creates press release, and distributes the materials utilizing Digital Semantic Agent, and aggregated data in the presented invention.

The steps that are taken in the module are: Assembly of aggregated data into press releases utilizing the Digital Semantic Agent; Sending out requests to new agencies; Tracking requests, and publicity created; Purchasing higher ranking distribution; Aggregating feedbacks and related comments to the submitted press releases; Record time and response rates; Recording the spatial point target for each press release for global analysis; Validating press release resulting sales, participation and global interest; Re submitting press releases on given time frames for maximum impact.

Any programmer skilled in the art could take the aggregated data specified, keywords and semantic phrases, and rules utilizing an Open Source search application designed for relational searches such as Nutch, in the method presented, and create relational database decisions for requests for participation, invitations to request, and request suggestions presented to users, by creating Microshare Requests, Fractional Requests, Change Request Searches, Random and/or Specified, Generating of Objects, Subjects, Thoughts, Goals, Facts, Emotional, Current News, Potential Negative or Positive Results, and potential provocative text, images, videos and media, and random transformations of all aggregated items for re-purposing of divided or un-divided properties searched by keywords, and key phrases utilizing a search engine form, entered by user, and aggregated stored data for creating real time request comparative responses and PHP and Mysql database relationship programming, in the present invention.

All processes and transformations were known for many years as separate image and audio processing methods, used in open source softwares such as Bash Shell Scripts, Gimp, Open CV, Audacity for audio, FFMpeg and Mencoder. Bash Shell Scripts is a Unix shell written by Brian Fox for the GNU Project as a free software replacement for the Bourne shell (sh). Released in 1989, it has been distributed widely as the shell for the GNU operating system and as a default shell on Linux and Mac OS X. It has been ported to Microsoft Windows and distributed with Cygwin and MinGW, to DOS by the DJGPP project, to Novell NetWare and to Android via various terminal emulation applications. In the late 1990s, Bash was a minor player among multiple commonly used shells, unlike presently where Bash has overwhelming favor.

Bash is a command processor that typically runs in a text window, where the user types commands that cause actions. Bash can also read commands from a file, called a script. Like all Unix shells, it supports filename wildcarding, piping, here documents, command substitution, variables and control structures for condition-testing and iteration. The keywords, syntax and other basic features of the language were all copied from sh. Other features, e.g., history, were copied from csh and ksh. Bash is a POSIX shell, but with a number of extensions.

The name itself is an acronym, a pun, and a description. As an acronym, it stands for Bourne-again shell, referring to its objective as a free replacement for the Bourne shell. As a pun, it expressed that objective in a phrase that sounds similar to born again, a term for spiritual rebirth. The name is also descriptive of what it did, bashing together the features of sh, csh, and ksh.

Many of the processes in this invention are using common well known Bash Shell script open source software, used by programmers skilled in the art. Tools used to perform image editing can be accessed via the toolbox, through menus and dialogue windows. They include filters and brushes, as well as transformation, selection, layer and masking tools.

There are several ways of selecting colors including palettes, color choosers and using an eyedropper tool to select a color on the canvas. The built-in color choosers include RGB/HSV selector or scales, water-color selector, CMYK selector and a color-wheel selector. Colors can also be selected using hexadecimal color codes as used in HTML color selection. GIMP has native support for indexed color and RGB color spaces; other color spaces are supported using decomposition where each channel of the new color space becomes a black and white image. CMYK, LAB and HSV (hue, saturation, value) are supported this way. [39] [40] Color blending can be achieved using the blend tool, by applying a gradient to the surface of an image and using GIMP's color modes. Gradients are also integrated into tools such as the brush tool, when the user paints this way the output color slowly changes. There are a number of default gradients included with GIMP; a user can also create custom gradients with tools provided.

GIMP selection tools include a rectangular and circular selection tool, free select tool, and fuzzy select tool (also known as magic wand). More advanced selection tools include the select by color tool for selecting contiguous regions of color—and the scissors select tool, which creates selections semi-automatically between areas of highly contrasting colors. GIMP also supports a quick mask mode where a user can use a brush to paint the area of a selection. Visibly this looks like a red colored overlay being added or removed. The foreground select tool is an implementation of Simple Interactive Object Extraction (SIOX) a method used to perform the extraction of foreground elements, such as a person or a tree in focus. The Paths Tool allows a user to create vectors (also known as Bézier curves). Users can use paths to create complex selections around natural curves. They can paint (or “stroke”) the paths with brushes, patterns, or various line styles. Users can name and save paths for reuse.

There are many tools that can be used for editing images in GIMP. The more common tools include a paint brush, pencil, airbrush, eraser and ink tools used to create new or blended pixels. Tools such as the bucket fill and blend tools are used to change large regions of space in an image and can be used to help blend images.

GIMP also provides ‘smart’ tools that use a more complex algorithm to do things that otherwise would be time consuming or impossible. These include a: Clone tool, which copies pixels using a brush Healing brush, which copies pixels from an area and corrects tone and color Perspective clone tool, which works like the clone tool but corrects for distance changes Blur and sharpen tool blurs and sharpens using a brush Dodge and burn tool is a brush that makes target pixels lighter (dodges) or darker (burns) GIMP transform tools include: Align Move Crop Rotate Scale Shear Perspective Flip

OpenCV (Open Source Computer Vision) is a library of programming functions mainly aimed at real-time computer vision, developed by Intel Russia research center in Nizhny Novgorod, and now supported by Willow Garage and Itseez. It is free for use under the open source BSD license. The library is cross-platform. It focuses mainly on real-time image processing. If the library finds Intel's Integrated Performance Primitives on the system, it will use these proprietary optimized routines to accelerate itself. Officially launched in 1999, the OpenCV project was initially an Intel Research initiative to advance CPU-intensive applications, part of a series of projects including real-time ray tracing and 3D display walls. The main contributors to the project included a number of optimization experts in Intel Russia, as well as Intel's Performance Library Team. In the early days of OpenCV, the goals of the project were described as Advance vision research by providing not only open but also optimized code for basic vision infrastructure. No more reinventing the wheel. Disseminate vision knowledge by providing a common infrastructure that developers could build on, so that code would be more readily readable and transferable.

Advance vision-based commercial applications by making portable, performance-optimized code available for free—with a license that did not require to be open or free themselves.

Audacity is a free open source digital audio editor and recording computer software application, available for Windows, Mac OS X, Linux and other operating systems. Audacity was started in May 2000 by Dominic Mazzoni and Roger Dannenberg at Carnegie Mellon University. As of 10 Oct. 2011, it was the 11th most popular download from SourceForge, with 76.5 million downloads. Audacity won the SourceForge 2007 and 2009 Community Choice Award for Best Project for Multimedia.

In addition to recording audio from multiple sources, Audacity can be used for post-processing of all types of audio, including podcasts by adding effects such as normalization, trimming, and fading in and out. Audacity has also been used to record and mix entire albums, such as by Tune-Yards. It is also currently used in the UK OCR National Level 2 ICT course for the sound creation unit.

As it is built from the same code as MPlayer, it can read from every source which MPlayer can read, decode all media which MPlayer can decode and it supports all filters which MPlayer can use. MPlayer can also be used to view the output of most of the filters (or of a whole pipeline of filters) before running MEncoder. If the system is not able to process this in realtime, audio can be disabled using-nosound to allow a smooth review of the video filtering results. It is possible to copy audio and/or video unmodified into the output file to avoid quality loss because of re-encoding. For example, to modify only the audio or only the video, or to put the audio/video data unmodified into a different container format.

Since it uses the same code as MPlayer, it features the same huge number of highly-configurable video and audio filters to transform the video and audio stream. Filters include cropping, scaling, vertical flipping, horizontal mirroring, expanding to create letterboxes, rotating, brightness/contrast, changing the aspect ratio, colorspace conversion, hue/saturation, color-specific gamma correction, filters for reducing the visibility of compression artifacts caused by MPEG compression (deblocking, deringing), automatic brightness/contrast enhancement (autolevel), sharpness/blur, denoising filters, several ways of deinterlacing, and reversing telecine.

All of these softwares were available to programmers skilled in the art at the time of the filing of this patent application, and the processes could have been created utilizing these software tools.

By having at least 9 identical comparisons in analysis of data aggregated from the 17 steps and processes of data aggregated at registration, we can identify the rightful human or object by these processes, methods of the invention.

The “human key” is a software identification method, run by a computer/machine. The “human key” enables a user to verify themselves to another user or another computer system. The software file, run by a computer/machine, of the human key enables a user to be verified and/or authenticated in a transaction and also provides tracking of the financial transaction by associating the transaction to one or more human keys which identify and authenticate one or more users in the system. The “human key” enables a user to verify themselves to another user or another computer system. The software file, run by a computer/machine, of the human key enables a user to be verified and/or authenticated in a transaction and also provides tracking of the financial transaction by associating the transaction to one or more human keys which identify and authenticate one or more users in the system. The “human key” enables the “authentication of users” with tracking, audio verification, and actual human identification, no merely password verification which does not verify the actual user.

The present invention teaches where a Human Key that is a method part of the Server, in many drawings in the specifications, which clearly shows the process used with a 3D camera to identify objects and humans. It is also shown step by step in the method patent application Ser. No. 12/653,749, and referenced in the granted patent from application Ser. No. 12/768,981 and in application Ser. No. 12/830,344, and further in application Ser. No. 13/332,173.

At the time of the filing of this patent, any programmer that was a skilled programmer, could have created the program to run on the computer servers presented in this document, simply from the processes that is presented here in FIG. 7, and combined with the processes that are shown in patent application Ser. No. 12/653,749, which included 18 redundancy processes, with very specific steps presented in Ser. No. 12/653,749, utilizing 3D camera, and a computer, anyone with even light programming skills could have created the invention to accomplish the steps presented at the time this was filed.

In the specifications, an algorithm is discussed; The Human Key method is used by a Server to transform “The audio voice print, video print, into color bands that are used to create calculated pattern to numbers that are registered in a database with spatial interpolation algorithm as a digital fingerprint. Processing of all audio and video input occurs on a human key system server so there is not usage by the thin client systems used by the user to access the human key server for authentication and verification. When a user/person registers in the system an audio and video fingerprint is created, which comprises audio file, video file, image files, text files, and all other files and data that is stored in the database, that are created as reference to identify the individual for the purpose of verification.”

“In identification of a human object the method needs to have protection from a user making a 3D model and putting it before the ATM and the system needs to be able to identify a live human object versus a fake human object, so this aspect would determine what the object is. The way to identify live humans, is that they are fluid not static and three dimensional, and with spatial reference points calculated in the background, a machine can identify fluid or static object.”

A plurality of 18 specific pre-processing aggregation and post processing verification redundancy steps used in identifying a human in the present invention are clearly demonstrated in the drawings and specification. And any programmer skilled in the art could use the steps to create the identification processes.

A quick view creator and viewer module is defined as a campaign and advertisement creation tool for making campaigns and advertisements that can be completely displayed, viewed and understood in a very short amount of time by the user. Utilizing an upload function that takes images, audio, text and assembles them together in a collage of a representation, and additionally where the text is converted to speech, for making it easy for a user to see and understand a campaign or advertisement in a short period of time.

A make an offer module is defined as a component where a user can create or make an offer for products, and/or services, on advertisements, campaigns, or embedded in QR codes revealed when scanned by device.

A search engine module is used for searching campaigns as related to advertisements, and QR code incentives, or color band coded currency, where a user can search for a product or service that they need, and can see what campaigns will benefit from the purchase, and at the same time what QR code offers are related, to the campaign and the advertisement, and what the QR Code pass along benefit will be if the user passes the QR Code off to their friends.

The word fair is used in the invention with the context of, treating people or users in a way that does not favor some over others;

A Fair Value module, calculates the amount of money that something is worth: the price or cost of something, in a fair way to all users.

A Fair Share module, calculates a portion belonging to, due to, or contributed by an individual or group. And what their ownership, contribution, loan, donation or labor value is.

A Fair Deal module, calculates how to give (something or an amount of something) to someone, to buy and sell as a business, and additionally to reach or try to reach a state of acceptance or reconcilement about real tangible or intangible object transactions.

A Fair Price module, calculates the amount of money that you pay for something or that something costs, and calculates the thing that is lost, damaged, or given up in order to get or do something, and additionally calculates the amount of money needed to persuade someone to do something, and calculates the quantity of one thing that is exchanged or demanded in barter or sale for another thing, and additionally calculates the amount of money given or set as consideration for the sale of a specified thing all in a fair way to the users in the network.

A Fair Division module, calculates how a real or intangible property should be divided for immediate trading, and sales, taking into account, participations of users, contributions of users, surface imaging of real properties, file encryptions and de-encryption of non tangible files and transactions, colors, sizes, shapes, and main whole evaluation of the value of the property assembled or made whole by rightful owners in a fair way to users in a network.

A Fair Placement module, calculates putting something in a particular place, and finding an appropriate place for someone to live, work, or learn, or placing an object, advertisement, or website in a strategic location for best possible results, in a fair way to users in a network.

Any programmer skilled in the art could take the aggregated data specified, keywords and semantic phrases, and rules utilizing an Open Source search application designed for relational searches such as the open source Nutch search engine, in the method presented, and create relational database decisions, and suggestions for Fair Value, Share, Deal, Price, Division, and Placement in the present invention.

A Micro Share Request Module, that calculates small shares of things, objects, real or intangible properties and makes an offer for a user in a network, for a fraction of the item.

A Fractional Request Module, that calculates separating components of a transaction, real or intangible property, or object through differences, determined by using all the modules including Fair Modules, and Micro Share Request Module in the system to create potential deals, suggestions, motivations to play, and potential transactions combined with the function of asking for collaborations related to the dividing of properties in a network for the benefit of the individual users.

A Property is something that is owned by a person, business, government etc. and in most aspects of the invention, a property is something owned by a person that is changed or transformed by the invention.

A Change Request Search Module, that allows users to change other users content, objects, real or intangible properties utilizing functions, such as:

Random and/or Specified, Generating Objects Function Module utilizing the digital semantic agent for aggregation of new or existing images, videos, shapes, ideas, and structures to create and modify old properties into new properties.

Random and/or Specified, Subjects, Thoughts and Goals Module that aggregates data for modifications of properties.

Random and/or Specified, Facts Module that aggregates facts for use in modifications of properties.

Random and/or Specified, Emotional Module, that aggregates how a user feels at the moment of, and all through the process of modification of properties.

Random and/or Specified, Current News Module, that aggregates news for modification of properties.

Random and/or Specified, Potential Negative Results (Adverse Reactions) Module, that calculates adverse reactions to the changed property.

Random and/or Specified, Potential Positive Results (Benefits) that calculates beneficial reactions to changed properties. In this invention this works within the Request module.

Random and/or Specified, Provocative Keywords, Images, and Videos converted into Text Module, that converts graphical objects and keywords into text, sentences, and phrases.

Random and/or Specified, Provocative Text converted into Keywords, Images, and Videos Module that converts text, sentences, and phrases into other text, images and videos.

Random and/or Specified, transformation module that transforms, re-purposes, and/or reformats all Random and/or Specified aggregated data into brand new divided, and/or color banded property.

Any programmer skilled in the art could take the aggregated data specified, keywords and semantic phrases, and rules utilizing an Open Source search application designed for relational searches such as Nutch, in the method presented, and create relational database decisions for requests for participation, invitations to request, and request suggestions presented to users, by creating Microshare Requests, Fractional Requests, Change Request Searches, Random and/or Specified, Generating of Objects, Subjects, Thoughts, Goals, Facts, Emotional, Current News, Potential Negative or Positive Results, and potential provocative text, images, videos and media, and random transformations of all aggregated items for re-purposing of divided or un-divided properties searched by keywords, and key phrases utilizing a search engine form, entered by user, and aggregated stored data for creating real time request comparative responses and PHP and Mysql database relationship programming, in the present invention.

The method invention presented here utilizes Python, PHP, and Pysal for Spatial Point Targeting for distribution, and identification and is embedded into the ITAVMIST Server System-on-a-chip (SoC) processor. All of these open source softwares would have been available and used by programmers skilled in the art at the time of the filing. Also Spatial Point Targeting is used in the system in all servers running software and methods run on those servers as a security feature.

The Python Software Foundation (PSF), is a non-profit organization devoted to the Python programming language, launched on Mar. 6, 2001. The mission of the foundation is to foster development of the Python community and is responsible for various processes within the Python community, including developing the core Python distribution, managing intellectual rights, developer conferences including PyCon, and raising funds. In 2005, the Python Software Foundation received the prestigious Computerworld Horizon Award for “cutting-edge” technology.

PySAL is an open source library of spatial analysis functions written in Python intended to support the development of high level applications. PySAL is open source under the BSD License. PySAL: Open Source Python Library for Spatial Analytical Functions

ASU's GeoDa Center for GeoSpatial Analysis and Computation, a research unit closely affiliated with the School of Geographical Sciences and Urban Planning, develops PySAL, an open source library of computational tools for spatial analysis.

PySAL grew out of a collaborative effort spearheaded by Professor Sergio Rey and Luc Anselin, Walter Isard Chair and Director of the School of Geographical Sciences and Urban Planning. The project integrates two analytical tools, STARS and PySpace, that were developed separately by the two researchers prior to their arrival at ASU.

PySAL provides a suite of spatial analytical methods that developers can incorporate into their own application development, and that spatial analysts may customize to further their research. The PySAL tools are programmed in the Python language, which is increasingly used in geographic information systems.

The Virtual World Airport Server (VWA) is a software application that is run on a System-on-a-chip (SoC) that includes a search transaction based primary management of Virtual Worlds, Virtual World objects, and Virtual World places built into the apparatus. This is accomplished by using multiple search engine technologies, with multiple processor cores, and parallel System-on-a-chip (SoC) processing for rapid processing of graphics components. This component of the system apparatus, and methods related to being served in that system effectively takes a user in the Virtual World environment to other Virtual Worlds, Virtual World objects, and Virtual World places, providing processing rapidly as an independent System-on-a-chip (SoC).

The following software applications and methods are embedded in the System-on-a-chip (SoC) that makes up the Virtual World Airport Server: Scrapy, Open Search Server, and Nutch.

Scrapy was readily known and used by programmers at the time of this patent filing, to create web scraping and has the following capabilities: Scrapy is a web crawling framework with support for web scraping. It is open-source and written in Python. It is controlled using command line tools, that can be used to trigger the scrapers written in Python. Scrapy was born at London-based web aggregation and e-commerce company Mydeco, where it was developed and maintained by employees of Mydeco and Insophia (a web consulting company based in Montevideo, Uruguay). The first official release was in August 2008, and it has been continually improved since then.

OpenSearchServer was readily known and used by programmers at the time of this patent filing, for application serving, and Virtual World Search and has the following capabilities:

OpenSearchServer is an open source application server allowing development of index-based applications such as search engines. Available since April 2009 on SourceForge for download, OpenSearchServer was developed under the GPL v3 license and offers a series of full text lexical analyzers. It can be installed on different platforms (Windows, Linux, Macintosh).

The main features of OpenSearchServer are:
A. An integrated crawler for databases, web pages and rich documents;
B. a user-friendly GUI allowing development of most applications through a web page interface built in Zkoss;
C. snippets;
D. faceting;
E. an HTML renderer for integrating search results in a page; and monitoring and administration features.

OpenSearchServer is written in Java and it can be integrated into almost any kind of application without the need to produce Java code. REST/XML APIs make OpenSearchServer connectable to other programming languages. The “advanced plugins” capability allows sophisticated customizations.

Nutch was readily known and used by programmers at the time of this patent filing, and was used for web search engine, and Virtual World Search and has the following capabilities:

Nutch is an effort to build an open source web search engine based on Lucene and Java for the search and index component. Nutch is coded entirely in the Java programming language, but data is written in language-independent formats. It has a highly modular architecture, allowing developers to create plug-ins for media-type parsing, data retrieval, querying and clustering. The fetcher (“robot” or “web crawler”) has been written from scratch specifically for this project.

Nutch originated with Doug Cutting, creator of both Lucene and Hadoop, and Mike Cafarella. In June, 2003, a successful 100-million-page demonstration system was developed. To meet the multimachine processing needs of the crawl and index tasks, the Nutch project has also implemented a MapReduce facility and a distributed file system. The two facilities have been spun out into their own subproject, called Hadoop. In January, 2005, Nutch joined the Apache Incubator, from which it graduated to become a subproject of Lucene in June of that same year.

Virtual Cash Virtual Currency Server is a software application that is run on a System-on-a-chip (SoC) that includes management, distribution and banking storage of Virtual Currencies utilizing MyBanco, and the Automatic Clearing House functions of OpenACH. And further works in the method and system, with the Human Key or Human Identity Key as well as the Object Key or Object Identification Key for security.

CODEFA is the identification registration encryption, decryption and function software application for registering media objects, video, audio, files, images in the system. By combining identification of media objects and human objects the apparatus can accomplish the purpose of the present invention.

CODEFA software application performed on a computer System-on-a-chip (SoC) that includes all the steps from patent '936 and '344 related to security of an actual file in the system. During the actual encryption and decryption, the following steps occur:

Encryption Steps for breaking file and storage:
The file is uploaded to the CODEFA Server;
The actual file is opened into the actual code;
Code is added that makes the file broken;
Then the file is renamed, and this code name is used for identification;
and stored in a folder;
the file is secure as it can not function;

Decryption Steps for fixing file and serving:
Then when use of the file is needed;
the name of the file is searched for;
the file is opened to it's code;
the code that was added is searched for and removed;
and then the file is saved in the folder;
and served to the user;

All of these software application functions and methods are embedded in the CODEFA Server System-on-a-chip (SoC) processor for the purpose of rapid deployment and use. This CODEFA processor is a different security system, that works inside the actual code of a file, than the Human Key which works to identify a human, or object.

By combining the software application CODEFA processor, for identification of actual files, and using the Human Key, for identification of the user as security features, combined with the other System on Chip (SOC) software application processor servers, we can accomplish attaching security and identification to objects, and content, with tracking, and delivery functions.

By combining the functions of the CODEFA Server software application for identifying objects and data files, and managing the Virtual Currency encryption de-encryption, we have protection and identification of virtual currency files. And when you combine the Human Key Server software application that is run a System on chip processor, to the process you have attachment of virtual currency (object file) to a human user (human verification identity file).

Publicity is the notice or attention given to someone or something by the media, and further the process of the giving out of information about a product, person, or company for advertising or promotional purposes, and involves special news material or information used for publicity.

A Self Publishing Publicity module utilizes the Digital Semantic Agent module and takes newly created, transformed and re-purposed web pages, images, videos, text, IP, and/or real tangible or intangible properties, entered into the search form or uploaded to the system by a user and creates assembled press releases, and further distributes the materials through the system request search engine functionality.

A server is a computer that provides data to other computers. It may serve data to systems on a local area network (LAN) or a wide area network (WAN) over the Internet.

Many types of servers exist, including web servers, mail servers, and file servers. Each type runs software specific to the purpose of the server. For example, a Web server may run Apache HTTP Server or Microsoft IIS, which both provide access to websites over the Internet. A mail server may run an advertising and marketing program like Exim or iMail, which provides SMTP services for sending and receiving email. A file server might use Samba or the operating system's built-in file sharing services to share files over a network.

A Clearing House is a financial institution that provides clearing and settlement services for financial and commodities derivatives and securities transactions. These transactions may be executed on a futures exchange or securities exchange, as well as off-exchange in the over-the-counter (OTC) market. A clearing house stands between two clearing firm is software application running on a computer which acts as a server for transmitting the information and executing the software from input and generating output as discussed above as the functions of a “clearing house”. (also known as member firms or clearing participants) and its purpose is to reduce the risk of one (or more) clearing firm failing to honor its trade settlement obligations. A clearing house reduces the settlement risks by netting offsetting transactions between multiple counterparties, by requiring collateral deposits (also called “margin deposits”), by providing independent valuation of trades and collateral, by monitoring the credit worthiness of the clearing firms, and in many cases, by providing a guarantee fund that can be used to cover losses that exceed a defaulting clearing firm's collateral on deposit.

Clearing House functions can be: 1. Banking: Affiliated agency or a facility operated by banks within a geographical area to act as a central site for collection, exchange, and settlement of checks drawn on each other. Modern clearance houses also clear electronic funds transfers. 2. Futures: Agency or affiliate of a governing exchange (such as a stock exchange) which, as a counter-party to every transaction on that exchange, is responsible for guaranteeing, reconciling, settling, collecting, and clearing, on all trades.

An “Independent Clearing House Agent Server (ICHA) is software application running on a computer which acts as a server for transmitting the information and executing the software from input and generating output as discussed above as the functions of a “clearing house”. The Independent Clearing House Agent Server (ICHA) software application is a System-on-a-chip (SoC) server component of the system includes Automatic Clearing House open source software readily known at the time of the filing of this patent, by programmers with knowledge in the art utilizing software application components Open ACH, My Banco, and PHP Bank which were available at the time of filing.

Automated Clearing House (ACH) is an electronic network for financial transactions in the United States. ACH processes large volumes of credit and debit transactions in batches. ACH credit transfers include direct deposit payroll and vendor payments. ACH direct debit transfers include consumer payments on insurance premiums, mortgage loans, and other kinds of bills.

Open ACH is an open source Clearing House application with the following capabilities, that was known to programmers at before the time of this filing as early as Sep. 6, 2011.

Multiple Originators

Using a single OpenACH installation, you could run multiple payment processing companies, or offer origination “sub-accounts” for others to process payments through your installation (each through their own banks).

Multiple Banks and Bank Accounts

Each originator can set up multiple banking relationships, and even multiple ACH originating accounts at each bank. This allows intelligent decisions to be made about where to process payments on a per-customer basis, as well as the ability for a single originator to internally transfer of funds between their own banks and bank accounts using the OpenACH system.

Role-Based User Accounts

User logins can be conFig.d with roles to individually control how many originators, banks, transfers, files, batches, etc., are allowed. This enables the system administrator to easily allow other originators to limit how users are utilizing the ACH system in a way that is adaptive to most third-party processing business models.

Automated Return/Change Handling

As payments are processed in the ACH system, financial institutions may send back ACH Return or Change records. Since there are a large number of possible return and change codes, OpenACH is designed to handle them in an automated fashion, relieving the administrator from the overwhelming workload that would be required to process these returns/changes by hand.

Modular API

Developed with a modular application programming interface (API), OpenACH is designed to allow others to easily extend the functionality and integrate it into other systems including, but not limited to, e-commerce, billing/invoicing systems, accounting systems, and websites.

Banking Plugins

Because there are a large number of banking choices available to your business, OpenACH provides a easy way to connect to many popular banks “out of the box”. The banking plugins contain all the information needed to successfully connect to a given bank, transfer files, and execute a full suite of tests required by the banks before processing can begin. This takes the guesswork out of adding a new bank to your payment workflow, or even moving all your business to a new bank.

International ACH (IAT)

OpenACH is designed to function on the International ACH system as well as the traditional, US Treasury system. This allows you to debit and credit Canadian accounts, and credit accounts in several other countries. Note that due to security limits on the International ACH system, at this time outbound debits are only allowed to Canadian accounts. Other IAT countries support only credits.

PCI Data Security Standards

The Payment Card Industry (PCI) Data Security Standards (e.g. PCI-DSS) are a set of rules for merchants processing debit and credit card payments. These requirements are proven to minimize fraud and protect customer information. Although OpenACH does not have anything to do with these types of payments, OpenACH is designed to meet these specifications wherever possible. This level of commitment to security minimizes your risk when processing ACH payments, both for your own business and for third-parties. All sensitive information is fully encrypted using military-grade encryption, and all inbound and outbound connections to the system require appropriate encryption.

MyBanco available as early as June 2008 from the day of it's conception, was built to process large volumes of transactions in a fast but safe environment that was able to be horizontally scaled out, that is, to add the ability to perform more transactions in a second, all that is needed is to add another node into the system. This is a major benefit that MyBanco has over other systems such as PHPbank, who's speed can only be improved on if it is scaled vertically.

MyBanco was programmed by Tim Groeneveld for a study in large scale scalability. A cheap MyBanco install can do 100 transactions a second.

Present features of MyBanco include:
1. Many-to-many bank account links
   (that is, three people might all be able to access three accounts).
2. Detailed transaction history.
3. Easy to use API based on JSON-RPC. (This means applications can be written in any programming language that leverage the MyBanco platform)
4. Internet Banking frontend
5. Phone Banking frontend
6. MyInfo backend can be compiled with Roadsend PHP Compiler for an extra speed boost.

MyBanco requirements:
1. PHP 5.2 or newer
2. pcre module enabled
3. j son module enabled
4. mail module enabled
5. mysql module enabled
6. Apache (other servers can be used with a little fiddling)
7. MyInfo is a network-aware Remote procedure call protocol encoded in JavaScript Object Notation (JSON).

MyInfo wraps around databases (currently only MySQL) to provide frontends securely information about anything. MyBanco uses MyInfo to store and retrieve data about users, bank accounts, documents in the customer relations management system and to also calculate past and present bank balances.

Internet Banking is built into MyBanco by building onto the pre-exist The Translation Server is a System-on-a-chip (SoC) server component of the system includes translation components gtranslator, GlobalSight, Moses SMT Decoder and Virtaal.ting MyInfo system.

Phone Banking is built into MyBanco by building onto the pre-existing MyInfo system and Asterisk, meaning people can literally dial into a physical phone line! No-one else can do this!

MyBanco is a kit made to run a ‘bank’. This ‘bank’ only does core banking, so the software does not take in account things like FOR-EX (foreign exchange) and other forms of trading (such as a stock exchange). MyBanco is modular software, which splits all functions into easy to manage separate applications which can be installed on separate machines to scale high loads.

PHPBank was written by Sander Dieleman, with the last known version, version 1.0 released 14th August 2006. PHPBank is still widely used by micronation

A person having ordinary skill in the art would clearly understand the recitation of the claim, and any skilled programmer in the art would have known how to create the Independent Clearing House utilizing the known open source software available at the time.

A Virtual World or massively multiplayer online world (MMOW) is a computer-based simulated environment. The term has become largely synonymous with interactive 3D virtual environments, where the users take the form of avatars visible to others. These avatars can be textual, two or three-dimensional graphical representations, or live video avatars with auditory and touch sensations. In general, virtual worlds allow for multiple users.

The user accesses a computer-simulated world which presents perceptual stimuli to the user, who in turn can manipulate elements of the modeled world and thus experience a degree of telepresence. Such modeled worlds and their rules may draw from the reality or fantasy worlds. Example rules are gravity, topography, locomotion, real-time actions, and communication. Communication between users can range from text, graphical icons, visual gesture, sound, and rarely, forms using touch, voice command, and balance senses.

Massively multiplayer online games depict a wide range of worlds, including those based on science fiction, the real world, super heroes, sports, horror, and historical milieus. The most common form of such games are fantasy worlds, whereas those based on the real world are relatively rare. Most MMORPGs have real-time actions and communication. Players create a character who travels between buildings, towns, and worlds to carry out business or leisure activities. Communication is usually textual, but real-time voice communication is also possible. The form of communication used can substantially affect the experience of players in the game.

Virtual Worlds are not limited to games but, depending on the degree of immediacy presented, can encompass computer conferencing and text based chat rooms. Edward Castronova is an economist who has argued that “synthetic worlds” is a better term for these cyberspaces, but this term has not been widely adopted.

Open Cobalt is a free and open source software platform for constructing, accessing, and sharing virtual worlds both on local area networks or across the Internet, without any requirement for centralized servers.

The technology makes it easy to create deeply collaborative and hyperlinked multi-user virtual workspaces, virtual exhibit spaces, and game-based learning and training environments that run on all major software operating systems. By using a peer-based messaging protocol to reduce reliance on server infrastructures for support of basic in world interactions across many participants, Open Cobalt makes it possible for people to hyperlink their virtual worlds via 3D portals to form a large distributed network of interconnected collaboration spaces. It also makes it possible for schools and other organizations to freely set up their own networks of public and private 3D virtual workspaces that feature integrated web browsing, voice chat, text chat and access to remote desktop applications and services.

Open Cobalt uses the Squeak software environment, which is an open source Smalltalk system freely available for Windows, Mac and Unix. As is true of almost any Smalltalk application, Open Cobalt has identical functionality on any supported platform. As a Smalltalk system, it can usually be updated while the system is running without requiring a restart.

Open Cobalt user interface and avatar-enabled virtual environment containing .kmz mesh content imported from Google's 3D Warehouse. Users are able to provision content to Open Cobalt spaces that can be developed and managed using third-party tools and resources. Open Cobalt is derived from the Croquet software development kit (SDK) that was publicly released under the MIT License by Hewlett-Packard and the Croquet Consortium in early 2007.

In early 2008, and with the support of the Andrew W. Mellon Foundation,[2] Julian Lombardi and Mark P. McCahill, at Duke University, launched the community-based software development effort to build Open Cobalt as an open source virtual world browser application and construction toolkit.

The goals of the Open Cobalt effort are to stimulate the use of distributed virtual environments, advance visual simulations, and deepen collaboration in education, research, and personal entertainment—and in so doing to: stimulate the development and dissemination of shared cyber environments for the staging, observation and evaluation of collaborative decision-making, problem finding, and problem solving among members of distributed virtual organizations and educational communities, and create the conditions for the emergence of a free, open, and scalable 3D-enabled global information space.

Open Cobalt was readily known and used by programmers at the time of this patent filing, to create Virtual Worlds and has the following capabilities: Open Cobalt is both an end-user application and full featured software development environment for creating a rich network of end-user created interlinked virtual worlds. It is more extensible than the proprietary technologies behind collaborative worlds such as Second Life, and before that ViOS. This is because: It is free (there are no fees for its use or distribution); The entire system is open source (it is licensed under the MIT free software license); It features the ability to create 3D hyperlinks in the form of doorways that connect virtual worlds to one another (in much the same manner by which 2D hyperlinks connect webpages); It supports VoIP (users can communicate with each other via voice while in-world); It does not require the use of servers to create and share virtual worlds (since it is based on a peer-to-peer synchronization architecture/messaging protocol); It is platform and device independent (because it is a virtual machine-based technology that runs on Mac OS X, Windows, and Linux); It provides a complete professional programmer's language (Smalltalk/Squeak, IDE, and class library in every distributed, running participant's copy (with the programming environment itself being simultaneously shareable and extensible); It is based on Squeak's late-binding architecture and meta-programming facilities (that allow for efficient handling of media); Users/developers within virtual worlds may freely access, modify and view the source code of the entire system (they can access running code from in-world); Users/developers can import 3D content directly into their worlds (Google 3D Warehouse content (kmz) and content in other formats can be drag-and-dropped directly into Open Cobalt worlds); Users/developers can import a variety of media content directly into their worlds (Open Cobalt worlds support audio and mpeg media content); Its software code can be updated/changed while the system is live (making it possible to program worlds from within worlds while they are running); and It is not hosted on a single organization's server (and hence not governed by any such organization) It is independent.

Croquet open source software development kit, The Croquet Project was an international effort to promote the continued development of the Croquet open source software development kit to create and deliver deeply collaborative multi-user on line applications. Implemented in Squeak Smalltalk, Croquet supports communication, collaboration, resource sharing, and synchronous computation among multiple users. Applications created with the Croquet software development kit (SDK) can be used to support highly scalable collaborative data visualization, virtual learning and problem solving environments, 3D wikis, online gaming environments (massively multiplayer online role-playing games), and privately maintained or interconnected multiuser virtual environments.

Real time, interactive, 3D map of this very same world. Change something in the world, the map changes. Move something in the map (as one would a chess piece), the object in the world represented by it moves the same way. Croquet is a software development kit (SDK) for use in developing collaborative virtual world applications.

Applications created using the Croquet SDK are automatically collaborative since application objects in Croquet share a common protocol that allows them to cooperate with each other by employing the principle of replicated computation (synchronization) together with a peer-based messaging protocol. The technology is designed to facilitate replication of computation between peers in order to greatly reduce the overhead required for widespread deployment of collaborative virtual worlds.

This efficiency, combined with the ability to deploy Croquet-based virtual worlds on consumer-level hardware, makes it possible for developers to deploy large-scale and highly participatory collaborative worlds at very low cost compared with virtual world technologies that are entirely dependent on server-based infrastructures to support the activities of their users.

Croquet is the confluence of several independent lines of work that were being carried out by its six principal architects, Alan Kay, David A. Smith. David P. Reed, Andreas Raab, Julian Lombardi, and Mark McCahill. The present identity of the project has its origins in a conversation between Smith and Kay in 1990, where both expressed their frustration with the state of operating systems at the time.

In 1994 Smith built ICE, a working prototype of a two user collaborative system that was a predecessor of the core of what Croquet is today. Also in 1994 Mark McCahill's team at the University of Minnesota developed GopherVR, a 3D user interface to Internet Gopher to explore how spatial metaphors could be used to organize information and create social spaces. In 1996 Julian Lombardi approached Smith to explore the development of highly extensible collaborative interfaces to the WWW. Later, in 1999, Smith built a system called OpenSpace, which was an early-bound variant of Croquet. Also in 1999, Lombardi began working with Smith on prototype implementations of highly extensible collaborative online environments based on OpenSpace. One of these implementations was a prototype implementation of ViOS, a way of spatially organizing all Internet-deliverable resources (including web pages) into a massively-scaled multiuser 3D environment.

Smith and Kay officially started the Croquet Project in late 2001 and were immediately joined by David Reed and Andreas Raab. Reed brought to the project his longstanding work on massively scalable peer-to-peer messaging architectures in a form deriving from his doctoral dissertation that was published in 1978. The first working Croquet code was developed in January 2002. Simultaneously and independently, Lombardi and McCahill began collaborating on defining and implementing highly scalable and enterprise-integrated architectures for multi-user collaboration and were invited by Kay to join the core architectural group in 2003.

From 2003 to 2006, the technology was developed under the leadership of its six principal architects with financial support from Hewlett-Packard, Viewpoints Research Institute Inc., the University of Wisconsin-Madison, University of Minnesota, Japanese National Institute of Communication Technology (NICT), and private individuals. On Apr. 18, 2006 the project released a beta version of the Croquet SDK 1.0 in the open source. Since then, the Croquet technology infrastructure has been successfully used by private industry to build and to deploy commercial-grade closed source collaborative applications. Open source production-grade software implementations for delivering secure, interactive, persistent, virtual workspaces for education and training have at the same time been developed and deployed at the University of Minnesota, University of Wisconsin-Madison, University of British Columbia, and Duke University.

As of 2009, continued development of the original Croquet technology is taking place through the Open Cobalt project.

Croquet open source software development kit was readily known and used by programmers at the time of this patent filing, to create Virtual Worlds and has the following capabilities: It is platform and device independent; Users and developers may freely share, modify and view the source code of the whole system, due to a liberal license; The technology is not hosted on one organization's server, and hence not governed by any such organization; It provides a complete professional programmer's language (Squeak Smalltalk), integrated development environment (IDE), and class library in every distributed, running participant's copy; the programming development environment itself is simultaneously shareable and extensible; and Croquet based worlds can also be updated while the system is live and running A person having ordinary skill in the art would clearly understand the recitation of Virtual World or Virtual World Network in the claims. All of the modules work within a computer server, computer processor, or System on Chip integrated circuit.

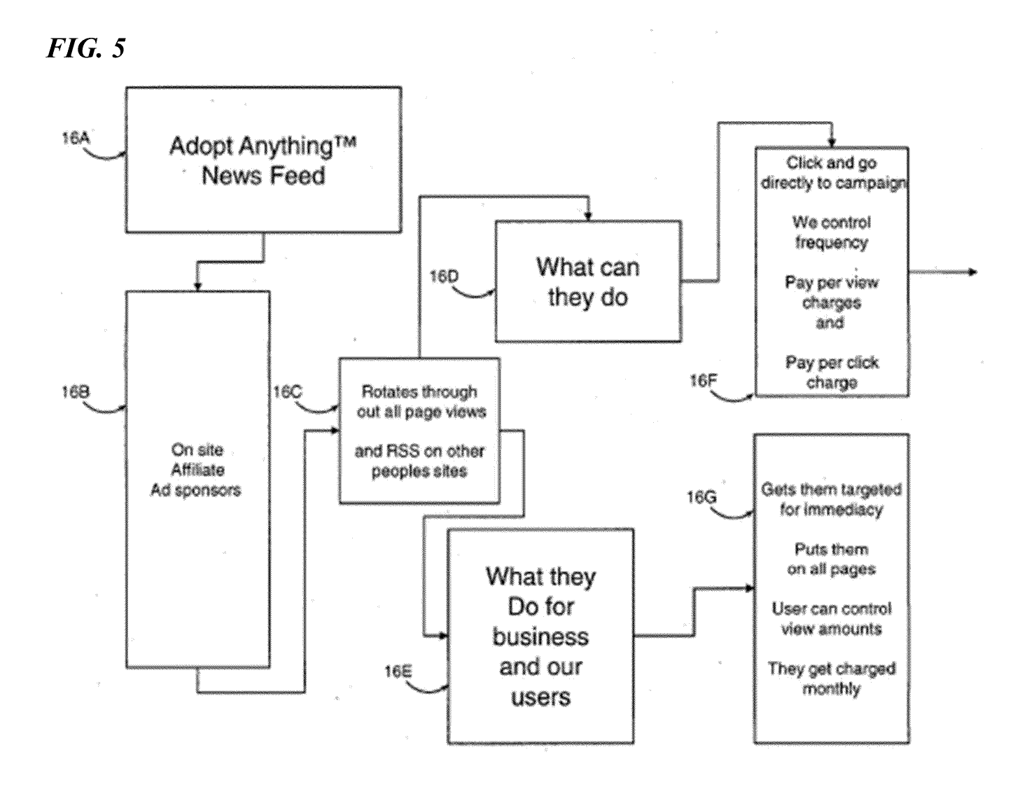

Now referring to FIG. 5, element 16A illustrates how adopt anything news feed system will be shown, whereby users are granted access. Element 16B describes that within the site, many affiliate ad sponsors will be given priority. Element 16C illustrates a tool that will allow rotations through all page views and rss on other people's sites. Element 16D describes the process of asking users, ‘what can you do?’ Element 16E describes the process of asking the user, ‘what can you do for business and its users?’ Element 16F illustrates the process of charging toward the campaign, controlling procedures toward frequency, pay per view charges and pay per click charges will be posted. Element 16G illustrates how immediacy will be targeted for news feed postings, putting them on all pages, and allowing users to control view amounts. The posting organization will be charged monthly for the space occupied.

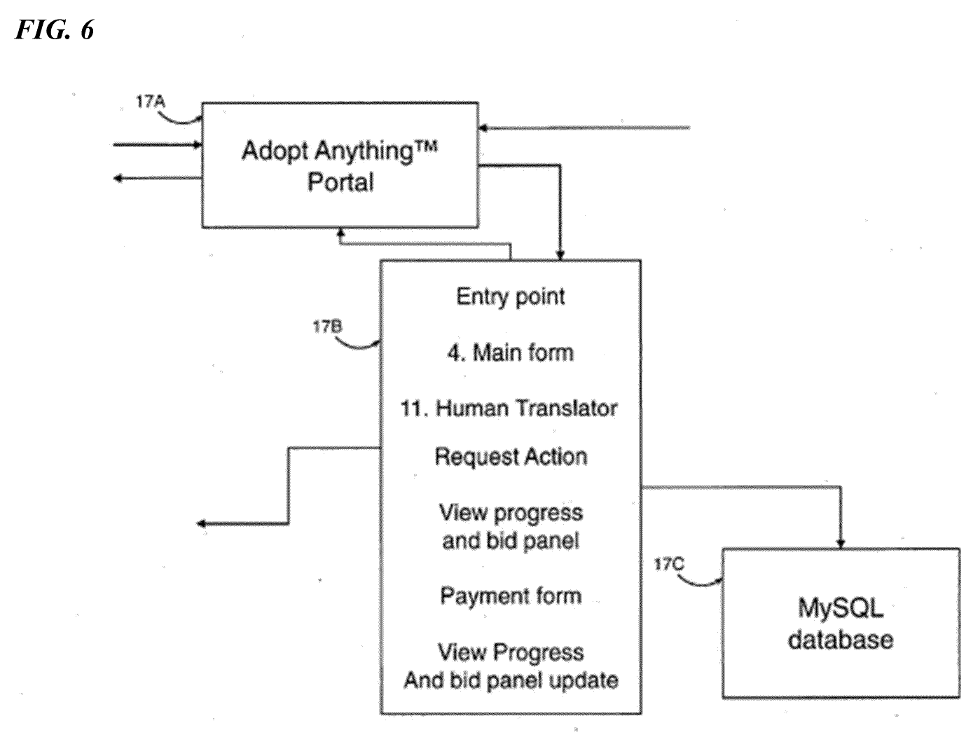

Now referring to FIG. 6, element 17A illustrates how to show adopt anything portal trademark. Element 17B describes the process of how listing legal processes within the portal will be documented, including entry point, main form, human translator, request action, view progress and bid panel, payment form, view progress and bid panel update. Element 17C illustrates that MYSQL database will store values from 17B.

Now referring to FIG. 7, element 18B illustrates the process of how adopting anything through pay portal will instantiate the process of money transfers. Element 18C illustrates how the world payment bank will serve as intermediary for money transactions.

Now referring to FIG. 8, element 19A illustrates what the individual/group wants to be paid. Element 19B describes the details of the specific order which states what comes after funding is accomplished. Element 19C illustrates that a single payment is made to the recipient, caretaker, or account of recipient. Element 19D illustrates that check cards can be bought at local stores, loaded online, or used like a credit cash card. Element 19E describes the process of explaining the monthly payments to recipient, caretaker, or account of recipient. Element 19F illustrates bill payment directions toward creditor or caretaker of recipient. Element 19G describes the process in which the vendor is given order directly, within the team which consists of vendor, service, and product. Element 19H describes the possible transfers of cash, including through check card, and even at local stores.

Now referring to FIG. 9, element 20A illustrates that 11 Human Response Statements are automatically created for form information. Element 20B describes the process of how to help promote the cause, whereby users should be asked if they have images, video, and or music. Element 20C describes the process of how the help request will document an individual borrowing money. According to 20C, Element 20D illustrates the creation of web pages that will assist with this matter. Element 20E describes the process of allowing people access to email their friends. Element 20F illustrates how users will be allowed to submit any press releases. Element 20G illustrates the process of enabling sharing of information onto search engines. Element 20H illustrates how video sharing will permit users to upload onto sites with ad link.

Now referring to FIG. 10, element 21A describes the process of how the adopt anything sign will display for the hierarchy of the system. Element 21B illustrates the creation of a webpage for the system that will give the site utility. Element 21C illustrates how emails to friends will be permitted on the site. Element 21D describes the process of allowing submissions of press release statements. Element 21E illustrates that submission to search engines will be permitted. Element 21F illustrates that submissions to blog postings will be allowed as well. Element 21G illustrates that affiliate code advertisements will be allowed. Element 21H illustrates that a limit will be given, where 20,000 sources need to be made. Element 21I describes how rankings need to be given within 5 days of search. Element 21J illustrates how a target for high traffic viral exponential results will give users what they need.

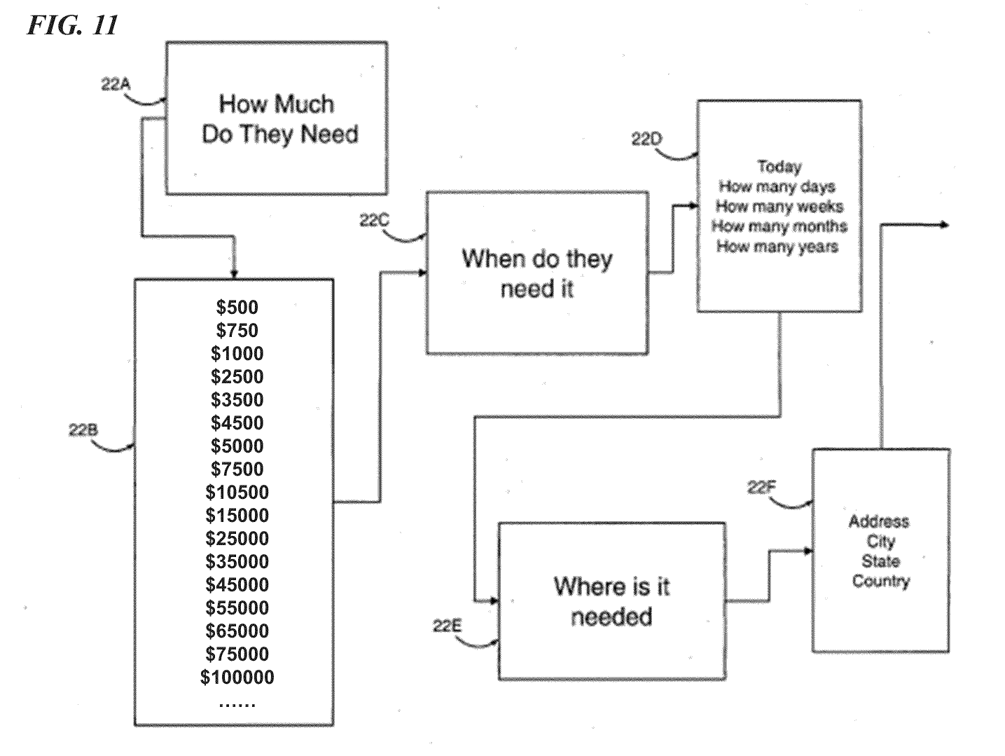

Now referring to FIG. 11, element 22A illustrates how much the person/group needs. Element 22B illustrates listing the number of dollar amounts, which the user should single out for their need. Element 22C describes the process of when the individual/group needs it. Element 22D describes a list of limits and constraints to a possible time line in which the user needs it. Element 22E illustrates where the person/group in need is located. Element 22F describes the process of letting the user type in specifics of location, including address, city, state, and country.

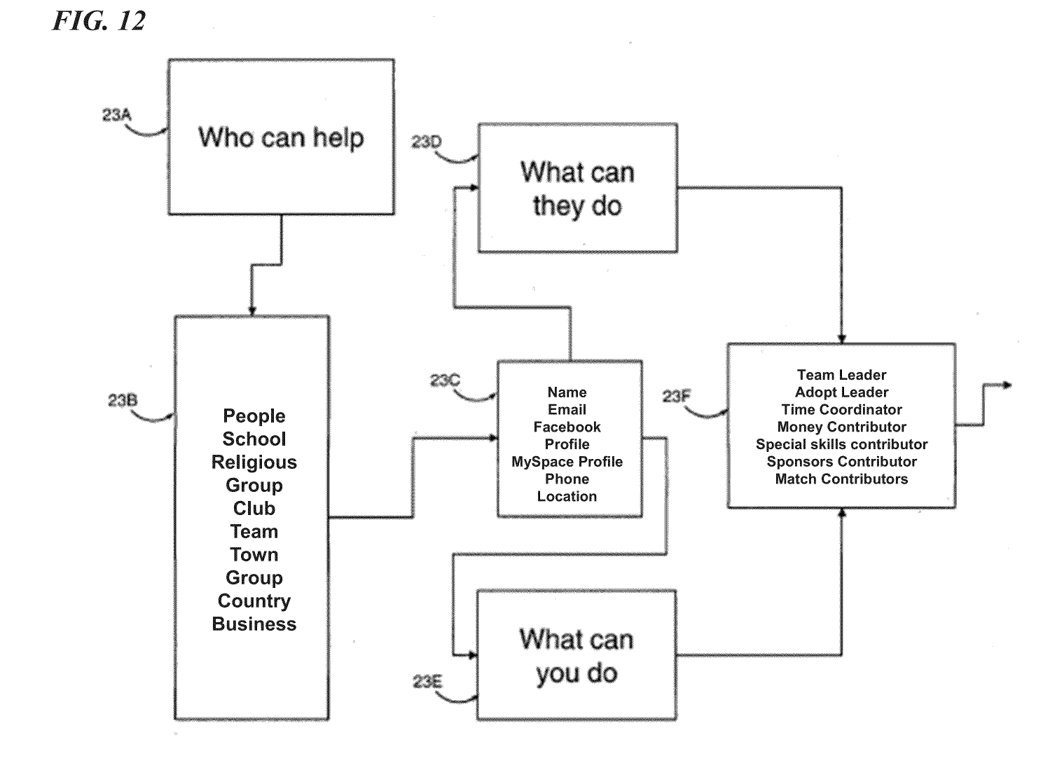

Now referring to FIG. 12, element 23A illustrates which individuals can help out. Element 23B describes the process of listing examples about person's and groups that can join Element 23C describes the process of letting users type in the details of their account, including name, emails, FACEBOOK profile, MYSPACE profile, phone and location. Element 23E describes the process of asking the user what he/she can do. Element 23F illustrates a list of people who have been set up as contributors or leaders.

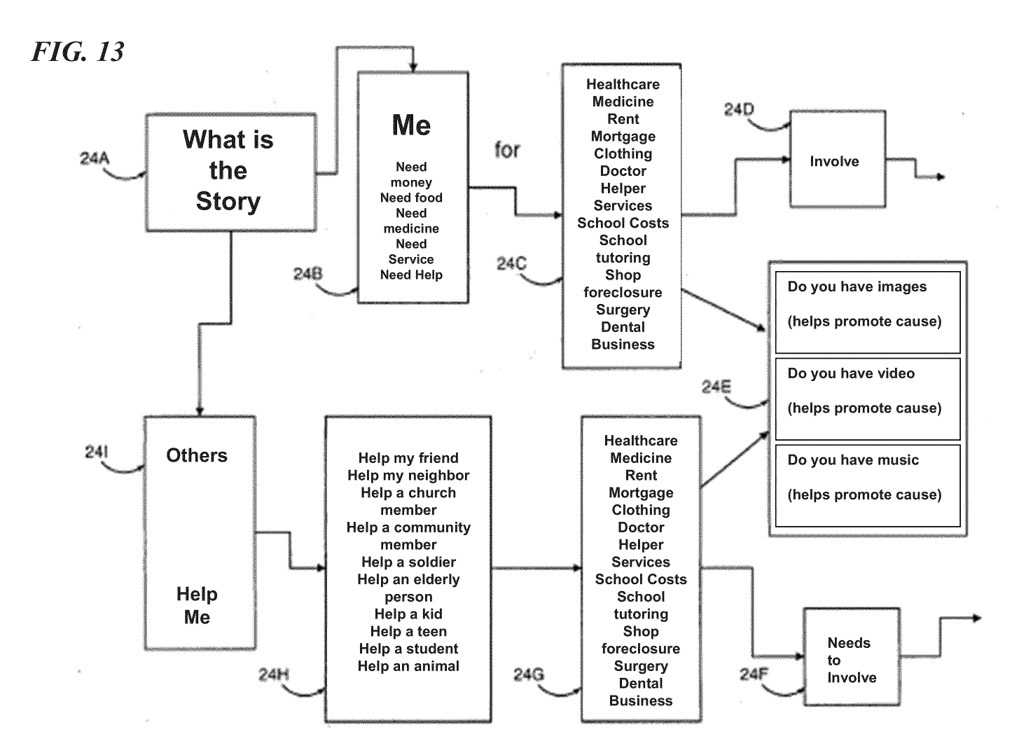

Now referring to FIG. 13, element 24A describes how the system will instantiate the process of extra elements to the story. Element 24B illustrates the process of asking the user to respond to interpret me, who may need money, food, medicine, calls, service and help. Element 24C describes several entity and action types, including healthcare, medicine, rent, mortgage, clothing, doctor, helper, services, school costs, school tutoring, stop foreclosure, surgery, dental, books, housing, business, and travel. Element 24D describes the process of involving what will be displayed for user apprehension about the subject. Element 24E illustrates that three separate helping promote causes will be categorized, including do you have images, video, and or music. Element 24F illustrates the process of involving what will be displayed to document user apprehension about this subject. Element 24G illustrates how separate entities will be written out for their stories, including healthcare, medicine, rent, mortgage, clothing, doctor, helper, services, school costs, school tutoring, stop foreclosure, surgery, dental, books, housing, business and travel. Element 24H illustrates how actions will be documented, including helping my friend, neighbor, co worker, church member, community member, soldier, elderly person, kid, teen, student, dog, cat, bird, pet, and even animal. Element 24I describes that to be specific, others have to be given priority, and they will be given consideration into helping themselves.

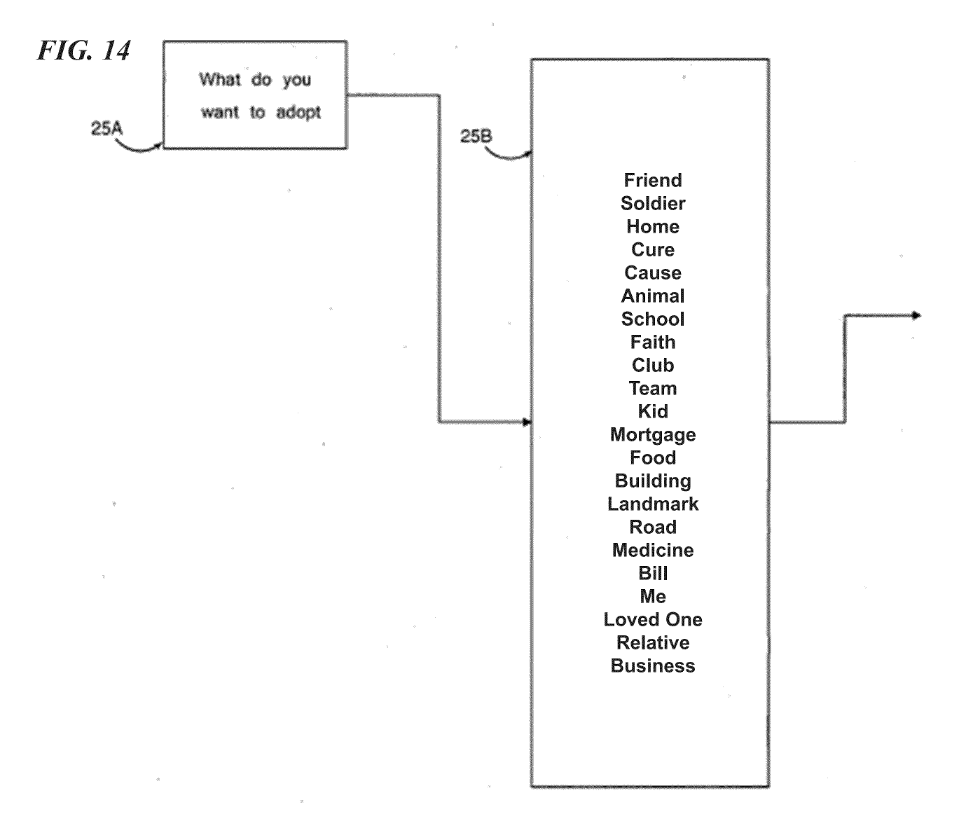

Now referring to FIG. 14, element 25A describes the process of when the individual/group wants to adopt? Element 25B illustrates a list of possible items, entities, animals, or other business entities that can be adopted.

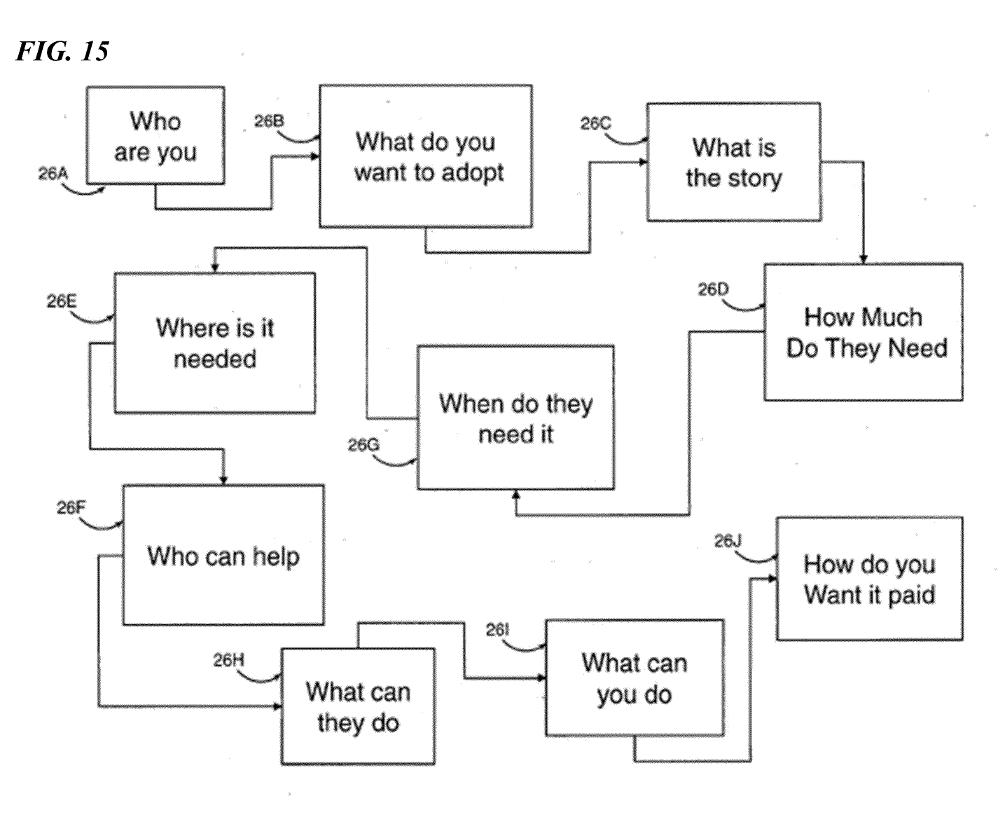

Now referring to FIG. 15, element 26A illustrates the tool used to identify the person. Element 26B illustrates process of user being asked what they want to adopt. Element 26C illustrates how the user types in specifics of the story. Element 26D describes the process how the user is asked how much they need. Element 26E describes the process of allowing the user to address the location of need. Element 26F describes allowing the user to find who can help in this effort. Element 26G illustrates the deadlines and time constraints to people's needs. Element 26H describes the process of asking the user what they can do. Element 26I describes the process of asking the user, what he/she can do. Element 26J describes the process of informing the user of possible forms of payment, which can be chosen. Element 28A describes how a “who are you sign”, will give consideration for user's personal details.

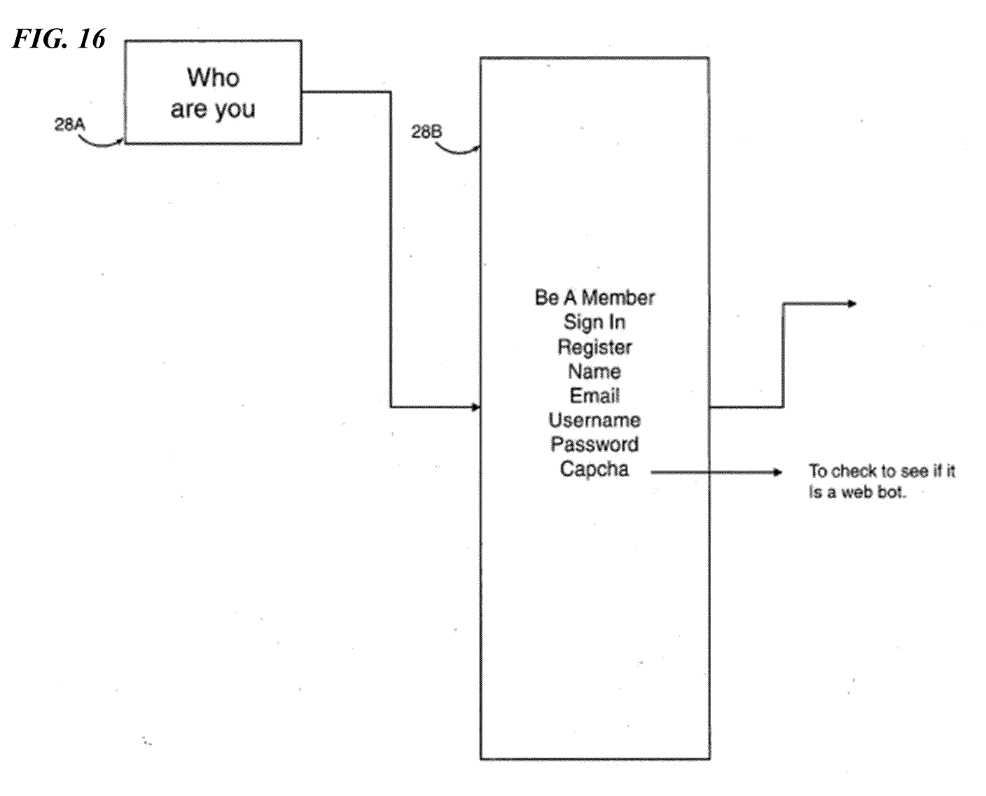

Now referring to FIG. 16, element 28B illustrates how a member sign in will register the person's name, email, username, password, and CAPCHA*.

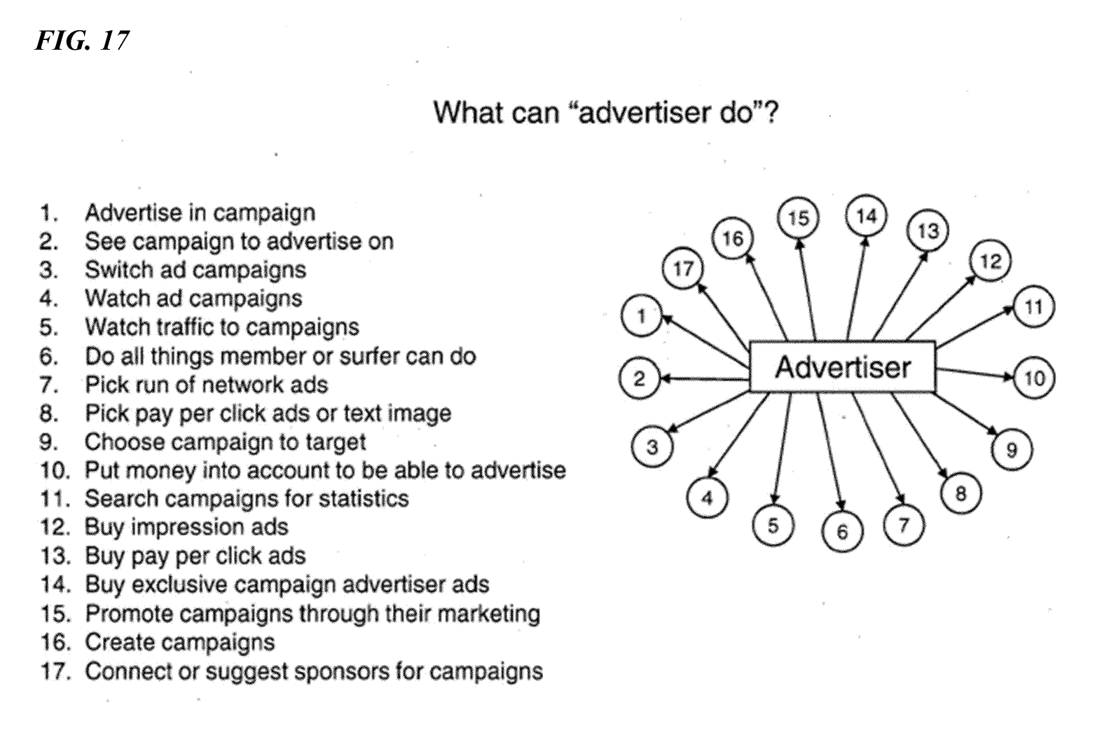

Now referring to FIG. 17, element 29 describes the numerous actions that can be performed by an advertiser within the Adopt Anything™ method, mechanism and invention.

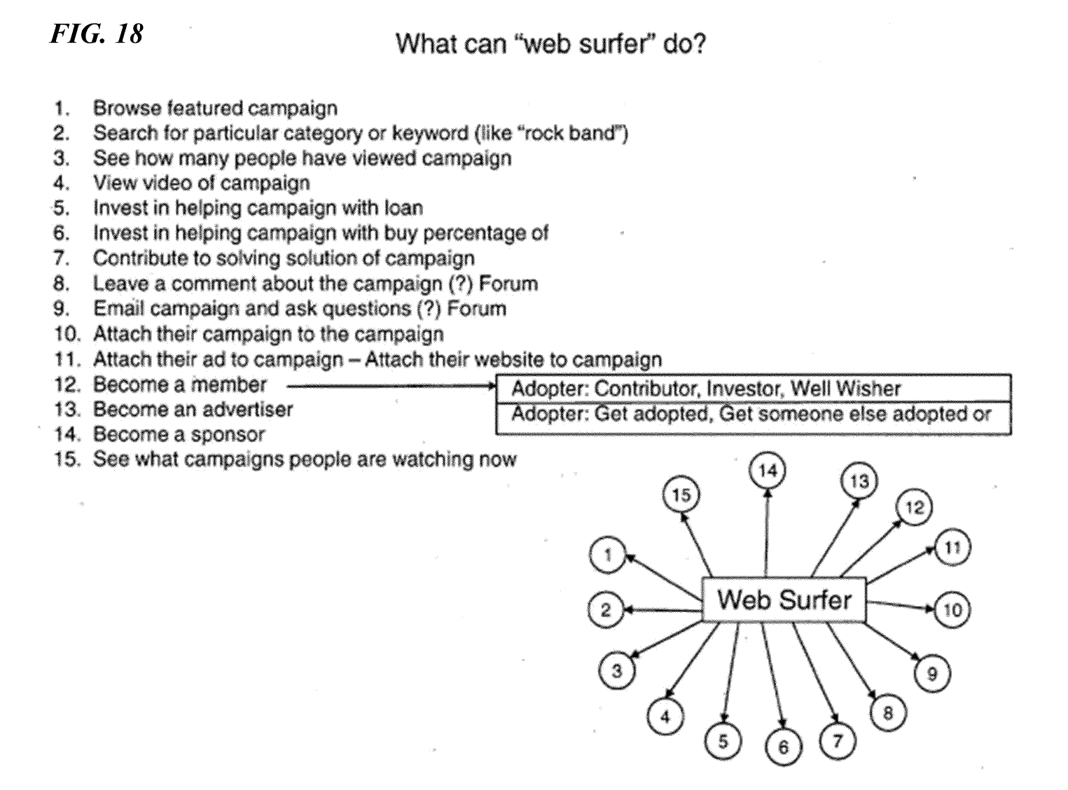

Now referring to FIG. 18, element 30R describes the numerous actions that can be performed by a “web surfer” within the Adopt Anything™ method, mechanism and invention.

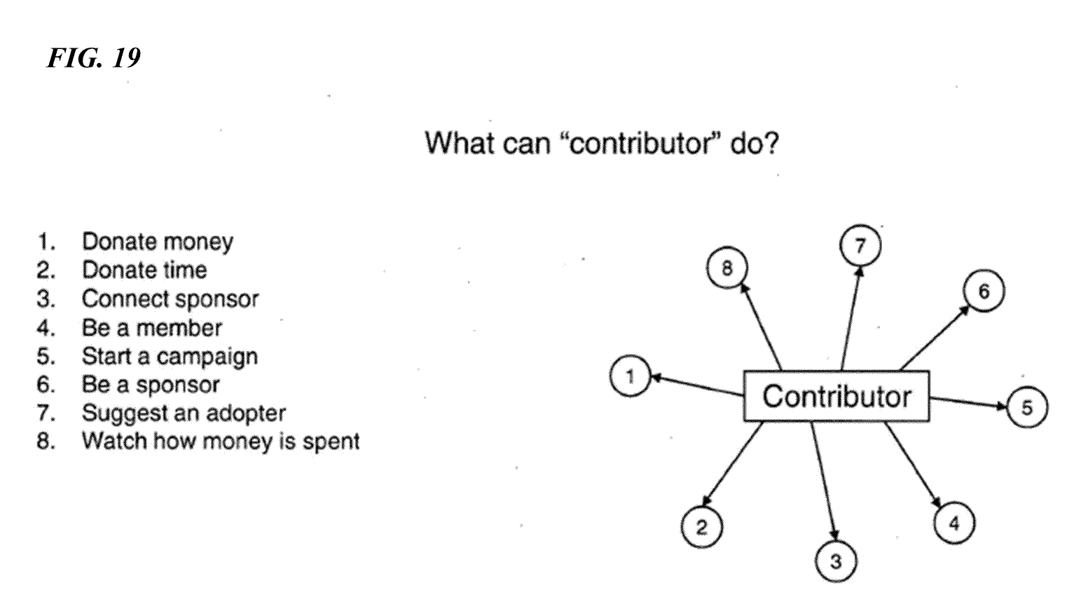

Now referring to FIG. 19, element 31R describes the numerous actions that can be performed by a “contributor” within the Adopt Anything™ method, mechanism and invention.

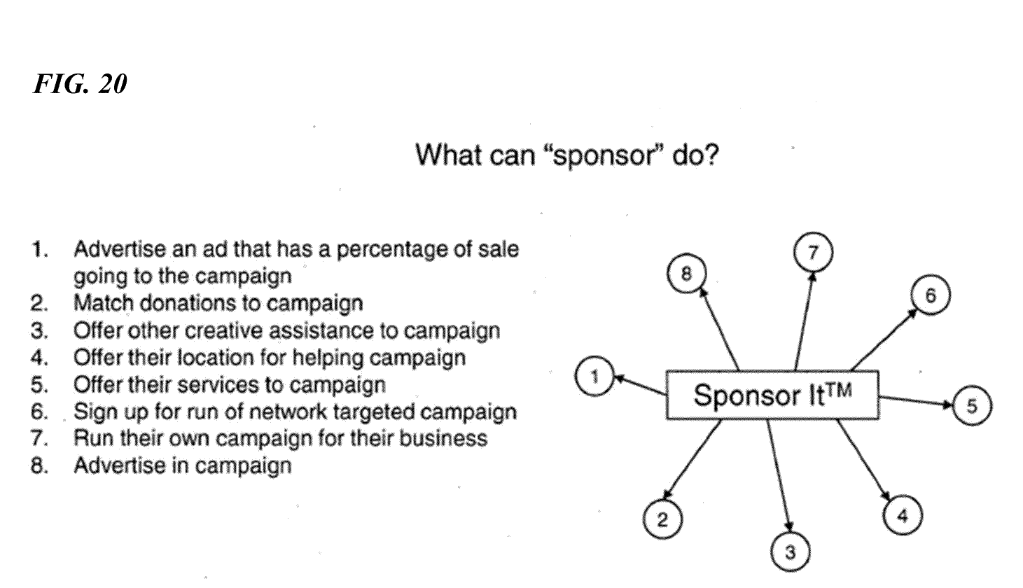

Now referring to FIG. 20, element t 32R describes the numerous actions that can be performed by a “sponsor” within the Adopt Anything™ method, mechanism and invention.

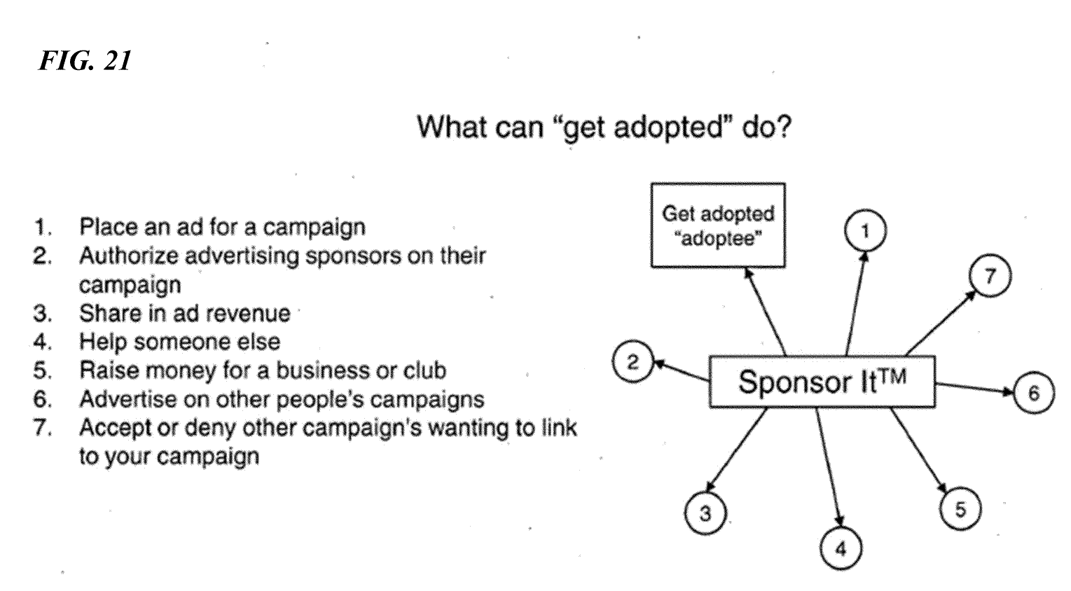

Now referring to FIG. 21, element 33R describes the numerous actions that can be performed by the “adoptee” within the Adopt Anything™ method, mechanism and invention.

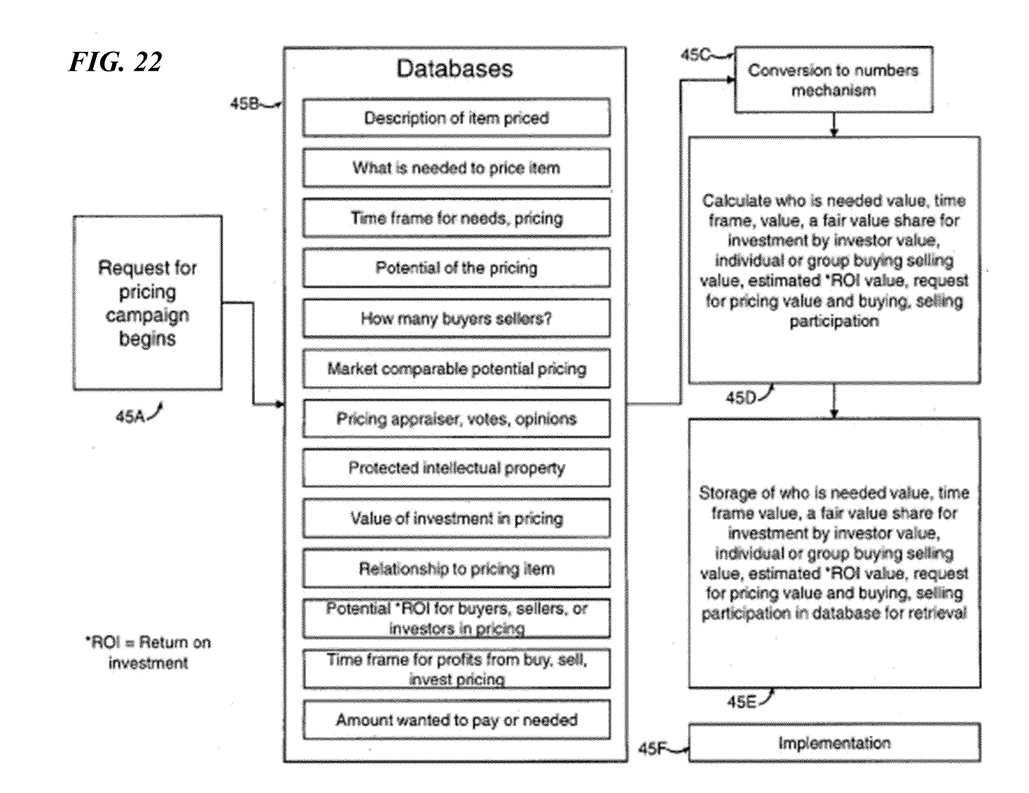

Now referring to FIG. 22, element 45A illustrates how the request for pricing campaign will be started. Element 45B illustrates how a list of database potentials, will give the guidelines onto the buyer/seller operations. The guidelines include, description of items priced, what is needed to price the item, time frame for needs, pricing, potential of the pricing, how many buyers sellers, market comparable potential pricing, pricing appraiser, votes, opinions, protected intellectual property, value of investment in pricing, relationship to pricing item, potential *ROI for buyers, sellers, or investors in pricing, time frame for profits from buy, sell, invest pricing, and amount wanted to pay or needed. Element 45C illustrates how to convert data to numbers. Element 45D illustrates how the calculations of who is needed values, time frame values and various other financial pricing will be necessary for setting up a financial framework. Element 45E illustrates how the storing capacity will show who is needed values, time frame values, a fair share for investment by investor value, and other buying selling participation in database for retrieval. Element 45F illustrates how the implementation for the pricing campaign will be started.

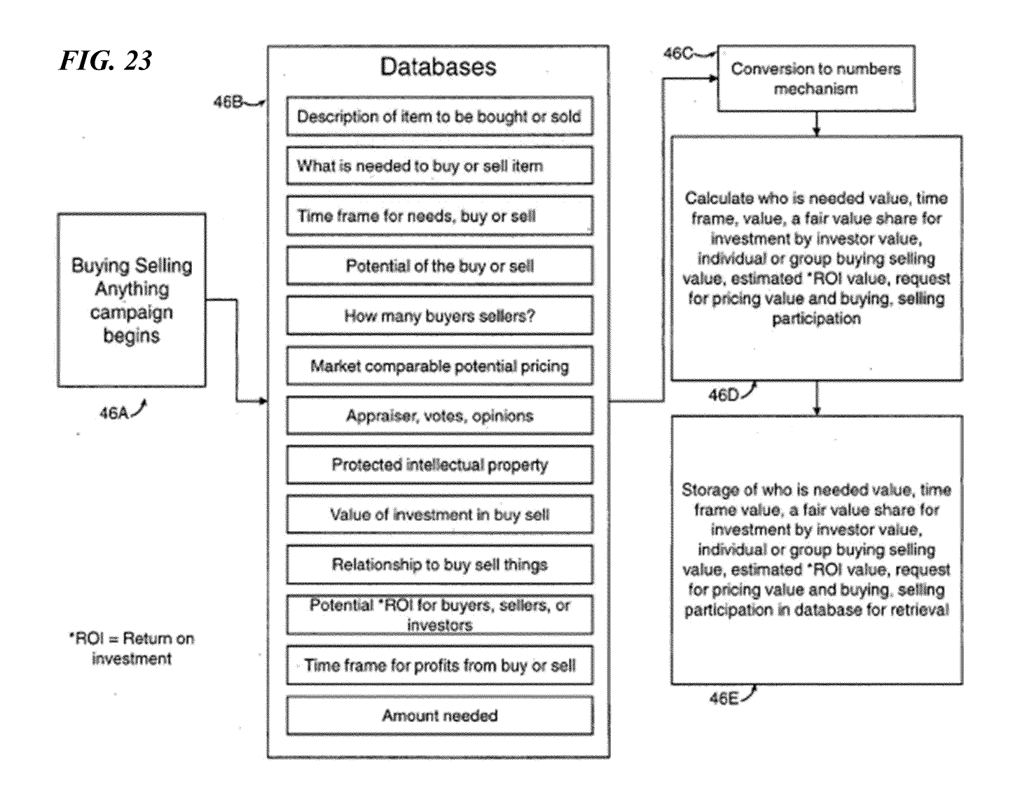

Now referring to FIG. 23, element 46A describes that buying and selling anything campaign starts for user purposes. Element 46B illustrates that a list of database potentials, will give the guidelines onto the buyer/seller operations. The guidelines include, description of item to be bought or sold, what is needed to buy or sell item, time frame for needs, buy or sell, potential of the buy or sell, how many buyers sellers, market comparable potential pricing, pricing appraiser, votes, opinions, protected intellectual property, value of investment in buy sell, relationship to buy sell things, potential *ROI for buyers, sellers, or investors in pricing, time frame for profits from buy, sell, and amount needed. Element 46C illustrates how the conversion mechanism method will change data into numbers. Element 46D illustrates, the calculation of who is needed value, time frame value, a fair value share for investment by investor value, individual or group buying selling value, estimated *ROI value, request for pricing value and buying, selling participation. Element 46E illustrates the storage of who is needed values, time frame values, a fair value share for investment by investor value, individual or group buying selling value, estimated *ROI value, request for pricing value and buying, selling participation in database for retrieval and other pricing procedures for buying and selling.

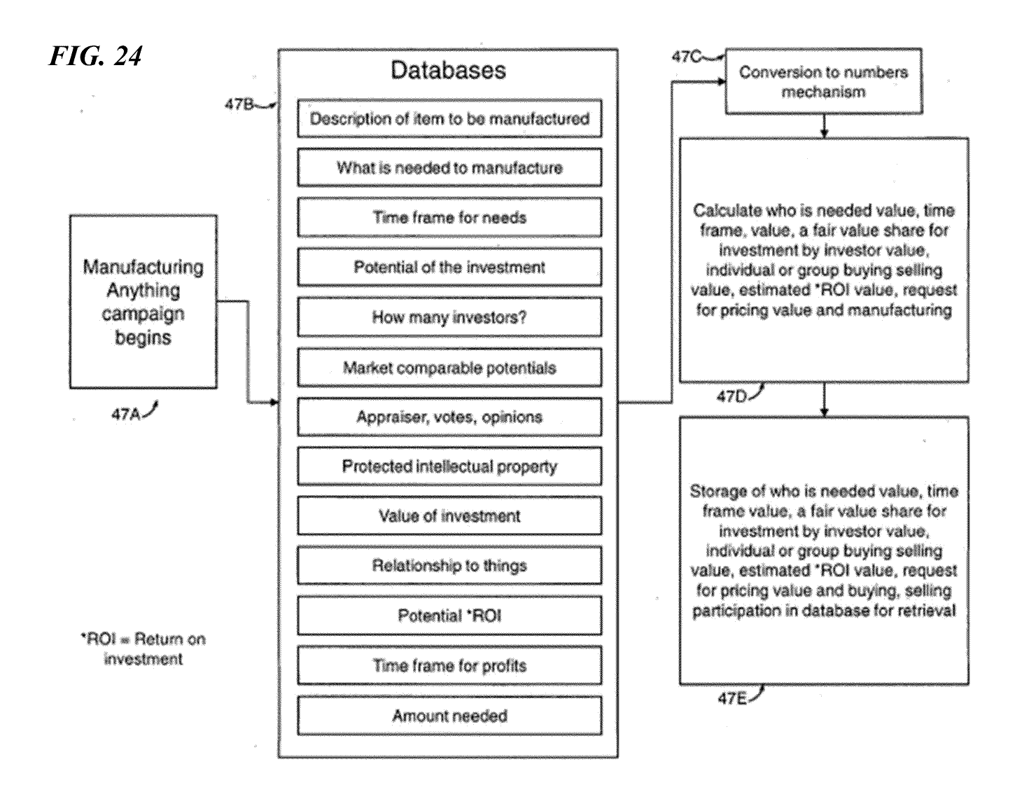

Now referring to FIG. 24, element 47A illustrates the manufacturing anything campaign initiation process. Element 47B illustrates the databases several financial guidelines, including, description of item to be manufactured, what is needed to manufacture, time frame for needs, potential of the investment, how many investors, market comparable potentials, appraiser, votes, opinions, protected intellectual property, value of investment, relationship to things, potential *ROI, time frame for profits, and amount needed. Element 47C illustrates how the conversion mechanism method will change data into numbers. Element 47D illustrates the calculation to who is needed value, time frame value, a fair value share for investment by investor value, estimated *ROI value, request for pricing value and manufacturing. Element 47E illustrates the storage of who is needed value, time frame value, a fair value share for investment by investor, estimated *ROI value, request for pricing and manufacturing value in database for retrieval.

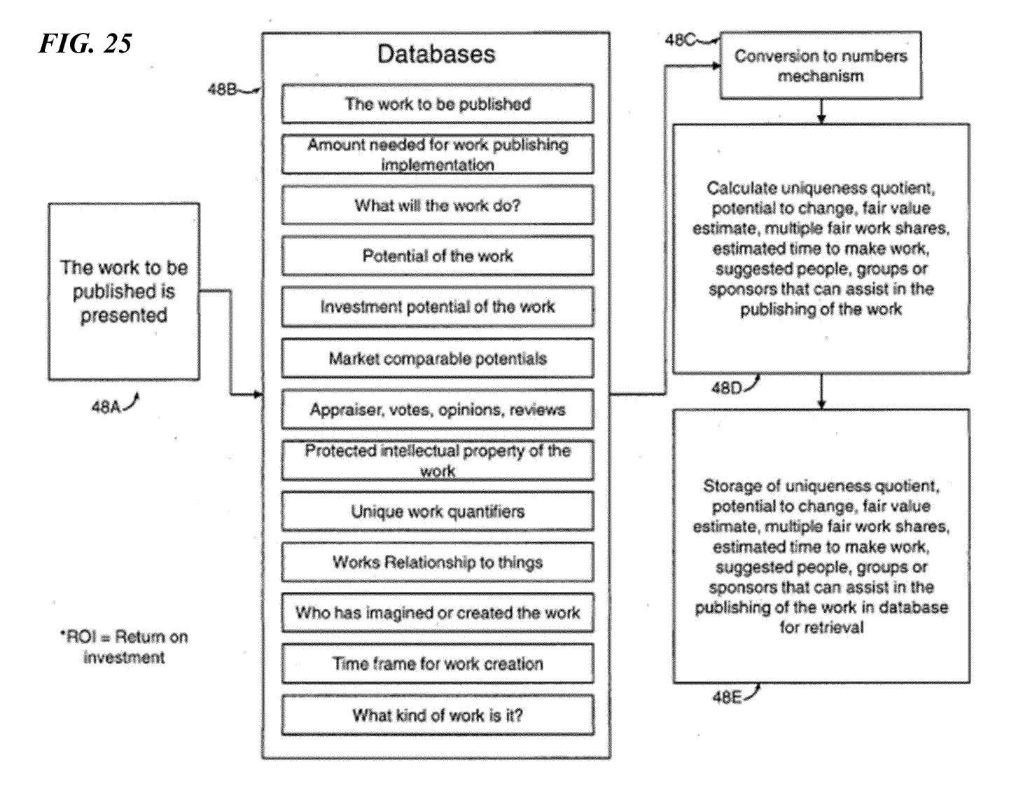

Now referring to FIG. 25, element 48A illustrates that the work to be published is presented. Element 48B illustrates 11 categories of database types. These range from the work to be published, amount needed for work publishing implementation, what the work will do, potential of the work, investment potential of the work, market comparable potentials, appraiser, votes, opinions, reviews, protected intellectual property of the work, unique work quantifiers, works relationship to things, who has imagined or created the work, time frame for work creation, and what kind of work it is. Element 48C illustrates the conversion to numbers mechanism. Element 48D illustrates the quality of calculation uniqueness, quotient, potential to change, fair value estimate, multiple fair work shares, estimated time to make work, suggested people, and the groups or sponsors that can assist in the publishing of the work. Element 48E illustrates storage of the uniqueness quotient, potential to change, fair value estimate, multiple fair work shares, and the estimated time to make work, suggested people, groups or sponsors that can assist in the publishing of the work in database for retrieval.

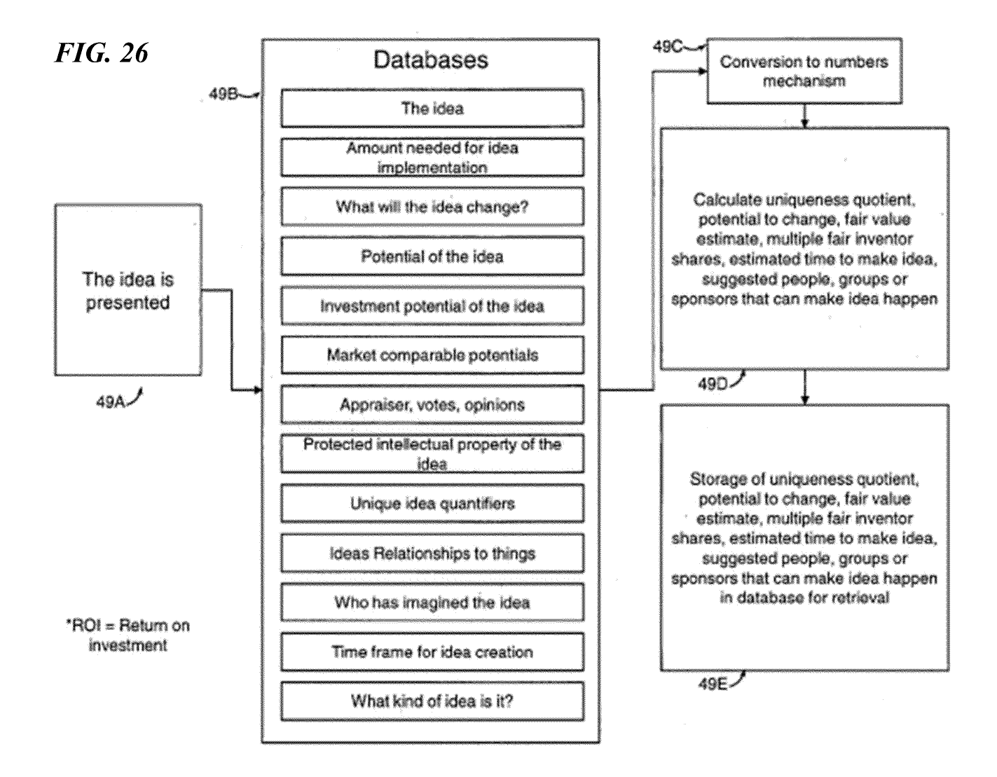

Now referring to FIG. 26, element 49A illustrates how the idea is presented. Element 49B illustrates 13 categories within databases, including the idea, amount needed for idea implementation, what the idea will change, potential of the idea, investment potential of idea, market comparable potentials, appraiser, votes, opinions, protected intellectual property of the idea, unique idea quantifiers, ideas relationship to things, who has imagined the idea, time frame for idea creation, and what kind of idea it is. Element 49C illustrates the conversion to numbers mechanism. Element 49D illustrates the calculation uniqueness quotient, potential to change, fair value estimate, multiple fair inventor shares, estimated time to make idea, suggested people, and groups or sponsors that can make idea happen. Element 49E illustrates the storage of uniqueness quotient, potential to change, fair value estimate, multiple fair inventor shares, estimated time to make idea, suggested people, and groups or sponsors that can make the idea happen in database for retrieval.

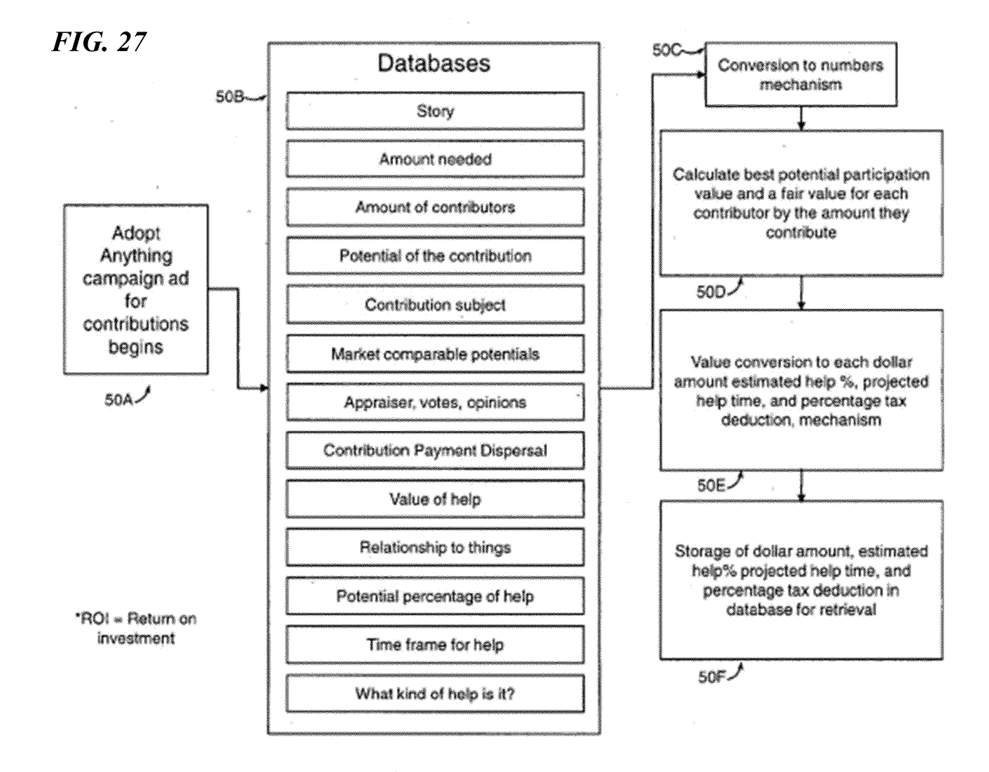

Now referring to FIG. 27, element 50A illustrates how adopt anything campaign ad for contributions begins. Element 50B illustrates 13 categories within databases, including story, amount needed, amount of contributors, potential of the contribution, contribution subject, market comparable potentials, appraiser, votes, opinions, contribution payment dispersal, value of help, relationship to things, potential percentage of help, time frame for help, and what kind of help it is. Element 50C illustrates the conversion to numbers mechanism. Element 50D illustrates the calculation's best potential participation value and a fair value for each contributor by the amount they contribute. Element 50E illustrates the value conversion to each dollar amount, estimated help %, projected help time, and percentage tax deduction as well as the mechanism. Element 50F illustrates the storage of dollar amount, estimated help % projected help time, and percentage tax deduction in database for retrieval.

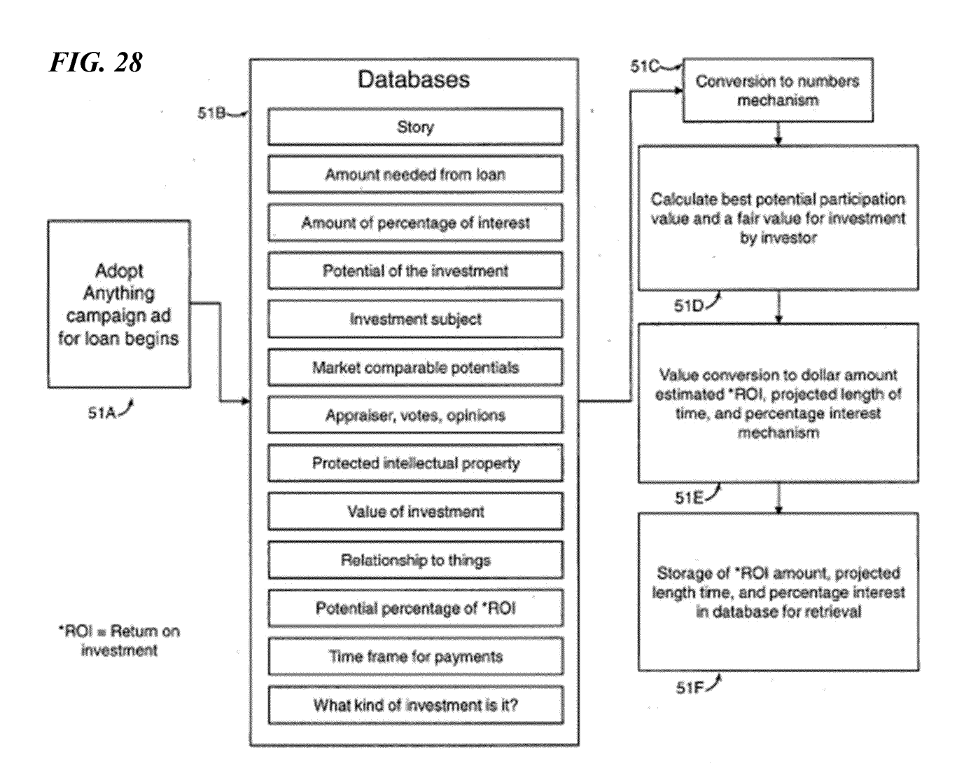

Now referring to FIG. 28, element 51A illustrates how the adopt anything campaign ad for loan begins. Element 51B illustrates 13 categories of databases, including story, amount needed form loan, amount of percentage of interest, potential of the investment; investment subject, market comparable potentials, appraiser, votes, opinions, protected intellectual property, value of investment, relationship to things, potential percentage *ROI, time frame for payments, and what kind of investment it is. Element 51C illustrates the conversion to numbers mechanism. Element 51D illustrates the calculation's best potential participation value and a fair value for investment by investor. Element 51E illustrates the value conversion to dollar amount, estimated *ROI, projected length time, and percentage interest mechanism. Element 51F illustrates the storage of *ROI amount, projected length time, and the percentage interest in database for retrieval.

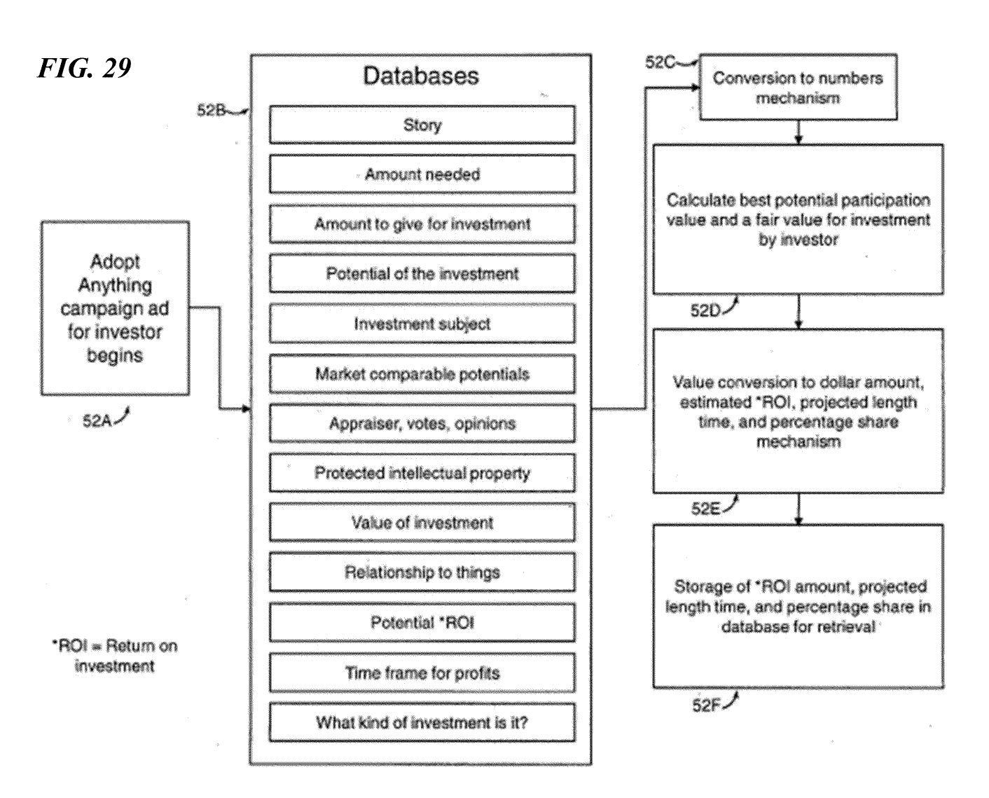

Now referring to FIG. 29, element 52A illustrates how the adopt anything campaign ad for investor begins. Element 52B illustrates 13 categories of databases, including story, amount needed, amount to give for investment, potential of the investment, investment subject, market comparable potentials, appraiser, votes, opinions, protected intellectual property, value of investment, relationship to things, potential *ROI, time frame for profits, and what kind of investment it is. Element 52C illustrates the conversion to numbers mechanism. Element 52D illustrates the calculation of best potential participation value, and a fair value for investment by investor. Element 52E illustrates the value conversion to dollar amount, estimated *ROI, projected length time, and percentage share mechanism. Element 52F illustrates the storage of *ROI amount, projected length time, and percentage share in database for retrieval.

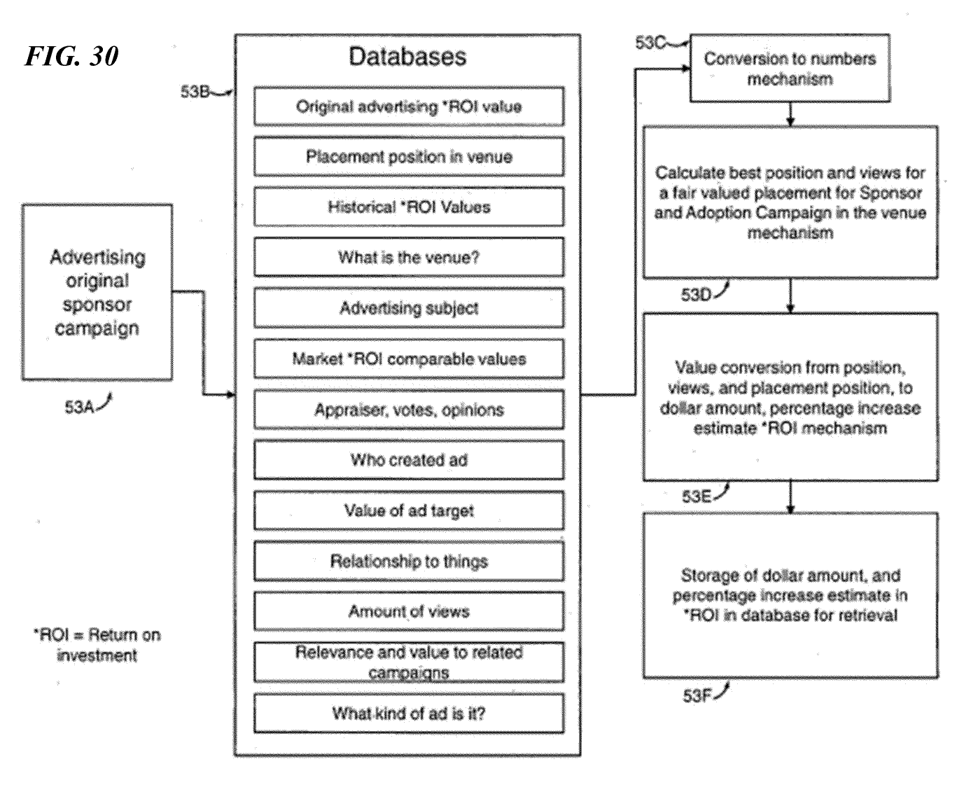

Now referring to FIG. 30, element 53A illustrates the advertising's original sponsor campaign. Element 53B illustrates 13 categories of databases, including original advertising *ROI value, placement position in venue, historical *ROI values, what the value is, advertising subject, market *ROI comparable values, appraiser, votes, opinions, who created the ad, value of ad target, relationship to things, amount of views, relevance and value to related campaigns, and what kind of ad it is. Element 53C illustrates the conversion to numbers mechanism. Element 53D illustrates the calculation's best position and views for a fair valued placement for Sponsor and adoption campaign in the venue mechanism. Element 53E illustrates the value conversion from position, views, and placement position, to dollar amount, as well as percentage increase estimate in *ROI mechanism. Element 53F illustrates the storage of dollar amount, and percentage increase estimate in *ROI for database retrieval.

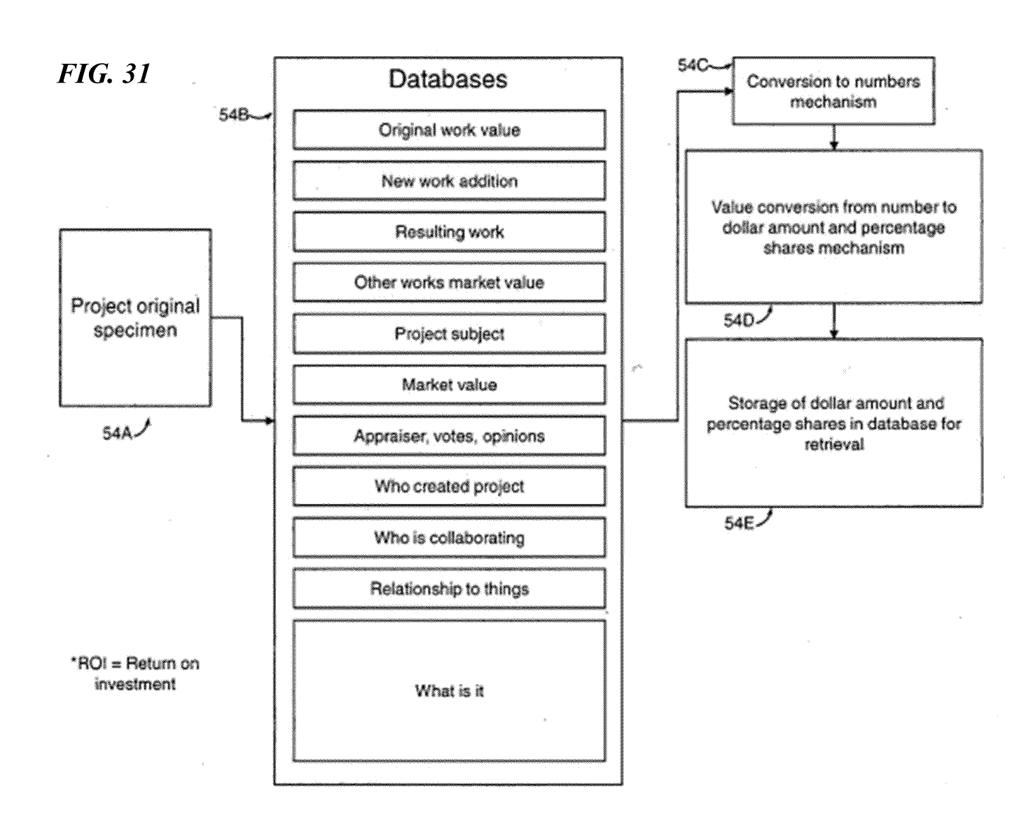

Now referring to FIG. 31, element 54A illustrates the project's original specimen. Element 54B illustrates 11 categories of databases, including original work value, new work addition, resulting work, other works market value, project subject, market value, appraiser, votes, opinions, who created the project, who is collaborating, relationship to things, and what it is. Element 54C illustrates the conversion to numbers mechanism. Element 54D illustrates the value conversion from number to dollar amount and percentage shares mechanism, and the storage of dollar amount and percentage shares in database for retrieval. Element 54E illustrates the storage of dollar amount and percentage shares in database for retrieval.

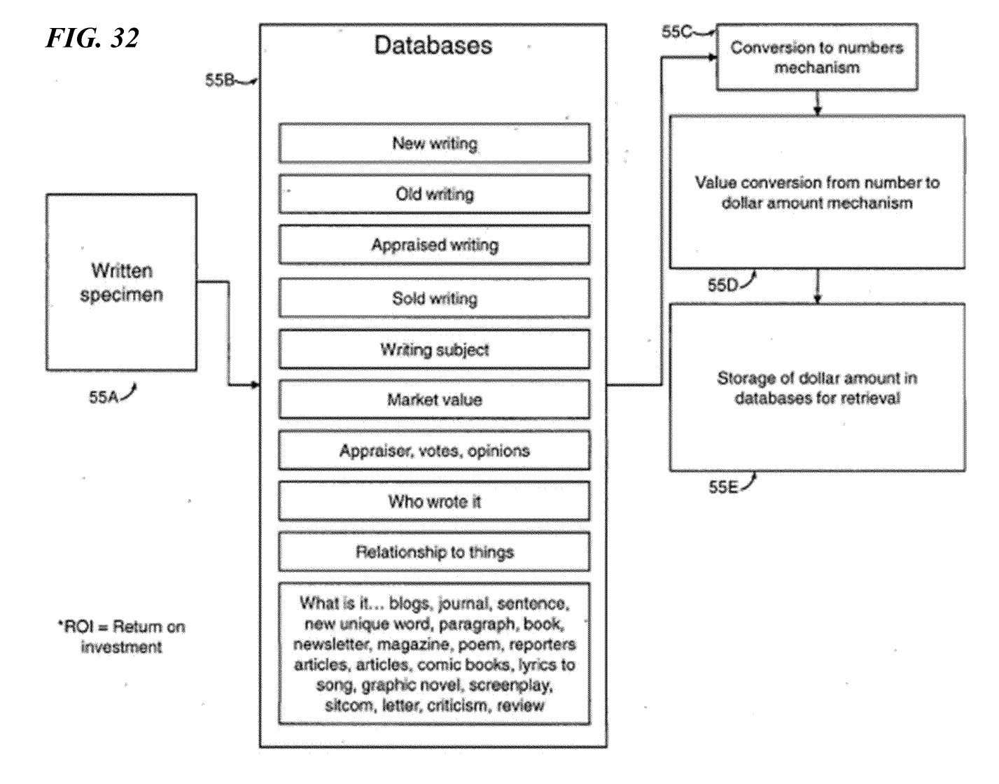

Now referring to FIG. 32, element 55A illustrates written specimen. Element 55B illustrates 10 categories of databases including, new writing, old writing, appraised writing, sold writing, writing subject, market value, appraiser, votes, opinions, who wrote it, relationship to things, and also the descriptions of what it is, blog, journal, sentence, new unique word, paragraph, book, newsletter, magazine, poem, reporters articles, articles, comic books, lyrics to song, graphic novel, screenplay, sitcom, letter, criticism, and review. Element 55C illustrates the conversion to numbers mechanism. Element 55D illustrates the value conversion from number to dollar amount mechanism. Element 55E illustrates the storage of dollar amount in database for retrieval.

Now referring to FIG. 33, element 56A illustrates the advertising's original specimen. Element 56B illustrates 11 categories of databases, including original advertising *ROI value, placement position in venue, historical *ROI values, what the value is, advertising subject, market *ROI comparable values, appraiser, votes, opinions, who created the ad, value of ad target, relationship to things, and what kind of ad it is. Element 56C illustrates the conversion to numbers mechanism. Element 56D illustrates the value conversion from number to dollar amount, percentage increase estimate in *ROI mechanism. Element 56E illustrates storage of dollar amount and percentage increase estimate in *ROI in database for retrieval.

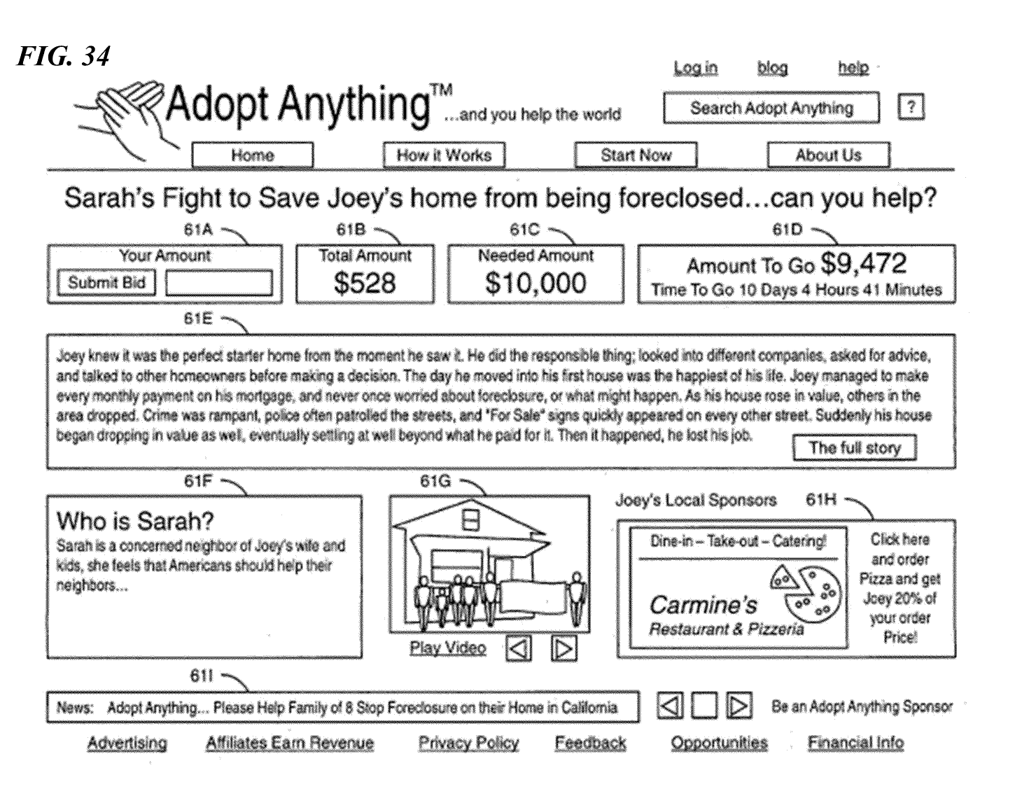

Now referring to FIG. 34, element 61A illustrates an input form field where an individual can submit a bid for the listed adoption cause. Element 61B illustrates a field where the total amount that has been donated is displayed. Element 61C illustrates a field where the total needed amount of money to fulfill the adoption of the thing is displayed. Element 61D illustrates a field where the amount of money still needed to fulfill the adoption of the thing, and the time until the money is due, is displayed. Thus the FIG. in 61B is subtracted from the FIG. in 61C to find the FIG. in 61D. 61E illustrates a field where a written description of the specific adoption is displayed. 61F illustrates a field where an individual who has already adopted the thing can leave comments. 61G illustrates a VCard application where the adoptee can explain more about his or her cause and update his or her investors with information relating to the cause. 61H illustrates a field where a sponsor can offer additional support to the adoptee in return for help with its own personal business venture. 61I illustrates a continuously running “ticker tape” type mechanism that shows other adoption causes.

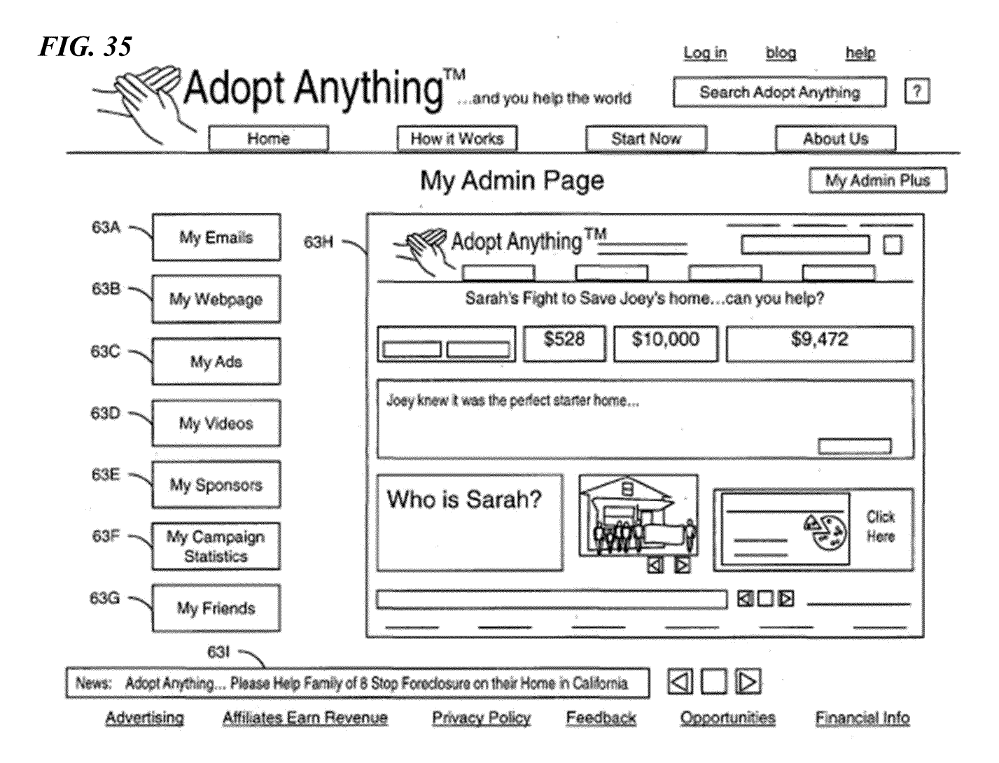

Now referring to FIG. 35, element 63A illustrates a link through which an individual will be able to access his or her e-mails. Element 63B illustrates a link through which an individual will be able to access their personal webpage. Element 63C illustrates a link through which an individual will be able to access his or her advertisements. Element 63D illustrates a link through which an individual will be able to access his or her videos. Element 63E illustrates a link through which an individual will be able to access his or her sponsors. Element 63F illustrates a link through which an individual will be able to access his or her campaign statistics. Element 63G illustrates a link through which an individual will be able to access his or her friends list. Element 63H illustrates an individual users administrative page where their personal Adopt Anything™ campaign is displayed. Element 63I illustrates a continuously running “ticker tape” type mechanism that shows other adoption causes.

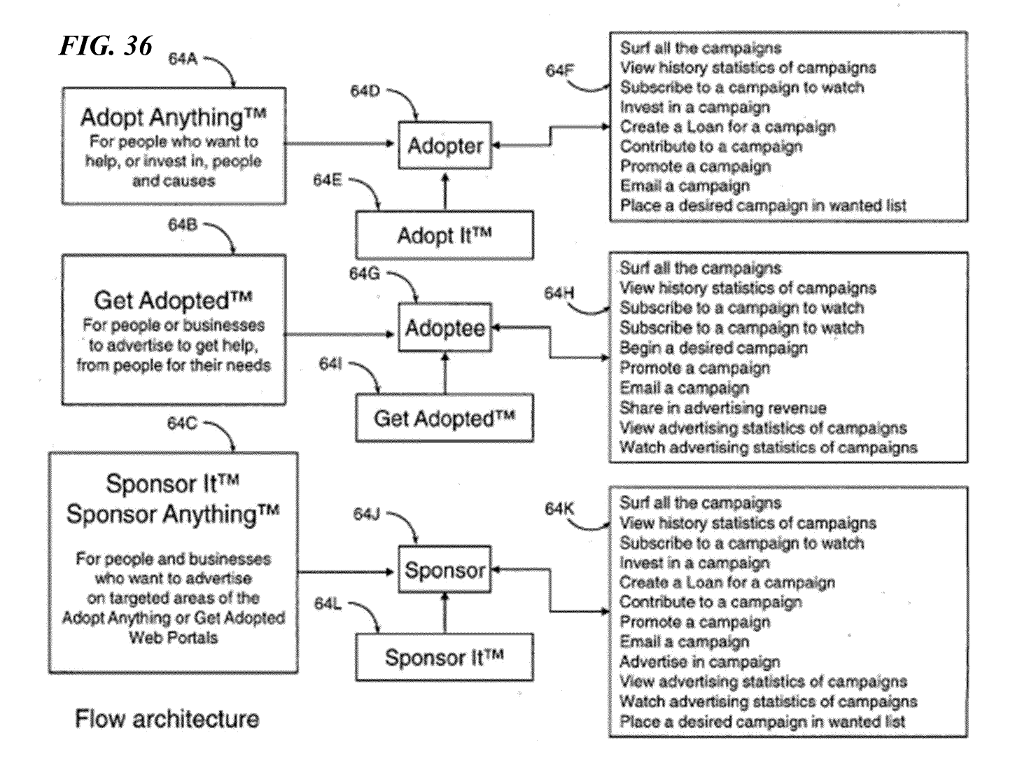

Now referring to FIG. 36, element 64A identifies the mechanism and method by which this is all possible, namely Adopt Anything™. Element 64B identifies a crucial element within the Adopt Anything network, namely the ability to get adopted. Element 64C identifies another crucial element within the Adopt anything network, namely the ability to sponsor an adoptee. Element 64D identifies the ability of an individual to become an adopter. Element 64E describes the functions that can be performed by the adopter within the Adopt Anything network. Element 64F identifies the ability of an individual to adopt a potential adoptee. Element 64G identifies the ability of an individual to get adopted. Element 64H describes the functions that can be performed by the adoptee within the Adopt Anything network. Element 64I identifies the ability of an individual to get adopted by a potential adopter. Element 64J identifies the ability of an individual to become a sponsor. Element 64K describes the functions that can be performed by the sponsor within the Adopt Anything network. Element 64L identifies the ability of an individual to sponsor something on the Adopt Anything network.

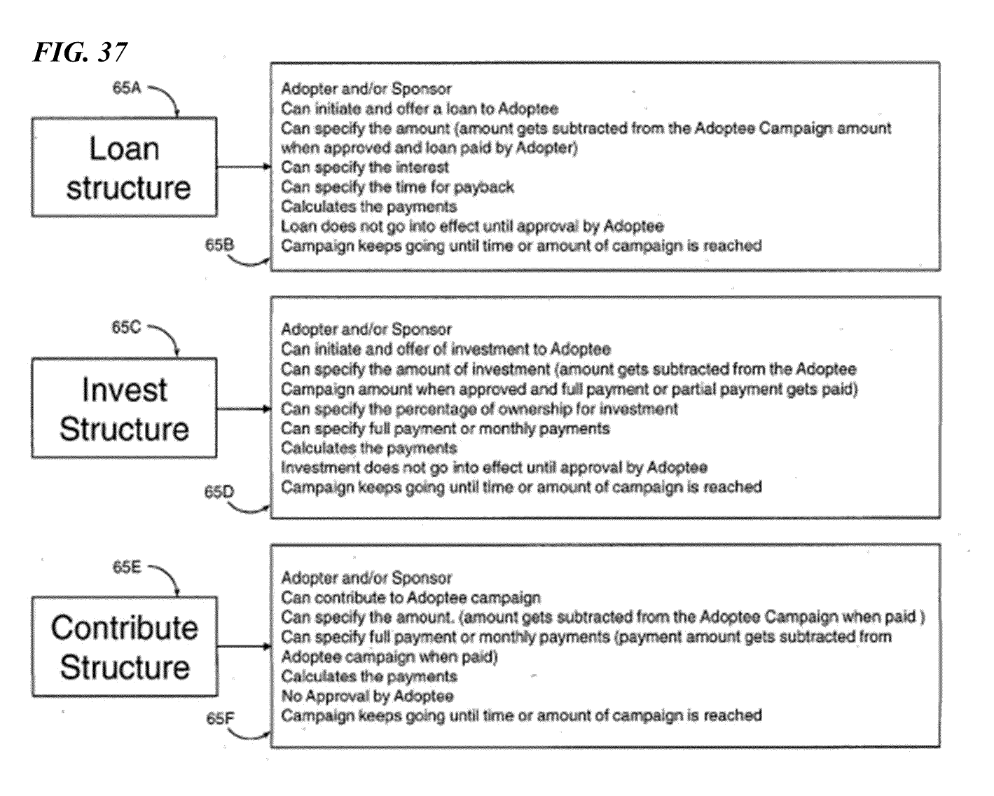

Now referring to FIG. 37, element 65A displays the method by which money is transferred between people involved in the Adopt Anything network. Element 65B describes the mechanisms through which the loans are processed. Element 65C displays the method by which money is invested within the Adopt Anything network. Element 65D describes the mechanisms through which investment is processed. Element 65E displays the method by which contributions are made within the Adopt Anything network. Element 65F describes the mechanisms through which contributions are processed.

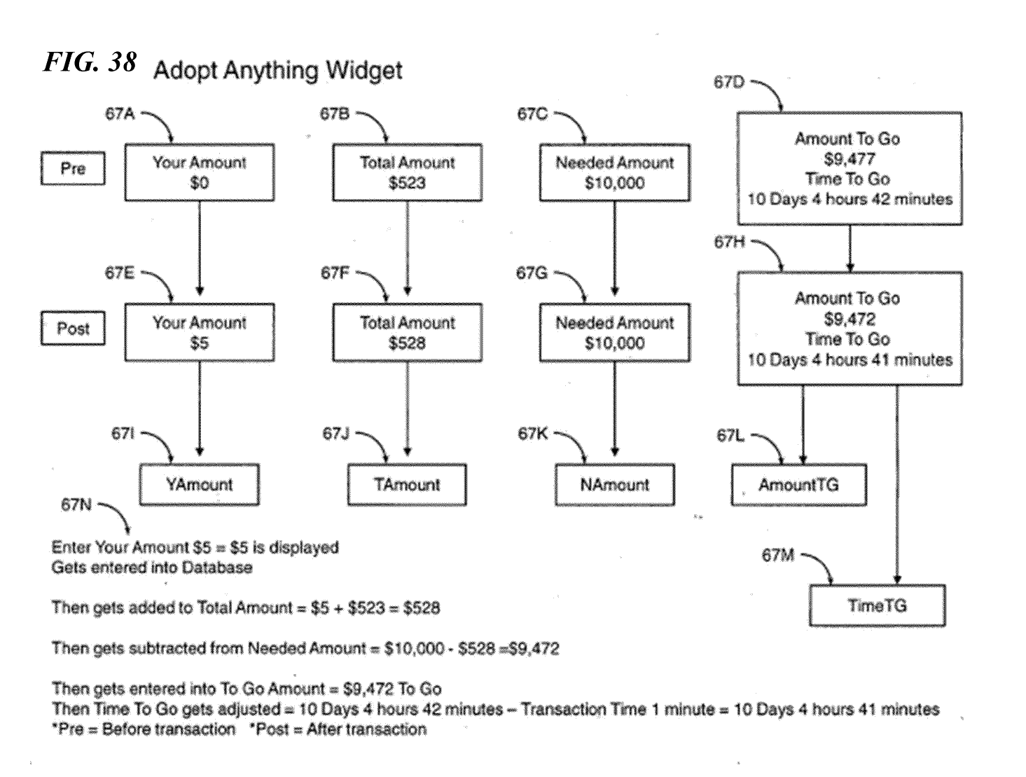

Now referring to FIG. 38, element 67A illustrates the amount box, which shows the starting points of amount values as in this case, $0. Element 67B illustrates the total amount box, which shows the first step in the accumulation of money. Element 67C illustrates the needed amount box, which displays the total of the needed amount as in this case, $10,000. Element 67D illustrates the amount to go box, which will calculate what is left to accumulate after subtracting needed amount from total amount. Element 67E illustrates your amount box, which is the amount that the member is will to put into the investment. Element 67F illustrates the total amount box, which in this case is added to the $5 a member has already invested to total $528. Element 67G illustrates the needed amount, which will still be the same as in 66C. Element 67H illustrates the amount to go box, which calculates what is left to accumulate after subtracting needed amount from total amount. Element 67I illustrates the YAmount, which is the total of all your amounts. Element 67J illustrates the TAmount, which is the total of all total amounts located in the second column. Element 67K illustrates the NAmount, which is the total of all needed amounts located in the third column. Element 67L illustrates the AmountTG, which is the accumulation of values from 66D and 66H of the fourth column. Element 67M illustrates the TimeTG, which gives a breakdown of total time to go from the values within 67D and 67H. Element 67N illustrates a series of formulas and calculations for the user to see where the numbers or equations are derived from.

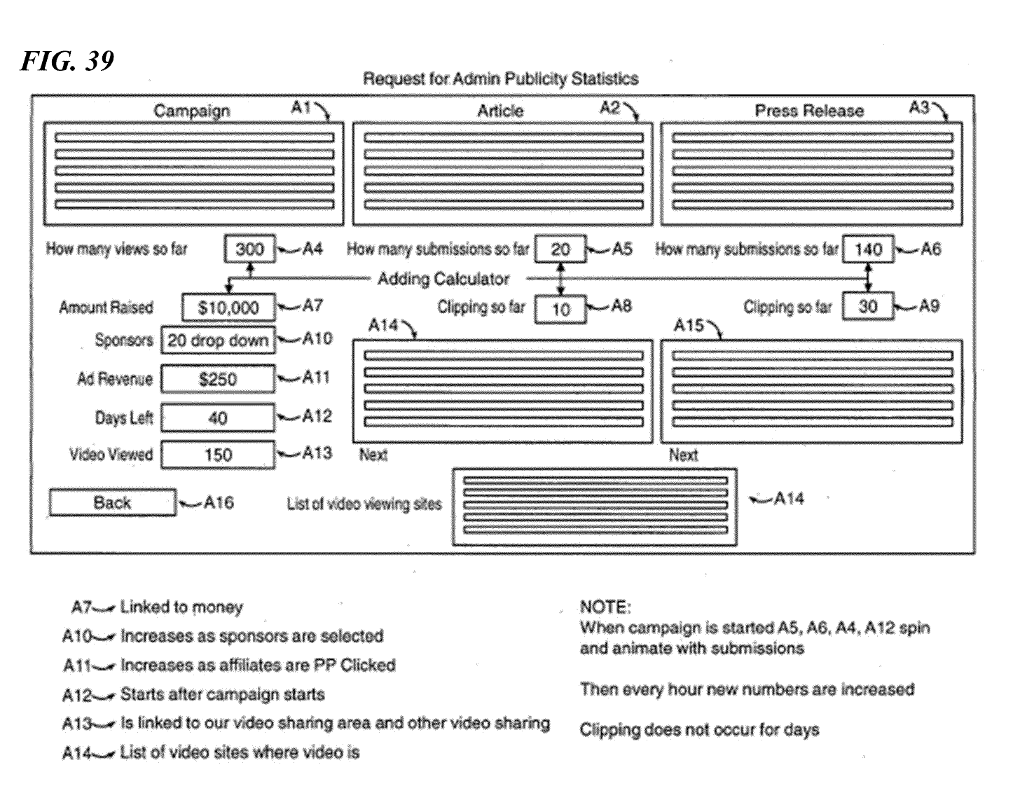

Now referring to FIG. 39, element 72A1 illustrates the highlights of the campaign within the admin publicity statistics. Element 72A2 illustrates an article synopsis within the admin publicity statistics. Element 72A3 illustrates the press release data within the admin publicity statistics, showing the updated press releases within a time frame series. Element 72A4 illustrates submission amounts for views in the campaign section, within the admin publicity statistics. Element 72A5 illustrates submission amounts for views in the article section, within the admin publicity statistics. Element 72A6 illustrates submission amounts for views in the press release section, within the admin publicity statistics. Element 72A7 illustrates the amount raised for the campaign within the admin publicity statistics page. Element 72A8 illustrates the clippings done so far within the article section. Element 72A9 illustrates the clippings done so far within, the press release section. Element 72A10 illustrates the amount of sponsors available inside the drop down box. Element 72A11 illustrates the amount of ad revenue available. Element 72A12 illustrates the days left for the campaign. Element 72A13 illustrates this system is linked to our video sharing area and other video sharing. Element 72A14 illustrates the list of video sharing sites where the video is.

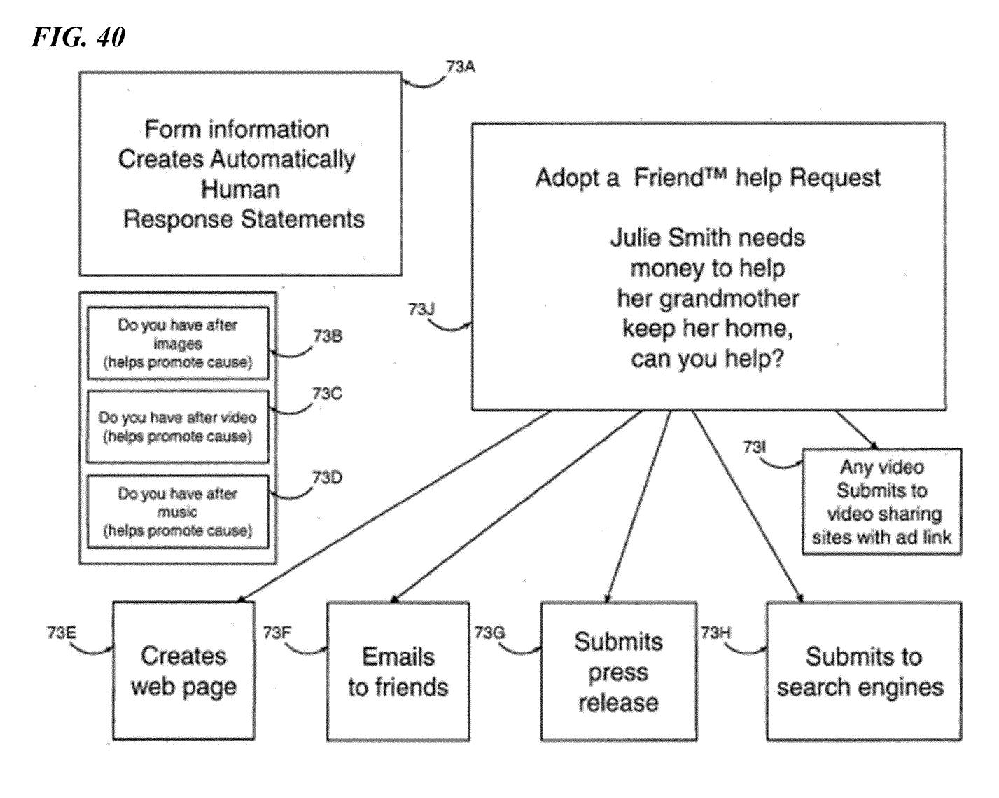

Now referring to FIG. 40, element 73 illustrates that form information creates automatic human response statements. Element 73B illustrates that the statement, “do you have after images,” will help promote the cause. Element 73C illustrates that the statement, “do you have after video,” will help promote the cause. Element 73D illustrates that the statement, “do you have after music,” will help promote the cause. Element 73E illustrates the action creates a web page, in order for ease of creation. Element 73F illustrates emails to friends, in order for members to email others about information found on this website. Element 73G illustrates submits press release in order for there to be convenient press release look up. Element 73H illustrates submits to search engines in order for there to be convenience in sharing the sites search. Element 73I illustrates the status of any video submits to video sharing sites with ad link. Element 73E illustrates the Adopt a Friend trademark will present someone's need for money, with the effect of directing visitors toward charity purposes into aiding money for them.

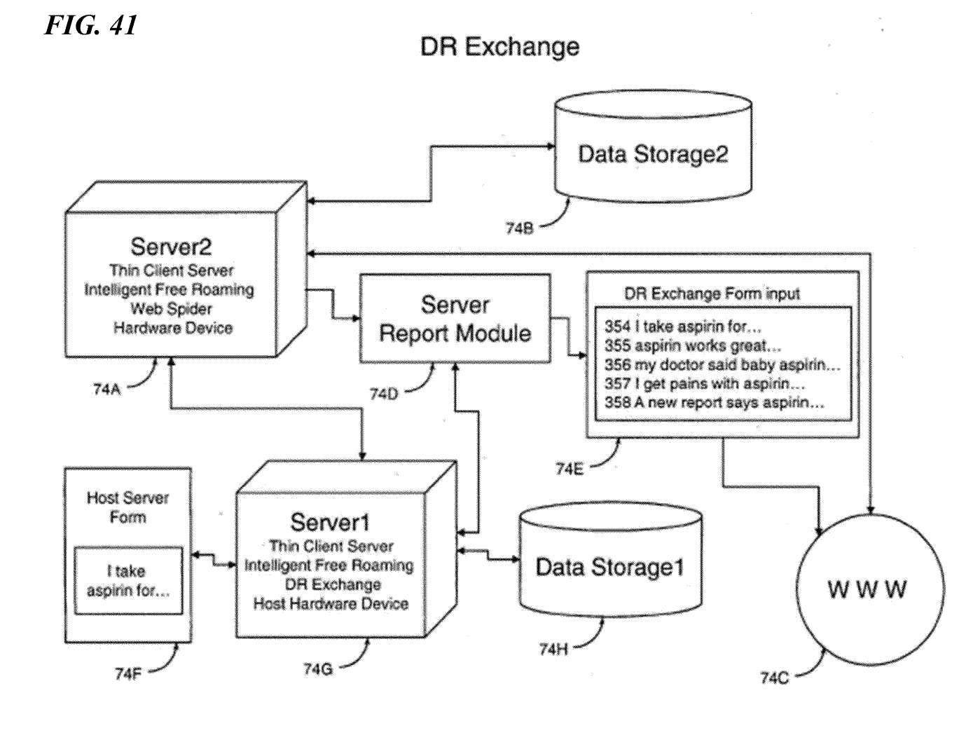

Now referring to FIG. 41, element 74A illustrates server2's main components, including thin client server, intelligent free roaming, web spider, and hardware device for the purpose of displaying the specifics of the system. Element 74B illustrates the data storage unit, which will allow data to accompany this memory space. Element 74C illustrates the www domain prefix, which will give the main interne address aspect. Element 74D illustrates the server report module, which will report the server's main frame specifics. Element 74E illustrates the DR Exchange form input, which maps out situations for a circumstance. In the case presented, the benefits and side effects of aspirin are explained including user and report statistics. Element 74F illustrates the host server form, which depicts an event happening. In the case presented, user finds the information that one takes aspirin for something. Element 74G illustrates server1's main components, including thin client server, intelligent free roaming, DR Exchange, and Host Hardware Device. These system components depict the type specifics of server1, and will allow user's to find the advantages of the server. Element 74H illustrates the second data storage unit, which will allow data to accompany this memory space.

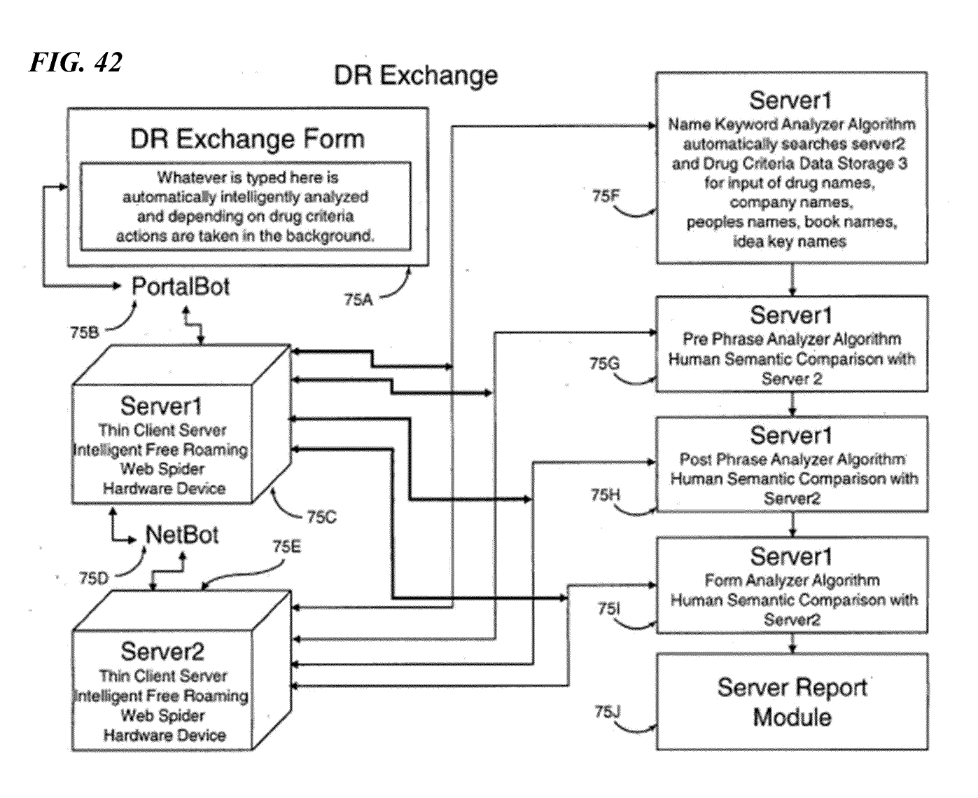

Now referring to FIG. 42, element 75A illustrates the scenario that anything typed here will be automatically and intelligently analyzed and depending on drug criteria actions are to be taken in the background. Element 75B illustrates the PortalBot, which will provide as a connection point between the DR Exchange Form and server1. Element 75C illustrates server1 and its main components, including thin client server, intelligent free roaming, web spider, and hardware device. These system specifics will provide the user with better views of the mainframe's advantages. Element 75D illustrates the NetBot, which will serve as a connection point between server1 and server2. Element 75E illustrates server2 and its main components, including thin client server, intelligent free roaming, web spider, and hardware device. These system specifics will provide the user with better views of the mainframe's advantages. Element 75F illustrates server1 and its main components including the name keyword analyzer algorithm, which will automatically search server2 and drug criteria data storage 3 for input of drug names, company names, peoples names, book names, and the idea key names. Element 75G illustrates server1's role within the DR Exchange, depicting the pre phrase analyzer algorithm and the human semantic comparison with server2. Element 75H illustrates another one of server 1's simultaneous roles within the DR Exchange, depicting the post phrase analyzer algorithm and the human semantic comparison with server2. Element 75I illustrates the third one of server1's simultaneous roles within the DR Exchange, depicting the form analyzer algorithm and the human semantic comparison with server2. Element 75J illustrates the server report module, which is the last step to the DR Exchange providing one last step to the reporting procedure.

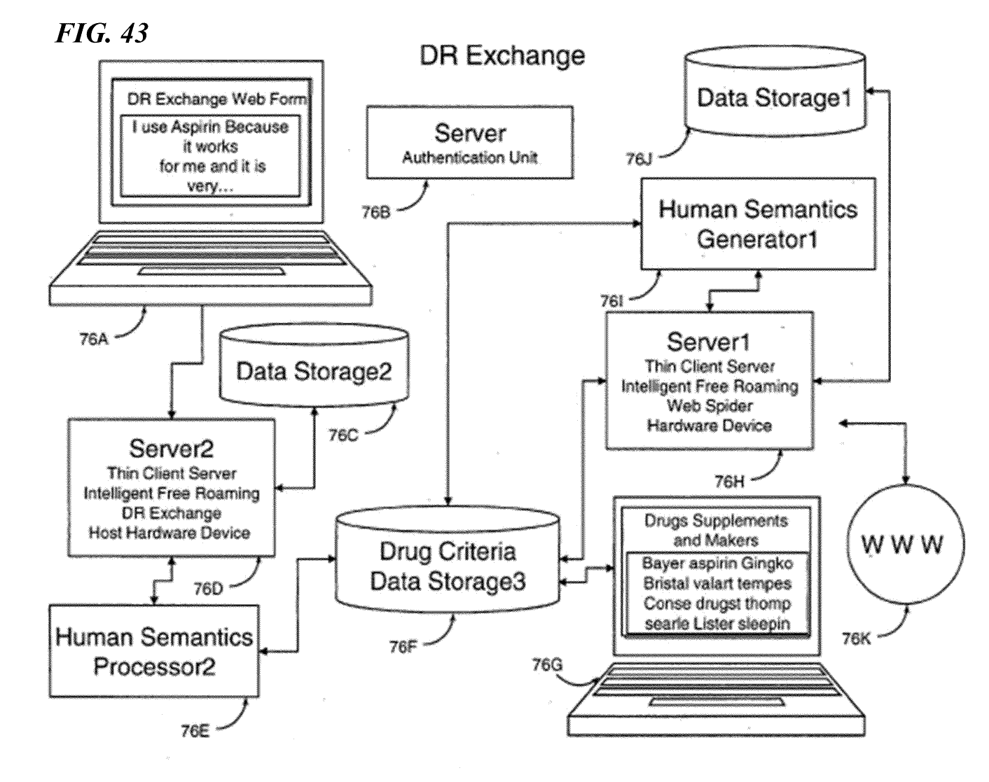

Now referring to FIG. 43, element 76A illustrates the super computer DR Exchange Web Form, which displays a written cause statement, “I use Aspirin, because it works for me and it is very ______.” Element 76B illustrates the server authentication unit, which provides a security layer for proper access. Element 76C illustrates data Storage2, which will allow data to accompany this memory space. Element 76D illustrates server2's main components, including thin client server, intelligent free roaming, DR Exchange, and host hardware device. These system specifics will provide the user with better views of the mainframe's advantages. Element 76E illustrates the human semantics processor2, which connects to server2 and the later Drug Criteria Data Storage3. This processor will be a tool for giving the proper meaning of certain language paths typed on the computer. Element 76F illustrates the Drug Criteria Data Storage3, which enables certain drug information to be stored onto the data storage unit's memory space. Element 76G illustrates the Drugs Supplements and Makers on screen layout, which will give a three part word series of available information. Element 76H illustrates server1's main component's, including thin client server, intelligent free roaming, web spider, and hardware device. These system specifics will provide the user with better views of the mainframe's advantages. Element 76I illustrates the Human Semantics Generator1, which works in lesion with Drug Criteria Data Storage3 and server1. This generator will work out meanings of word meanings and map out semantic word language. Element 76J illustrates the data storage 1 unit, which is connected only to server1. This storage unit will allow data to accompany this memory space. Element 76 k illustrates the www domain prefix, which will give the main interne address aspect.

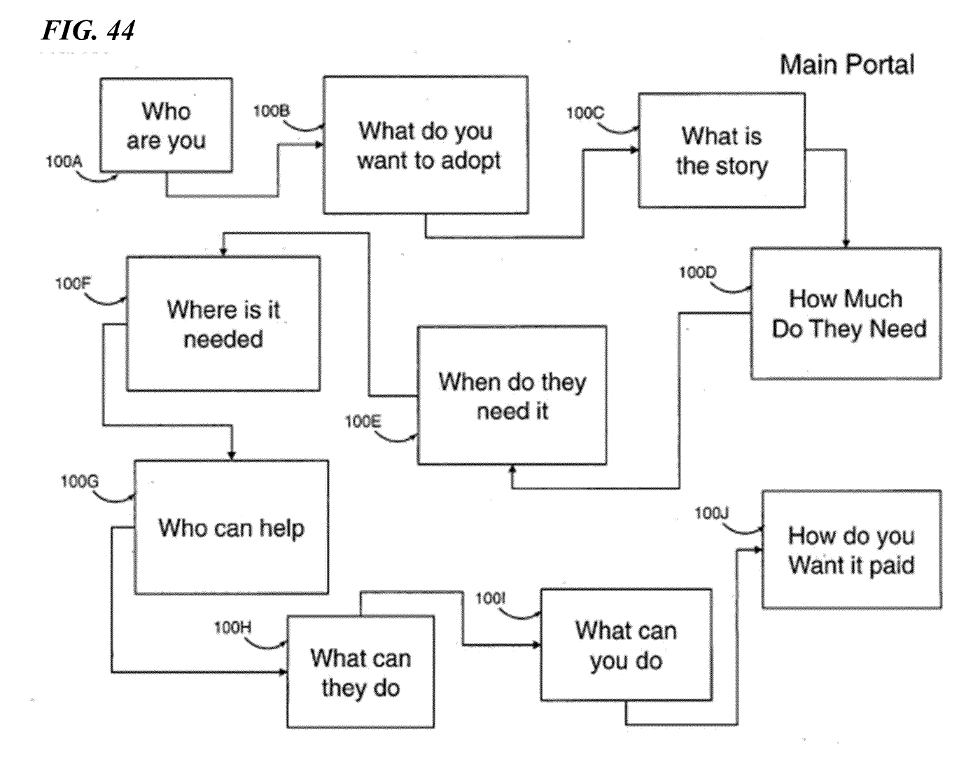

Now referring to FIG. 44, element 100A illustrates how the individual must identify his or her self in relation to Adopt Anything and its purpose. Element 100B illustrates how the individual must then site her or her own wants and desires within the context of Adopt Anything. The question, “What do I want to adopt?” must be reflected upon. Element 100C describes the process by which the individual seeks to accumulate information about the thing he or she is looking to adopt. Element 100D describes how the individual assesses the wants and needs of the thing he or she is looking to adopt. Element 100E describes how the individual gauges the time needed to meet the needs and wants of the thing he or she is looking to adopt. Element 100F describes how the individual determines the most pressing needs and wants of the thing he or she is looking to adopt. Element 100G describes how the individual decides if he or she is able to meet the needs and wants of the adopted thing on his or her own or whether assistance is needed is meeting those needs and wants. Element 100H describes how the individual judges the extent of the services others can provide for the adopted thing. Element 100I describes how the individual judges the extent of the services he or she can provide for the adopted thing. Element 100J describes how the individual determines the monetary necessities inherent in adopting the thing and how everything will be paid for.

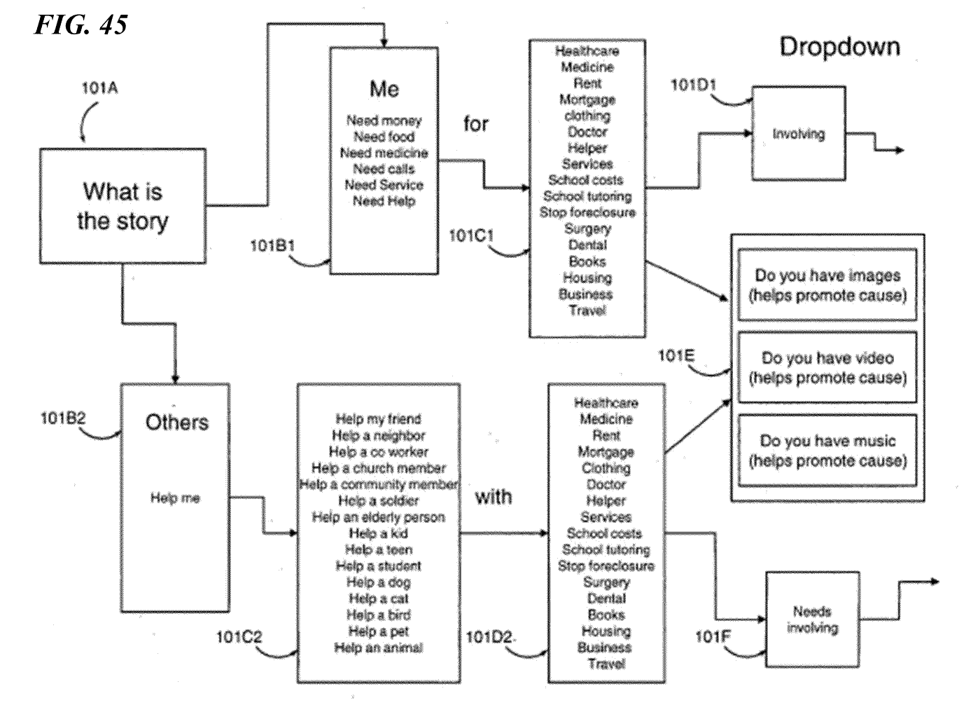

Now referring to FIG. 45, element t 101A describes the process by which the individual seeks to accumulate information about the thing he or she is looking to adopt. Element 101B1 describes how an individual calculates his or her own needs and wants. Element 101C1 describes how an individual assesses the total cost of all these needs and wants. Element 101D1 describes how an individual determines the amount of personal involvement needed, or rather time expended, in meeting these needs and wants. Element 101E describes the multimedia aspect of Adopt Anything and what purpose it will serve in helping to promote proper fulfillment of Adopt Anything's purpose. Element 101B2 describes that there is something that exists and needs help and can be adopted through Adopt Anything. Element 101C2 describes the multitude of things that can be helped through Adopt Anything Element 101D2 describes the needs and wants of the things that can be adopted. Element 101F illustrates the necessary involvement and responsibilities of the individual inherent in the adoption of the thing.

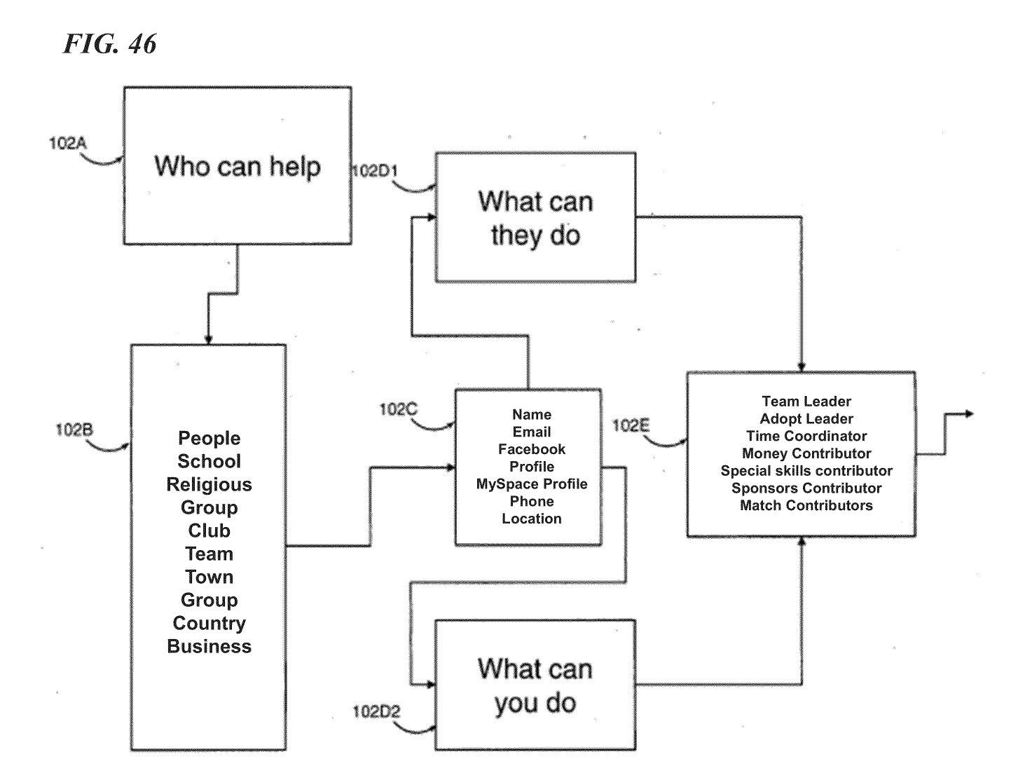

Now referring to FIG. 46, element t 102A describes how the individual decides if he or she is able to meet the needs and wants of the adopted thing on his or her own or whether assistance is needed is meeting those needs and wants. Element 102B describes the entities that can assist in helping the individual care for the adopting thing. Element 102C describes the means by which these entities can be contacted. Element 102D1 describes how the individual judges the extent of the services others can provide for the adopted thing Element 102D2 describes how the individual judges the extent of the services he or she can provide for the adopted thing. Element 102E describes the various leadership and contribution positions that can be assigned to the entities aiding in the adoption process.

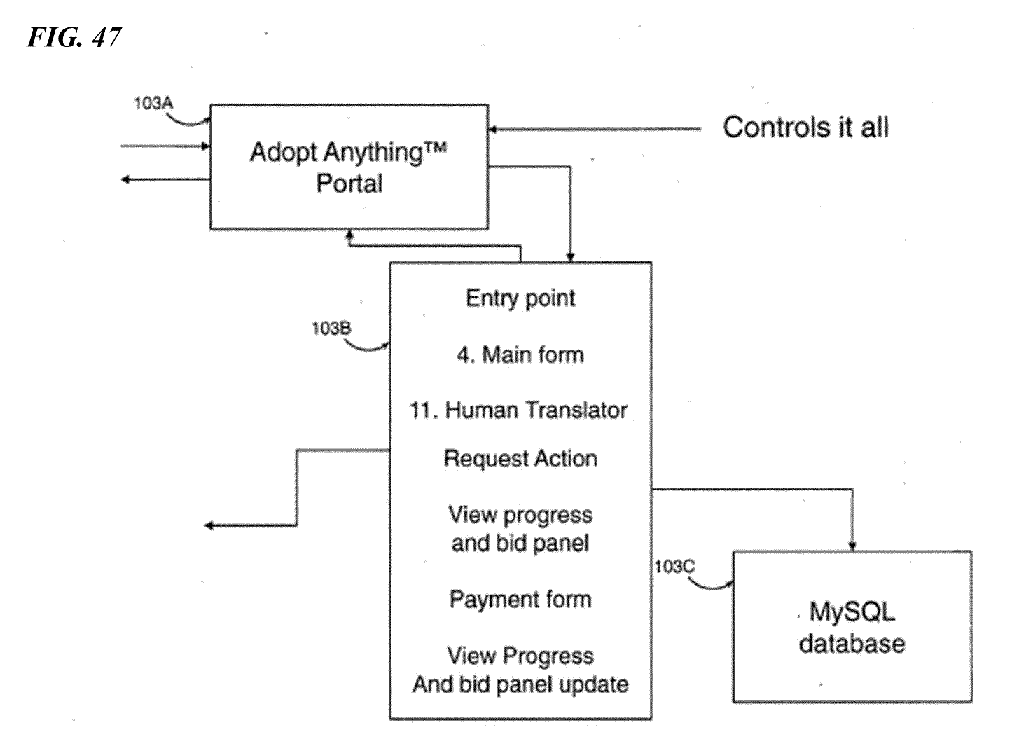

Now referring to FIG. 47, element 103A identifies the mechanism and method by which this is all possible, namely Adopt Anything™. Element 103B describes the instruments through which Adopt Anything™ is run. Element 103C describes the method by which the information fed into the Adopt Anything™ mechanism is safely secured, namely by way of the My SQL Database.

Now referring to FIG. 48, element 104A identifies the mechanism and method by which this is all possible, namely Adopt Anything™. Element 104B describes the movement of money within the Adopt Anything™ Pay Portal. Element 104C describes the medium through which money is received, transferred and paid out, namely the World Payment bank, an Adopt Anything™ affiliate.

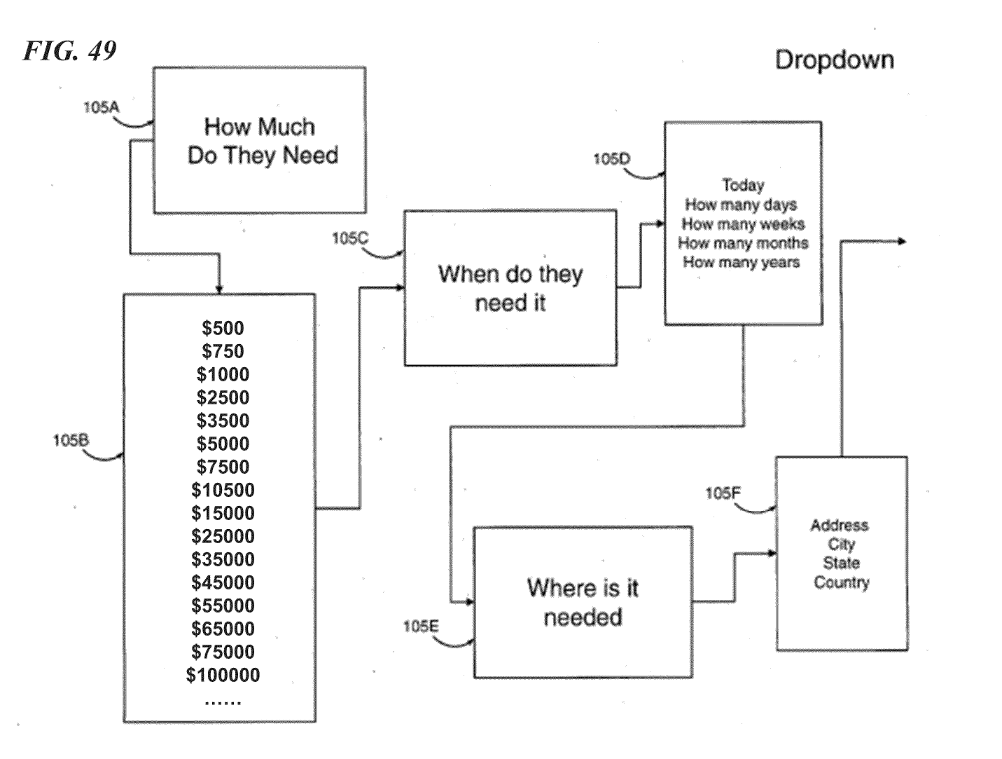

Now referring to FIG. 49, element 105A describes how the individual assesses the wants and needs of the thing he or she is looking to adopt. Element 105B describes the monetary wants and or needs of the thing that might be adopted. Element 105C describes how the individual gauges the time needed to meet the needs and wants of the thing he or she is looking to adopt. Element 105D describes the specific time frames needed to meet the needs and or wants of the adopted thing. Element 105E describes how the individual determines the most pressing needs and wants of the thing he or she is looking to adopt and the physical location where the necessary and or desired resources will be delivered. Element 105F describes the means by which the needs and or wants and physical location can be identified.

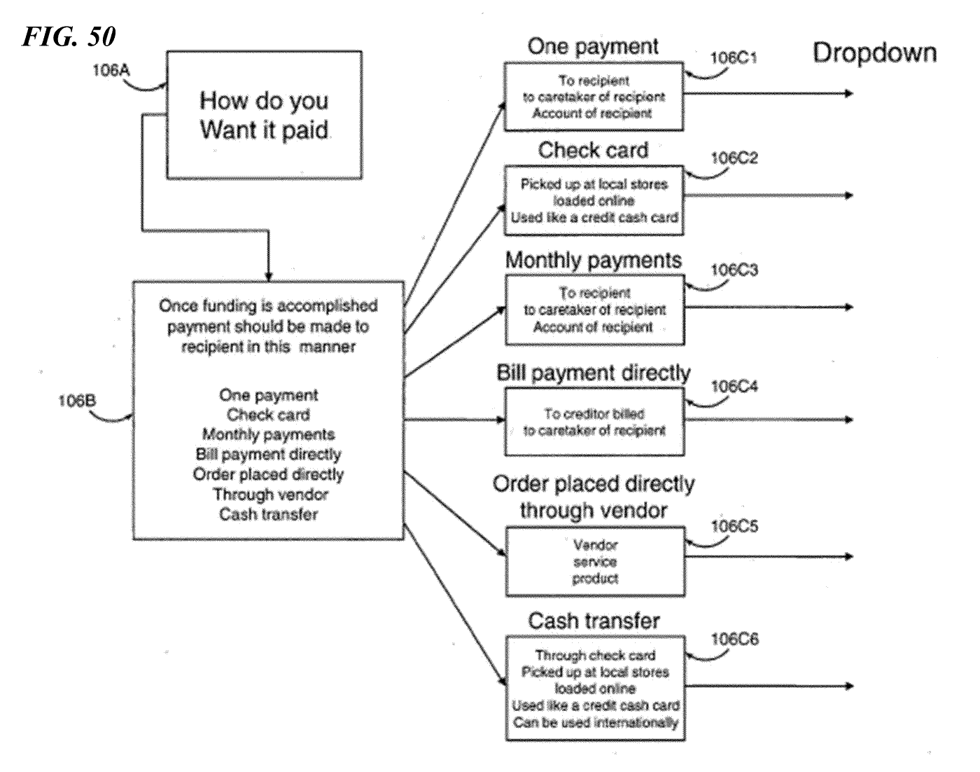

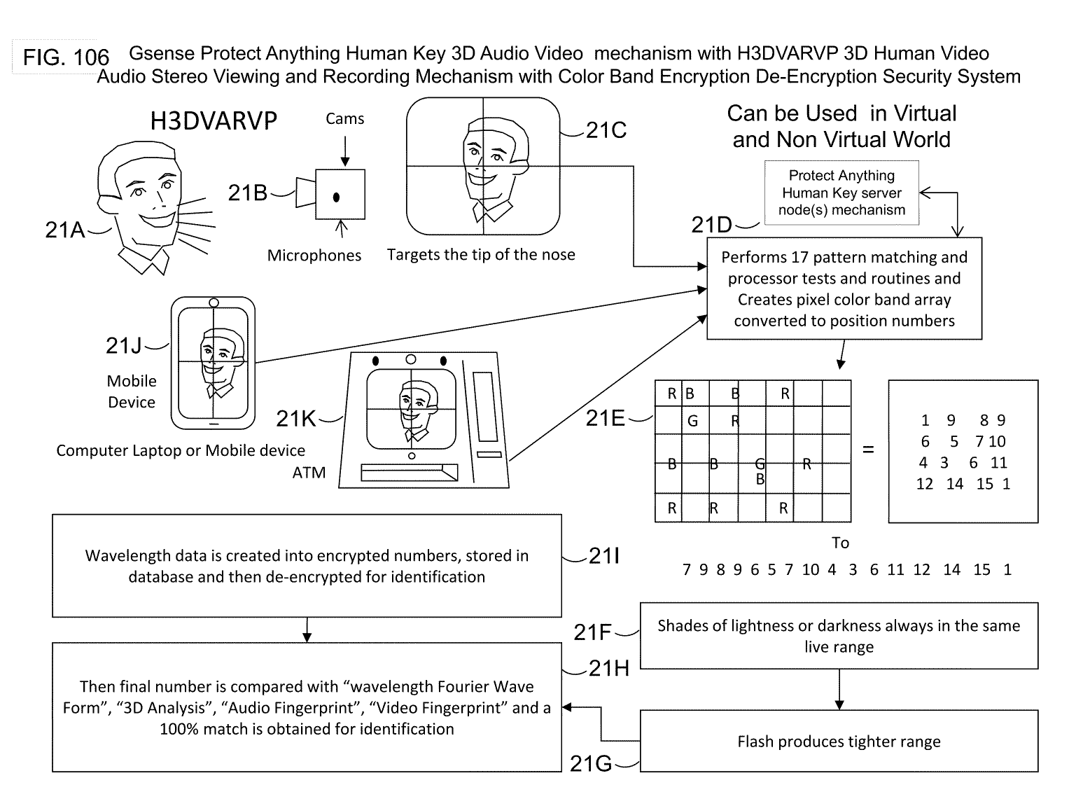

Now referring to FIG. 50, element 106A describes how the individual determines the monetary necessities inherent in adopting the thing and how everything will be paid for and the mediums through which the money will reach its required destination. Element 106B describes the six methods through which payment can be processed. FIGS. 106C1-6 describe the six methods through which payment can be processed, namely online payment, check card, monthly payments, direct bill payment, direct order payment through a vendor or cash transfer, in detail.

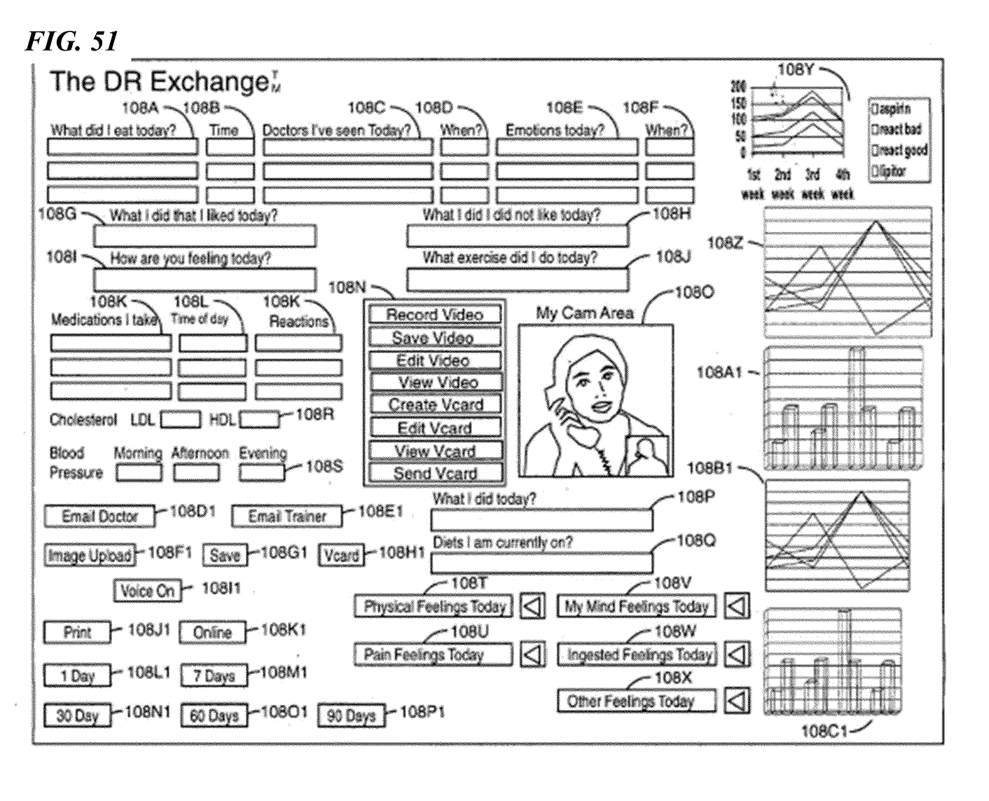

Now referring to FIG. 51, element 108A illustrates an input form field where an individual to write about what he or she has eaten that day. Element 108B illustrates an input form field where an individual to list the time corresponding to the items he or she has eaten that day. Element 108C illustrates an input form field where an individual can list the doctors he or she has seen that day. Element 108D illustrates an input form field where an individual can list the time at which he or she visited the doctor. Element 108E illustrates an input form field where an individual can list the emotions he or she has felt throughout the course of the day. Element 108F illustrates an input form field where an individual can list the times at which he or she felt a particular emotion. Element 108G illustrates an input form field where an individual can write about what he or she did during that course of the day that was positive. Element 108H illustrates an input form field where an individual can write about what he or she did that day that was negative. Element 108I illustrates an input form field where an individual can write an overarching summary of how he or she felt that day. Element 108J illustrates an input form field where an individual can write about the exercise he or she performed that day. Element 108K illustrates an input form field where an individual can list the medications he or she took that day. Element 108L illustrates an input form field where an individual can list the time at which he or she took a specific medication. Element 108M illustrates an input form field where an individual can list the reactions he or she had to the medications taken that day. Element 108N illustrates the eight functions that can be performed within the “My Cam Area” video application. Element 108O illustrates the “My Cam Area” mechanism where an individual can record, save, edit, view, create, edit, view and send video within The DR Exchange. Element 108P illustrates an input form field where an individual can write about what he or she did that day. Element 108Q illustrates an input form field where an individual can write about the diets he or she is currently on. Element 108R illustrates an input form field where an individual can write in what his or her HDL and LDL cholesterol levels are at presently. Element 1085 illustrates an input form field where an individual can list what his or her blood pressure was at three points throughout the day, namely morning, afternoon and evening. Element 108T illustrates a field where an individual can identify his or her physical feelings experienced that day and find descriptions written on previous days. Element 108U illustrates a field where an individual can identify his or her painful physical feelings experienced that day and find written descriptions from on previous days. Element 108V illustrates a field where an individual can identify his or her mental feelings experienced that day and find written descriptions written from previous days. Element 108W illustrates a field where an individual can identify his or her ingested feelings experienced that day and find written descriptions from previous days. Element 108X illustrates a field where an individual can identify his or her miscellaneous feelings experienced that day and find written descriptions from previous days. Element 108Y illustrates a graph that displays the drugs an individual has been taking and the reactions he or she has had over time. Element 108Z illustrates a graph that displays the severity of the feelings an individual has experience over the course of the day. Element 108A1 illustrates a graph that displays the likes and dislikes of an individual over a period of time. Element 108B1 illustrates a graph that displays an individual's, blood pressure, cholesterol and diet habits over a period of time. Element 108C1 illustrates a graph that displays a variety of factors over a period of time. Element 108D1 illustrates a link through which an individual will be able to e-mail his or her doctor. Element 108E1 illustrates a link through which an individual will be able to e-mail his or her trainer. Element 108F1 illustrates a link through which an individual will be able to upload an image of anything. Element 108G1 illustrates a link through which an individual will be able to save his or her The DR Exchange page after working on it. Element 108H1 illustrates a link through which an individual will be able to send a VCard. Element 108I1 illustrates a link through which an individual will be able to turn on or off the sound on the “My Cam Area” video application. Element 108J1 illustrates a link through which an individual will be able to print anything on The DR Exchange page. Element 108K1 illustrates a link through which an individual will be able to sign out of his or her The DR Exchange page. Element 108L1 illustrates a link through which an individual will be able to call up information from one day ago Element 108M1 illustrates a link through which an individual will be able to call up information from seven day ago Element 108N1 illustrates a link through which an individual will be able to call up information from 30 days ago. Element 108O1 illustrates a link through which an individual will be able to call up information from 60 days ago. Element 108P1 illustrates a link through which an individual will be able to call up information from 90 days ago.

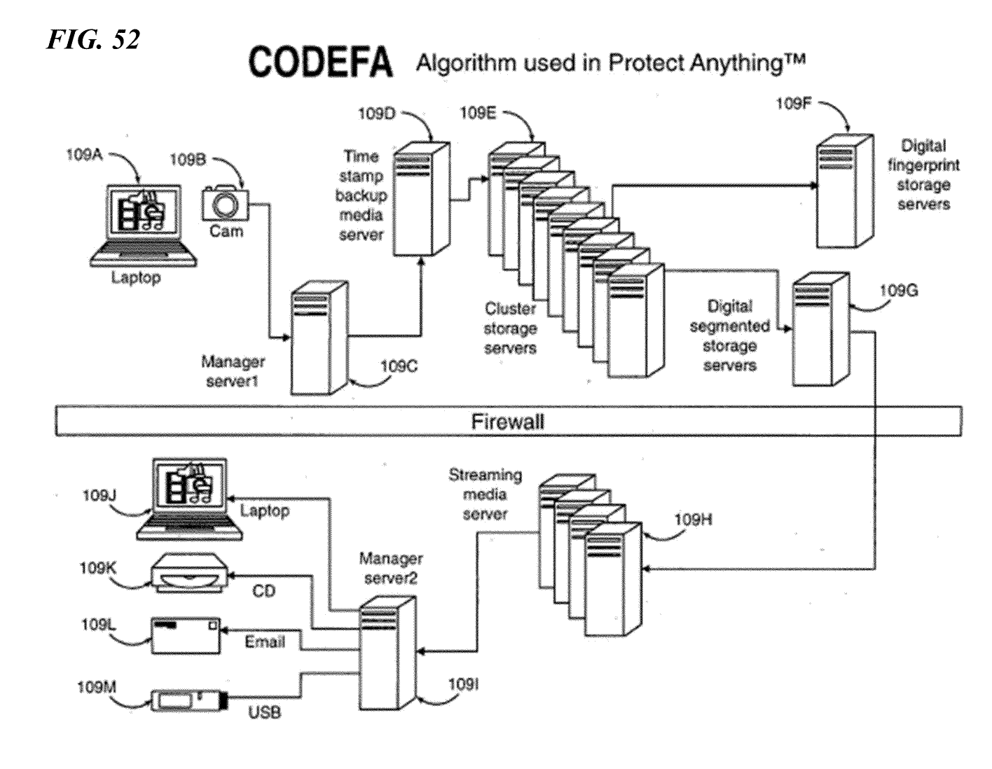

Now referring to FIG. 52, element 109A illustrates a computer capable of processing different forms of multimedia including digital pictures, video and music. Element 109B illustrates a camera which can be used to upload pictures onto a computer. Element 109C illustrates the entry manager server where the data is initially processed. Element 109D illustrates the backup media server where the data is given a time stamp. Element 109E illustrates the cluster of servers where the data is stored. Element 109F illustrates the server where a digital fingerprint is issued to the data. Element 109G illustrates the server where the data is digitally segmented. Element 109H illustrates the series of servers used to stream video.

Element 109I illustrates the second manager server where data passes as it is downloaded onto the computer or other device. Element 109J illustrates a computer capable of processing different forms of multimedia including digital pictures, video and music. Element 109K illustrates a CD drive. Element 109L illustrates e-mail which would be processed through the servers. Element 109M illustrates a USB storage device.

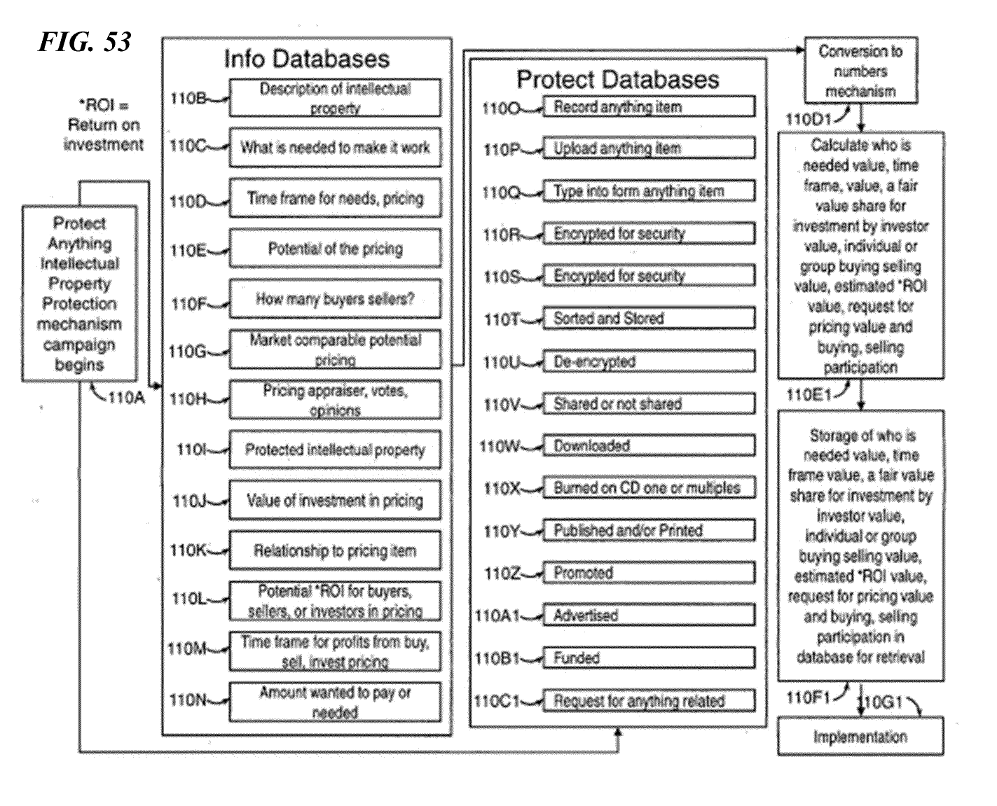

Now referring to FIG. 53, element 110A describes the method by which all information that an individual needs or wants to be protected, can and will be protected, namely Protect Anything™. Element 110B illustrates the process by which an individual will describe his or her intellectual property. Element 110C describes the process by which an individual decides what is needed to build and successfully operate the thing. Element 110D describes the process by which an individual evaluates the time needed to construct the thing. Element 110E describes the process by which an individual determines the price of the thing Element 110F describes the process by which an individual establishes how many buyers and sellers will constitute the initial market for the thing. Element 110G describes the process by which an individual determines competitive pricing for the thing. Element 110H describes the process by which an individual appraises the previously determined price of the thing. Element 110I describes the process by which an individual seeks to protect his or her intellectual property. Element 110J describes the process by which an individual evaluates the importance and or necessity of investment. Element 110K describes the process by which an individual determines the relationship to pricing item. Element 110L describes the process by which an individual evaluates the potential ROI for buyers, sellers and investors in pricing. Element 110M describes the process by which an individual estimates how long it will take to turn a profit based on buying, selling and investing pricing. Element 110N describes the process by which an individual determines how much customers would be willing to pay versus how much they need to pay. Element 110O describes the process by which an individual can protect any recorded item within the Protect Anything database. Element 110P describes the process by which an individual can protect any uploaded item within the Protect Anything database. Element 110Q describes the process by which an individual can protect anything he or she types into an input field form within the Protect Anything database. Element 110R describes the process by which any data is encoded to protect quality within the Protect Anything database. Element 110S describes the process by which data is protected through encryption within the Protect Anything database. Element 110T describes the process by which data is sorted and stored within the Protect Anything database. Element 110U describes the process by which data is de-encrypted within the Protect Anything database. Element 110V describes the process by which an individual can choose to share or not share his or her data within the Protect Anything database. Element 110W describes the process by which data is downloaded within the Protect Anything database. Element 110X describes the process by which data is burned onto one or multiple CD's within the Protect Anything database. Element 110Y describes the process by which an individual chooses to publish and or print his or her data within the Protect Anything database. Element 110Z describes the process by which data is promoted within the Protect Anything database. Element 110A1 describes the process by which data is advertised within the Protect Anything database. Element 110B1 describes the process by which data is funded within the Protect Anything database. Element 101C1 describes the process by which an individual can request data within the Protect Anything database. Element 101D1 describes the process by which data within the information database is converted to numbers using a certain mechanism. Element 101E1 describes the means by which the value of several different elements related to the information and protection databases is calculated. Element 101F1 describes the process by which the value of several different elements related to the information and protection databases is stored. Element 110G1 describes the process by which all of the processes are implemented into a working cohesive whole.

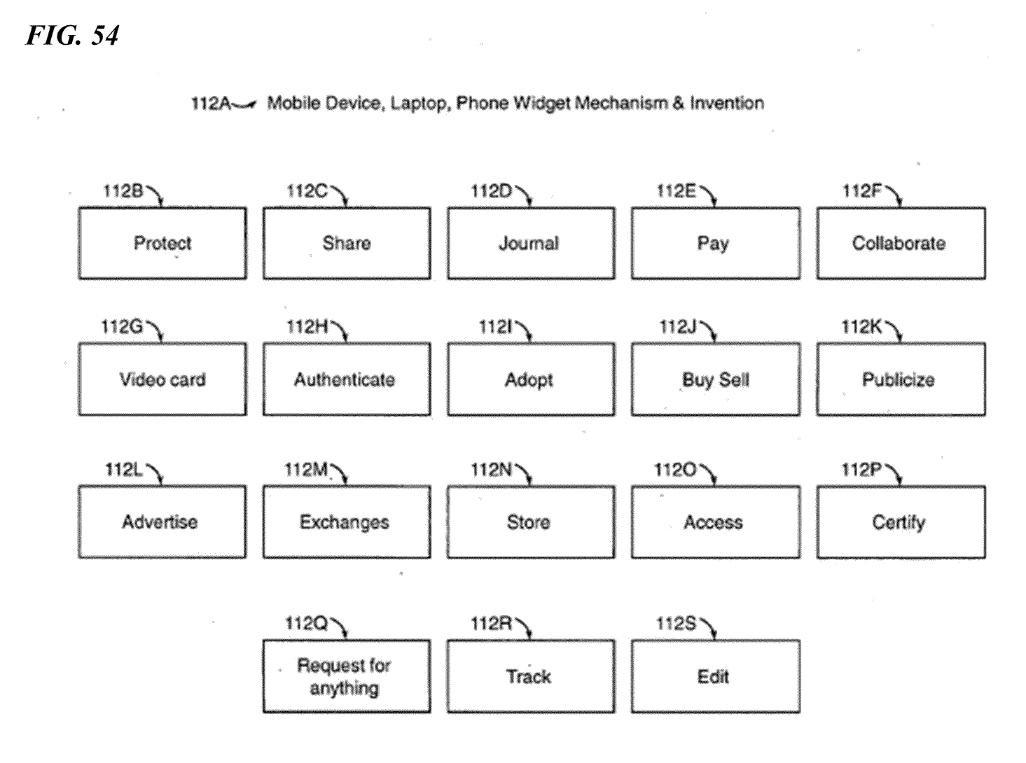

Now referring to FIG. 54, element 112A describes the devices through which the widget mechanism and invention will be able to operate on. Element 112B illustrates a link through which an individual can protect his or her data. Element 112C illustrates a link through which an individual can share his or her data. Element 112D illustrates a link through which an individual can access his or her journal. Element 112E illustrates a link through which an individual can make payments. Element 112F illustrates a link through which an individual can collaborate with other individuals. Element 112G illustrates a link through which an individual can access his or her VCard Element 112H illustrates a link through which an individual can authenticate anything Element 112I illustrates a link through which an individual can access Adopt Anything™. Element 112J illustrates a link through which an individual can access Buy And Sell Anything. Element 112K illustrates a link through which an individual can publicize whatever he or she wants to. Element 112L illustrates a link through which an individual can access his or her advertisements or look at others advertisements. Element 112M illustrates a link through which an individual can access his or her exchanges. Element 112N illustrates a link through which an individual can access an online store. Element 112O illustrates a link through which an individual can access an authenticated network. Element 112P illustrates a link through which an individual can certify him or her self. Element 112Q illustrates a link through which an individual can request anything Element 112R illustrates a link through which an individual can track anything. Element 112S illustrates a link through which an individual can edit anything.

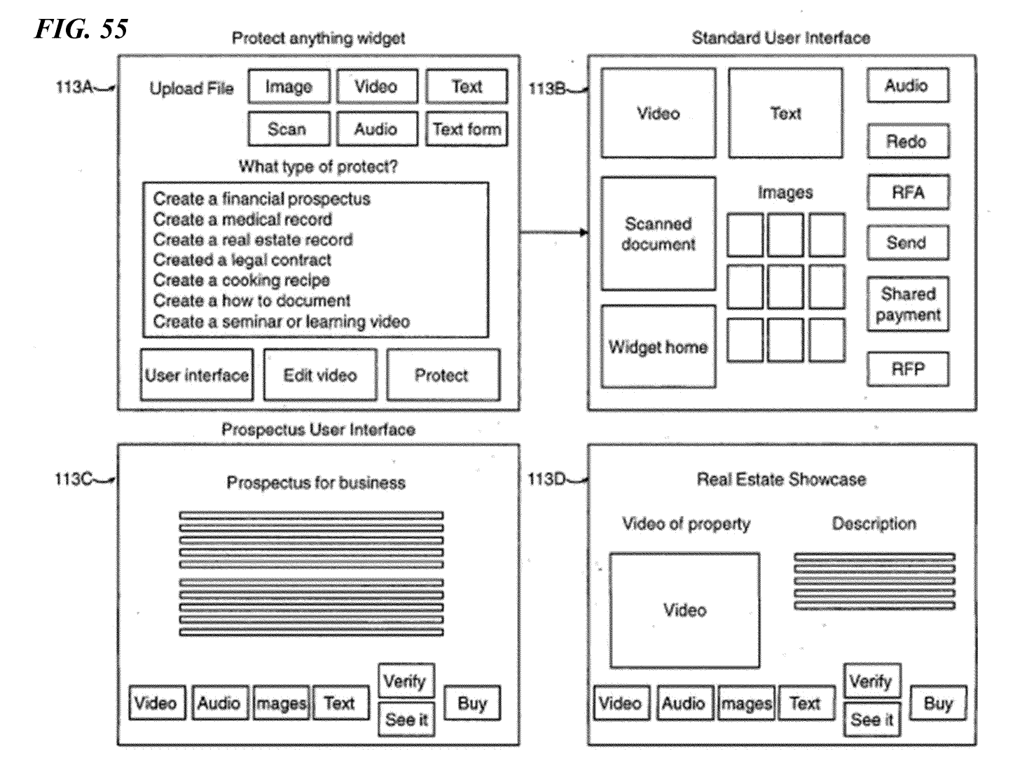

Now referring to FIG. 55, element 113A illustrates a graphical user interface of the Protect Anything widget. It displays the different areas through which data can be loaded and stored securely. Element 113B illustrates the standard graphical user interface that will greet the user. Element 113C illustrates the graphical user interface for the ‘Prospectus for Business’ zone of the widget. Element 113D illustrates the graphical user interface for the ‘Real Estate Record’ zone of the widget. Both 113C and 113D are examples of what the product will resemble.

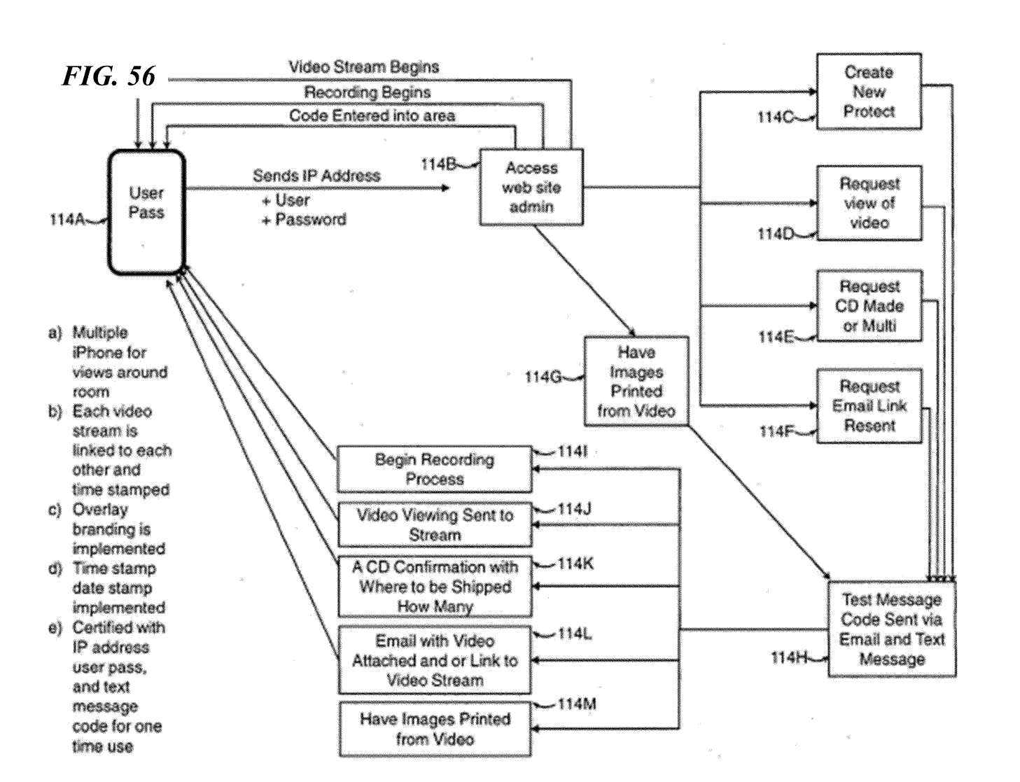

Now referring to FIG. 56, element 114A illustrates the user pass needed to access the network. Element 114B describes an individual accessing the network and being able to record and stream video instantly. Element 114C describes an individual creating a new product. Element 114D describes an individual requesting to view a video. Element 114E describes an individual requesting to make a single or multiple CD's. Element 114F describes an individual requesting an email to be sent. Element 114G describes an individual having images printed that originally appeared in a video. Element 114H describes an individual sending and receiving text messages via e-mail. Element 114I describes an individual beginning the video recording process. Element 114J describes an individual viewing a video. Element 114K describes an individual confirming the shipment of an item or items to a location. Element 114L describes an individual sending a video in an e-mail. Element 114M describes an individual printing an image from a video.

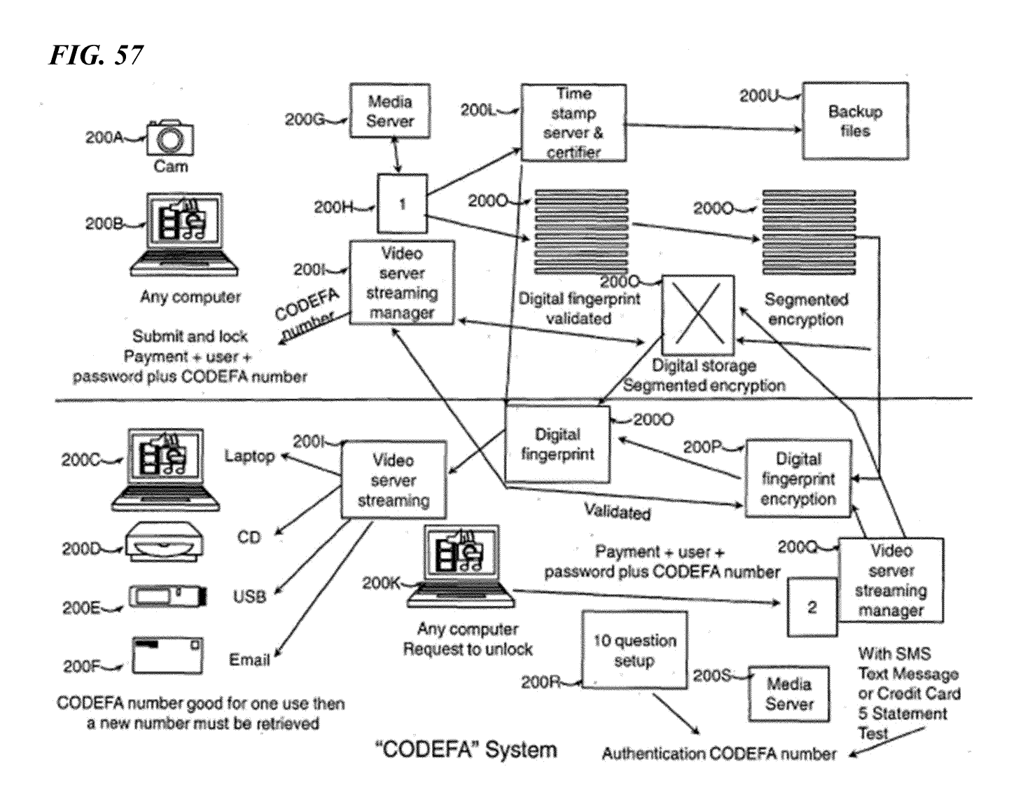

Now referring to FIG. 57, element 200A describes the camera's primary location within the system and where it will act as a video taking tool. Element 200B illustrates the literal meaning, “any computer,” which describes these computer's possible connections with the cam and video and media servers. Element 200C illustrates the video terminal, which will act as a guiding point for video server streaming. Element 200D illustrates the CD's role within the video server streaming interface. Element 200E illustrates the USB's role within video server streaming, whereby an external tool will allow for extra storage, usage, and external connection points Element 200F illustrates the email system within video server streaming, whereby users are able to compose and receive email through their member pages. Element 200G illustrates the media server which connects to point 1, where video server streaming manager will take instance. Element 200H illustrates the point 1 instance, where three outgoing signals will connect to media server, time stamp server and certifier, digital fingerprint validated. Three incoming signals will pass the point 1 instance, which are digital storage segmented encryption, digital fingerprint encryption, and media server again. This video server streaming manager enables the managing of video server's streaming network. Element 200J illustrates video server streaming, which will perform functions related to video streaming maintenance. Video server streaming connects to five outgoing points, which only connecting to one incoming point. Video terminal, CD, USB, email, Request to & unlock is the outgoing signals, while the digital fingerprint is the only one incoming. Element 200K illustrates the request to & unlock feature, which will allow the system to perform commands. Element 200L illustrates the time stamp server & certifier, which will give precision time keeping and recording responses from the video server streaming manager to the backup files. Element 200M illustrates the digital fingerprint validated tool, which will act as a security liaison between the video server streaming manager and the digital storage segmented encryption. Element 200N illustrates the digital storage segmented encryption, which has one digital fingerprint output and input, and has two inputs consisting of video server streaming manager with segmented encryption, and also the video server streaming manager. Element 200O illustrates the digital finger print point, which will input from digital storage segmented encryption, digital fingerprint encryption, and time stamp server & certifier, and output to video server streaming. Element 200P illustrates digital fingerprint encryption, which has two outputs the digital fingerprint, video server streaming manager and two inputs from video server streaming manager1 and video server streaming manager2. Element 200Q illustrates the video server streaming manager, which has only two inputs the media server and request to & unlock. The three outputs it has are the digital fingerprint encryption, digital storage segmented encryption and the media server. Element 200R illustrates to question setup point, which relies on authentication CODEFA to secure program's users. Element 200S illustrates media server, which allows media types to be transmitted on a network. This server will have an input with output connection to video server streaming manager. Element 200T illustrates segmented encryption, which has a one way input from digital fingerprint validated and an output towards digital storage segmented encryption. Element 200U illustrates the backup files point, which has one input from time stamp server & certifier.

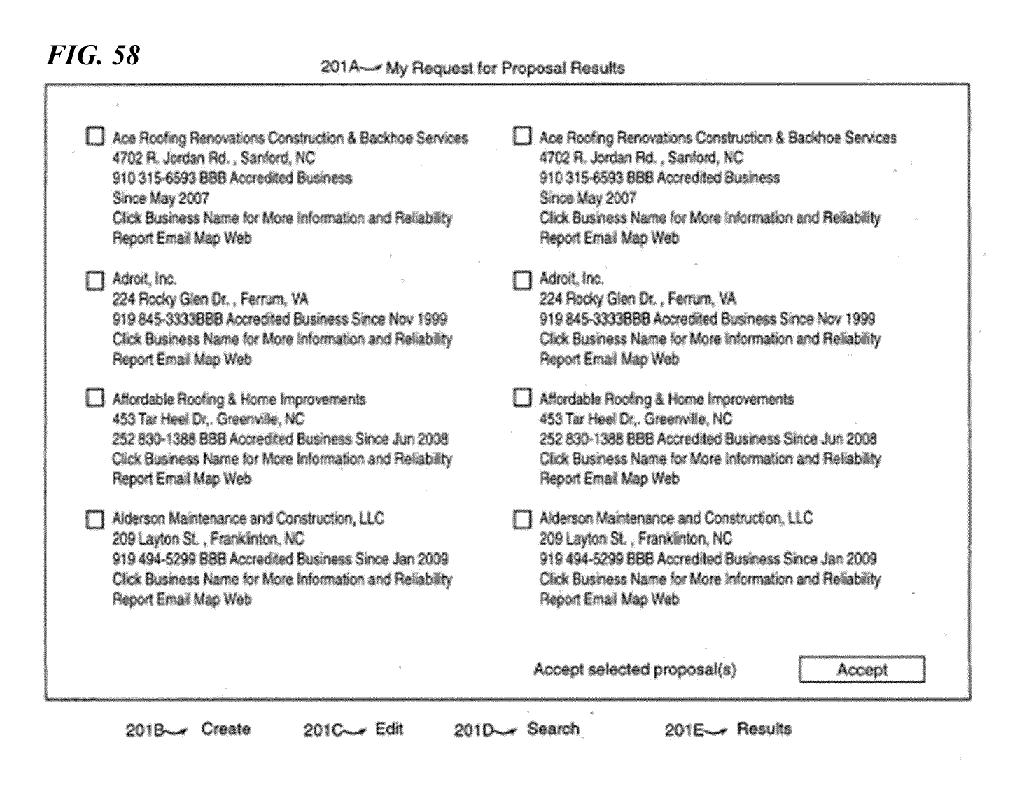

Now referring to FIG. 58, element 201A illustrates the main title point, “My Request for Proposal Results,” which will be centered on top a box of values. Element 201B illustrates the click tool to create a proposal file within the database. Element 201C illustrates the edit value for existing proposal entries to be edited inside the database. Element 201D illustrates the search value for existing proposal database, where a list of value can be found. Element 201E illustrates the results section, which will give an array of the results gained from a search. Element 201F illustrates an address box, where the phone number, street, city and state and business initiation date can be found for 16 entries.

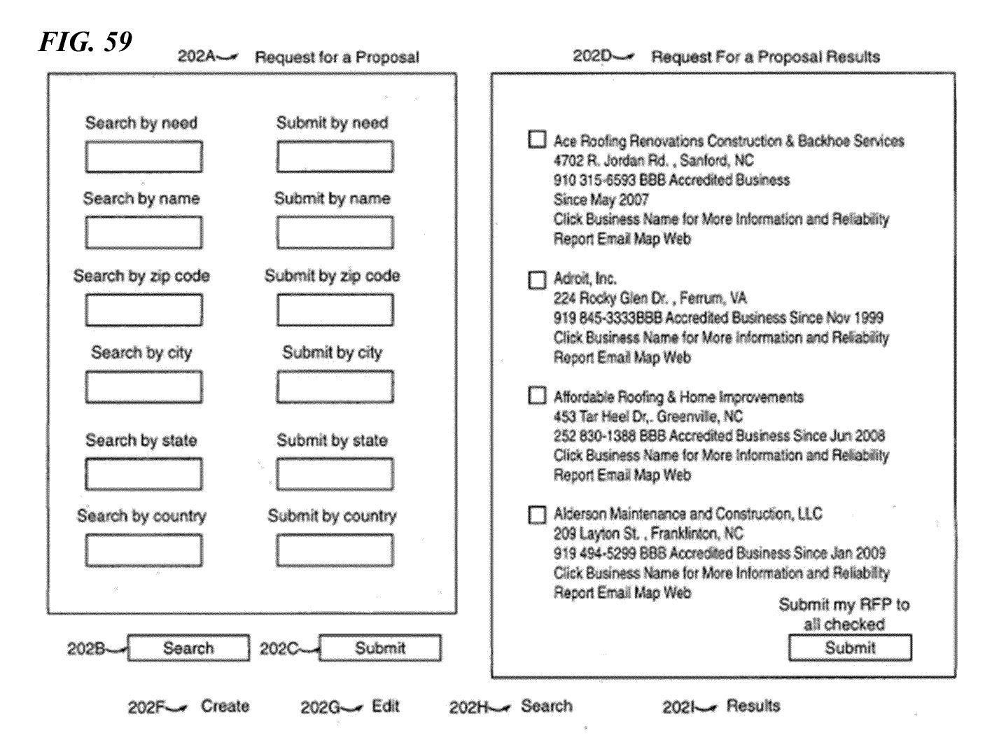

Now referring to FIG. 59, element 202A illustrates an input section where the location details and needs may be entered to query a result. Element 202B illustrates a search bar, which will go through valid responses and relay them back. Element 202C illustrates the submit bar, which lets you input details for the effect of storing in the database. Element 202F illustrates the create bar, which lets users create the specifics of their member details. Element 202G illustrates the edit bar, which will allow users to modify information previously stored in the database. Element 202H illustrates the search bar, which gives users the ability to get results of there search terms. Element 202I illustrates the results bar, which shows a series of results for the purpose of giving users knowledge.

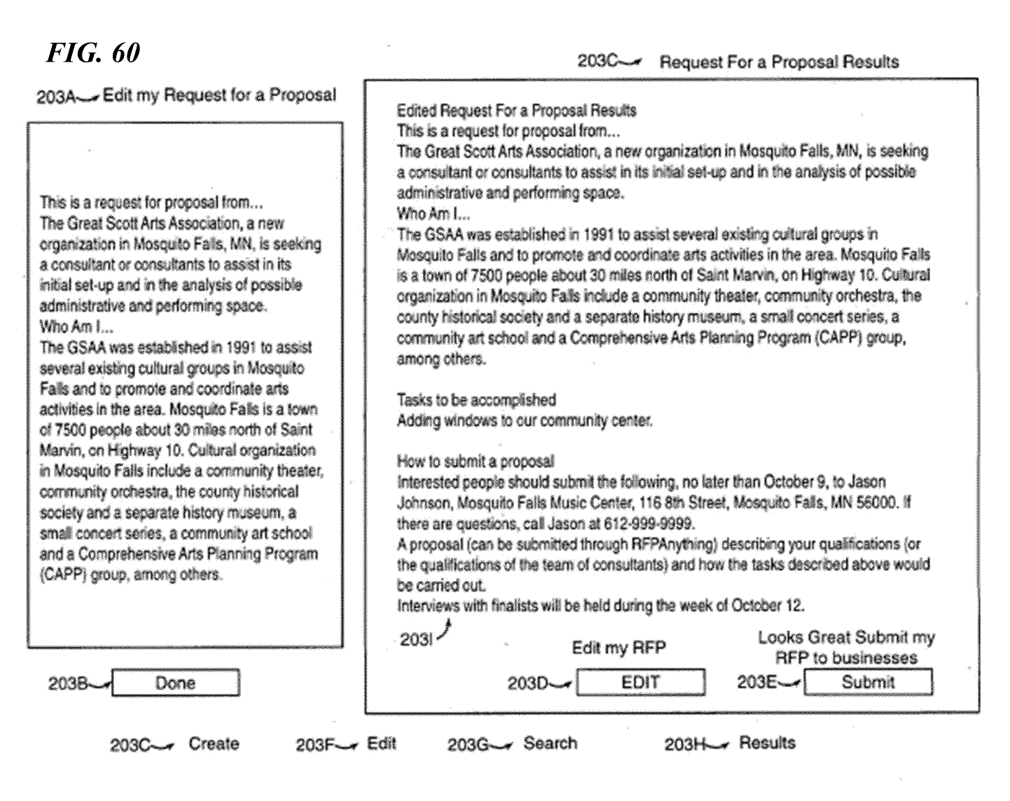

Now referring to FIG. 60, element 203A illustrates a sample proposal that seeks out candidates for employment, other opportunities that will be convenient for the user to find. Element 203B illustrates the done button, which can be pressed upon to show users their selection has been processed and even if they have left the page. Element 203C illustrates a summary briefing of the proposal forming company that includes their history, who they are, tasks to be accomplished, and how to submit a proposal. Element 203D illustrates the button which can be pressed upon to access edit my RFP. Element 203E illustrates the button which can be pressed upon to submit, this is only if the RFP looks great for submission to businesses. The submit bar will execute the command, and leave you with a confirmation later on. Element 203F illustrates the edit bar, which will allow users to modify information previously stored in the database. Element 203G illustrates the search bar, which gives users the ability to get results of there search terms. Element 203H illustrates the results bar, which shows a series of results for the purpose of giving users knowledge. Element 203I illustrates, which lets users create the specifics of their member details.

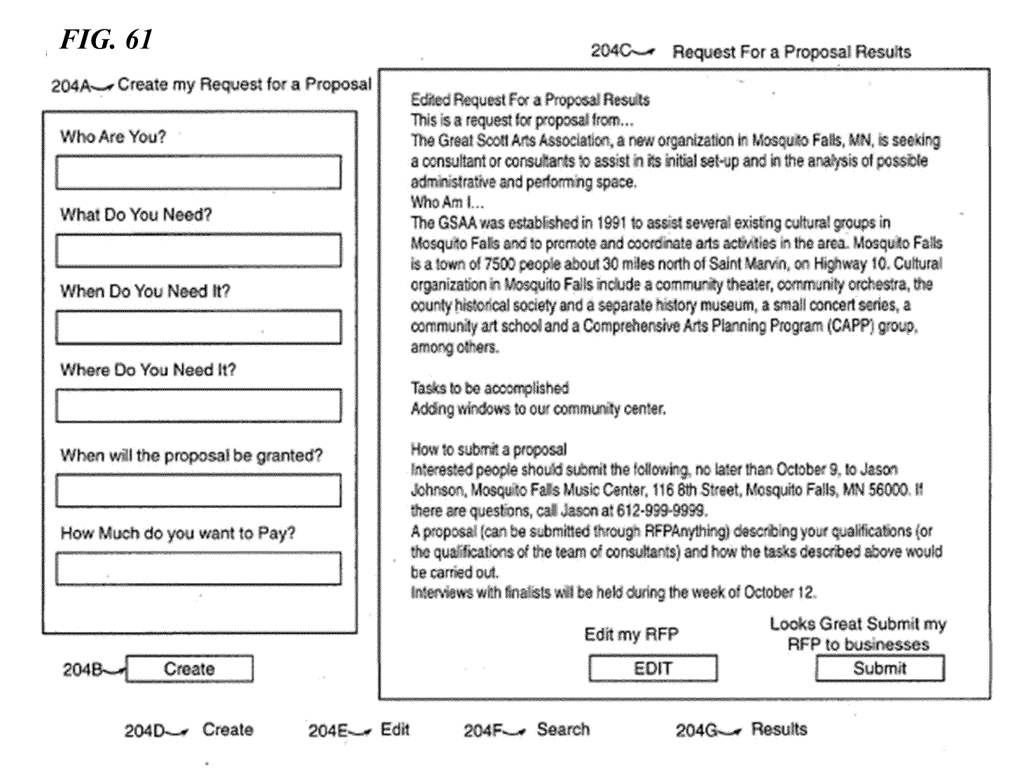

Now referring to FIG. 61, element illustrates an input tool, which will give users the ability to type in who they are, what they need, when they need it, where they need it, when the proposal will be granted, and how much they want to pay. Element 204B illustrates the create tab, which lets users create the specifics of their member details. Element 204C illustrates a summary briefing of the proposal forming company that includes their history, who they are, tasks to be accomplished, and how to submit a proposal. Element 204D illustrates another create tab, which will allow users to create a member profile and even organization specifics. Element 204E illustrates the edit bar, which will allow users to modify information previously stored in the database. Element 204F illustrates the search bar, which gives users the ability to get results of there search terms. Element 204G illustrates the results bar, which shows a series of results for the purpose of giving users knowledge.

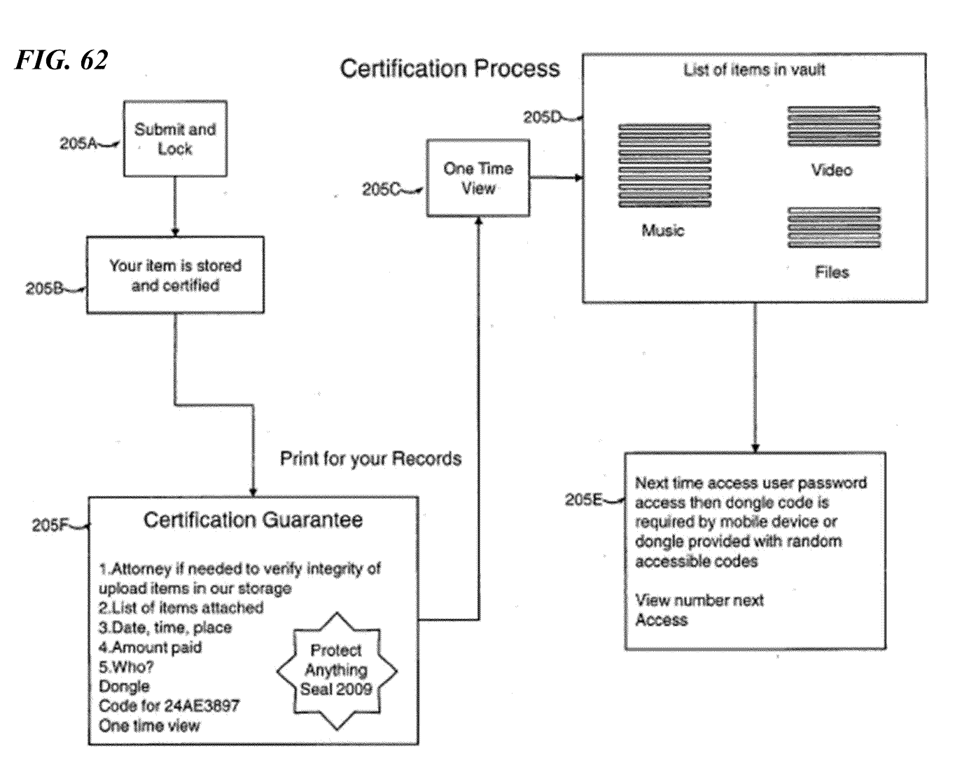

Now referring to FIG. 62, element 205A illustrates the submit & lock tool, which will provide the user with a means to securely transmit files online and lock. Element 205B illustrates, “your item is stored and certified,” for the user to get a signal that the procedure is correct. Element 205C illustrates, “one time view,” which will provide a safe passage between the certification guarantee and list of items in vault. Element 205D illustrates, “list of items in vault,” which will contain separate sections such as music, files and videos. Element 205E illustrates a series of security codes that will authenticate through security code and tools access to the system. Element 205F illustrates the certification guarantee, which needs to be passed by attorney for safe passage into upload. The items attached need to be listed, where the date time, place, amount paid, and who it is need to be verified.

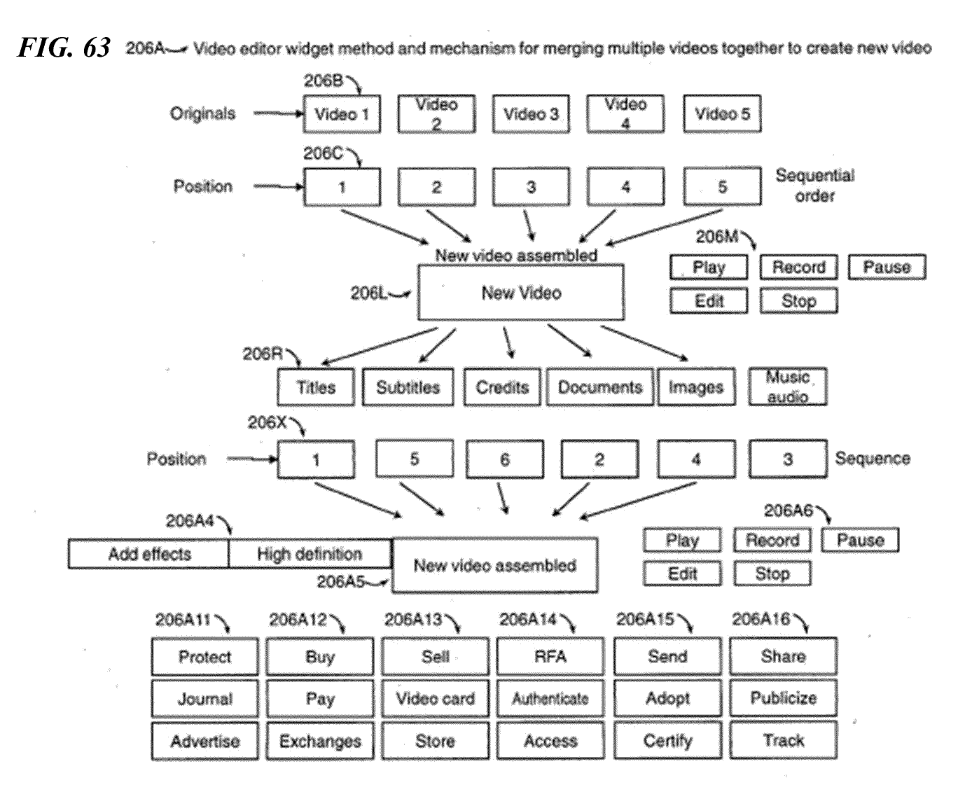

Now referring to FIG. 63, element 206A illustrates that a video editor widget method and mechanism for merging multiple video together to create new videos will be created. Element 206B illustrates that throughout this row, video 1, video2, video3, video4, video5 will be store in units to categorize with the originals. Element 206C illustrates that throughout this row, units 1, 2, 3, 4, 5 will be stored in units to categorize with sequenced order in mind. Element 206L illustrates that new video assembled into the new video section will be formulated with a series of requirements. Element 206M illustrates that the play, record, pause, edit, and stop functions will be crucial elements for the new video to be easily accessible. Element 206R illustrates a series of elements needed for the new video file, these include titles, sub-titles, credits, documents, images, and music audio. Element 206X illustrates a series of positions for the prior elements in 206R to pass down through. Element 206A4 illustrates the add effects element that are needed for high definition to work properly. Element 206A5 illustrates new video assembled unit, which provides as an entry point from all elements listed in Element 206X. Element 206A6 illustrates that the functions listed in 206M for video playback controls will have effect here. These controls again, are play, record, pause, edit, and stop. Element 206A11 illustrates the first column will contain the elements protect, journal and advertise. The three elements will ensure that the written documents are protected. Element 206A12 illustrates transaction procedures, including buy, pay and exchanges. Element 206A13 illustrates the sell, video card, and store functions. Sell will be used for the purpose of making money, while video card will provide a digital rendering advantage, while the last store procedure will be an efficient was for items, documents or files to be kept safe. Element 206A14 illustrates RFA, Authenticate, and access functions. The RFA will be a request for applications tool, while authenticate will establish authenticity of something, will access will give permission for entry. Element 206A15 illustrates the send, adopt, and certify functions. The send function will transmit a stored file to another location, while adopt will give oneself permission to enter into agreement to adopt, while certify will label the item or product as valid. Element 206A16 illustrates the share, publicize and track functions. The share function will be used to exchange file/s between one or more people, while publicize will let the document be accessed by other parties, while track will allow events or sequences within the video editing widget to be tracked for its status.

Now referring to FIG. 64, element 1A Describes the GSense Management of a plurality of methods and mechanisms integrally working as one system mechanism in Virtual and Non Virtual World with Independent Clearing House Agent (ICHA) server node(s) mechanism. Element 1B Describes the GSense Management of a plurality of methods and mechanisms integrally working as one system mechanism in Virtual and Non Virtual World with GSense Solar Panel Wind Turbine Communications Server Network Apparatus and parallel server node(s) sensing and reasoning mechanism. Element 1C Describes the GSense Management of a plurality of methods and mechanisms integrally working as one system mechanism in Virtual and Non Virtual World with Virtual Cash Virtual Currency (VCVC) server node(s) mechanism. Element 1D Describes the GSense Management of a plurality of methods and mechanisms integrally working as one system mechanism in Virtual and Non Virtual World with Illumination Transformer Audio Video Manager Interactive Server Transmitter (ITAVMIST) server node(s) mechanism. Element 1E Describes the GSense Management of a plurality of methods and mechanisms integrally working as one system mechanism in Virtual and Non Virtual World with Mobile, Handheld, and Independent Device Application Development (MHIDAD) server node(s) mechanism. Element 1F Describes the GSense Management of a plurality of methods and mechanisms integrally working as one system mechanism in Virtual and Non Virtual World with Virtual World Airport (VWA), server node(s) mechanism. Element 1G Describes the GSense Management of a plurality of methods and mechanisms integrally working as one system mechanism in Virtual and Non Virtual World with GSense management of a plurality of methods and mechanisms integrally working as one system. Element 1H Describes the GSense Management of a plurality of methods and mechanisms integrally working as one system mechanism in Virtual and Non Virtual World with Universal Virtual World (UVW), server node(s) mechanism. Element 1I Describes the GSense Management of a plurality of methods and mechanisms integrally working as one system mechanism in Virtual and Non Virtual World with Translate Anything server node(s) Mechanism. Element 1J Describes the GSense Management of a plurality of methods and mechanisms integrally working as one system mechanism in Virtual and Non Virtual World with Protect Anything Human Key server node(s) mechanism.

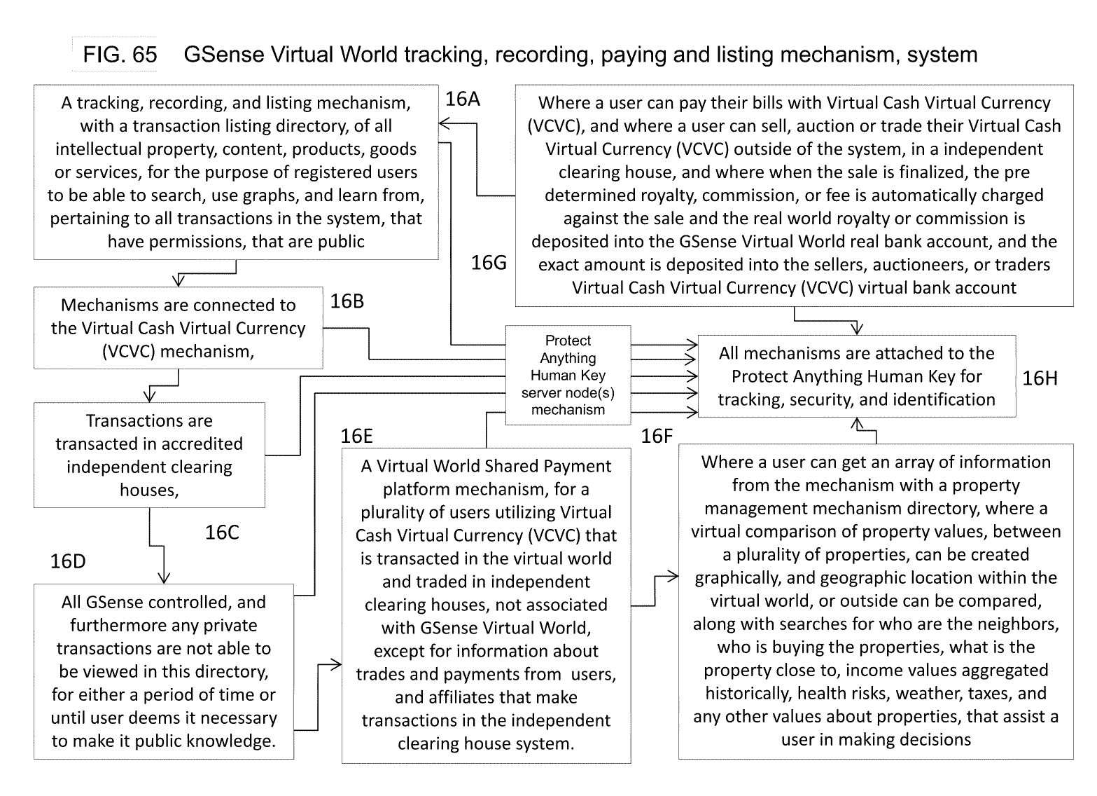

Now referring to FIG. 65, element 16A illustrates the GSense Virtual World tracking, recording, paying and listing mechanism, system with a tracking, recording, and listing mechanism, with a transaction listing directory, of all intellectual property, content, products, goods or services, for the purpose of registered users to be able to search, use graphs, and learn from, pertaining to all transactions in the system, that have permissions, that are public. Element 16B illustrates the GSense Virtual World tracking, recording, paying and listing mechanism, system with mechanisms that are connected to the Virtual Cash Virtual Currency (VCVC) mechanism. Element 16C illustrates the GSense Virtual World tracking, recording, paying and listing mechanism, system where Transactions are transacted in accredited independent clearing houses. Element 16D illustrates the GSense Virtual World tracking, recording, paying and listing mechanism, system where all GSense controlled, and furthermore any private transactions are not able to be viewed in this directory, for either a period of time or until user deems it necessary to make it public knowledge. Element 16E illustrates the GSense Virtual World tracking, recording, paying and listing mechanism, system where a Virtual World Shared Payment platform mechanism, for a plurality of users utilizing Virtual Cash Virtual Currency (VCVC) that is transacted in the virtual world and traded in independent clearing houses, not associated with GSense Virtual World, except for information about trades and payments from users, and affiliates that make transactions in the independent clearing house system. Element 16F illustrates the GSense Virtual World tracking, recording, paying and listing mechanism, system where a user can get an array of information from the mechanism with a property management mechanism directory, where a virtual comparison of property values, between a plurality of properties, can be created graphically, and geographic location within the virtual world, or outside can be compared, along with searches for who are the neighbors, who is buying the properties, what is the property close to, income values aggregated historically, health risks, weather, taxes, and any other values about properties, that assist a user in making decisions. Element 16G illustrates the GSense Virtual World tracking, recording, paying and listing mechanism, system where a user can pay their bills with Virtual Cash Virtual Currency (VCVC), and where a user can sell, auction or trade their Virtual Cash Virtual Currency (VCVC) outside of the system, in a independent clearing house, and where when the sale is finalized, the pre determined royalty, commission, or fee is automatically charged against the sale and the real world royalty or commission is deposited into the GSense Virtual World real bank account, and the exact amount is deposited into the sellers, auctioneers, or traders Virtual Cash Virtual Currency (VCVC) virtual bank account. Element 16H illustrates the GSense Virtual World tracking, recording, paying and listing mechanism, system where all mechanisms are attached to the Protect Anything Human Key for tracking, security, and identification.

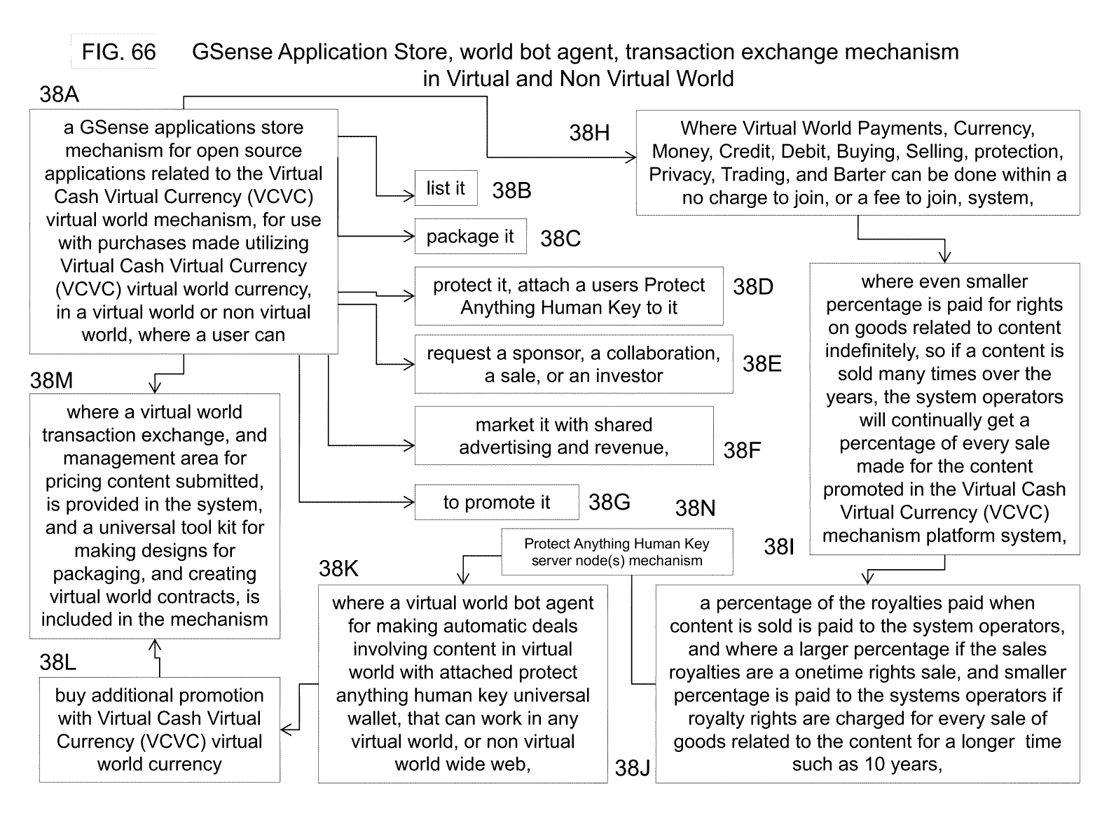

Now referring to FIG. 66, element 38A illustrates the GSense Application Store, world bot agent, transaction exchange mechanism in Virtual and Non Virtual World and a GSense applications store mechanism for open source applications related to the Virtual Cash Virtual Currency (VCVC) virtual world mechanism, for use with purchases made utilizing Virtual Cash Virtual Currency (VCVC) virtual world currency, in a virtual world or non virtual world, where a user can. Element 38B illustrates the GSense Application Store, world bot agent, transaction exchange mechanism in Virtual and Non Virtual World and can list it. Element 38C illustrates the GSense Application Store, world bot agent, transaction exchange mechanism in Virtual and Non Virtual World and can package it. Element 38D illustrates the GSense Application Store, world bot agent, transaction exchange mechanism in Virtual and Non Virtual World and can protect it, attach a users Protect Anything Human Key to it. Element 38E illustrates the GSense Application Store, world bot agent, transaction exchange mechanism in Virtual and Non Virtual World and can request a sponsor, a collaboration, a sale, or an investor. Element 38F illustrates the GSense Application Store, world bot agent, transaction exchange mechanism in Virtual and Non Virtual World and can market it with shared advertising and revenue. Element 38G illustrates the GSense Application Store, world bot agent, transaction exchange mechanism in Virtual and Non Virtual World to promote it. Element 38H illustrates the GSense Application Store, world bot agent, transaction exchange mechanism in Virtual and Non Virtual World where Virtual World Payments, Currency, Money, Credit, Debit, Buying, Selling, protection, Privacy, Trading, and Barter can be done within a no charge to join, or a fee to join, system. Element 38I illustrates the GSense Application Store, world bot agent, transaction exchange mechanism in Virtual and Non Virtual World where even smaller percentage is paid for rights on goods related to content indefinitely, so if a content is sold many times over the years, the system operators will continually get a percentage of every sale made for the content promoted in the Virtual Cash Virtual Currency (VCVC) mechanism platform system. Element 38J illustrates the GSense Application Store, world bot agent, transaction exchange mechanism in Virtual and Non Virtual World where a percentage of the royalties paid when content is sold is paid to the system operators, and where a larger percentage if the sales royalties are a onetime rights sale, and smaller percentage is paid to the systems operators if royalty rights are charged for every sale of goods related to the content for a longer time such as 10 years. Element 38K illustrates the GSense Application Store, world bot agent, transaction exchange mechanism in Virtual and Non Virtual World where a virtual world bot agent for making automatic deals involving content in virtual world with attached protect anything human key universal wallet, that can work in any virtual world, or non virtual world wide web.

Element 38L illustrates the GSense Application Store, world bot agent, transaction exchange mechanism in Virtual and Non Virtual World where user can buy additional promotion with Virtual Cash Virtual Currency (VCVC) virtual world currency. Element 38M illustrates the GSense Application Store, world bot agent, transaction exchange mechanism in Virtual and Non Virtual World where a virtual world transaction exchange, and management area for pricing content submitted, is provided in the system, and a universal tool kit for making designs for packaging, and creating virtual world contracts, is included in the mechanism. Element 38N illustrates the GSense Application Store, world bot agent, transaction exchange mechanism in Virtual and Non Virtual World with the Protect Anything Human Key server node(s) mechanism.

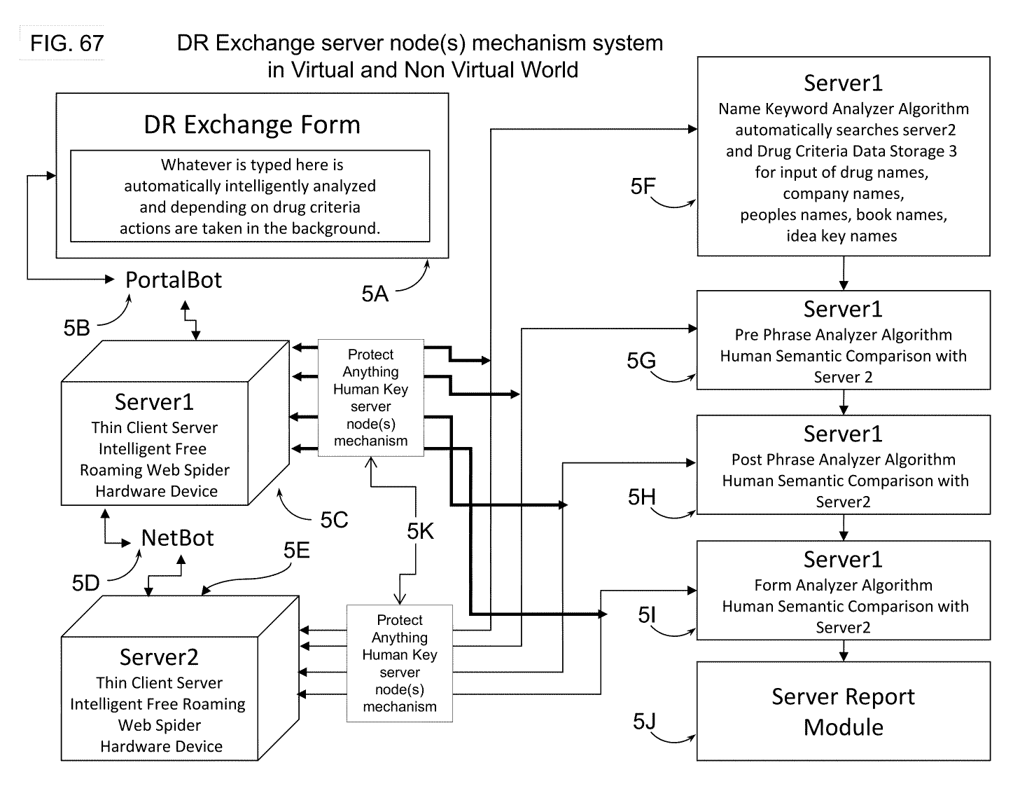

Now referring to FIG. 67, element 5A illustrates the scenario that anything typed here will be automatically and intelligently analyzed and depending on drug criteria actions are to be taken in the background. Element 5B illustrates the PortalBot, which will provide as a connection point between the DR Exchange Form and server 1. Element 5C illustrates server I and its main components, including thin client server, intelligent free roaming, web spider, and hardware device. These system specifics will provide the user with better views of the mainframe's advantages. Element 5D illustrates the NetBot, which will serve as a connection point between server I and server 2. Element 5E illustrates server 2 and its main components, including thin client server, intelligent free roaming, web spider, and hardware device. These system specifics will provide the user with better views of the mainframe's advantages. Element 5F illustrates server I and its main components including the name keyword analyzer algorithm, which will automatically search server 2 and drug criteria data storage 3 for input of drug names, company names, people's names, book names, and the idea key names. Element 5G illustrates server's role within the DR Exchange, depicting the pre phrase analyzer algorithm and the human semantic comparison with server2. Element 5H illustrates another one of server I's simultaneous roles within the DR Exchange, depicting the post phrase analyzer algorithm and the human semantic comparison with server 2. Element 5I illustrates the third one of server I's simultaneous roles within the DR Exchange, depicting the form analyzer algorithm and the human semantic comparison with server 2. Element 5J illustrates the server report module, which is the last step to the DR Exchange providing one last step to the reporting procedure. Element 5K illustrates the Protect Anything Human Key server node(s) mechanism used in the mechanism at key points for protection, authentication and identification.

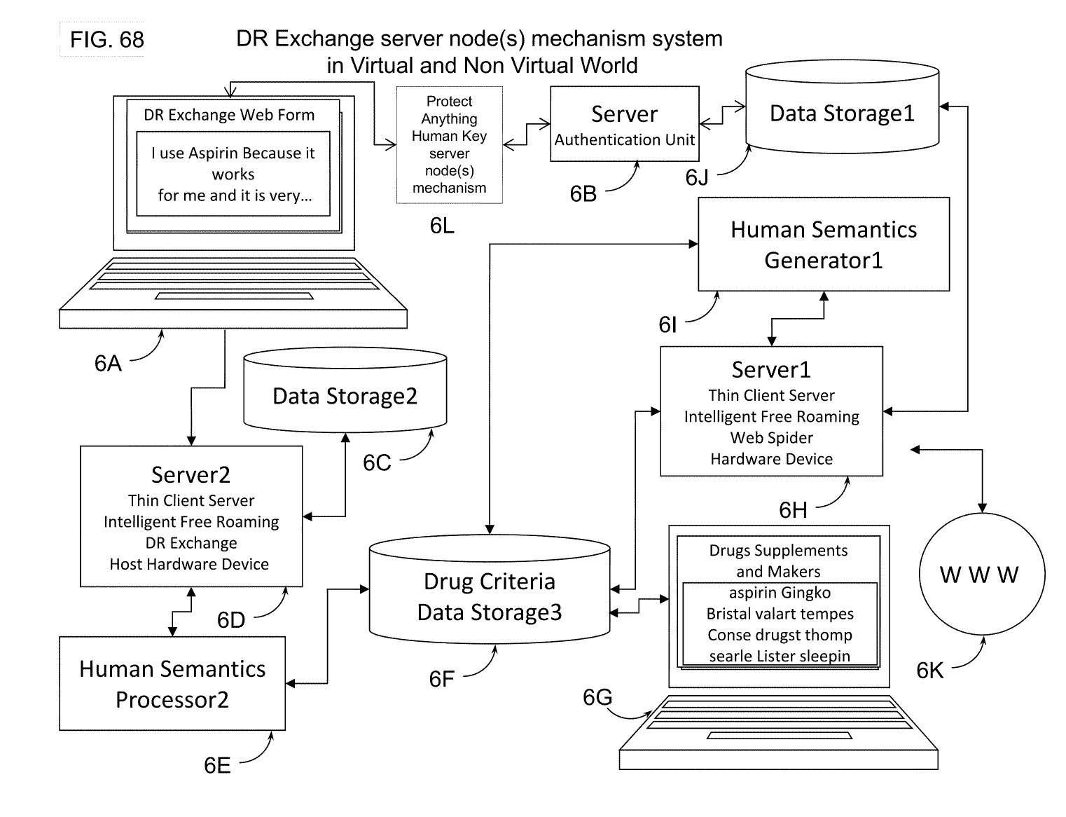

Now referring to FIG. 68, element 6A illustrates the super computer DR Exchange Web Form, which displays a written cause statement, “I use Aspirin, because it works for me and it is very ______.” Element 6B illustrates the server authentication unit, which provides a security layer for proper access. Element 6C illustrates data Storage 2, which will allow data to accompany this memory space. Element 6D illustrates server 2's main components, including thin client server, intelligent free roaming, DR Exchange, and host hardware device. These system specifics will provide the user with better views of the mainframe's advantages. Element 6E illustrates the human semantics processor 2, which connects to server 2 and the later Drug Criteria Data Storage 3. This processor will be a tool for giving the proper meaning of certain language paths typed on the computer. Element 6F illustrates the Drug Criteria Data Storage 3, which enables certain drug information to be stored onto the data storage unit's memory space. Element 6G illustrates the Drugs Supplements and Makers on screen layout, which will give a three part word series of available information. Element 6H illustrates server's main components, including thin client server, intelligent free roaming, web spider, and hardware device. These system specifics will provide the user with better views of the mainframe's advantages. Element 6I illustrates the Human Semantics Generator, which works in connection with Drug Criteria Data Storage 3 and server 1. This generator will work out meanings of word meanings and map out semantic word language. Element 6J illustrates the data storage 1 unit, which is connected only to server 1. This storage unit will allow data to accompany this memory space. Element 6K illustrates the www domain prefix, which will give the main interne address aspect. Element 6L illustrates the Protect Anything Human Key server node(s) mechanism used in the mechanism at key points for protection, authentication and identification.

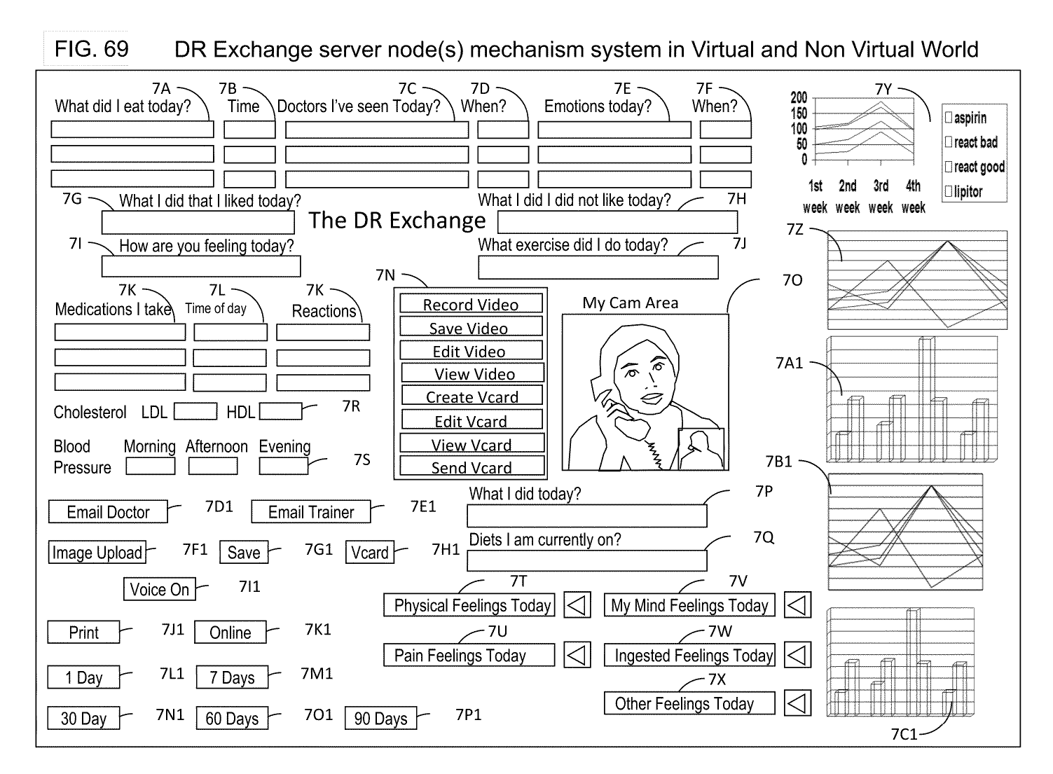

Now referring to FIG. 69, element 7A illustrates an input form field where an individual to write about what he or she has eaten that day. Element 7B illustrates an input form field where an individual to list the time corresponding to the items he or she has eaten that day. Element 7 e illustrates an input form field where an individual can list the doctors he or she has seen that day. Element 7D illustrates an input form field where an individual can list the time at which he or she visited the doctor. Element 7E illustrates an input form field where an individual can list the emotions he or she has felt throughout the course of the day. Element 7F illustrates an input form field where an individual can list the times at which he or she felt a particular emotion. Element 7G illustrates an input form field where an individual can write about what he or she did during that course of the day that was positive. Element 7H illustrates an input form field where an individual can write about what he or she did that day that was negative. Element 7I illustrates an input form field where an individual can write an overarching summary of how he or she felt that day. Element 7J illustrates an input form field where an individual can write about the exercise he or she performed that day. Element 7K illustrates an input form field where an individual can list the medications he or she took that day. Element 7L illustrates an input form field where an individual can list the time at which he or she took a specific medication. Element 7M illustrates an input form field where an individual can list the reactions he or she had to the medications taken that day. Element 7N illustrates the eight functions that can be performed within the “My Cam Area” video application. Element 70 illustrates the “My Cam Area” mechanism where an individual can record, save, edit, view, create, edit, view and send video within The DR Exchange. Element 7P illustrates an input form field where an individual can write about what he or she did that day. Element 7Q illustrates an input form field where an individual can write about the diets he or she is currently on.

Element 7R illustrates an input form field where an individual can write in what his or her HDL and LDL cholesterol levels are at presently. Element 7S illustrates an input form field where an individual can list what his or her blood pressure was at three points throughout the day, namely morning, afternoon and evening Element 7T illustrates a field where an individual can identify his or her physical feelings experienced that day and find descriptions written on previous days, Element 7U illustrates a field where an individual can identify his or her painful physical feelings experienced that day and filled written descriptions from on previous days, Element 7V illustrates a field where an individual can identify his or her mental feelings experienced that day and find written descriptions written from previous days, Element 7W illustrates a field where an individual can identify his or her ingested feelings experienced that day and find written descriptions from previous days. Element 7X illustrates a field where an individual can identify his or her miscellaneous feelings experienced that day and find written descriptions from previous days, Element 7Y illustrates a graph that displays the drugs an individual has been taking and the reactions he or she has had over time, Element 7Z illustrates a graph that displays the severity of the feelings an individual has experience over the course of the day, Element 7A1 illustrates a graph that displays the likes and dislikes of an individual over a period of time, Element 7B1 illustrates a graph that displays an individual's, blood pressure, cholesterol and diet habits over a period of time, Element 7C1 illustrates a graph that displays a variety of factors over a period of time, Element 7D1 illustrates a link through which an individual will be able to e-mail his or her doctor. Element 7E1 illustrates a link through which an individual will be able to e-mail his or her trainer. Element 7F1 illustrates a link through which an individual will be able to upload an image of anything. Element 7G1 illustrates a link through which an individual will be able to save his or her The DR Exchange page after working on it. Element 7H1 illustrates a link through which an individual will be able to send a VCard. Element 7I1 illustrates a link through which an individual will be able to turn on or off the sound on the “My Cam Area” video application. Element 7J1 illustrates a link through which an individual will be able to print anything on The DR Exchange page. Element 7K1 illustrates a link through which an individual will be able to sign out of his or her The DR Exchange page. Element 7L1 illustrates a link through which an individual will be able to call up information from one day ago Element 7M1 illustrates a link through which an individual will be able to call up information from seven day ago Element 7N1 illustrates a link through which an individual will be able to call up information from 30 days ago. Element 7O1 illustrates a link through which an individual will be able to call up information from 60 days ago. Element 7P1 illustrates a link through which an individual will be able to call up information from 90 days ago.

Now referring to FIG. 70, element 8A illustrates a computer capable of processing different forms of multimedia including digital pictures, video and music. Element 8B illustrates a camera which can be used to upload pictures onto a computer. Element 8C illustrates the entry manager server where the data is initially processed. Element 8D illustrates the backup media server where the data is given a time stamp. Element 8E illustrates the cluster of servers where the data is stored. Element 8F illustrates the server where a digital fingerprint is issued to the data Element 8G illustrates the server where the data is digitally segmented. Element 8H illustrates the series of servers used to stream video. Element 8I illustrates the second manager server where data passes as it is downloaded onto the computer or other device. Element 8J illustrates a computer capable of processing different forms of multimedia including digital pictures, video and music. Element 8K illustrates a CD drive. Element 8L illustrates e-mail which would be processed through the servers. Element 8M illustrates a USB storage device. Element 8N illustrates the Protect Anything Human Key server node(s) mechanism used in the mechanism at key points for protection, authentication and identification.

Now referring to FIG. 71, element 9A describes the method by which all information that an individual needs or wants to be protected, can and will be protected, namely Protect Anything. Element 9B illustrates the process by which an individual will describe his or her intellectual property. Element 9C describes the process by which an individual decides what is needed to build and successfully operate the thing. Element 9D describes the process by which an individual evaluates the time needed to construct the thing Element 9E describes the process by which an individual determines the price of the thing. Element 9F describes the process by which an individual establishes how many buyers and sellers will constitute the initial market for the thing. Element 9G describes the process by which an individual determines competitive pricing for the thing. Element 9H describes the process by which an individual appraises the previously determined price of the thing. Element 9I describes the process by which an individual seeks to protect his or her intellectual property. Element 9J describes the process by which an individual evaluates the importance and or necessity of investment. Element 9K describes the process by which an individual determines the relationship to pricing item. Element 9L describes the process by which an individual evaluates the potential ROI for buyers, sellers and investors in pricing. Element 9M describes the process by which an individual estimates how long it will take to turn a profit based on buying, selling and investing pricing.

Element 9N describes the process by which an individual determines how much customers would be willing to pay versus how much they need to pay.
Element 9O describes the process by which an individual can protect any recorded item within the Protect Anything database.
Element 9P describes the process by which an individual can protect any uploaded item within the Protect Anything database.
Element 9Q describes the process by which an individual can protect anything he or she types into an input field form within the Protect Anything database.
Element 9R describes the process by which any data is encoded to protect quality within the Protect Anything database.
Element 9S describes the process by which data is protected through encryption within the Protect Anything database.
Element 9T describes the process by which data is sorted and stored within the Protect Anything database.
Element 9U describes the process by which data is de-encrypted within the Protect Anything database.
Element 9V describes the process by which an individual can choose to share or not share his or her data within the Protect Anything database.
Element 9W describes the process by which data is downloaded within the Protect Anything database.
Element 9X describes the process by which data is burned onto one or multiple CD's within the Protect Anything database.
Element 9Y describes the process by which an individual chooses to publish and or print his or her data within the Protect Anything database.
Element 9Z describes the process by which data is promoted within the Protect Anything database.
Element 9A1 describes the process by which data is advertised within the Protect Anything database.
Element 9B1 describes the process by which data is funded within the Protect Anything database.
Element 9C1 describes the process by which a request for anything related to the requested subject, is stored within the Protect Anything database.
Element 9D1 identifies the conversion and transformation of info databases data to numbers mechanism.
Element 9E1 identifies the aspect where the mechanism calculates who is needed value, time frame, value, a fair value share for investment by investor value, individual or group buying selling value, estimated *ROI value, request for pricing value and buying, selling participation in the mechanism system.
Element 9F1 identifies where storage of who is needed value, time frame value, a fair value share for investment by investor value, individual or group buying selling value, estimated *ROI value, request for pricing value and buying, selling participation data in database for retrieval is implemented in the mechanism.
Element 9G1 shows implementation of all data aggregated in the mechanism.
Element 9H1 illustrates the Protect Anything Human Key server node(s) mechanism used in the mechanism at key points for protection, authentication and identification.

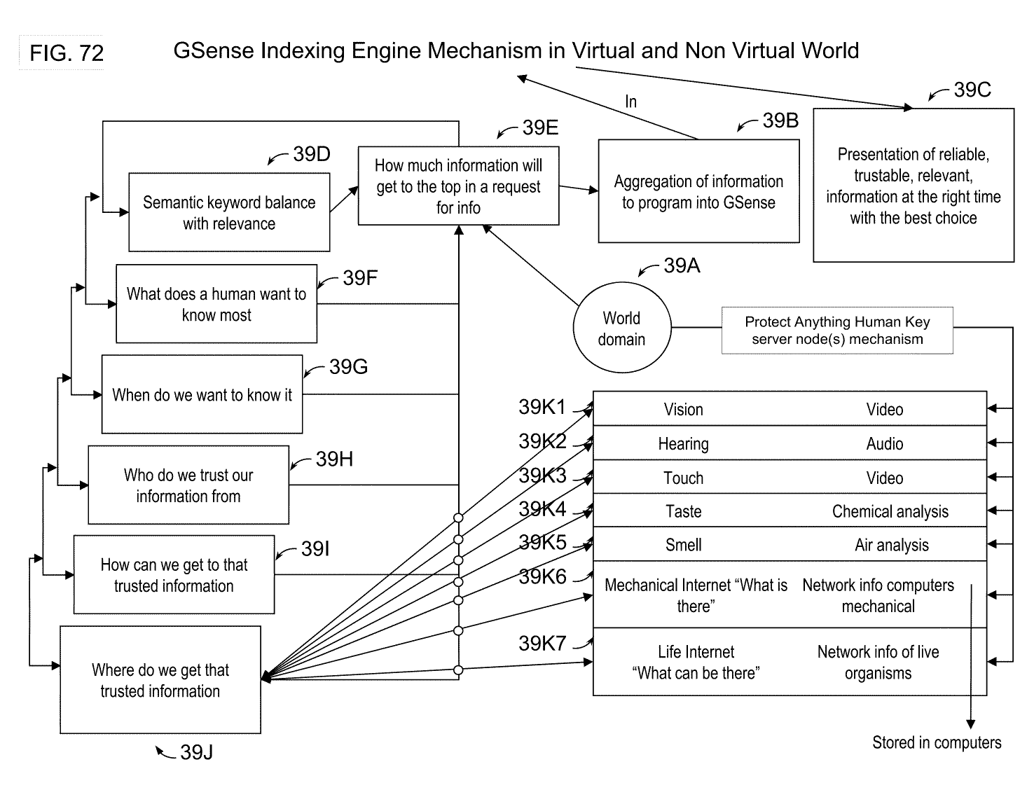

Now referring to FIG. 72, element 39A describes GSense Engine and mechanism and shows how world domains connect with GSense engine.

Element 39B describes GSense Engine and mechanism and shows the aggregation of information to programmed into the GSense engine mechanism.
Element 39C describes GSense Engine and mechanism and shows how information flows out from the GSense engine mechanism for presentation of reliable, trustable, relevant information at the right time with the best choice for decision-making.
Element 39D describes GSense Engine and mechanism and shows how semantic keyword balances with relevance in the GSense engine.
Element 39E describes GSense Engine and mechanism and shows how much information will get to the top of the list in a request for information.
Element 39F describes GSense Engine and mechanism and shows questions are asked and fulfilled like what does a human one to know about most?
Element 39G describes GSense Engine and mechanism and shows questions are asked and fulfilled like when do we want to know it?
Element 39H describes GSense Engine and mechanism and shows questions are asked and fulfilled like who do we trust our information from?
Element 39I describes GSense Engine and mechanism and shows questions are asked and fulfilled like how can we get instantly automatically to that trust information?
Element 39J describes GSense Engine and mechanism and shows questions are asked and fulfilled like where do we get that trusted information automatically?
Element 39K1 describes GSense Engine and mechanism and shows vision information utilizing video aggregation, analysis, storage, and information distribution.
Element 39K2 describes GSense Engine and mechanism and shows hearing information utilizing audio aggregation, analysis, storage and information distribution.
Element 39K3 describes GSense Engine and mechanism and shows touch information utilizing sensors aggregation, analysis, storage and information distribution.
Element 39K4 describes GSense Engine and mechanism and shows taste information utilizing chemical analysis sensors aggregation, analysis, storage and information distribution.
Element 39K5 describes GSense Engine and mechanism and shows smell information utilizing chemical analysis of gases sensors aggregation, analysis, storage and information distribution.
Element 39K6 describes GSense Engine and mechanism and shows the mechanical internet “what is there” information utilizing network information from mechanical computers stored in computers aggregation, analysis, storage and information distribution.
Element 39K7 describes GSense Engine and mechanism and shows life internet what can be there and is there at this moment information utilizing network info of live organisms aggregation, analysis, storage and information distribution.

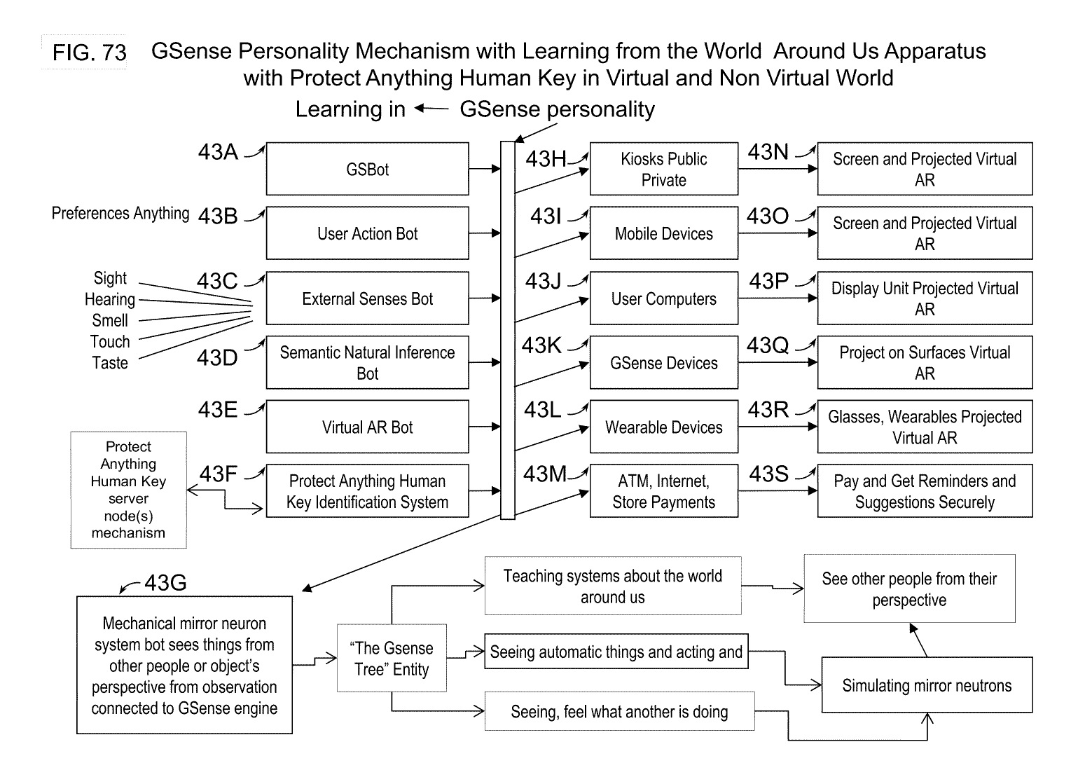

Now referring to FIG. 73, element 43A describes the GSense Personality Mechanism with Learning from the World Around Us Apparatus and shows the GS bot learning into the GSense personality.

Element 43B describes the GSense Personality Mechanism with Learning from the World Around Us Apparatus and shows the user actions bot learning into the GSense personality. Element 43C describes the GSense Personality Mechanism with Learning from the World Around Us Apparatus and shows the external senses bot with sight, hearing, smell, touch, and taste learning into the GSense personality.
Element 43D describes the GSense Personality Mechanism with Learning from the World Around Us Apparatus and shows the semantic natural inference bot learning into the GSense personality.
Element 43E describes the GSense Personality Mechanism with Learning from the World Around Us Apparatus and shows the virtual augmented reality bot learning into the GSense personality.
Element 43F describes the GSense Personality Mechanism with Learning from the World Around Us Apparatus and shows the Protect Anything Human Key identification system managing learning into the GSense personality.
Element 43G describes the GSense Personality Mechanism with Learning from the World Around Us Apparatus and shows the mechanical mirror neuron system bot that sees things from other people or objects perspective from observation connected to the Life Internet and the GSense engine learning into the GSense personality.
Element 43H describes the GSense Personality Mechanism with Learning from the World Around Us Apparatus and shows kiosks public or private getting data from the GSense personality.
Element 43I describes the GSense Personality Mechanism with Learning from the World Around Us Apparatus and shows mobile devices getting data from the GSense personality.
Element 43J describes the GSense Personality Mechanism with Learning from the World Around Us Apparatus and shows user computers getting data from the GSense personality.
Element 43K describes the GSense Personality Mechanism with Learning from the World Around Us Apparatus and shows projection devices getting data from the GSense personality.
Element 43L describes the GSense Personality Mechanism with Learning from the World Around Us Apparatus and shows wearable devices getting data from the GSense personality.
Element 43M describes the GSense Personality Mechanism with Learning from the World Around Us Apparatus and shows bank AIMs Internet stores payments getting data from the GSense personality.
Element 43N describes the GSense Personality Mechanism with Learning from the World Around Us Apparatus and shows screen and projected virtual augmented reality data from kiosks public or private data from the GSense personality.
Element 43O describes the GSense Personality Mechanism with Learning from the World Around Us Apparatus and shows screen and projected virtual augmented reality data from mobile devices data from the GSense personality.
Element 43P describes the GSense Personality Mechanism with Learning from the World Around Us Apparatus and shows screen display unit and projected virtual augmented reality data from user computers with data from the GSense personality.
Element 43Q describes the GSense Personality Mechanism with Learning from the World Around Us Apparatus and shows screen and projected virtual augmented reality data on surfaces from projectors with data from the GSense personality.
Element 43R describes the GSense Personality Mechanism with Learning from the World Around Us Apparatus and shows glasses, wearable's and projected virtual augmented reality data from wearable devices with data from the GSense personality.

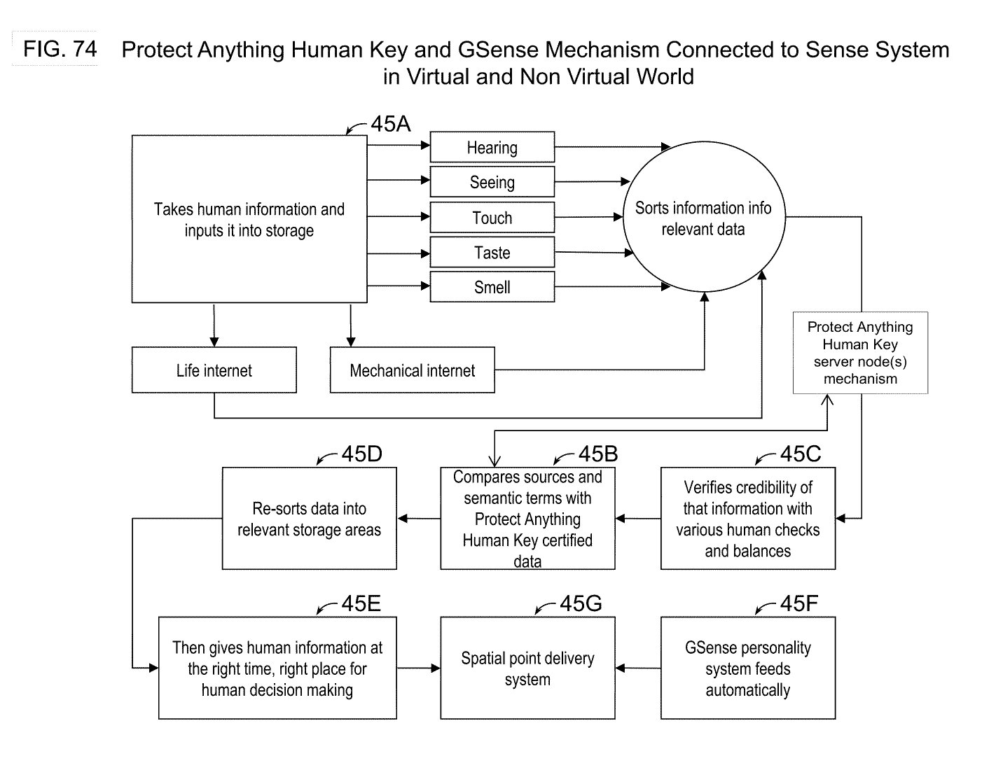

Now referring to FIG. 74, element 45A describes how Protect Anything Human Key and GSense mechanism is connected to the sense system and shows how the system takes human information in implicit into storage the mechanism takes hearing, seeing, touching, taste, smell, life Internet, the mechanical Internet and sorts all information into relevant data areas.

Element 45B describes how Protect Anything Human Key and GSense mechanism is connected to the sense system and shows where the mechanism compares sources and semantic terms with Protect Anything Human Key certified data.
Element 45C describes how Protect Anything Human Key and GSense mechanism is connected to the sense system and shows where the mechanism verifies the credibility of that information with various human checks and balances built-in to be mechanism automatically.
Element 45D describes how Protect Anything Human Key and GSense mechanism is connected to the sense system and shows where the mechanism sorts again the data into relevant storage areas.
Element 45E describes how Protect Anything Human Key and GSense mechanism is connected to the sense system and shows the system then gives human information at the right time, right place for enhancing human decision making.
Element 45F describes how Protect Anything Human Key and GSense mechanism is connected to the sense system and shows that the GSense personality system feeds the relevant information automatically.
Element 45G describes how Protect Anything Human Key and GSense mechanism is connected to the sense system and shows that relevant information can be targeted with the spatial point delivery system mechanism.

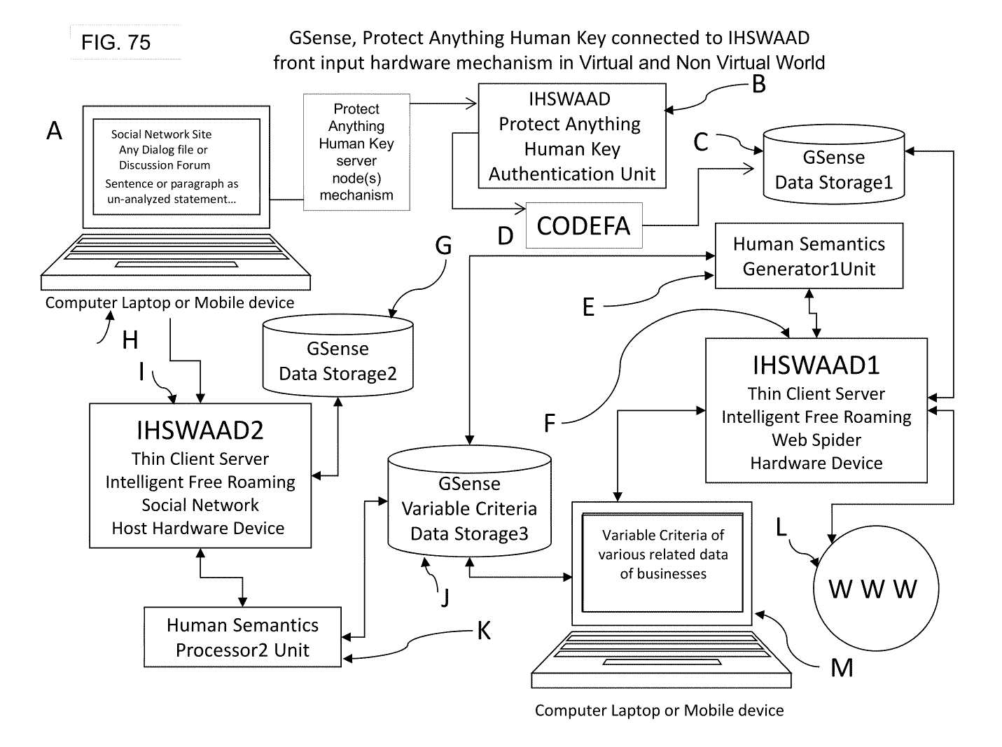

Now referring to FIG. 75, element 51A describes GSense, Protect Anything Human Key connected to IHSWAAD hardware mechanism front input mechanism where data is input or aggregated from social networking site or any dialog file or discussion forum and a sentence or paragraph is entered as an un-analyzed statement from a computer, laptop, or mobile device for processing.

Element 51B describes GSense, Protect Anything Human Key connected to IHSWAAD hardware mechanism front input mechanism where data is input or aggregated through the IHSWAAD Protect Anything Human Key Authentication Unit and/or raw into the IHSWAAD2 Thin Client Server Intelligent Free Roaming Social Network Host Hardware Device from a computer, laptop, or mobile device for processing.
Element 51C describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing to the CODEFA encryption processing unit to the GSense Data Storage1.
Element 51D describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing through CODEFA Prot 1 security encryption processor.
Element 51E describes GSense, Protect Anything Human Key connected to IHSWAAD hardware mechanism front input mechanism where data is input into the Human Semantics Generator 1 Unit for keyword phrase analysis, intelligent pattern matching and processing.
Element 51F describes GSense, Protect Anything Human Key connected to IHSWAAD hardware mechanism front input mechanism where data is input and/or aggregated from WWW to the IHSWAAD1 Thin Client Server Intelligent Free Roaming Web Spider. Hardware Device and a sentence or paragraph is entered as an un-analyzed statement, from a computer, laptop, or mobile device for processing by the system.
Element 51G describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Data Storage2.
Element 51H describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing.
Element 51I describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing IHSWAAD2 Thin Client Server Intelligent Free Roaming Social Network Host Hardware Device.
Element 51J describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Variable Criteria Data Storage3.
Element 51K describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Human Semantics Processor2 Unit.
Element 51L describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing from the WWW.
Element 51M describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Variable Criteria of various related data of businesses.

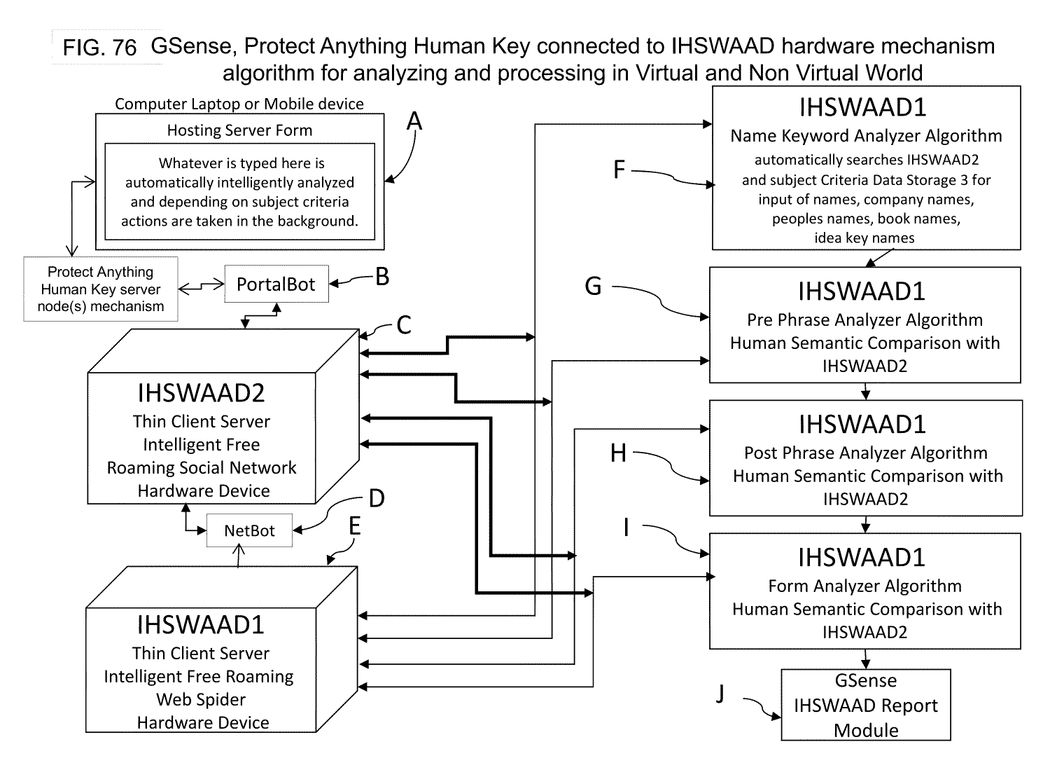

Now referring to FIG. 76, element 53A describes GSense, Protect Anything Human Key connected to IHSWAAD hardware mechanism algorithm for analyzing and processing related information and shows Hosting Server Form input from Computer Laptop or Mobile device. Whatever is typed here is automatically intelligently analyzed and depending on subject criteria actions are taken in the background.

Element 53B describes GSense, Protect Anything Human Key connected to IHSWAAD hardware mechanism algorithm for analysis and processing related information and shows PortalBot.
Element 53C describes GSense, Protect Anything Human Key connected to IHSWAAD hardware mechanism algorithm for analyzing and processing related information and shows IHSWAAD2 Thin Client Server Intelligent Free Roaming Social Network Hardware Device.
Element 53D describes GSense, Protect Anything Human Key connected to IHSWAAD hardware mechanism algorithm for analyzing and processing related information and shows NetBot.
Element 53E describes GSense, Protect Anything Human Key connected to IHSWAAD hardware mechanism algorithm for analyzing and processing related information and shows IHSWAAD1 Thin Client Server Intelligent Free Roaming Web Spider Hardware Device.
Element 53F describes GSense, Protect Anything Human Key connected to IHSWAAD hardware mechanism algorithm for analyzing and processing related information and shows IHSWAAD1 Name Keyword Analyzer Algorithm automatically searches IHSWAAD2 and subject Criteria Data Storage 3 for input of names, company names, people's names, book names, idea key names.
Element 53G describes GSense, Protect Anything Human Key connected to IHSWAAD hardware mechanism algorithm for analyzing and processing related information and shows IHSWAAD1 Pre Phrase Analyzer Algorithm Human Semantic Comparison with IHSWAAD2.
Element 53H describes GSense, Protect Anything Human Key connected to IHSWAAD hardware mechanism algorithm for analyzing and processing related information and shows IHSWAAD1 Post Phrase Analyzer Algorithm Human Semantic Comparison with IHSWAAD2.
Element 53I describes GSense, Protect Anything Human Key connected to IHSWAAD hardware mechanism algorithm for analyzing and processing related information and shows IHSWAAD1 Form Analyzer Algorithm Human Semantic Comparison with IHSWAAD2.
Element 53J describes GSense, Protect Anything Human Key connected to IHSWAAD hardware mechanism algorithm for analyzing and processing related information and shows GSense IHSWAAD Report Module.

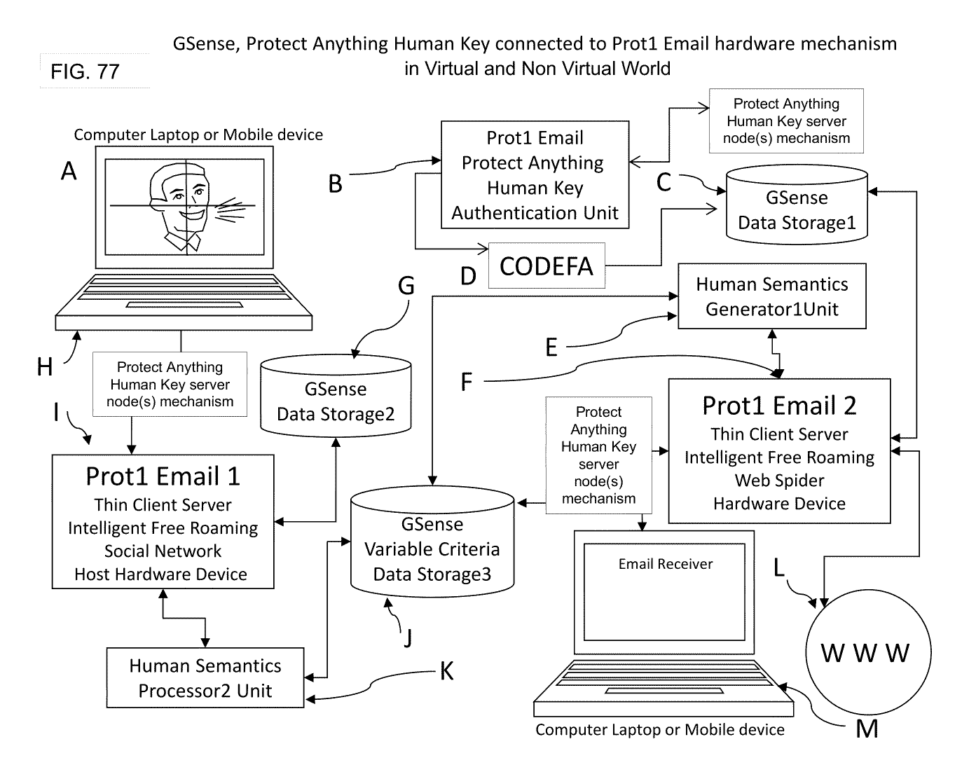

Now referring to FIG. 77, element 54A describes GSense, Protect Anything Human Key connected to Prot1 Email hardware mechanism and shows the Computer Laptop or Mobile device.

Element 54B describes GSense, Protect Anything Human Key connected to Prot1 Email, 1 hardware mechanism and shows the Prot1 Email Protect Anything Human Key Authentication Unit.
Element 54C describes GSense, Protect Anything Human Key connected to Prot1 Email hardware mechanism and shows the GSense Data Storage1.
Element 54D describes GSense, Protect Anything Human Key connected to Prot1 Email hardware mechanism and where the Protect Anything CODEFA mechanism provides storage, security; human key and tracking features are used.
Element 54E describes GSense, Protect Anything Human Key connected to Prot1 Email hardware mechanism and shows the Human Semantics Generator1 Unit.
Element 54F describes GSense, Protect Anything Human Key connected to Prot1 Email hardware mechanism and shows the Prot1 Email 2 Thin Client Server Intelligent Free Roaming Web Spider Hardware Device.
Element 54G describes GSense, Protect Anything Human Key connected to Prot1 Email hardware mechanism and shows the GSense Data Storage2.
Element 54H describes GSense, Protect Anything Human Key connected to Prot1 Email hardware mechanism and shows the Computer Laptop or Mobile device.
Element 54I describes GSense, Protect Anything Human Key connected to Prot1 Email hardware mechanism and shows the Prot1 Email 1 Thin Client Server Intelligent Free Roaming Social Network Host Hardware Device.
Element 54J describes GSense, Protect Anything Human Key connected to Prot1 Email hardware mechanism and shows the GSense Variable Criteria Data Storage3.
Element 54 K describes GSense, Protect Anything Human Key connected to Prot1 Email hardware mechanism and shows the Human Semantics Processor2 Unit.
Element 54 L describes GSense, Protect Anything Human Key connected to Prot1 Email hardware mechanism and shows where the WWW or World Wide Web is used for data aggregation and comparison analysis methods
Element 54M describes GSense, Protect Anything Human Key connected to Prot1 Email hardware mechanism and shows where the Email Receiver Computer Laptop or Mobile device.

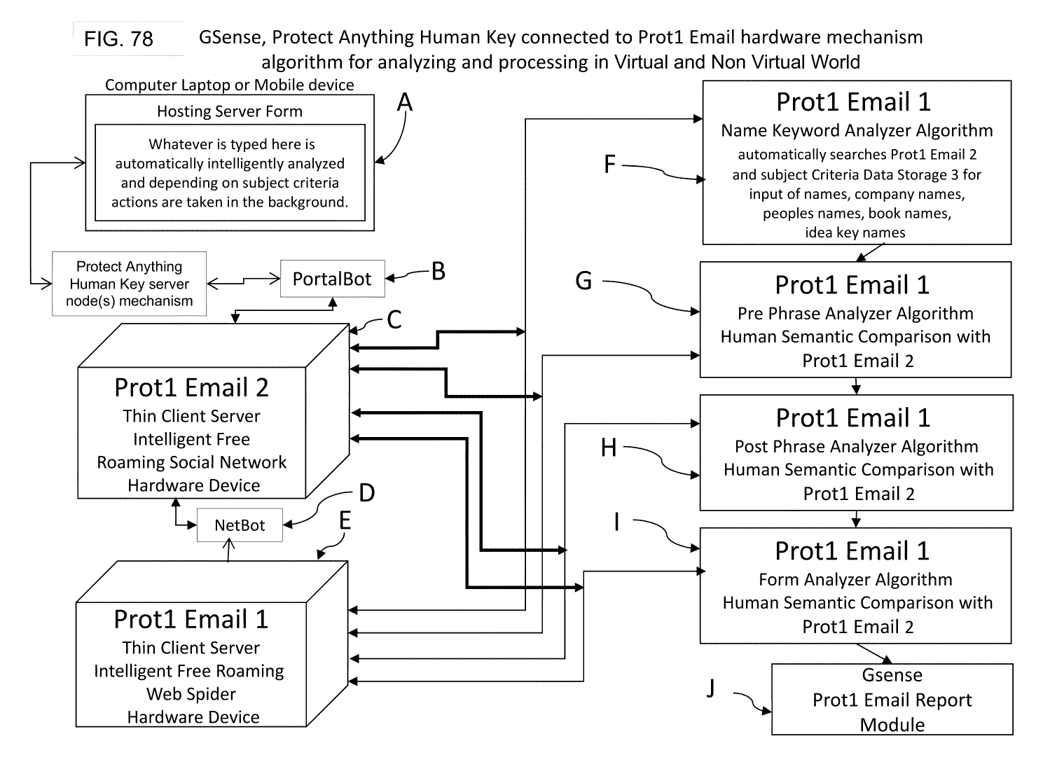

Now referring to FIG. 78, element 56A describes GSense, Protect Anything Human Key connected to Prot1 Email hardware mechanism algorithm for analyzing and processing email data and shows the Computer Laptop or Mobile device Hosting Server Form Whatever is typed here is automatically intelligently analyzed and depending on subject criteria actions are taken in the background.

Element 56B describes GSense, Protect Anything Human Key connected to Prot1 Email hardware mechanism algorithm for analyzing and processing email data and shows the Portal Bot.
Element 56C describes GSense, Protect Anything Human Key connected to Prot1 Email hardware mechanism algorithm for analyzing and processing email data and shows the Prot1 Email 2 Thin Client Server Intelligent Free Roaming Social Network Hardware Device.
Element 56D describes GSense, Protect Anything Human Key connected to Prot1 Email hardware mechanism algorithm for analyzing and processing email data and shows the Net Bot.
Element 56E describes GSense, Protect Anything Human Key connected to Prot1 Email hardware mechanism algorithm for analyzing and processing email data and shows the Prot1 Email 1 Thin Client Server Intelligent Free Roaming Web Spider Hardware Device.
Element 56F describes GSense, Protect Anything Human Key connected to Prot1 Email hardware mechanism algorithm for analyzing and processing email data and shows the Prot1 Email 1 Name Keyword Analyzer Algorithm automatically searches Prot1 Email 2 and subject Criteria Data Storage 3 for input of names, company names, people's names, book names, idea ^{˜}ey names.
Element 56G describes GSense, Protect Anything Human Key connected to Prot1 Email hardware mechanism algorithm for analyzing and processing email data and shows the Prot1 Email 1 Pre Phrase Analyzer Algorithm Human Semantic Comparison with Prot1 Email 2.
Element 56H describes GSense, Protect Anything Human Key connected to Prot1 Email hardware mechanism algorithm for analyzing and processing email data and shows the Prot1 Email 1 post Phrase Analyzer Algorithm Human Semantic Comparison .with Prot1 Email 2.
Element 56I describes GSense, Protect Anything Human Key connected to Prot1 Email hardware mechanism algorithm for analyzing and processing email data and shows the Prot1 Email 1 Form Analyzer Algorithm Human Semantic Comparison with Prot1 Email 2.
Element 56J describes GSense, Protect Anything Human Key connected to Prot1 Email hardware mechanism algorithm for analyzing and processing email data and shows the GSense Prot1 Email Report Module.

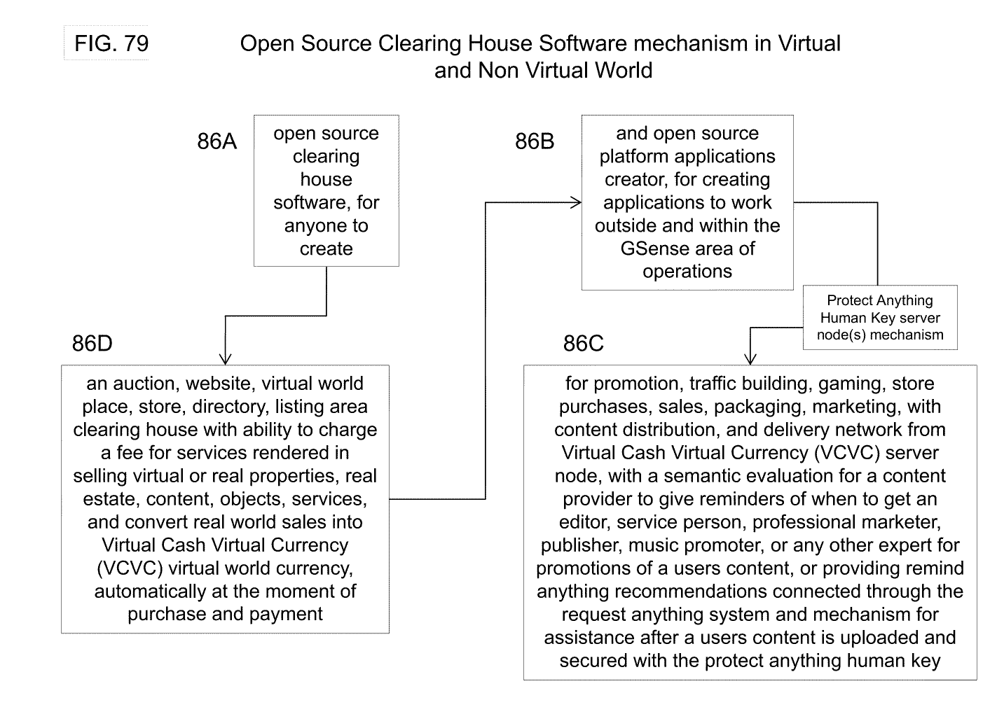

Now referring to FIG. 79, element 86A illustrates the Open Source Clearing House Software mechanism in Virtual and Non Virtual World, open source clearing house software, for anyone to create.

Element 86B illustrates and open source platform applications creator, for creating applications to work outside and within the GSense area of operations linked to the Protect Anything Human Key server node(s) mechanism.
Element 86C illustrates for promotion, traffic building, gaming, store purchases, sales, packaging, marketing, with content distribution, and delivery network from Virtual Cash Virtual Currency (VCVC) server node, with a semantic evaluation for a content provider to give reminders of when to get an editor, service person, professional marketer, publisher, music promoter, or any other expert for promotions of a users content, or providing remind anything recommendations connected through the request anything system and mechanism for assistance after a users content is uploaded and secured with the protect anything human key.
Element 86D illustrates an auction, website, virtual world place, store, directory, listing area clearing house with ability to charge a fee for services rendered in selling virtual or real properties, real estate, content, objects, services, and convert real world sales into Virtual Cash Virtual Currency (VCVC) virtual world currency, automatically at the moment of purchase and payment.

Now referring to FIG. 81, element 58A describes GSense Prot2 Protect Anything Human Key Authentication Unit Video Fourier wave form Pixel “A” Processor with H3DVARV 3D Human Video Audio Stereo Viewing and Recording Mechanism and shows how the Specimen is video recorded and streamed to Protect Anything Human Key server for sign up or sign in Computer Laptop, or Mobile device.

Element 58B describes GSense Prot2 Protect Anything Human Key Authentication Unit Video Fourier wave form Pixel “A” Processor and shows how the WWW or World Wide Web is used for data aggregation and comparison analysis methods.
Element 58C describes GSense Prot2 Protect Anything Human Key Authentication Unit Video Fourier wave form Pixel “A” Processor and shows where the Prot2 Protect Anything Human Key Authentication Unit Video Fourier wave form Pixel “A” Processor A1 Data created for registration mechanism, 1. Converts video to .jpg image files, 2. Converts .jpg image files to ASCII PPM files, 3. Converts PPM files to Protect Anything CODEFA mechanism provides storage, security, human key and tracking features files, 4. Converts Protect Anything CODEFA mechanism provides storage, security, human key and tracking features file into Fourier wave form for analysis, 5. Converts Protect Anything CODEFA mechanism provides storage, security, human key and tracking features file into interpolated brightness variables, 6. Creates Fourier wave form coordinates and pixel data, 7. Stores files in Prot2 “A” Data Storage 1 and numerical data in Prot2 “A” Data Storage2.
Element 58D describes GSense Prot2 Protect Anything Human Key Authentication Unit Video Fourier wave form Pixel “A” Processor and shows where the Prot2 Protect Anything Human Key Authentication Unit Video Fourier wave form Pixel “A” Processor A2 Data created for identification mechanism, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “A” Data Storage 1 and numerical data in Prot2 “A” Data Storage 2, 8. Compares A 1 data to A2 data and send to verification, 9. Where A match combined with 9 out of 16 positive point evaluations returns “Hello, and your first name”, 10. Where a non match returns negative point evaluation.
Element 58E describes GSense Prot2 Protect Anything Human Key Authentication Unit Video Fourier wave form Pixel “A” Processor and shows the GSense Prot2 “A” Data Storage1.
Element 58-F describes GSense Prot2 Protect Anything Human Key Authentication Unit Video Fourier wave form Pixel “A” Processor and shows the GSense Prot2 “A” Data Storage2.
Element 58G describes GSense Prot2 Protect Anything Human Key Authentication Unit Video Fourier wave form Pixel “A” Processor and shows the A1 to A2 Pattern matching and Comparison Processor Mechanism that analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 58H describes GSense Prot2 Protect Anything Human Key Authentication Unit Video Fourier wave form Pixel “A” Processor and shows the Protect Anything CODEFA mechanism that provides storage, security, human key and tracking features.
Element 58I describes GSense Prot2 Protect Anything Human Key Authentication Unit Video Fourier wave form Pixel “A” Processor and shows where the WWW or World Wide Web is used for data aggregation and comparison analysis methods “Hello, John” in Computer Laptop or Mobile device.

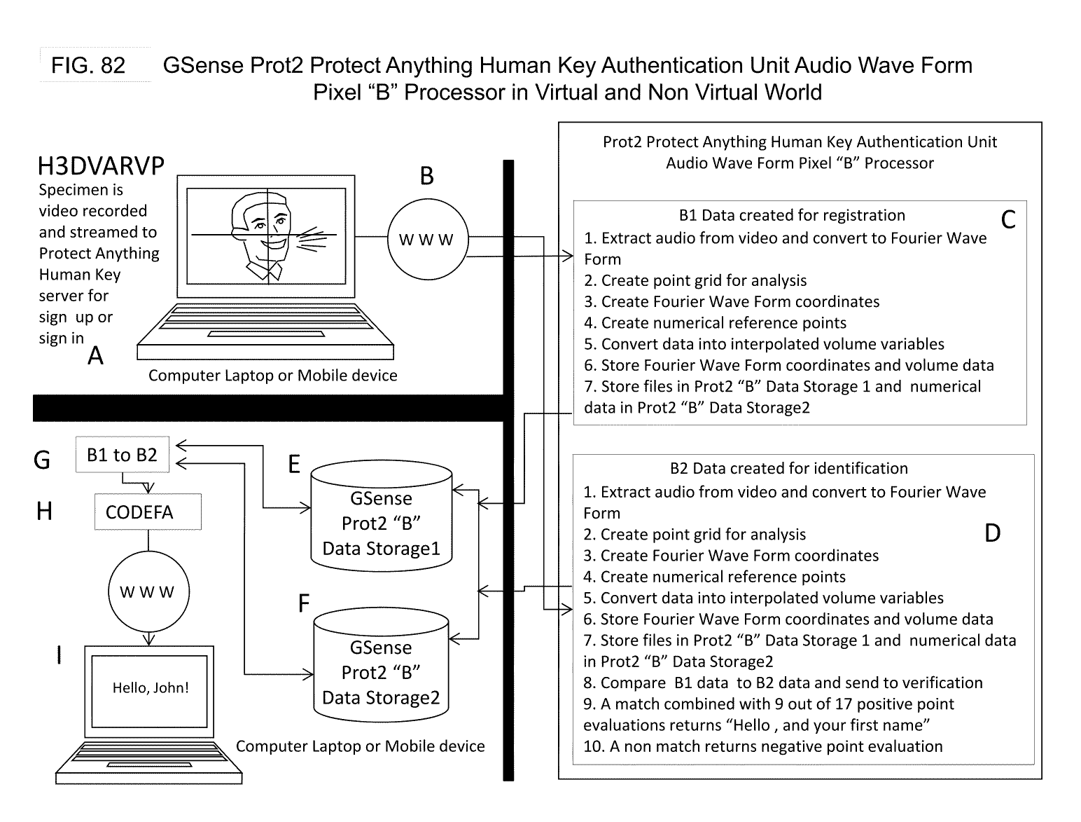

Now referring to FIG. 82, element 59A describes GSense Prot2 Protect Anything Human Key Authentication Unit Audio Fourier wave form Pixel “B” Processor with H3DVARV 3D Human Video Audio Stereo Viewing and Recording Mechanism and shows where the Specimen is video recorded and streamed to Protect Anything Human Key server for sign up or sign in Computer Laptop or Mobile device.

Element 59B describes GSense Prot2 Protect Anything Human Key Authentication Unit Audio Fourier wave form Pixel “B” Processor and shows where the WWW or World Wide Web is used for data aggregation and comparison analysis methods.
Element 59C describes GSense Prot2 Protect Anything Human Key Authentication Unit Audio Fourier wave form Pixel “B” Processor and shows where the Prot2 Protect Anything Human Key Authentication Unit Audio Fourier wave form Pixel “B” Processor B1 Data created for registration mechanism, 1. Extracts audio from video and convert to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data, 7. Stores files in Prot2 “B” Data Storage 1 and numerical data in Prot2 “B” Data Storage2.
Element 59D describes GSense Prot2 Protect Anything Human Key Authentication Unit Audio Fourier wave form Pixel “B” Processor and shows where the Prot2 Protect Anything Human Key Authentication Unit Audio Fourier wave form Pixel “B” Processor B2 Data created for identification mechanism, 1. Extracts audio from video and convert to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data, 7. Stores files in Prot2 “B” Data Storage 1 and numerical data in Prot2 “B” Data Storage2, 8. Compares B1 data to B2 data and send to verification, 9. Where a match combined with 9 out of 16 positive point evaluations returns “Hello, and your first name”, 10. And where a non match returns negative point evaluation.
Element 59E describes GSense Prot2 Protect Anything Human Key Authentication Unit Audio WaveForm Pixel “B” Processor and shows the GSense Prot2 “B” Data Storage1.
Element 59F describes GSense Prot2 Protect Anything Human Key Authentication Unit Audio Fourier wave form Pixel “B” Processor and shows the GSense Prot2 “B” Data Storage2.
Element 59G describes GSense Prot2 Protect Anything Human Key Authentication Unit Audio Fourier wave form Pixel “B” Processor and shows where the B1 to B2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 59H describes GSense Prot2 Protect Anything Human Key Authentication Unit Audio Fourier wave form Pixel “B” Processor and shows the Protect Anything CODEFA mechanism that provides storage, security, human key and tracking features.
Element 59I describes GSense Prot2 Protect Anything Human Key Authentication Unit Audio Fourier wave form Pixel “B” Processor and shows where the WWW or world wide web is used for data aggregation and comparison analysis methods Hello, John! In Computer Laptop or Mobile device.

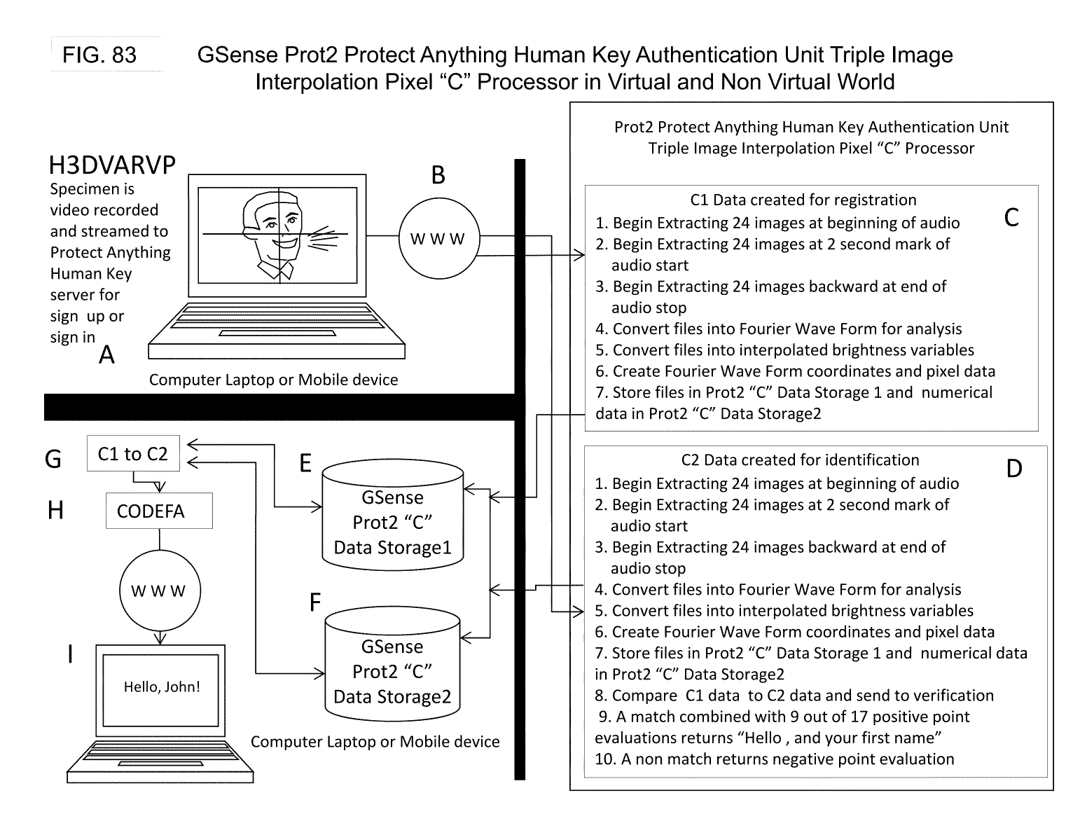

Now referring to FIG. 83, element 60A describes GSense Prot2. Protect Anything Human Key, Authentication Unit Triple Image Interpolation Pixel “C” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 60B describes GSense Prot2 Protect Anything Human Key Authentication Unit Triple Image Interpolation Pixel “C” Processor and shows where the WWW or World Wide Web is used for data aggregation and comparison analysis methods.
Element 60C describes GSense Prot2 Protect Anything Human Key Authentication Unit Triple Image Interpolation Pixel “C” Processor and shows where the Prot2 Protect Anything Human Key Authentication Unit Triple Image Interpolation Pixel “C” Processor C1 Data created for registration, 1. Begins Extracting 24 images at beginning of audio, 2. Begins Extracting 24 images at 2 second mark of audio start, 3. Begins Extracting 24 images backward at end of audio stop, 4. Converts files into Fourier wave form for analysis, 5. Converts files into interpolated brightness variables, 6. Creates Fourier wave form coordinates and pixel data, 7. Stores files in Prot2 “C” Data Storage 1 and numerical data in Prot2 “C” Data Storage 2.
Element 60D describes GSense Prot2 Protect Anything Human Key Authentication Unit Triple Image Interpolation Pixel “C” Processor and shows where the Prot2 Protect Anything Human Key Authentication Unit Triple Image Interpolation Pixel “C” Processor C2 Data created for identification, 1. Begins Extracting 24 images at beginning of audio, 2. Begins Extracting 24 images at 2 second mark of audio start, 3. begins Extracting 24 images, backward at end of audio stop, 4. converts files into Fourier wave form for analysis, 5. converts files into interpolated brightness variables, 6. creates Fourier wave form coordinates and pixel data, 7. stores files in Prot2 “G” Data Storage 1 and numerical data in Prot2 “C” Data Storage2, 8. Compares G1 data to G2 data arid send to verification, 9. where a match combined with 9 out of 16 positive point evaluations returns “Hello, and your first name”, 10. where a non match ‘returns negative point evaluation.
Element 60E describes GSense Prot2 Protect Anything Human Key Authentication Unit Triple Image Interpolation Pixel “C” Processor and shows the GSense Prot2 “G” Data Storage1.
Element 60F describes GSense Prot2 Protect Anything Human Key Authentication Unit Triple Image Interpolation Pixel “C” Processor and shows the GSense Prot2 “C” Data Storage2.
Element 60G describes GSense Prot2 Protect Anything Human Key Authentication Unit Triple Image Interpolation Pixel “C” Processor and shows where the C1 to C2 pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 60H describes GSense Prot2 Protect Anything Human Key Authentication Unit Triple Image Interpolation Pixel “C” Processor and shows where the Protect Anything CODEFA mechanism that provides storage, security, human key and tracking features.
Element 60I describes GSense Prot2 Protect Anything Human Key Authentication Unit Triple Image Interpolation Pixel “C” Processor and shows where the WWW or World Wide Web is used for data aggregation and comparison analysis methods Hello, John! in computer Laptop or Mobile device.

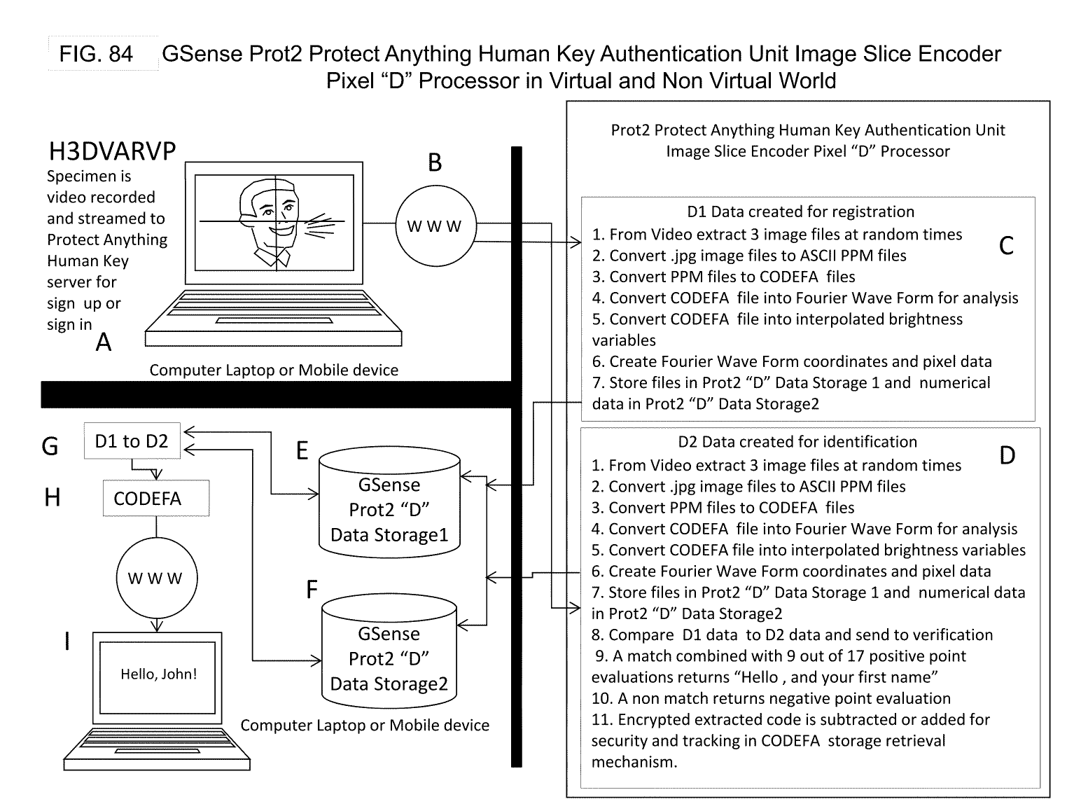

Now referring to FIG. 84, element 61A describes GSense Prot2 Protect Anything Human Key, Authentication Unit Image Slice Encoder Pixel “D” Processor, with H3DVARV 3D Human Video Audio Stereo Viewing, and Recording Mechanism, and shows where the Specimen video is recorded, and streamed to Protect Anything Human Key server for sign up or sign in Computer Laptop or Mobile device.

Element 61B describes GSense Prot2 Protect Anything Human Key Authentication Unit Image Slice Encoder Pixel “D” Processor and shows where the WWW or World Wide Web is used for data aggregation and comparison analysis methods.
Element 61C describes GSense Prot2 Protect Anything Human Key Authentication Unit Image Slice Encoder Pixel “D” Processor and shows where the Prot2 Protect Anything Human Key Authentication Unit Image Slice Encoder Pixel “D” Processor D1 Data created for registration, 1. from Video extracts 3 image files at random times, 2. converts .jpg image files to ASCII PPM files, 3. converts PPM files to Protect Anything CODEFA mechanism that provides storage, security, human key and tracking features files, 4. converts Protect Anything CODEFA mechanism that provides storage, security, human key’ and tracking features file into Fourier wave form for analysis, 5. converts Protect Anything COOEFA mechanism that provides storage, security, human key and tracking features file into interpolated brightness variables, 6. creates Fourier wave form coordinates and pixel data, 7. stores files in Prot2 “D” Data Storage 1. and numerical data in Prot2 “D” Data Storage2.
Element 61D describes GSense Prot2 Protect Anything Human Key Authentication Unit Image Slice Encoder Pixel “D” Processor and shows where the Prot2 Protect Anything Human Key Authentication Unit Image Slice Encoder Pixel “D” Processor. D2 Data created for identification, 1. From Video extracts 3 image files at random times, 2. Converts .jpg image files to ASCII PPM files, 3. Converts PPM files to Protect Anything COOEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “D” Data Storage 1 and numerical data in Prot2 “D” Data Storage 2, 8. Compares D1 data to D2 data and send to verification, 9. Where a match combined with 9 out of 16 positive point evaluations returns “Hello, and your first name”, 10. Where a non match returns negative point evaluation, 11. Where encrypted extracted code is subtracted or added for security and tracking in the Protect Anything CODEFA mechanism that provides storage, security, human key and tracking features storage retrieval mechanism.
Element 61E describes GSense Prot2 Protect Anything Human Key Authentication Unit Image Slice Encoder Pixel “D” Processor and shows the GSense Prot2 “D” Data Storage1.
Element 61F describes GSense Prot2 Protect Anything Human Key Authentication Unit. Image Slice Encoder Pixel “D” Processor and shows the GSense Prot2 “D” Data Storage2.
Element 61G describes GSense Prot2 Protect Anything Human Key Authentication Unit Image Slice Encoder Pixel “D” Processor and shows where the D1 to D2 Pattern matching and Comparison Processor Mechanism analyzes the data utilizing one or all of these analysis mechanisms including maximum distance analysis, mean distance analysis, mathematical error/data fit analysis; average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 61H describes GSense Prot2 Protect Anything Human Key Authentication Unit Image Slice Encoder Pixel “D” Processor and shows the Protect Anything CODEFA mechanism that provides storage, security, human key and tracking features.
Element 61I describes GSense Prot2 Protect Anything Human Key Authentication Unit Image Slice Encoder Pixel “D” Processor and shows where the WWW or World Wide Web is used for data aggregation and comparison analysis methods Hello, John! in Computer Laptop, or Mobile device.

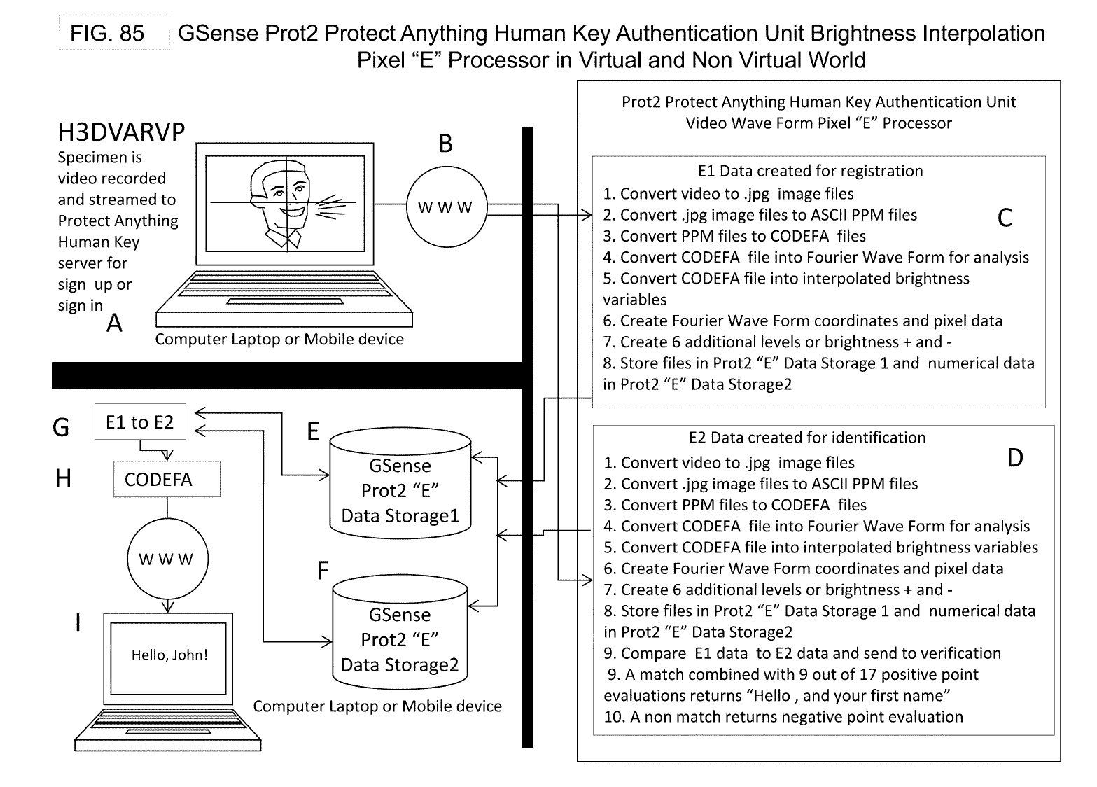

Now referring to FIG. 85, element 62A describes GSense Prot2 Protect Anything Human Key Authentication Unit Brightness Interpolation Pixel “E” Processor with H30VARV 30 Human Video Audio Stereo Viewing and Recording Mechanism and shows where the Specimen video is recorded and streamed to Protect Anything Human Key server for sign up or sign in Computer Laptop or Mobile device.

Element 62B describes GSense Prot2 Protect Anything Human Key Authentication Unit Brightness Interpolation Pixel “E” Processor and shows where the WWW or World Wide Web is used for data aggregation and comparison analysis methods.
Element 62C describes GSense Prot2 Protect Anything Human Key Authentication Unit Brightness Interpolation Pixel “E” Processor and shows where the Prot2 Protect Anything Human Key Authentication Unit Video Fourier wave form Pixel “E” ProcessorEl Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Creates 6 additional levels or brightness + and −, 8. Stores files in Prot2 “E” Data Storage 1 and numerical data in Prot2 “E” Data Storage2.
Element 62D describes GSense Prot2 Protect Anything Human Key Authentication Unit Brightness Interpolation Pixel “E” Processor and shows where the Prot2 Protect Anything Human Key Authentication Unit Video Fourier wave form Pixel “E” Processor E2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7: Creates 6 additional levels or brightness + and −, 8. Stores files in Prot2 “E” ‘Data Storage 1 and numerical data in Prot2 “E” Data Storage 2, 9. Compares E1 data to E2 data and send to verification, 9. Where a match combined with 9 out of 16 positive point evaluations returns “Hello, and your first name”, 10. Where a non match returns negative point evaluation.
Element 62E describes GSense Prot2 Protect Anything Human Key Authentication Unit Brightness Interpolation Pixel “E” Processor and shows the GSense Prot2 “E” Data Storage1.
Element 62F describes GSense Prot2 Protect Anything Human, Key Authentication Unit Brightness Interpolation Pixel “E” Processor and shows the GSense Prot2 “E” Data Storage2.
Element 158-G describes GSense Prot2 Protect Anything Human Key Authentication Unit Brightness Interpolation Pixel “E” Processor and shows where the E1 to E2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 62H describes GSense Prot2 Protect Anything Human Key Authentication Unit Brightness Interpolation Pixel “E” Processor and shows the Protect Anything CODEFA mechanism that provides storage, security, human key and tracking features.
Element 62I describes GSense Prot2 Protect Anything Human Key Authentication Unit Brightness Interpolation Pixel “E” Processor and shows where the WWW or World Wide Web is used for data aggregation and comparison analysis methods Hello, John! Computer Laptop, or Mobile device.

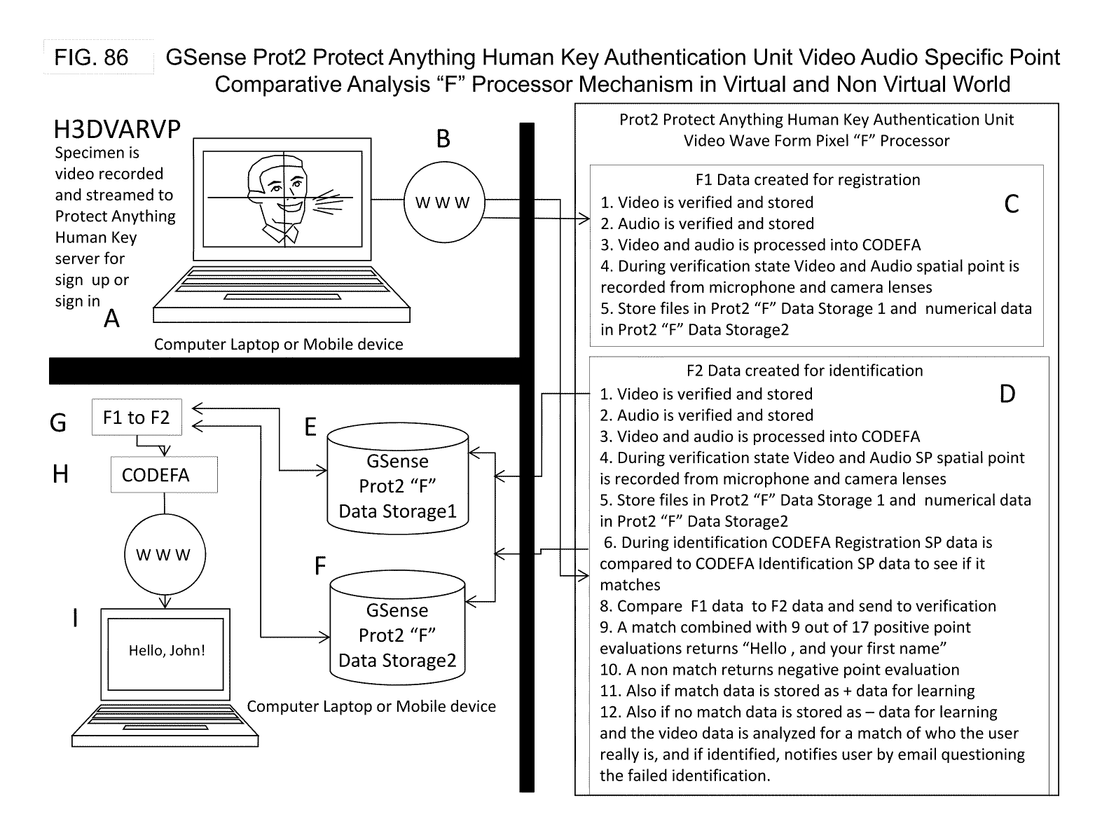

Now referring to FIG. 86, element 63A describes GSense Prot2 Protect Anything Human Key Authentication Unit Video Audio Specific Point Comparative Analysis “F” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 63B describes GSense Prot2 Protect Anything Human Key Authentication Unit Video Audio Specific Point Comparative Analysis “F” Processor Mechanism and shows where the WWW or World Wide Web is used for data aggregation and comparison analysis methods.
Element 63C describes GSense Prot2 Protect Anything Human Key Authentication Unit Video Audio Specific Point Comparative Analysis “F” Processor Mechanism and shows where the Prot2 Protect Anything Human Key Authentication Unit Video Fourier wave form Pixel “F” Processor F1 Data created for registration, 1. Video is verified and stored, 2. Audio is verified and stored, 3. Video and audio is processed into CODEFA, 4. During verification state Video and Audio spatial point is recorded from microphone and camera lenses, 5. Stores files in Prot2 “F” Data Storage 1 and numerical data in Prot2. “F” Data Storage2.
Element 63D describes GSense Prot2 Protect Anything Human Key Authentication Unit Video Audio Specific Point Comparative Analysis “F” Processor Mechanism and shows where the Prot2 Protect Anything Human Key Authentication Unit Video Fourier wave form Pixel “F” Processor F2 Data created for identification, 1. Video is verified and stored, 2. Audio is verified and stored, 3. Video and audio is processed into CODEFA, 4. During verification state Video and Audio SP spatial point is recorded from microphone and camera lenses, 5. Store files in Prot2 “F” Data Storage 1 and numerical data in Prot2 “F” Data Storage2, 6. During identification CODEFA Registration SP data is compared to CODEFA Identification SP data to see if it matches, 8. Compare F1 data to F2 data and send to verification, 9. Where a match combined with 9 out of 16 positive point evaluations returns “Hello, and your first name”, 10. Where a non match returns negative point evaluation, 11. Also if match data is stored as +data for learning 12. Also if no match data is stored as −data for learning and the video data is analyzed for a match of who the user really is, and if identified, notifies user by email questioning the failed identification.
Element 63E describes GSense Prot2 Protect Anything Human Key Authentication Unit.Video Audio Specific Point Comparative Analysis “F” Processor Mechanism and shows the GSense Prot2 “F” Data Storage1.
Element 63F describes GSense Prot2 Protect Anything Human Key Authentication Unit Video Audio Specific Point Comparative Analysis “F” Processor Mechanism and shows the GSense Prot2 “F” Data Storage2.
Element 63G describes GSense Prot2 Protect Anything Human Key Authentication Unit Video Audio Specific Point Comparative Analysis “F” Processor Mechanism and shows where the F1 to F2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 63H describes GSense Prot2 Protect Anything Human Key Authentication Unit Video Audio Specific Point Comparative Analysis “F” Processor Mechanism and shows the Protect Anything CODEFA mechanism that provides storage, security, human key and tracking features.
Element 63I describes GSense Prot2 Protect Anything Human Key Authentication Unit Video Audio Specific Point Comparative Analysis “F” Processor Mechanism and shows where the WWW or World Wide Web is used for data aggregation and comparison analysis methods Hello, John! Computer Laptop, or Mobile device.

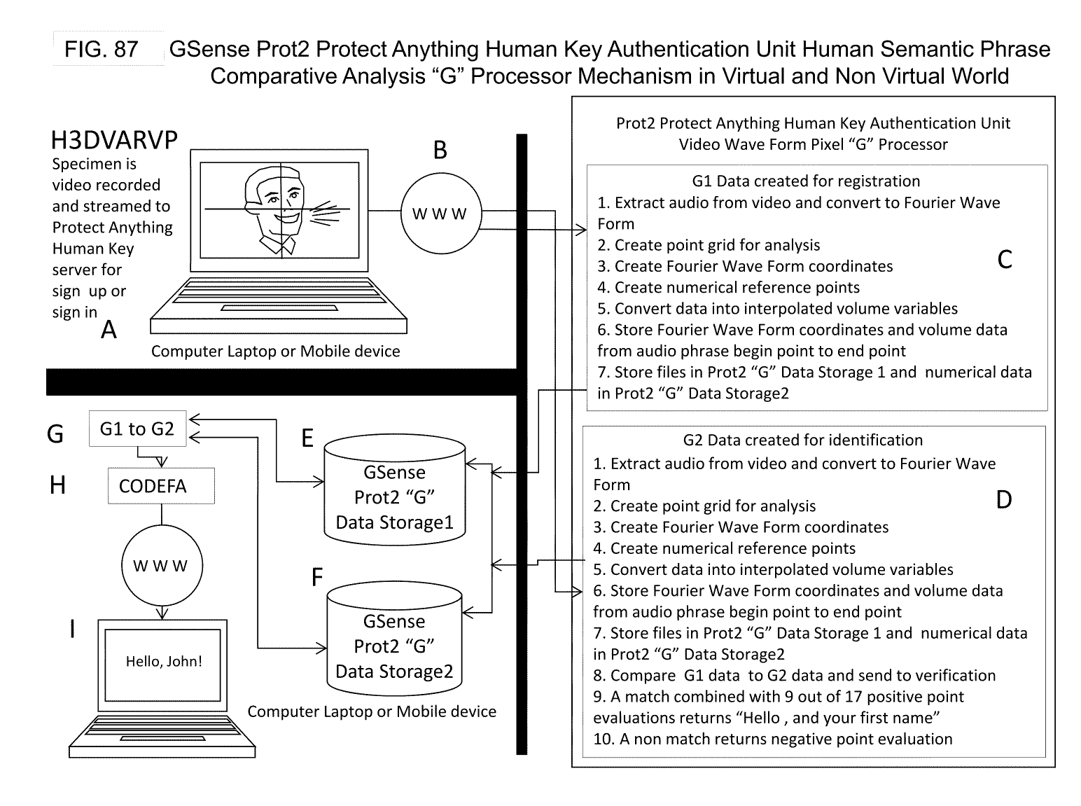

Now referring to FIG. 87, element 64A describes GSense Prot2 Protect Anything Human Key Authentication Unit Human Semantic Phrase Comparative Analysis “G” Processor Mechanism with. H3DVARV 3D Human Video Audio Stereo Viewing and Recording Mechanism and shows where the Specimen video is recorded and streamed to Protect Anything Human Key server for sign up or sign in Computer Laptop or Mobile device

Element 64B describes GSense Prot2 Protect Anything Human Key Authentication Unit Human Semantic Phrase Comparative Analysis “G” Processor Mechanism and shows where the WWW or World. Wide Web is used for data aggregation and comparison analysis methods.
Element 64C describes GSense Prot2 Protect Anything Human Key Authentication Unit Human Semantic Phrase Comparative Analysis “G” Processor Mechanism and where the Prot2 Protect Anything Human Key Authentication Unit Video Fourier wave form Pixel “G” Processor G1 Data created for registration, 1. Extracts audio from video and converts to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data from audio phrase begin point to end point, 7. Stores files in Prot2 “G” Data Storage 1 and numerical data in Prot2 “G” Data Storage 2.
Element 64D describes GSense Prot2 Protect Anything Human Key Authentication Unit Human Semantic Phrase Comparative Analysis “G” Processor Mechanism and shows where the Prot2 Protect Anything Human Key Authentication Unit Video Fourier wave form Pixel “G” Processor G2 Data created for identification, 1. Extracts audio from video and converts to Fourier wave form, 2. Creates point grid for analysis, 3. Creates Fourier wave form coordinates, 4. Creates numerical reference points, 5. Converts data into interpolated volume variables, 6. Stores Fourier wave form coordinates and volume data from audio phrase begin point to end point, 7. Stores files in Prot2 “G” Data Storage 1 and numerical data in Prot2 “G” Data Storage 2, 8. Compares G1 data to G2 data and send to verification, 9. Where a match combined with 9 out of 16 positive point evaluations returns “Hello, and your first name”, 1 O. Where a non match returns negative point evaluation.
Element 64E describes GSense Prot2 Protect Anything Human Key Authentication Unit Human Semantic Phrase Comparative Analysis “G” Processor Mechanism and shows the GSense Prot2 “G” Data Storage 1.
Element 64F describes GSense Prot2 Protect Anything Human Key Authentication Unit Human Semantic Phrase Comparative Analysis “G” Processor Mechanism and shows the GSense Prot2 “G” Data Storage2.
Element 64G describes GSense Prot2 Protect Anything Human Key Authentication Unit Human Semantic Phrase Comparative Analysis “G” Processor Mechanism and shows where the G1 to G2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 64H describes GSense Prot2 Protect Anything Human Key Authentication Unit Human Semantic Phrase Comparative Analysis “G” Processor Mechanism and shows the Protect Anything CODEFA mechanism that provides storage, security, human key and tracking features.
Element 64I describes GSense Prot2 Protect Anything Human Key Authentication Unit Human Semantic Phrase Comparative Analysis “G” Processor Mechanism and shows where the WWW or World Wide Web is used for data aggregation and comparison analysis methods Hello, John! Computer Laptop, or Mobile device.

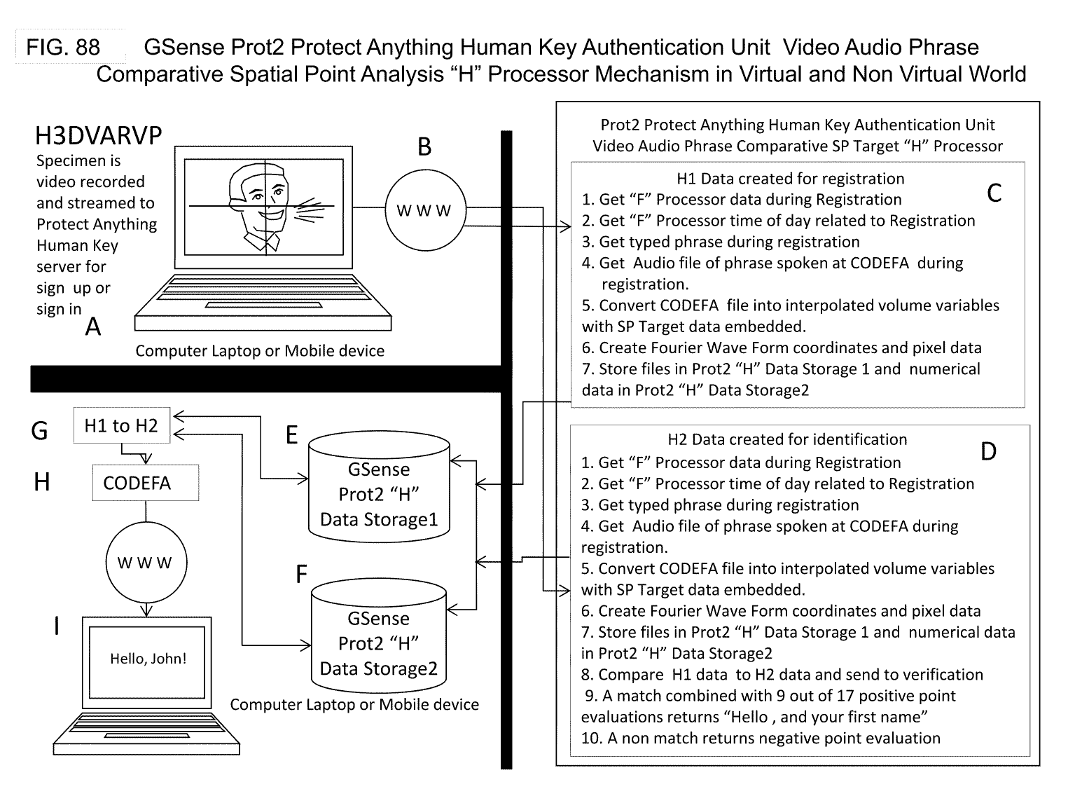

Now referring to FIG. 88, element 65A describes GSense Prot2 Protect Anything Human Key Authentication Unit Video Audio Text Comparative Spatial Point Analysis “H” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 65B describes GSense Prot2 Protect Anything Human Key Authentication Unit Video Audio Text Comparative Spatial Point Analysis “H” Processor Mechanism and shows where the WWW or World Wide Web is used for data aggregation and comparison analysi^{˜} methods.
Element 65C describes GSense Prot2 Protect Anything Human Key Authentication Unit Video Audio Text Comparative Spatial Point Analysis “H” Processor Mechanism and shows where the Prot2 Protect Anything Human Key Authentication Unit Video Audio Text Comparative SP Target “H” Processor H1 Data created for registration, 1. Gets “F” Processor data, during Registration, 2. Gets “F” Processor time of day related to Registration, 3. Gets typed phrase during registration, 4. Gets Audio file of phrase spoken at Protect Anything CODEFA mechanism that provides storage, security, human key and tracking features during registration, 5. Converts Protect Anything CODEFA mechanism that provides storage, security, human key and tracking features file into interpolated volume variables with SP Target data embedded, 6. Creates Fourier wave form coordinates and pixel data, 7. Stores files in Prot2 “H” Data Storage 1 and numerical data in Prot2 “H” Data Storage2.
Element 65D describes GSense Prot2 Protect Anything Human Key Authentication Unit Video Audio Text Comparative Spatial P18 int Analysis “H” Processor Mechanism and shows where the Prot2 Protect Anything Human Key Authentication Unit Video Audio Text Comparative SP Target “H” Processor H2 Data created for identification, 1. Gets “F” Processor data during Registration, Gets “F” Processor time of day related to Registration, 3. Gets typed phrase during registration, 4. Gets Audio file of phrase spoken at Protect Anything CODEFA mechanism that provides storage, security, human key and tracking features during registration, 5. Converts Protect Anything CODEFA mechanism that provides storage, security, human key and tracking features file into interpolated volume variables with SP Target data embedded, 6. Creates Fourier wave form coordinates and pixel data, 7. Stores files in Prot2 “H” Data Storage 1 and numerical data in Prot2 “H” Data Storage2, 8. Compares H1 data to H2 data and send to verification, 9. Where a match combined with 9 out of 16 positive point evaluations returns “Hello, and your first name”, 10. Where a non match returns negative point evaluation.
Element 65E describes GSense Prot2 Protect Anything Human Key Authentication Unit Video Audio Text Comparative Spatial Point Analysis “H” Processor Mechanism and shows the GSense Prot2 “H” Data Storage 1.
Element 65F describes GSense Prot2 Protect Anything Human Key Authentication Unit Video Audio Text Comparative Spatial Point Analysis “H” Processor Mechanism and shows the GSense Prot2 “H” Data Storage 2.
Element 65G describes GSense Prot2 Protect Anything Human Key Authentication Unit Video Audio Text Comparative Spatial Point Analysis “H” Processor Mechanism and shows where the H1 to H2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 65H describes GSense Prot2 Protect Anything Human Key Authentication Unit Video Audio Text Comparative Spatial Point Analysis “H” Processor Mechanism and shows the Protect Anything CODEFA mechanism that provides storage, security, human key and tracking features.
Element 65I describes GSense Prot2 Protect Anything Human Key Authentication Unit Video Audio Text Comparative Spatial Point Analysis “H” Processor Mechanism and shows where the WWW or World Wide Web is used for data aggregation and comparison analysis methods Hello, John! Computer Laptop, or Mobile device.

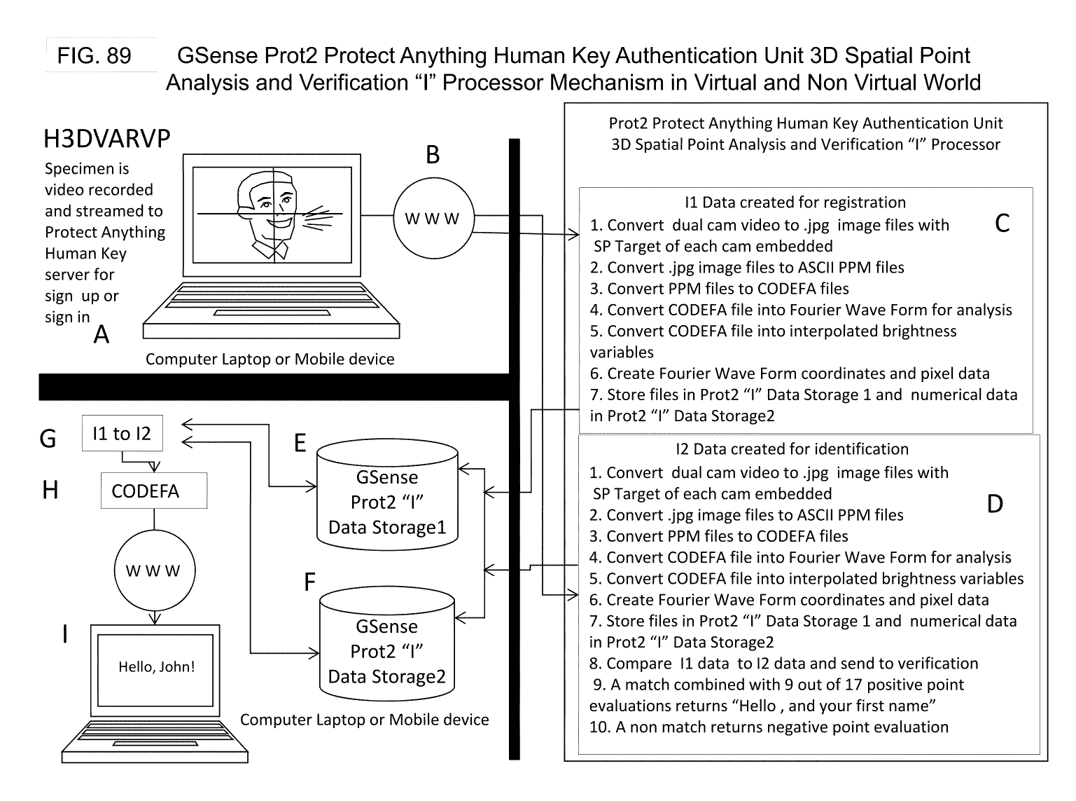

Now referring to FIG. 89, element 66A describes GSense Prot2 Protect Anything Human Key Authentication Unit 3D Spatial Point Analysis and Verification “I” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 66B describes GSense Prot2 Protect Anything Human Key Authentication Unit 3D Spatial Point Analysis and Verification “I” Processor Mechanism and shows where the WWW or World Wide Web is used for data aggregation and comparison analysis methods.
Element 66C describes GSense Prot2 Protect Anything Human Key Authentication Unit 3D Spatial Point Analysis and Verification “I” Processor Mechanism and shows where the Prot2 Protect Anything Human Key Authentication Unit 3D Spatial Point Analysis and Verification “I” Processor 11 Data created for registration, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “I” Data Storage 1 and numerical data in Prot2 “I” Data Storage2.
Element 66D describes GSense Prot2 Protect Anything Human Key Authentication Unit 3D′Spatial Point Analysis and Verification “I” Processor Mechanism and shows where the Prot2 Protect Anything Human Key Authentication Unit 3D Spatial Point Analysis and Verification “I” Processor 12 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form Fourier analysis, 5. Converts Protect Anything CODEFA mechanism that provides storage, security, human key and tracking features file into interpolated brightness variables, 6. Creates Fourier wave form coordinates and pixel data, 7. Stores files in Prot2, “I” Data Storage 1 and numerical data in Prot2 “I” Data Storage2, 8. Compares 11 data to 12 data and send to verification, 9. Where a match combined with 9 out of 16 positive point evaluations returns “Hello, and your first name”, 1 O. Where a non match returns negative point evaluation.
Element 66E describes GSense Prot2 Protect Anything Human Key Authentication Unit 3D Spatial Point Analysis and Verification “I” Processor Mechanism and shows the GSense Prot2 “I” Data Storage1.
Element 66F describes GSense Prot2 Protect Anything Human Key Authentication Unit 3D Spatial Point Analysis and Verification “I” Processor Mechanism and shows the GSense Prot2 “I” Data Storage2.
Element 66G describes GSense Prot2 Protect Anything Human Key Authentication Unit 3D Spatial Point Analysis and Verification “I” Processor Mechanism and shows where the 11 to 12 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 66H describes GSense Prot2 Protect Anything Human Key Authentication Unit 3D Spatial Point Analysis and Verification “I” Processor Mechanism and shows the Protect Anything CODEFA mechanism that provides storage, security, human key and tracking features:
Element 66I describes GSense Prot2 Protect Anything Human Key Authentication Unit 3D Spatial Point Analysis and Verification “I” Processor Mechanism and shows where the WWW or World Wide Web is used for data aggregation and comparison analysis methods Hello, John! Computer Laptop or Mobile device.

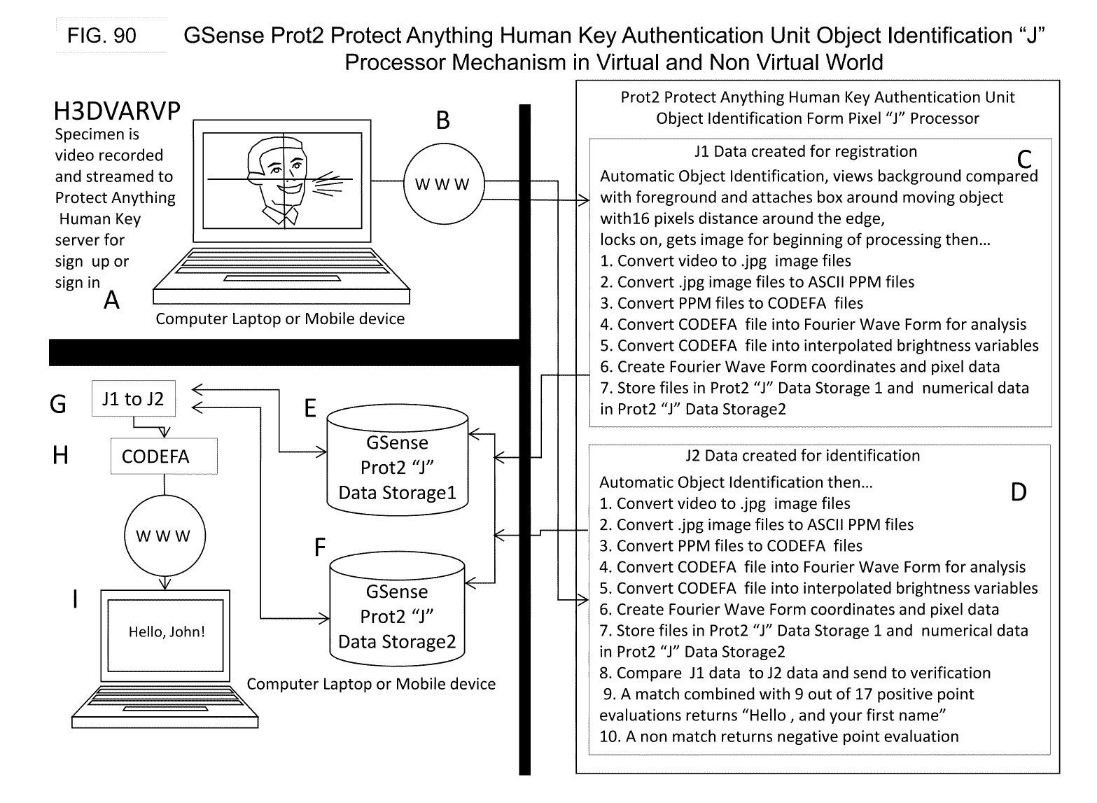

Now referring to FIG. 90, element 67A describes GSense Prot2 Protect Anything Human Key Authentication Unit Object Identification “J” Processor Mechanism with H3DVARV 3D Human Video.Audio Stereo Viewing and Recording Mechanism and shows where the Specimen video is recorded and streamed to Protect Anything Human Key server for sign up or sign in Computer Laptop or Mobile device.

Element 67B describes GSense Prot2 Protect Anything Human Key Authentication Unit Object Identification “J” Processor Mechanism and shows where the WWW or World Wide Web is used for data aggregation and comparison analysis methods.
Element 67C describes GSense Prot2 Protect Anything Human Key Authentication Unit Object Identification “J” Processor Mechanism and shows where the Prot2 Protect Anything Human Key Authentication Unit Object Identification Form Pixel “J” Processor J1 Data created for registration Automatic Object Identification, views background compared with foreground and attaches box around moving object with 16 pixels distance around the edge, locks on, gets image for beginning of processing then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “J” Data Storage 1 and numerical data in Prot2 “J” Data Storage2.
Element 67D describes GSense Prot2 Protect Anything Human Key Authentication Unit Object Identification “J” Processor Mechanism and shows where the Prot2 Protect Anything Human Key Authentication Unit Object Identification Form Pixel “J” Processor J2 Data created for identification Automatic Object Identification then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “J” Data Storage 1 and numerical data in Prot2 “J” Data Storage2, 8. Compares, J1 data to J2 data and send to verification, 9. Where a match combined with 9 out of 16 positive point evaluations returns “Hello, and your first name”, 10. Where a non match returns negative point evaluation.
Element 67E describes GSense Prot2 Protect Anything Human Key Authentication Unit Object Identification “J” Processor Mechanism and shows the GSense Prot2 “J” Data Storage1.
Element 67F describes GSense Prot2 Protect Anything Human Key Authentication Unit Object Identification “J” Processor Mechanism and shows the GSense Prot2 “J” Data Storage2.
Element 67G describes GSense Prot2 Protect Anything Human Key Authentication Unit Object Identification “J” Processor Mechanism and shows where the J1 to J2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 67H describes GSense Prot2 Protect Anything Human Key Authentication Unit Object Identification “J” Processor Mechanism and shows the Protect Anything CODEFA mechanism that provides storage, security, human key and tracking features.
Element 67I describes GSense Prot2 Protect Anything Human Key Authentication Unit Object Identification “J” Processor Mechanism and shows where the WWW or World Wide Web is used for data aggregation and comparison analysis methods Hello, John! Computer Laptop, or Mobile device.

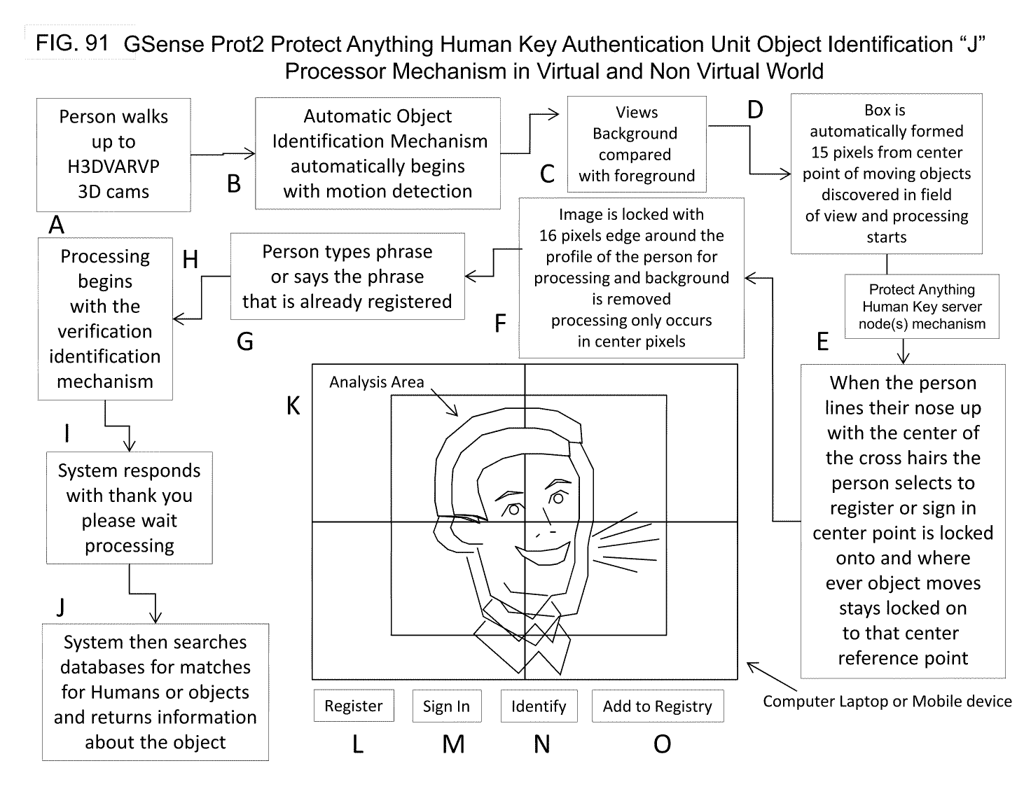

Now referring to FIG. 91, element 68A describes GSense Prot2 Protect Anything Human Key Authentication Unit Object Identification “J” Processor with H3DVARV 3D Human Video Audio Stereo Viewing and Recording Mechanism Analysis Area Mechanism and shows where the Person walks up to H3DVARV 3D Human Video Audio Stereo Viewing and Recording Mechanism 3D cams.

Element 68B describes GSense Prot2 Protect Anything Human Key Authentication Unit Object Identification “J” Processor Analysis Area Mechanism and shows where automatic Object Identification Mechanism automatically begins with motion detection.
Element 68C describes GSense Prot2 Protect Anything Human Key Authentication Unit Object Identification “J” Processor Analysis Area Mechanism and shows where the Views Background is compared with foreground.
Element 68D describes GSense Prot2 Protect Anything Human Key Authentication Unit Object Identification “J” Processor Analysis Area Mechanism and shows where the Box is automatically formed 200 pixels from center point of moving objects discovered in field of view and processing starts.
Element 68E describes GSense Prot2 Protect Anything Human Key Authentication Unit Object Identification “J” Processor Analysis Area Mechanism and shows where when the person lines their nose up with the center of the cross hairs the person selects to register or sign in center point is locked onto and where ever object moves stays locked onto that center reference point, and data is stored in the Protect Anything Human Key server node(s) mechanism for processing.
Element 68F describes GSense Prot2 Protect Anything Human Key Authentication Unit Object Identification “J’, ‘Processor Analysis Area Mechanism and shows where the, Image is locked with 16 pixels edge around the profile of the person for processing and the background is removed processing only occurs in center pixels.
Element 68G describes GSense Prot2 Protect Anything Human Key Authentication Unit Object Identification “J” Processor Analysis Area Mechanism and shows where the Person types phrase or says the phrase that is already registered.
Element 68H describes GSense Prot2 Protect Anything Human Key Authentication Unit Object Identification “J” Processor Analysis Area Mechanism and shows where the Processing begins with the verification identification mechanism.
Element 68I describes GSense Prot2 Protect Anything Human Key Authentication Unit Object Identification “J” Processor Analysis Area Mechanism and shows where the System responds with thank you please wait processing.
Element 68J describes GSense Prot2 Protect Anything Human Key Authentication Unit Object Identification “J” Processor Analysis Area Mechanism and shows where the System then searches databases for matches for Humans or objects and returns information about the object.
Element 68K describes GSense Prot2 Protect Anything Human Key Authentication Unit Object Identification “J” Processor Analysis Area Mechanism and shows where analysis Area is used with any Computer, Laptop, or Mobile device.
Element 68L describes GSense Prot2 Protect Anything Human Key Authentication Unit Object Identification “J” Processor Analysis Area Mechanism and shows where the Register button is located.
Element 68M describes GSense Prot2 Protect Anything Human Key Authentication Unit Object Identification “J” Processor Analysis Area Mechanism and shows where the Sign In button is located.
Element 68N describes GSense Prot2 Protect Anything Human Key Authentication Unit Object Identification “J” Processor Analysis Area Mechanism and shows where the Identify button is located.
Element 68O describes GSense Prot2 Protect Anything Human Key Authentication Unit Object Identification “J” Processor Analysis Area Mechanism and shows where add to Registry button is located.

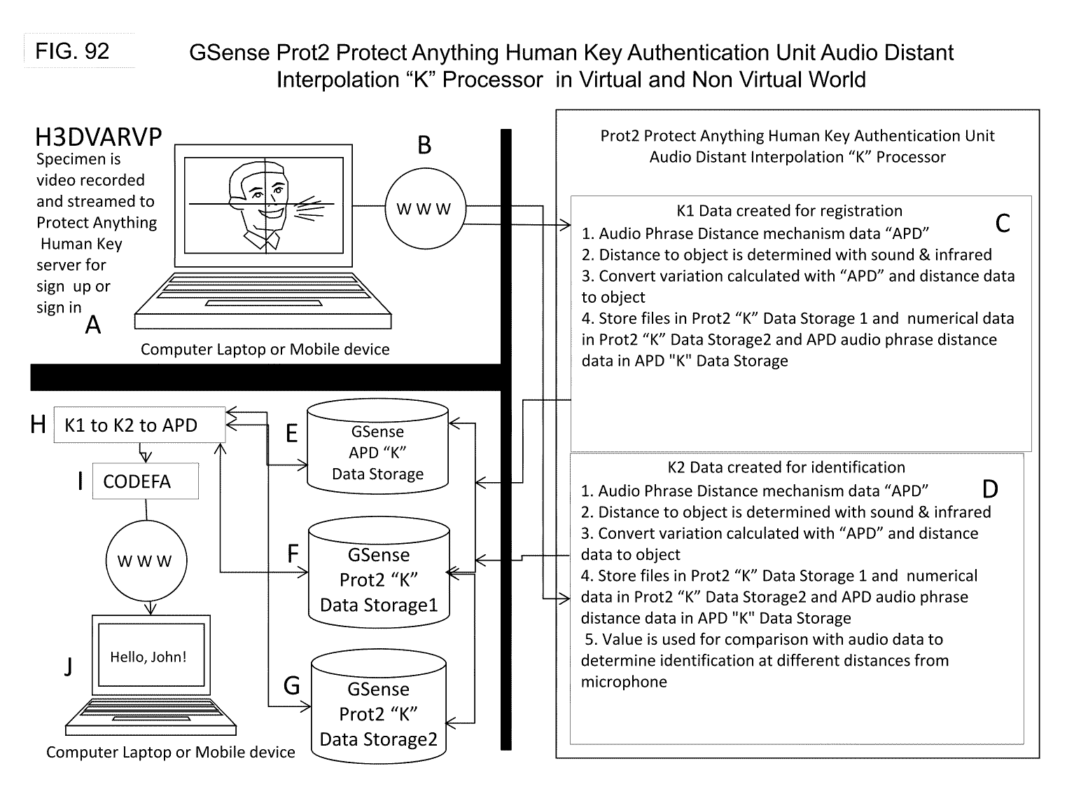

Now referring to FIG. 92, element t 69A describes GSense Prot2 Protect Anything Human Key Authentication Unit Audio Distant Interpolation “K” Processor with H3DVARV 3D Human Video Audio Stereo Viewing and Recording Mechanism and shows where the Specimen video is Recorded, and streamed to Protect Anything Human Key server for sign up or sign in Computer Laptop or Mobile device.

Element 69B describes GSense Prot2 Protect Anything Human Key Authentication Unit Audio Distant Interpolation “K” Processor and shows where the WWW or World Wide Web is used for data aggregation and comparison analysis methods.
Element 69C describes GSense Prot2 Protect Anything Human Key Authentication Unit Audio Distant Interpolation “K” Processor and shows where the Prot2 Protect Anything Human Key Authentication Unit Audio Distant Interpolation “K” Processor K1 Data created for registration, 1. Audio Phrase Distance mechanism data “APD”, 2. Distance to object is determined with sound & infrared, 3. Converts variation calculated with “APD” and distance data to object, 4. Stores files in Prot2 “K” Data Storage 1 and numerical data in Prot2 “K” Data Storage2 and APD audio phrase distance data in APD “K” Data Storage.
Element 69D describes GSense Prot2 Protect Anything Human Key Authentication Unit Audio Distant Interpolation “K” Processor and shows. where the Prot2 Protect Anything Human Key Authentication Unit Audio Distant Interpolation “K” Processor K2 Data created for identification, 1. Audio Phrase Distance mechanism data “APD”, 2. Distance to object is determined with sound & infrared, 3. Converts variation calculated with “APD” and distance data to object, 4. Stores files in Prot2 “K” Data Storage 1 and numerical data in Prot2 “K” Data Storage2 and APD audio phrase distance data in APD “K” Data Storage, 5. Where value is used for comparison with audio data to determine identification at different distances from microphone.
Element 69E describes GSense Prot2 Protect Anything Human Key Authentication Unit Audio Distant Interpolation “K” Processor and shows the GSense APD “K” Data Storage.
Element 69F describes GSense Prot2 Protect Anything Human Key Authentication Unit Audio Distant Interpolation “K” Processor and shows the GSense Prot2 “K” Data Storage1.
Element 69G describes GSense Prot2 Protect Anything Human Key Authentication Unit Audio Distant Interpolation uK” Processor and shows the GSense Prot2 “K” Data Storage2.
Element 69H describes GSense Prot2 Protect Anything Human Key Authentication Unit Audio Distant Interpolation “K” Processor and shows where the APD to K1 to K2 to APD Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 69I describes GSense Prot2 Protect Anything Human Key Authentication Unit Audio Distant Interpolation “K” Processor and shows the Protect Anything CODEFA Mechanism, that provides storage, security, human key and tracking features.
Element 69J describes GSense Prot2 Protect Anything Human Key Authentication Unit Audio Distant Interpolation “K” Processor and shows where the W W′W or World Wide Web is used for data aggregation and comparison analysis methods Hello, John! Computer Laptop or Mobile device.

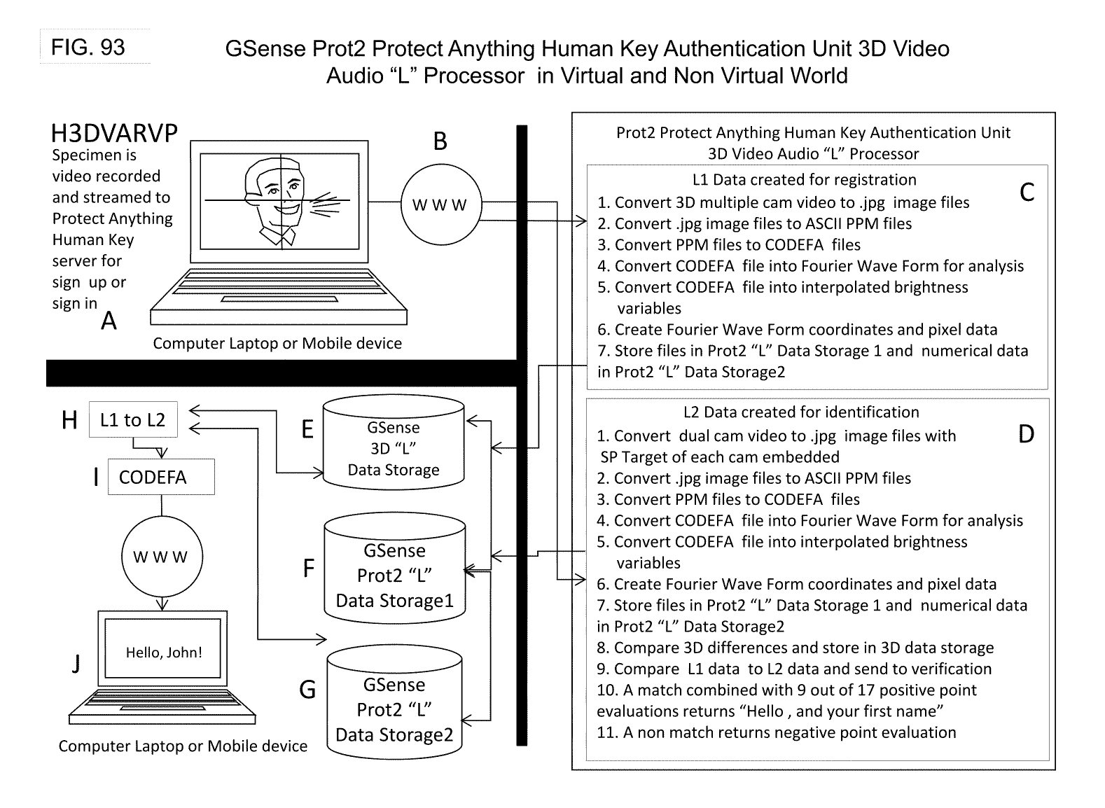

Now referring to FIG. 93, element 70A describes GSense Prot2 Protect Anything Human Key Authentication Unit 3D Video Audio “L” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 70B describes GSense Prot2 Protect Anything Human Key Authentication Unit 3D Video Audio “L” Processor and shows where the W WW or World Wide Web is used for data aggregation and comparison analysis methods.
Element 70C describes GSense Prot2 Protect Anything Human Key Authentication Unit 3D Video Audio “L” Processor “and shows where the Prot2 Protect Anything Human Key Authentication Unit 3D Video Audio “L” Processor L1 Data created for registration, 1. Converts 3D multiple cam video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “L” Data Storage 1 and numerical data in Prot2 “L” Data Storage2.
Element 70D describes GSense Prot2 Protect Anything Human Key Authentication Unit 3D Video Audio “L” Processor and shows where the Prot2 Protect Anything Human Key Authentication Unit3D Video Audio “L” Processor L2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “L” Data Storage 1 and numerical data in Prot2 “L” Data Storage2, 8. Compares 3D differences and store in 3D data storage, 9. Compares L1 data to L2 data and send to verification, 10. Where a match combined with 9 out of 16 positive point evaluations returns “Hello, and your first name” 11. Where a non match returns negative point evaluation.
Element 70E describes GSense Prot2 Protect Anything Human Key Authentication Unit 3D Video Audio “L” Processor and shows the GSense 3D “L” Data Storage.
Element 70F describes GSense Prot2 Protect Anything Human Key Authentication Unit 3D Video Audio “L” Processor and shows the GSense Prot2 “L” Data Storage1.
Element 70G describes GSense Prot2 Protect Anything Human Key Auy^{˜}entication Unit 3D Video Audio “L” Processor and shows the GSense Prot2 “L” Data Storage2.
Element 70H describes GSense Prot2 Protect Anything Human Key Authentication Unit 3D Video Audio “L” Processor and shows where the L1 to L2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis audio Fourier wave form pattern analysis, and audio converted to image comparative analysis.
Element 70I describes GSense Prot2 Protect Anything Human Key Authentication Unit 3D Video Audio “L” Processor and shows the Protect Anything CODEFA mechanism that provides storage, security, human key and tracking features.
Element 70J describes GSense Prot2 Protect Anything Human Key Authentication Unit 3D Video Audio “L” Processor and shows where the WWW or World Wide Web is used for data aggregation and comparison analysis methods Hello, John! Computer Laptop, or Mobile device.

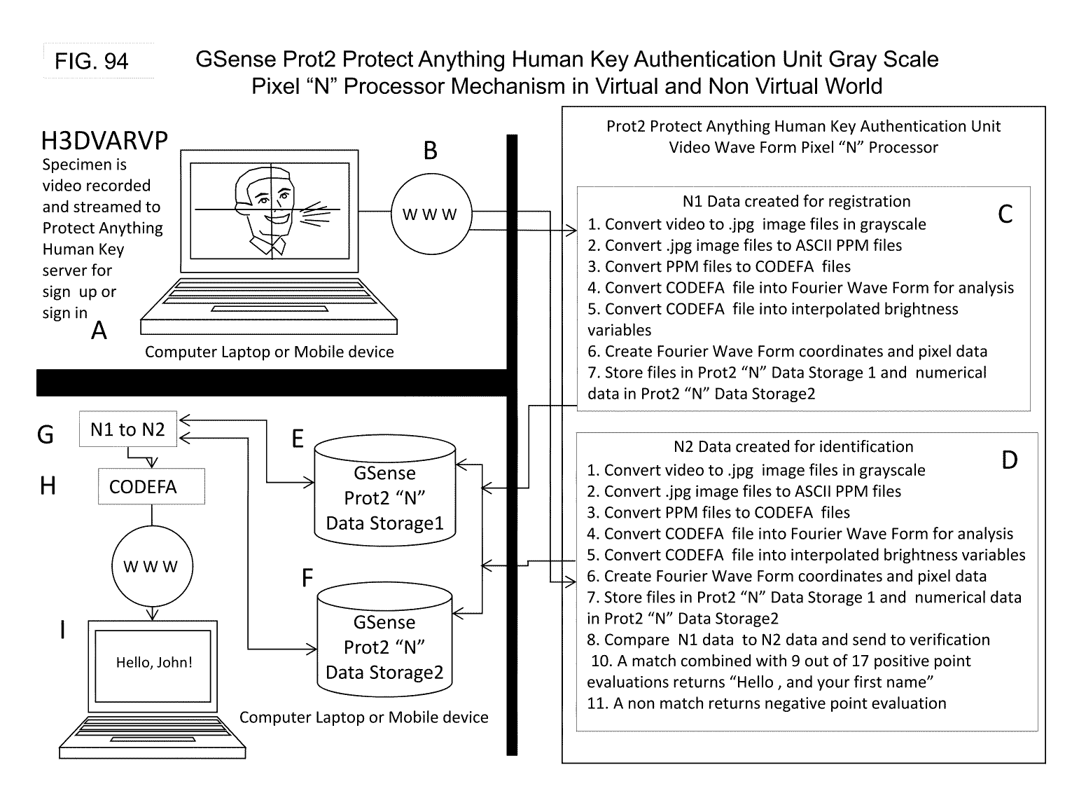

Now referring to FIG. 94, element 71A describes GSense Prot2 Protect Anything Human Key Authentication Unit Gray Scale Pixel “N” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 71B describes GSense Prot2 Protect Anything Human Key Authentication Unit Gray Scale Pixel “N” Processor Mechanism and shows where the WWW or World Wide Web is used for data aggregation and comparison analysis methods.
Element 71C describes GSense Prot2 Protect Anything Human Key Authentication Unit Gray Scale Pixel “N” Processor Mechanism and shows where the Prot2 Protect Anything Human Key Authentication Unit Video Fourier wave form. Pixel “N” Processor N1 Data created for registration, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage; security, human key and tracking features file into interpolated brightness variables, 6. Creates Fourier wave form coordinates and pixel data, 7. Stores files in Prot2 “N” Data Storage 1 and numerical data in Prot2 “N” Data Storage2.
Element 71D describes GSense Prot2 Protect Anything Human Key Authentication Unit Gray Scale Pixel “N” Processor Mechanism and shows where the Prot2 Protect Anything Human Key Authentication Unit Video Fourier wave form Pixel “N” Processor N2 Data created for identification, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “N” Data Storage 1 and numerical data in Prot2 “N” Data Storage2, 8. Compares N1 data to N2 data and send to verification, 10. Where a match combined with 9 out of 16 positive point evaluations returns “Hello, and your first name” 11. Where a non match returns negative point evaluation.
Element 71E describes GSense Prot2 Protect Anything Human Key Authentication Unit Gray Scale Pixel “N” Processor Mechanism and shows the GSense Prot2 “N” Data Storage 1.
Element 71F describes GSense Prot2 Protect Anything Human Key Authentication Unit Gray Scale Pixel “N” Processor Mechanism and shows the GSense Prot2 “N” Data Storage2.
Element 71G describes GSense Prot2 Protect Anything Human Key Authentication Unit Gray Scale Pixel “N” Processor Mechanism and shows where the N1 to N2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector o″,erlay pattern analysis, audio Fourier wave form pattern analysis, and audio converted to image comparative analysis.
Element 71H describes GSense Prot2 Protect Anything Human Key Authentication Unit Gray Scale Pixel “N” Processor Mechanism and shows the Protect Anything CODEFA mechanism that provides stor^{˜}ge, security, human key and tracking features.
Element 71I describes GSense Prot2 Protect Anything Human Key Authentication Unit Gray Scale Pixel “N” Processor Mechanism and shows where the WWW or World Wide Web is used for data aggregation and comparison analysis methods Hello, John! Computer Laptop or Mobile device.

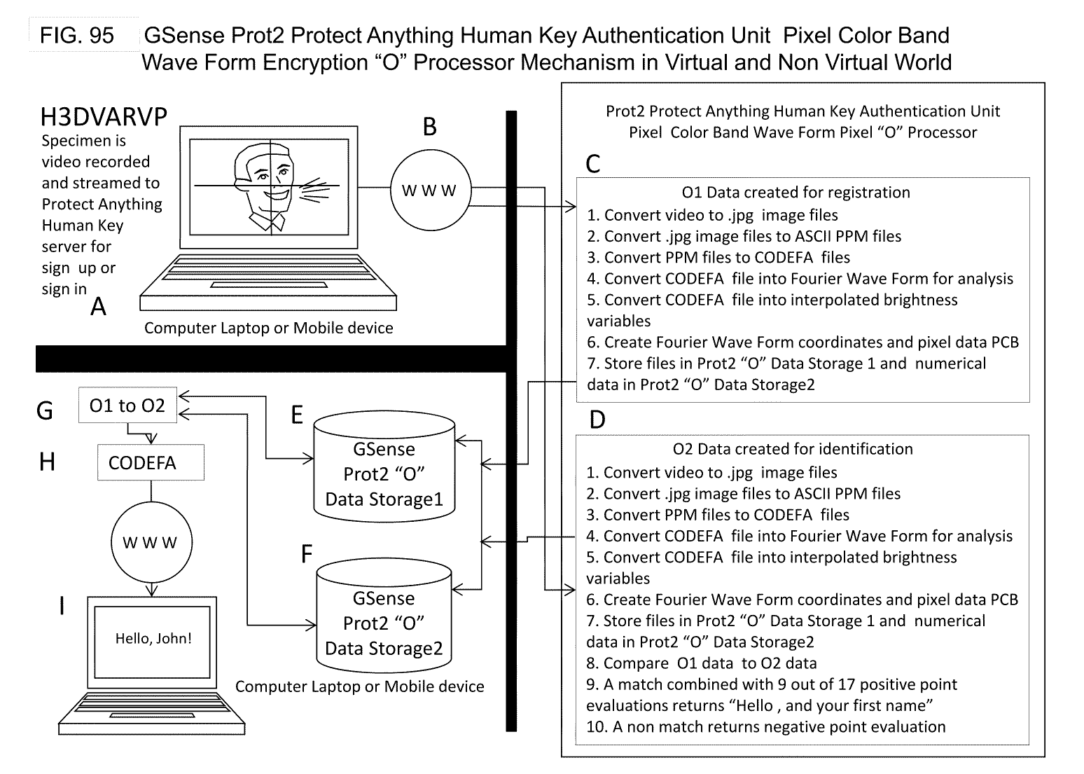

Now referring to FIG. 95, element 72A describes GSense Prot2 Protect Anything Human Key Authentication Unit Pixel Color Band Fourier wave form Encryption “Q” Area Processor Method and Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 72B describes GSense Prot2 Protect Anything Human Key Authentication Unit Pixel Color Band Fourier wave form Encryption “Q” Area Processor Method and Mechanism and shows where the WWW or World Wide Web is used for data aggregation and comparison analysis methods.
Element 72C describes GSense Prot2 Protect Anything Human Key Authentication Unit Pixel Color Band Fourier wave form Encryption “Q” Area Processor Method and Mechanism and shows where the Prot2 Protect Anything Human Key Authentication Unit Pixel Color Band Fourier wave form Pixel “Q” Processor Q1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data PCB, 7. Stores files in Prot2 “Q” Data Storage 1 and numerical data in Prot2 “Q” Data Storage2.
Element 72D describes GSense Prot2 Protect Anything Human Key Authentication Unit Pixel Color Band Fourier wave form Encryption “Q” Area Processor Method and Mechanism. and shows where the Prot2 Protect Anything Human Key Authentication Unit Pixel Color Band Fourier wave form Pixel “Q” Processor Q2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data PCB, 7. Stores files in Prot2 “Q” Data Storage 1 and numerical data in Prot2 “Q” Data Storage2, 8. Compares Q1 data to Q2 data, 9: Where a match combined with 9 out of 16 positive point evaluations returns “Hello, and your first name”, 10. Where a non match returns negative point evaluation.
Element 72E describes GSense Prot2 Protect Anything Human Key Authentication Unit Pixel Color Band Fourier wave form Encryption “Q” Area Processor Method and Mechanism and shows the GSense Prot2 “Q” Data Storage1.
Element 72F describes GSense Prot2 Protect Anything Human Key Authentication Unit Pixel Color Band Fourier wave form Encryption “Q” Area Processor Method and Mechanism and shows the GSense Prot2 “Q” Data Storage2.
Element 72G describes GSense Prot2 Protect Anything Human Key Authentication Unit Pixel Color Band Fourier wave form Encryption “Q” Area Processor Method and Mechanism and shows where the Q1 to Q2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 72H describes GSense Prot2 Protect Anything Human Key Authentication Unit Pixel Color Band Fourier wave form Encryption “Q” Area Processor Method and Mechanism and shows the Protect Anything CODEFA mechanism that provides storage, security, human key and tracking features.
Element 72I describes GSense Prot2 Protect Anything Human Key Authentication Unit ‘Pixel Color Band Fourier wave form Encryption “Q” Area Processor Method and Mechanism and shows where the WWW or World Wide Web is used for data aggregation and comparison analysis methods Hello, John! Computer Laptop or Mobile device.

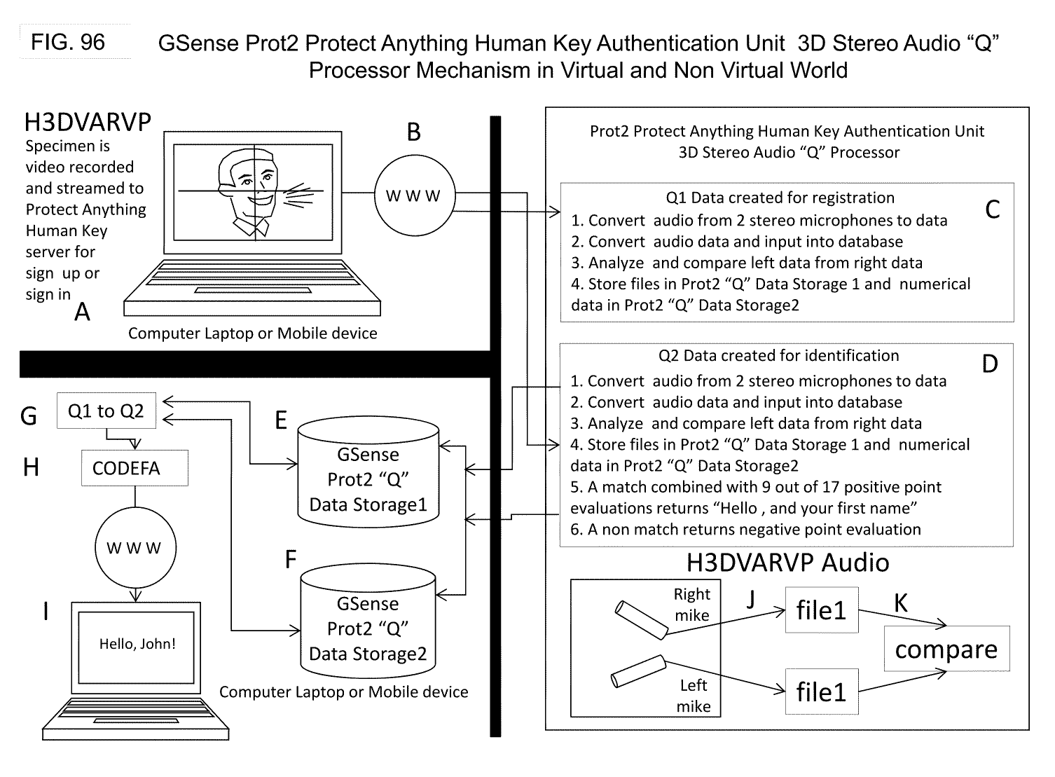

Now referring to FIG. 96, element 73A describes GSense Prot2 Protect Anything Human Key Authentication Unit 3D Stereo Audio “Q” Processor Mechanism with H3DVARV 3D Human Video Audio Stereo Viewing and Recording Mechanism and shows where the Specimen Video is recorded and streamed to Protect Anything Human Key server for sign up or sign in Computer Laptop or Mobile device.

Element 73B describes GSense Prot2 Protect Anything Human Key Authentication Unit 3D Stereo Audio “Q” Processor Mechanism and shows where the WWW or World Wide Web is used for data aggregation and comparison analysis methods.
Element 73C describes GSense Prot2 Protect Anything Human Key Authentication Unit 3D Stereo Audio “Q” Processor’ Mechanism and shows where the Prot2 Protect Anything Human Key Authentication Unit 3D Stereo Audio “Q” Processor Q1 Data created for registration, 1. Converts audio from 2 stereo microphones to data, 2. Converts audio data and input into database, 3. Analyzes and compares left data from right data, 4. Stores files in Prot2 “Q” Data Storage 1 and numerical data in Prot2 “Q” Data Storage2.’
Element 73D describes GSense Prot2 Protect Anything Human Key Authentication Unit 3D Stereo Audio “Q” Processor Mechanism and shows where the Prot2 Protect Anything Human Key Authentication Unit 3D Stereo Audio “Q” Processor Q2 Data created for identification, 1. Converts audio from 2 stereo microphones to data, 2. Converts audio data and input into database, 3. Analyzes and compares left data from right data, 4. Stores files in Prot2 “Q” Data Storage 1 and numerical data in Prot2 “Q” Data Storage2, 5. Where a match combined with 9 out of 16 positive point evaluation's returns “Hello, and your first name”, 6. Where a non match returns negative point evaluation.
Element 73E describes GSense Prot2 Protect Anything Human Key Authentication Unit 3D Stereo Audio “Q” Processor Mechanism and shows the GSense Prot2 “Q” Data Storage1.
Element 73F describes GSense Prot2 Protect Anything Human Key Authentication Unit 3D Stereo Audio “Q” Processor Mechanism and shows the GSense Prot2 “Q” Data Storage2.
Element 73G describes GSense Prot2 Protect Anything Human Key Authentication Unit 3D Stereo Audio “Q” Processor Mechanism and shows where the Q1 to Q2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 73H describes GSense Prot2 Protect Anything Human Key Authentication Unit 3D Stereo Audio “Q” Processor Mechanism and shows the Protect Anything CODEFA mechanism that provides storage, security, human key and tracking features.
Element 73I describes GSense Prot2 Protect Anything Human Key Authentication Unit 3D Stereo Audio “Q” Processor Mechanism and shows where the WWW or World Wide Web is used for data aggregation and comparison analysis methods Hello, John1 Computer Laptop, or Mobile device.
Element 73J describes GSense Prot2 Protect Anything Human Key Authentication Unit 3D Stereo Audio “Q” Processor Mechanism and shows where, the right microphone and left microphone creates and aggregates into separate files file 1 and file 2
Element 73K describes GSense Prot2 Protect Anything Human Key Authentication Unit Vector Line Overlay to Grid Form Pixel Analysis “M” Processor Mechanism with H3DVARV 3D Human Video Audio Stereo Viewing and Recording Mechanism and shows where the 2 3D Stereo audio files, file 1 and file 2 are overlaid and converted to pixel data and compared.

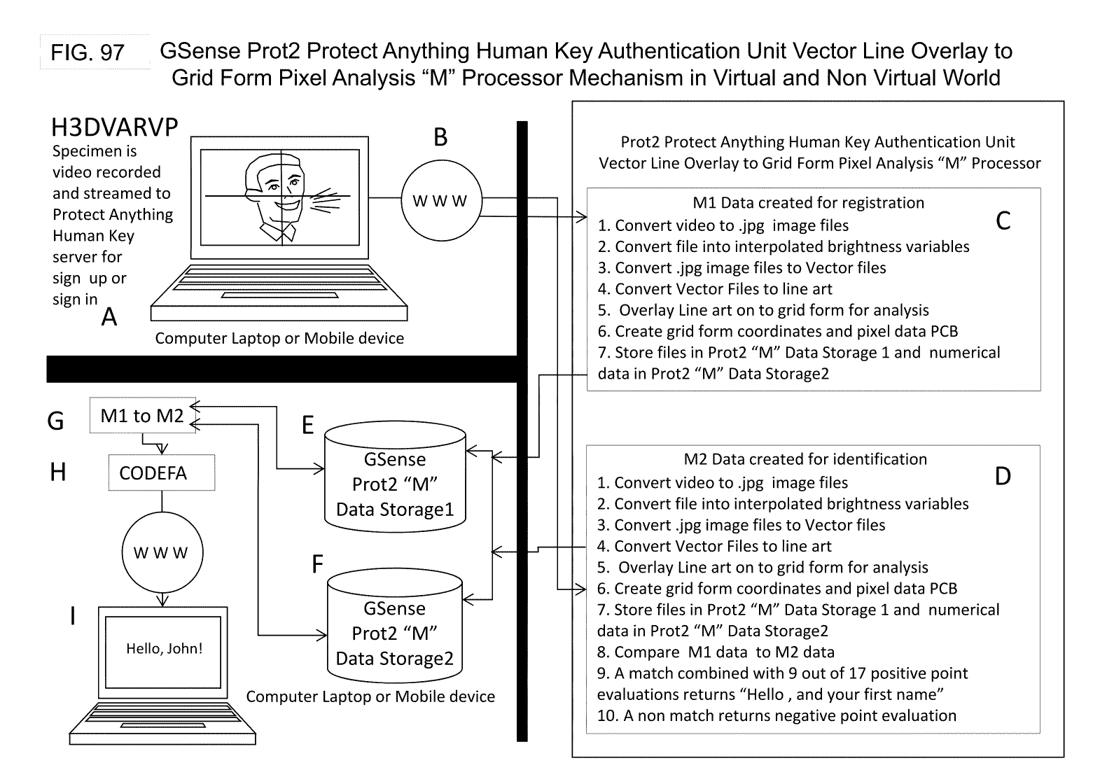

Now referring to FIG. 97, element 74A describes GSense Prot2 Protect Anything Human Key Authentication Unit Vector Line Overlay to Grid Form Pixel Analysis “M” Processor Mechanism with H3DVARV 3D Human Video Audio Stereo Viewing and Recording Mechanism′ and shows where the Specimen video is recorded and streamed to Protect Anything Human Key server for sign up or sign in Computer Laptop or Mobile device.

Element 74B describes GSense Prot2 Protect Anything Human Key Authentication Unit Vector Line Overlay to Grid Form Pixel Analysis “M” Processor Mechanism′ and shows where the WWW or World Wide Web is used for data aggregation and comparison analysis methods.
Element 74C describes GSense Prot2 Protect Anything Human Key Authentication Unit Vector Line Overlay to Grid Form Pixel Analysis “M” Processor Mechanism and shows where the Prot2 Protect Anything Human Key Authentication Unit Vector Line Overlay to Grid Form Pixel Analysis “M” Processor M1 Data created for registration, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “M” Data Storage 1 and numerical data in Prot2 “M” Data Storage2.
Element 74D describes GSense Prot2 Protect Anything Human Key Authentication Unit Vector Line Overlay to Grid Form Pixel Analysis “M” Processor Mechanism and shows where the Prot2 Protect Anything Human Key Authentication Unit Vector Line Overlay to Grid Form Pixel Analysis “M” Processor M2 Data created for identification, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “M” Data Storage 1 and numerical data in Prot2 “M” Data Storage2, 8. Compares M1 data to M2 data, 9. Where a match combined with 9′ out of 16 positive point evaluations returns “Hello, and your first name”, 10. Where a non match returns negative point evaluation.
Element 74E describes GSense Prot2 Protect Anything Human Key Authentication Unit Vector Line Overlay to Grid Form Pixel Analysis “Mil Processor Mechanism and shows the GSense Prot2 “M” Data Storage 1.
Element 74F describes GSense Prot2 Protect Anything Human Key Authentication Unit Vector Line Overlay to Grid Form Pixel Analysis “M” Processor Mechanism and shows the GSense Prot2 “M” Data Storage2.
Element 74G describes GSense Prot2 Protect Anything Human Key Authentication Unit Vector Line Overlay to Grid Form Pixel Analysis “M” Processor Mechanism and shows where the M1 to M2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 74H describes GSense Prot2 Protect Anything Human Key Authentication Unit Vector Line Overlay to Grid Form Pixel Analysis “M” Processor Mechanism and shows the Protect Anything CODEFA mechanism that provides storage, security, human key and tracking features.
Element 74I describes GSense Prot2 Protect Anything Human Key Authentication Unit Vector Line Overlay to Grid Form Pixel Analysis “M” Processor Mechanism and shows where the WWW or World Wide Web is used for data aggregation and comparison analysis methods Hello, John! Computer Laptop, or Mobile device.

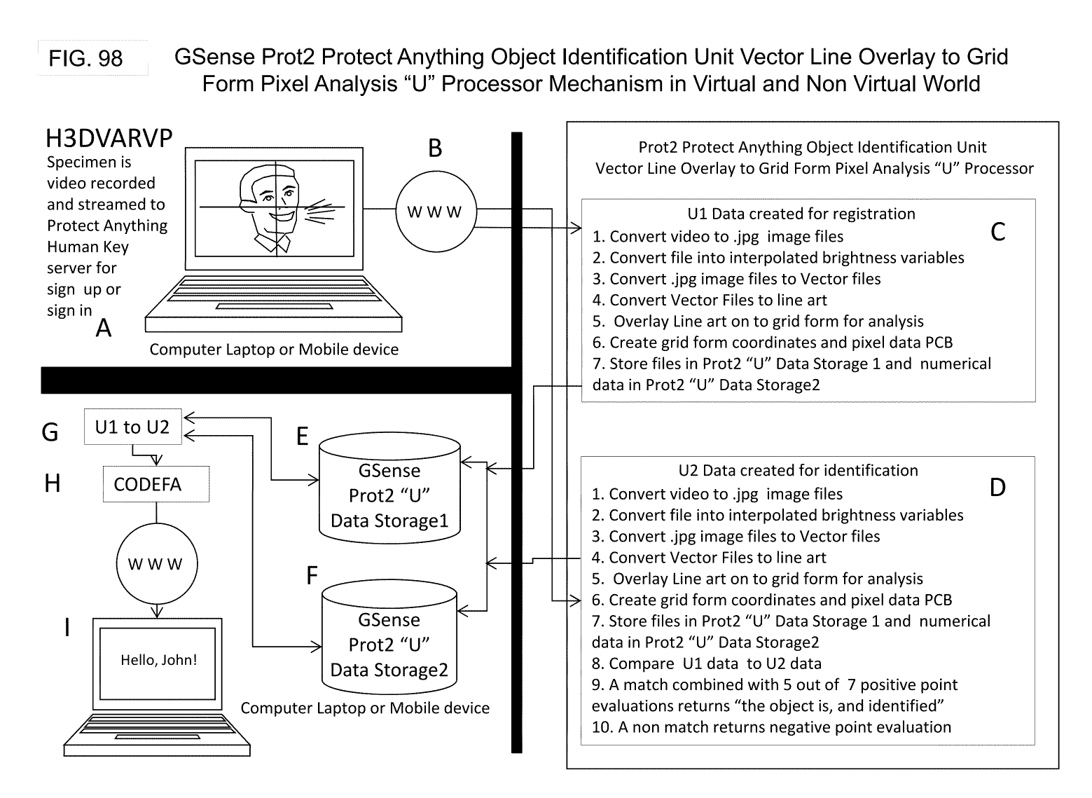

Now referring to FIG. 98, element 75A describes GSense Prot2 Protect Anything Object Identification Unit Vector Line Overlay to Grid Form Pixel Analysis “U” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 75B describes GSense Prot2 Protect Anything Object Identification Unit Vector Line Overlay to Grid Form Pixel Analysis “U” Processor Mechanism and shows where. the WWW or World Wide Web is used for data aggregation and comparison analysis methods.
Element 75C describes GSense Prot2 Protect Anything Object Identification Unit Vector Line Overlay to Grid Form Pixel Analysis “U” Processor Mechanism and shows where the Prot2 Protect Anything Object Identification Unit Vector Line Overlay to Grid Form Pixel Analysis “U” Processor U1 Data created for registration, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “U” Data Storage 1 and numerical data in Prot2 “U” Data Storage2.
Element 75D describes GSense Prot2 Protect Anything Object Identification Unit. Vector Line Overlay to Grid Form Pixel Analysis “U” Processor Mechanism and shows where the Prot2 Protect Anything Object Identification Unit Vector Line Overlay to Grid Form Pixel Analysis “U” Processor U2 Data created for identification, 1. Converts video to .jpg image files, 2. Converts file into interpolated brightness variables, 3. Converts .jpg image files to Vector files, 4. Converts Vector Files to line art, 5. Overlays Line art on to grid form for analysis, 6. Creates grid form coordinates and pixel data PCB, 7. Stores files in Prot2 “U” Data Storage 1 and numerical data in Prot2 “U” Data Storage2, 8. Compares U1 data to U2 data, 9. Where a match combined with 5 out of 7 positive point evaluations returns “the object is, and identified”, 10. Where a non match returns negative point evaluation.
Element 75E describes GSense Prot2 Protect Anything Object Identification Unit Vector Line Overlay to Grid Form Pixel Analysis “U” Processor Mechanism and shows the GSense Prot2 “U” Data Storage 1.
Element 75F describes GSense prot2 Protect Anything Object Identification Unit Vector Line Overlay to Grid Form Pixel Analysis “U” Processor Mechanism and shows the GSense Prot2 “U” Data Storage2.
Element 75G describes GSense Prot2 Protect Anything Object Identification Unit Vector Line Overlay to Grid Form Pixel Analysis “U”, Processor Mechanism and shows where the U1 to U2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 75H describes GSense Prot2 Protect Anything Object Identification Unit Vector Line Overlay to Grid Form Pixel Analysis “U” Processor Mechanism and shows the Protect Anything CODEFA mechanism that provides storage, security, human key and tracking features.
Element 75I describes GSense Prot2 Protect Anything Object Identification Unit Vector Line Overlay to Grid Form Pixel Analysis “U” Processor Mechanism and shows where the WWW or World Wide Web is used for data aggregation and comparison analysis methods Hello, John! Computer Laptop, or Mobile device.

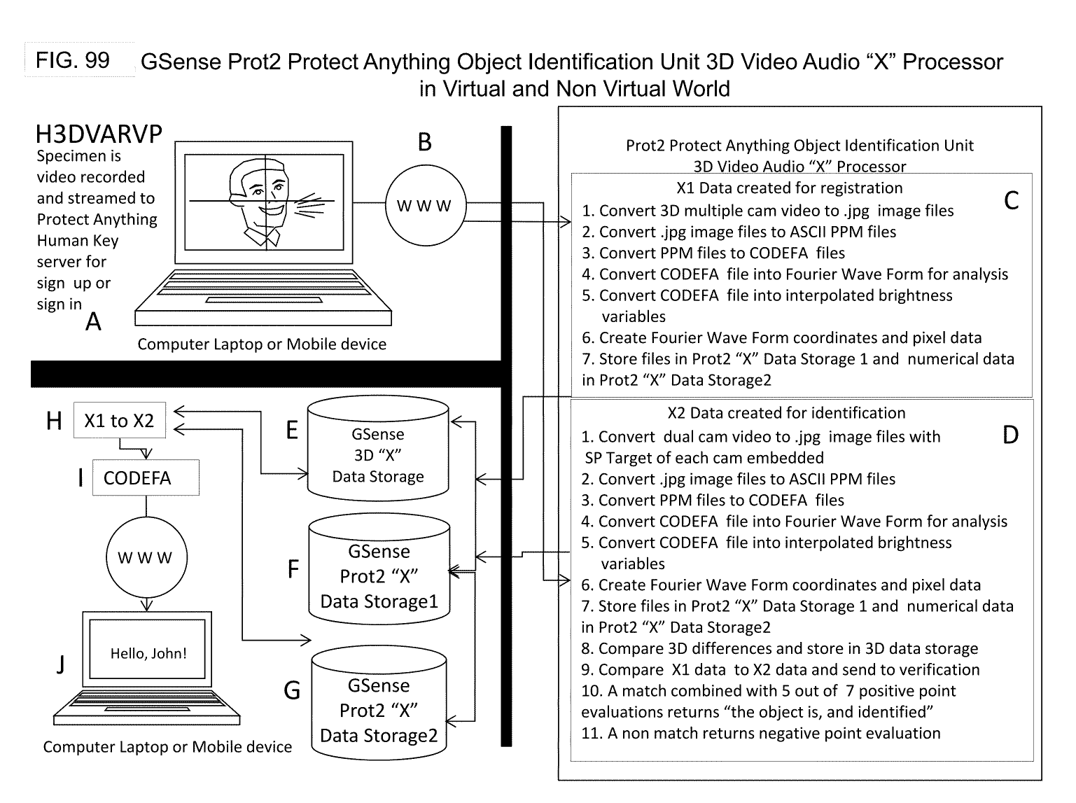

Now referring to FIG. 99, element 76A describes GSense Prot2 Protect Anything Object Identification Unit 3D Video Audio “X” Processor, with H30VARV 3D Human Video Audio Stereo Viewing and Recording Mechanism, and shows where the Specimen video is recorded and streamed to Protect Anything Human Key server, for sign up, or sign in Computer Laptop or Mobile device.

Element 76B describes GSense Prot2 Protect Anything Object Identification Unit 3D Video Audio “X” Processor and shows where the WWW or World Wide Web is used for data aggregation. and comparison analysis methods.
Element 76C describes GSense Prot2 Protect Anything Object Identification Unit 3D Video Audio “X” Processor and shows where the Prot2 Protect Anything Object Identification Unit 30 Video Audio “X” Processor X1 Data created for registration, 1. Converts 3D multiple cam video to .jpg image files, 2. Converts .jpg image files to ASCII PPM files, 3. Converts PPM files to Protect Anything COOEFA mechanism that provides storage, security, human key and tracking features files, 4. Converts Protect Anything COOEFA mechanism that provides storage, security, human key and tracking features file into Fourier wave form for analysis, 5. Converts Protect Anything COOEFA mechanism that provides storage, security, human key and tracking features file into interpolated brightness variables, 6. Creates Fourier wave form coordinates and pixel data, 7. Stores files in Prot2 “X” Data Storage 1 and numerical data in Prot2 “X” Data Storage2.
Element 76D describes GSense Prot2 Protect Anything Object Identification Unit 3D Video Audio “X” Processor and shows where the Prot2 Protect Anything Object Identification Unit 3D Video Audio “X” Processor X2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “X” Data Storage 1 and numerical data in Prot2 “X” Data Storage2, 8. Compares 3D differences and store in 3D data storage, 9. Compares X1 data to X2 data and send to verification, 10. Where a match combined with 5 out of 7 positive point evaluations returns “the object is, and identified”.11. Where a non match returns negative point evaluation.
Element 76E describes GSense Prot2 Protect Anything Object Identification Unit 3D Video Audio “X” Processor and shows the GSense 3D “X” Data Storage.
Element 76F describes GSense ‘Prot2 Protect Anything Object Identification Unit 3D Video Audio “X” Processor and shows the GSense Prot2 “X” Data Storage 1.
Element 76G describes GSense Prot2 Protect Anything Object Identification Unit 3D Video Audio “X” Processor and shows the GSense Prot2 “X” Data Storage2.
Element 76H describes GSense Prot2 Protect Anything Object Identification Unit 3D Video Audio “X” Processor and shows where the X1, to X2 Pattern matching and Comparison Processor-Mechanism analyzes the data utilizing one or all of these analysis mechanisms including maximum distance analysis, mean distance analysis, ‘mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 76I describes GSense Prot2 Protect Anything Object Identification Unit 3D Video Audio “X” Processor and shows the Protect Anything CODEFA mechanism that provides storage, security, human key and tracking features.
Element 76J describes GSense Prot2 Protect Anything Object Identification Unit 3D Video Audio “X” Processor and shows where the WWW or World Wide Web is used for data aggregation and comparison analysis methods Hello, John! Computer Laptop, or Mobile device.

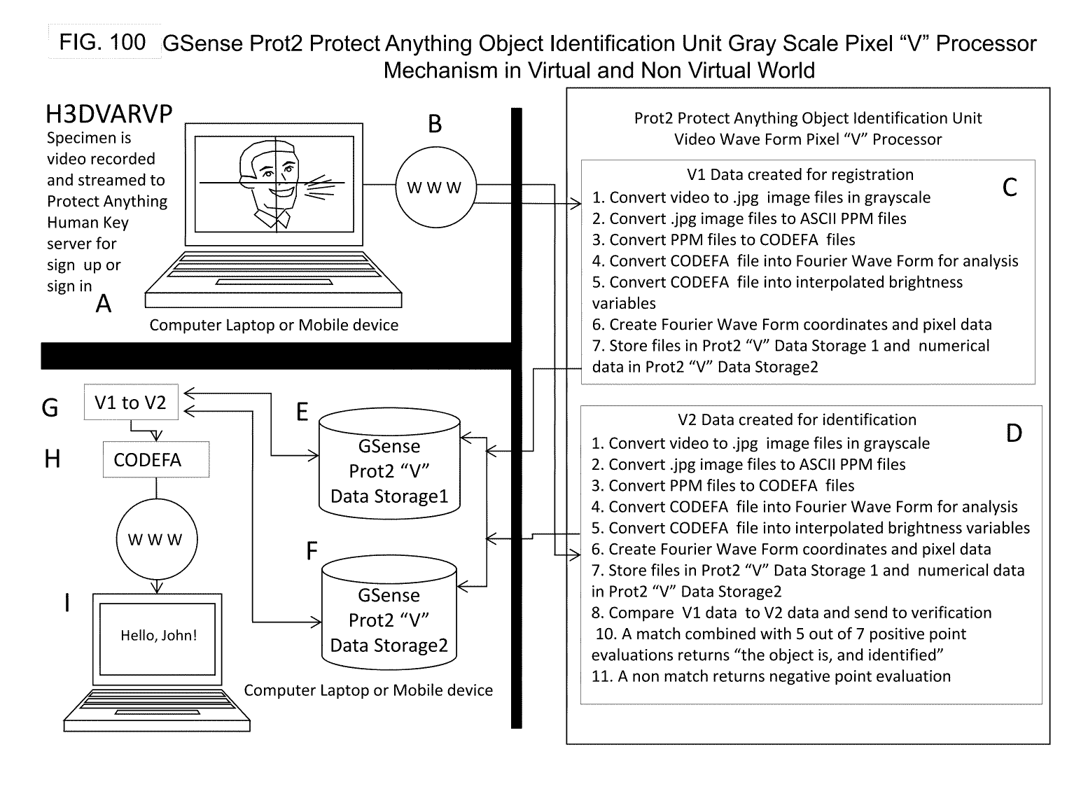

Now referring to FIG. 100, element 77A describes GSense Prot2 Protect Anything Object Identification Unit Gray Scale Pixel “V” Processor Mechanism with H3DVARV 3D Human Video Audio Stereo Viewing and Recording Mechanism and shows where the Specimen video is recorded and streamed to Protect Anything Human Key server for sign up or sign in Computer, Laptop or Mobile device.

Element 77B describes GSense Prot2 Protect Anything Object Identification Unit Gray Scale Pixel “V” Processor Mechanism and shows where the WWW or World Wide Web is used for data aggregation and comparison analysis methods.
Element 77C describes GSense Prot2 Protect Anything Object Identification Unit Gray Scale Pixel “V” Processor Mechanism and shows where the Prot2 Protect Anything Object Identification Unit Video Fourier wave form Pixel “V” Processor V1 Data created for registration, 1. Converts video to .jpg image files in grayscale, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “V” Data Storage 1 and numerical data in Prot2 “V” Data Storage2.
Element 77D describes GSense Prot2 Protect Anything Object Identification Unit Gray Scale Pixel “V” Processor Mechanism and shows where the Prot2 Protect Anything Object Identification Unit Video Fourier wave form Pixel “V” Processor V2 Data created for identification, 1. Converts video to .jpg image files'in grayscale, 2. Converts .jpg image files to ASCII PPM flies, 3. Converts PPM files to Protect, Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files, in Prot2 “V” Data Storage 1 and numerical data in Prot2 “V” Data Storage2, 8. Compares V1 data to V2 data and send to verification, 10. Where a match combined with 5 out of, 7 positive point evaluations returns “the object is, and identified” 11. Where a non match returns negative point evaluation.
Element 77E describes GSense Prot2 Protect Anything Object Identification Unit Gray Scale Pixel “V” Processor Mechanism and shows the GSense Prot2 “V” Data Storage 1.
Element 77F describes GSense Prot2 Protect Anything Object Identification Unit Gray Scale Pixel “V” Processor Mechanism and shows the GSense Prot2 “V” Data Storage2.
Element 77G describes GSense Prot2 Protect Anything Object Identification Unit Gray Scale Pixel “V” Processor Mechanism and shows where the V1 to V2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 77H describes GSense Prot2 Protect Anything Object Identification Unit Gray Scale Pixel “V” Processor Mechanism and shows the Protect Anything CODEFA mechanism that provides storage, security, human key and tracking features.
Element 77I describes GSense Prot2 Protect Anything Object Identification Unit Gray Scale Pixel “V” Processor Mechanism and shows’ where the WWW or World Wide Web is used for data aggregation and comparison analysis methods Hello, John! Computer Laptop, or Mobile ‘device.

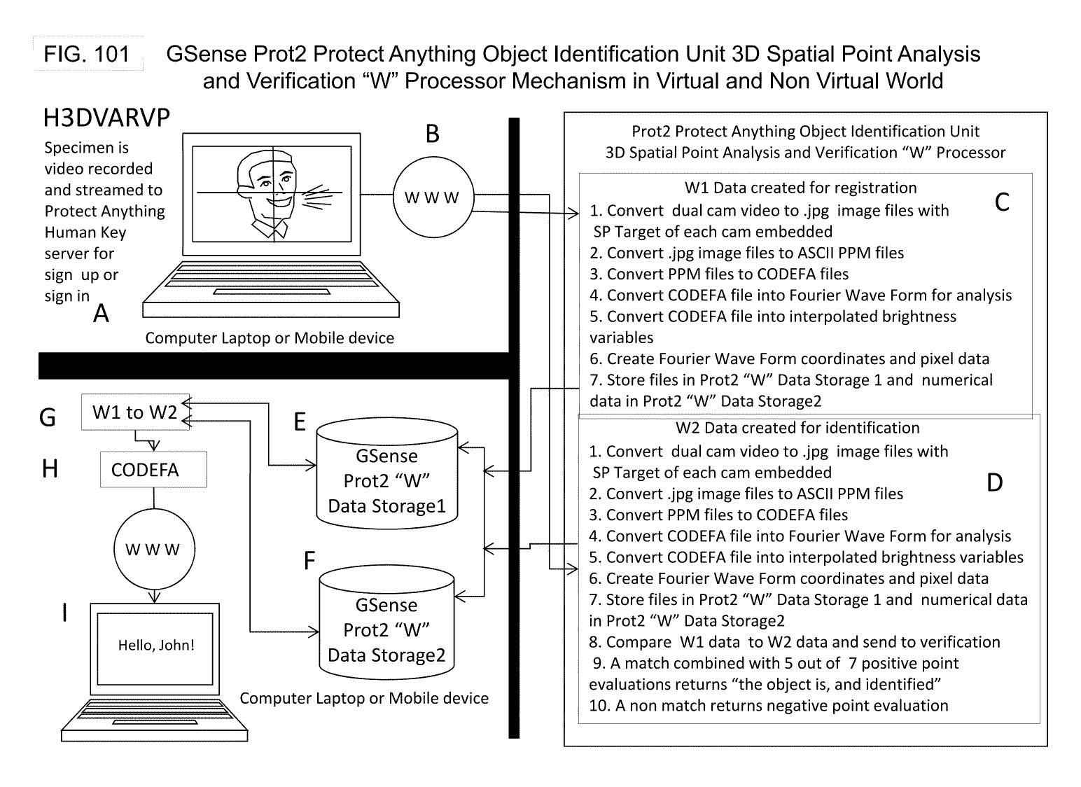

Now referring to FIG. 101, element 78A describes GSense Prot2 Protect Anything Object Identification Unit 3D Spatial Point Analysis and Verification “W” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 78B describes GSense Prot2 Protect Anything Object Identification Unit 3D Spatial Point Analysis and Verification “W” Processor Mechanism and shows where the WWW or World Wide Web is used for data aggregation and comparison analysis methods.
Element 78C describes GSense Prot2 Protect Anything Object Identification Unit 3D Spatial Point Analysis and Verification “W” Processor Mechanism and shows where the Prot2 Protect Anything Object Identification Unit3D Spatial Point Analysis and Verification “W” Processor W1 Data created for registration, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “W” Data Storage 1 and numerical data in Prot2 “W” Data Storage2.
Element 78D describes GSense Prot2 Protect Anything Object Identification Unit 3D Spatial Point Analysis and Verification “W” Processor Mechanism and shows where the Prot2 Protect Anything Object Identification Unit3D Spatial Point Analysis and Verification “W” Processor W2 Data created for identification, 1. Converts dual cam video to .jpg image files with SP Target of each cam embedded, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “W” Data Storage 1 and numerical data in Prot2 “W” Data Storage2, 8. Compares W1 data to W2 data and send to verification, 9. Where a match combined with 5 out of 7 positive point evaluations returns “the object is, and identified”, 10. Where a non match returns negative point evaluation.
Element 78E describes GSense Prot2 Protect Anything Object Identification Unit 3D Spatial Point Analysis and Verification “W” Processor Mechanism and shows the GSense Prot2 “W” Data Storage 1.
Element 78F describes GSense Prot2 Protect Anything Object Identification Unit 3D Spatial Point Analysis and Verification “W” Processor Mechanism and shows the GSense Prot2 “W” Data Storage2.
Element 78G describes GSense Prot2 Protect Anything Object Identification Unit 3D Spatial Point Analysis and Verification “W” Processor Mechanism and shows where the W1 to W2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 78H describes GSense Prot2 Protect Anything Object ‘Identification Unit 30 Spatial Point Analysis and Verification ‘W” Processor Mechanism and shows the Protect Anything CODEFA mechanism that provides storage, security, human key and tracking features.
Element 78I describes GSense Prot2 Protect Anything Object Identification Unit 3D Spatial Point Analysis and Verification “W” Processor Mechanism and shows where the WWW or World Wide Web is used for data aggregation and comparison analysis methods Hello, John! Computer Laptop, or Mobile device.

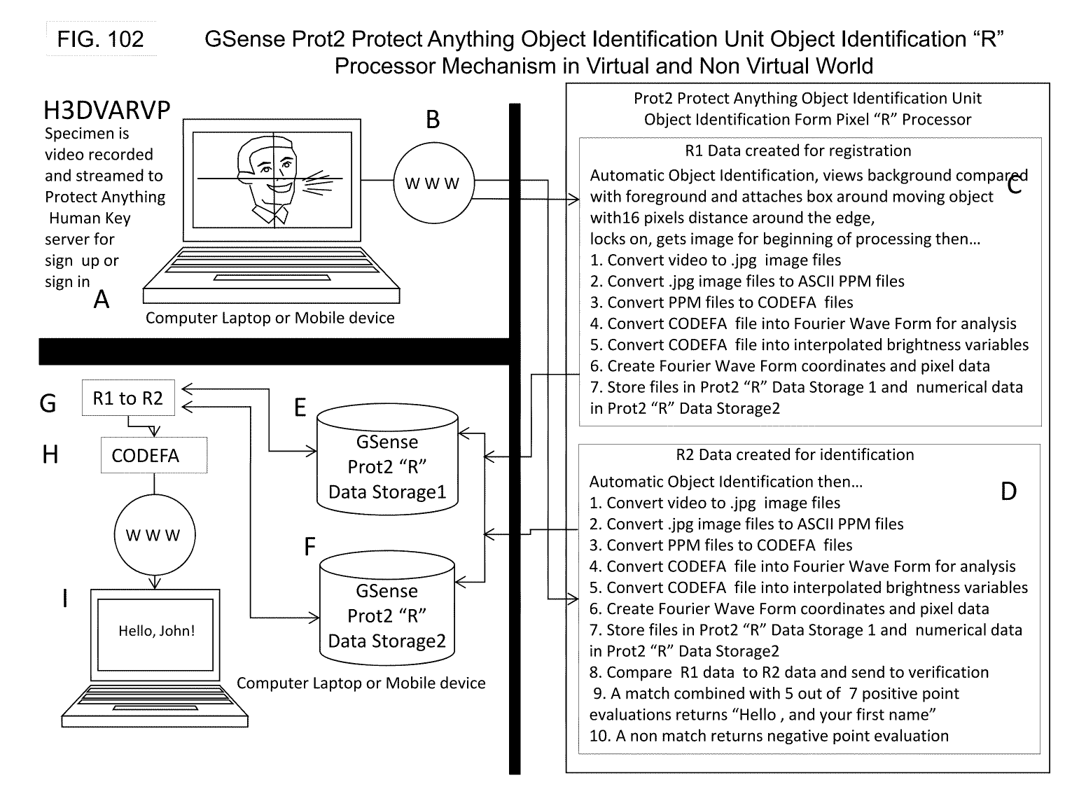

Now referring to FIG. 102, element 79A describes GSense Prot2 Protect Anything Object Identification Unit Object Identification “r” Processor Mechanism with H30VARV 3D Human Video Audio Stereo Viewing and Recording Mechanism and shows where the Specimen video is recorded and streamed to Protect Anything Human Key server for sign up or sign in Computer Laptop or Mobile device.

Element 79B describes GSense Prot2 Protect Anything Object Identification Unit Object Identification “R” Processor Mechanism and shows where the WWW or World Wide Web is used for data aggregation and comparison analysis methods.
Element 79C describes GSense Prot2 Protect Anything Object Identification Unit Object Identification “R” Processor Mechanism and shows where the Prot2 Protect Anything Object Identification Unit Object Identification Form Pixel “R” Processor R1 Data created for registration Automatic Object Identification, views background compared with foreground and attaches box around moving object with 16 pixels distance around the edge, locks on, gets image’ for beginning of processing then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “R” Data Storage 1 and numerical data in Prot2 “R” Data Storage2.
Element 79D describes GSense Prot2 Protect Anything Object Identification Unit Object Identification “R” Processor Mechanism and shows where the Prot2 Protect Anything Object Identification Unit Object Identification Form Pixel “R” Processor R2 Data created for identification Automatic Object Identification then, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “R” Data Storage 1 and numerical data in Prot2 “R” Data Storage2, 8. Compares R1 data to R2 data and send to verification, 9. Where a match combined with 5 out of 7 positive point evaluations returns “the object is, and identified”, 10. Where a non match returns negative point evaluation.
Element 79E describes GSense Prot2 Protect Anything Object Identification Unit Object Identification “R” Processor Mechanism and shows the GSense Prot2 “R” Data Storage1.
Element 79F describes GSense Prot2 Protect Anything Object Identification Unit Object Identification “R” Processor Mechanism and shows the GSense Prot2 “R” Data Storage2.
Element 79G describes GSense Prot2 Protect Anything Object Identification Unit Object Identification “R” Processor Mechanism and shows where the R1 to R2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 79H describes GSense Prot2 Protect Anything Object Identification Unit Object Identification “R” Processor Mechanism and shows the Protect Anything CODEFA mechanism that provides storage, security, human key and tracking features.
Element 79I describes GSense Prot2 Protect Anything Object Identification Unit Object Identification “R” Processor Mechanism and shows where the WWW or World Wide Web is used for data aggregation and comparison analysis methods Hello, John! Computer Laptop, or Mobile device.

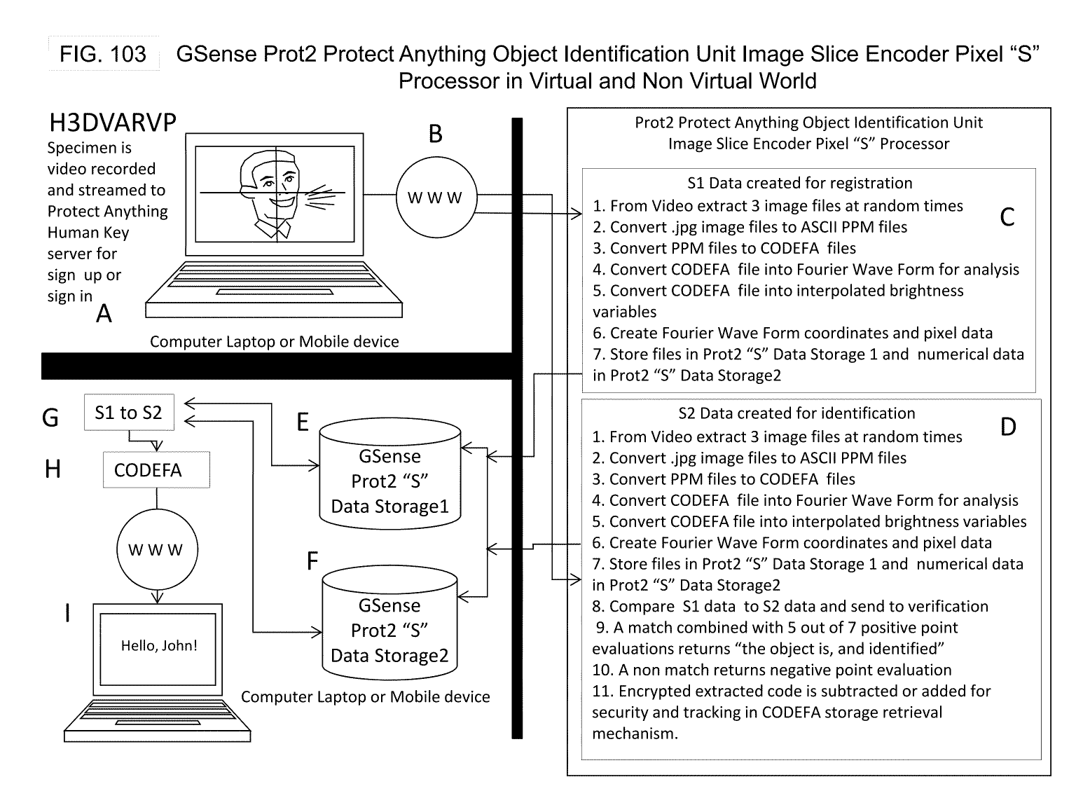

Now referring to FIG. 103, element 80A describes GSense Prot2 Protect Anything Object Identification Unit Image Slice Encoder Pixel “S” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 80B describes GSense Prot2 Protect Anything Object Identification Unit Image Slice Encoder Pixel “S” Processor and shows where the WWW or World Wide Web is used for data aggregation and comparison analysis methods.
Element 80C describes GSense Prot2 Protect Anything Object Identification Unit Image Slice Encoder Pixel “S” Processor and shows where the Prot2 Protect Anything Object Identification Unit Image Slice Encoder Pixel “S” Processor 81 Data created for registration, 1. From Video extracts 3 image files at random times, 2. Converts .jpg image files, to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “S” Data Storage 1 and numerical data in Prot2 “S” Data Storage2.
Element 80D describes GSense Prot2 Protect Anything Object Identification Unit Image Slice Encoder. Pixel “S” Processor and shows where the Prot2 Protect Anything Object Identification Unit Image Slice Encoder Pixel “S” Processor S2 Data created for identification, 1. From Video extracts 3 image files at random times, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Stores files in Prot2 “s” Data Storage 1 and numerical data in Prot2 “S” Data Storage 2, 8. Compares s1 data-to S2 data and send to verification, 9. Where a match combined with 5 out of 7 positive point evaluations returns “the object is, and identified”, 10. Where a non match returns negative point evaluation, 11. Where encrypted extracted code is subtracted or added for security and tracking in the Protect Anything CODEFA mechanism that provides storage, security, human key and tracking features storage retrieval mechanism.
Element 80E describes GSense Prot2 Protect Anything Object identification Unit Image Slice Encoder Pixel “S” Processor and shows the GSense Prot2 “S” Data Storage1.
Element 80F describes GSense Prot2 Protect Anything Object Identification Unit Image Slice Encoder Pixel “S” Processor and shows the GSense Prot2 “S” Data Storage2.
Element 80G describes GSense Prot2 Protect Anything Object Identification Unit Image Slice Encoder Pixel “S” Processor and shows where the S1 to S2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 80H describes GSense Prot2 Protect Anything Object Identification Unit Image Slice Encoder Pixel “S” Processor and shows the Protect Anything CODEFA mechanism that provides storage, security, human key and tracking features.
Element 80I describes GSense Prot2 Protect Anything Object Identification Unit Image Slice Encoder Pixel “S” Processor and shows where the WWW or World Wide Web is used for data aggregation and comparison analysis methods Hello, John! Computer Laptop or Mobile device.

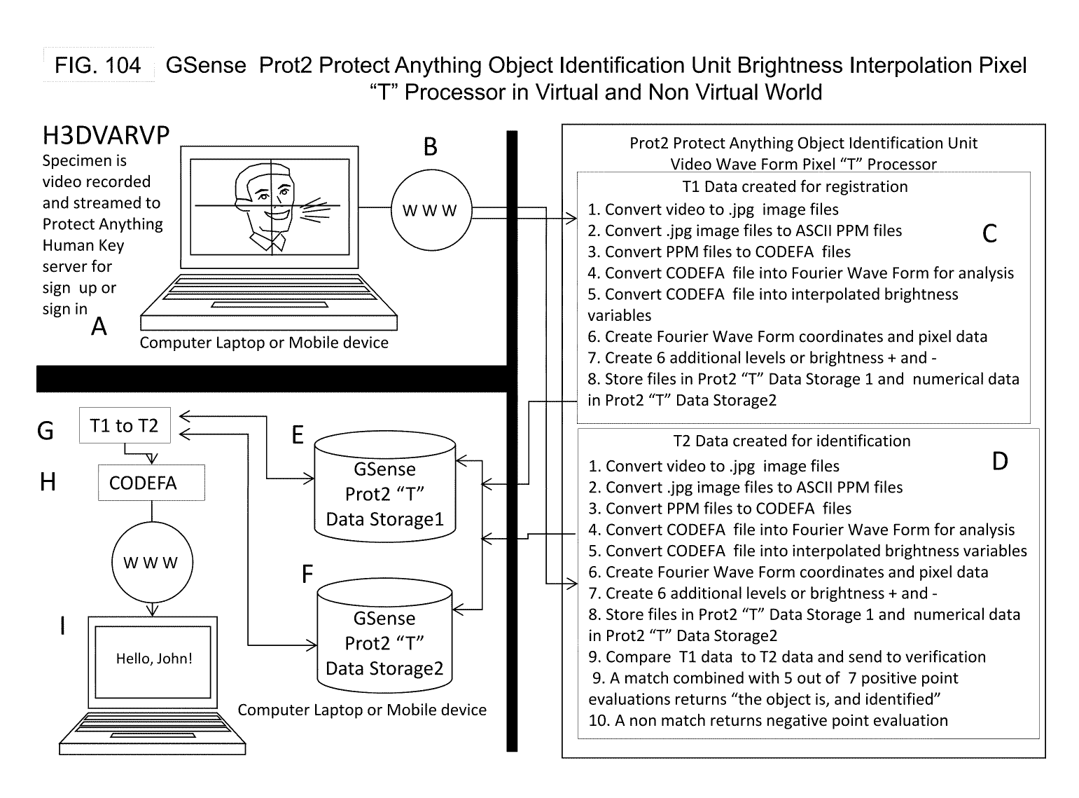

Now referring to FIG. 104, element 81A describes GSense Prot2 Protect Anything Object Identification Unit Brightness Interpolation Pixel “T” Processor with H3DVARV 3D Human Video Audio Stereo Viewing and Recording Mechanism and shows where the Specimen video is recorded and streamed to Protect Anything Human Key server for sign up or sign in Computer Laptop or Mobile device.

Element 81B describes GSense Prot2 Protect Anything Object Identification Unit Brightness Interpolation Pixel “T” Processor and shows where the WWW or World Wide Web is used for data aggregation and comparison analysis methods.
Element 81C describes GSense Prot2 Protect Anything Object Identification Unit Brightness Interpolation Pixel “T” Processor and shows where the Prot2 Protect Anything Object Identification Unit Video Fourier wave form Pixel “T” Processor T1 Data created for registration, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Creates 6 additional levels or brightness + and −, 8. Stores files in Prot2 “T” Data Storage 1 and numerical data in Prot2 “T” Data Storage2.
Element 81D describes GSense Prot2 Protect Anything Object Identification Unit Brightness Interpolation Pixel “T” Processor and shows where the Prot2 Protect Anything Object Identification Unit Video Fourier wave form Pixel “T” Processor T2 Data created for identification, 1. Converts video to .jpg image files, 2. Converts .jpg image files to ASCII PPM files, 3. Converts PPM files to Protect Anything CODEFA mechanism that provides storage, security, human key and tracking features files, 4. Converts Protect Anything CODEFA mechanism that provides storage, security, human key and tracking features file into Fourier wave form for analysis, 5. Converts Protect Anything CODEFA mechanism that provides storage, security, human key and tracking features file into interpolated brightness variables, 6. Creates Fourier wave form coordinates and pixel data, 7. Creates 6 additional levels or brightness + and −, 8. Stores files in Prot2 “T” Data Storage 1 and numerical data in Prot2 “T” Data Storage 2, 9. Compares T1 data to T2 data and send to verification, 9. Where a match combined with 5 out of 7 positive point evaluations returns “the object is, and identified”, 10. Where a non match returns negative point evaluation.
Element 81E describes GSense Prot2 Protect Anything Object Identification Unit Brightness Interpolation Pixel “T” Processor and shows the GSense Prot2 “T” Data Storage1.
Element 81F describes GSense Prot2 Protect Anything Object Identification Unit Brightness Interpolation Pixel “T” Processor and shows the GSense Prot2 “‘T” Data Storage2.
Element 81G describes GSense Prot2 Protect Anything Object Identification Unit Brightness Interpolation Pixel “T” Processor and shows where the T1 to T2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio Fourier wave form pattern analysis, and audio converted to image comparative analysis.
Element 81H describes. GSense Prot2 Protect Anything Object Identification Unit Brightness Interpolation Pixel “T” Processor and shows the Protect Anything CODEFA mechanism that provides storage, security, human key and tracking features.
Element 81I describes GSense Prot2 Protect Anything Object Identification Unit Brightness Interpolation Pixel “T” Processor and shows where the WWW or World Wide Web is used for data aggregation and comparison analysis methods “Hello, John” with a Computer Laptop, or Mobile device.

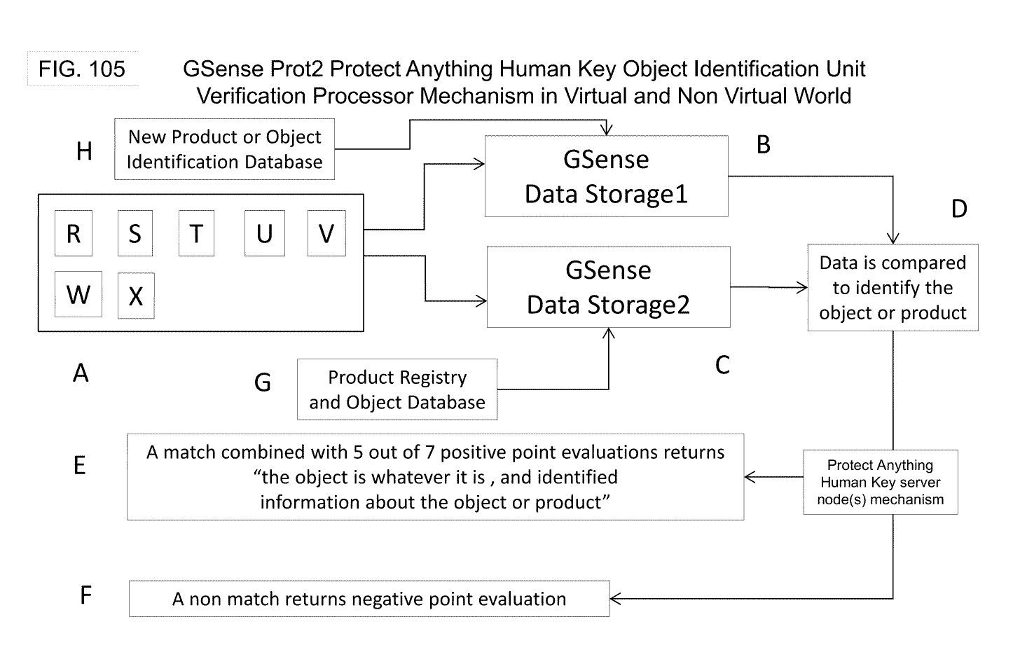

Now referring to FIG. 105, element 82A describes GSense Prot2 Protect Anything Object Identification Unit Verification Processor Mechanism where the R, S, T, U, V, W, X object identification processors are used to compare the product registry and objects database data with the new product or object identification database for possible matches.

Element 82B describes GSense Prot2 Protect Anything Object Identification Unit Verification Processor Mechanism GSense Data Storage 1 area with new product or object identification database.
Element 82C describes GSense Prot2 Protect Anything Object Identification Unit Verification Processor Mechanism GSense Data Storage 2 area with pre entered product registry and object database data.
Element 82D describes GSense Prot2 Protect Anything Object Identification Unit Verification Processor Mechanism is where data is compared to identify the object or the product.
Element 82E describes GSense Prot2 Protect Anything Object Identification Unit Verification Processor Mechanism where a match combined with 5 out of 7 positive point evaluations returns “the object is whatever it is, and identified information about the object or product”.
Element 82F describes GSense Prot2 Protect Anything Object Identification Unit Verification Processor Mechanism where a non match returns negative point evaluation.
Element 82G describes GSense Prot2 Protect Anything Object Identification Unit Verification Processor Mechanism Product Registry and Object Database.
Element 82H describes GSense Prot2 Protect Anything Object Identification Unit Verification Processor Mechanism the New Product or Object identification Database.

Now referring to FIG. 106, element 21A describes the, Protect Anything Human Key 3D Audio Video Color Band Encryption De-Encryption Security System with H3DVARV 3D Human Video Audio Stereo Viewing and Recording Mechanism where a person speaks.

Element 21B describes the Protect Anything Human Key 3D Audio Video Color Band Encryption De-Encryption Security System with H3DVARV 3D Human Video Audio Stereo Viewing and Recording Mechanism cams.
Element 21C describes the Protect Anything Human Key 3D Audio Video Color Band Encryption De-Encryption Security System with H3DV ARV 3D Human Video Audio Stereo Viewing and Recording Mechanism where crosshairs target the tip of the human's nose.
Element 21D describes the Protect Anything Human Key 3D Audio Video Color Band Encryption De-Encryption Security System with H3DVARV 3D Human Video Audio Stereo Viewing and Recording Mechanism where the mechanism automatically does 16 tests and creates pixel color band array converted to position numbers.
Element 21E describes the Protect Anything Human Key 3D Audio Video Color Band Encryption De-Encryption Security System with H3DVARV 3D Human Video Audio Stereo Viewing and Recording Mechanism where the red, green, and blue is converted to numbers.
Element 21F describes the Protect Anything Human Key 3D Audio Video Color Band Encryption De-Encryption Security System with H3DVARV 3D Human Video Audio Stereo Viewing and Recording Mechanism where the shades of lightness or darkness always in the same live range during conversion with mechanisms algorithm.
Element 21G describes the Protect Anything Human Key 3D Audio Video Color Band Encryption De-Encryption Security System with H3DVARV 3D Human Video Audio Stereo Viewing and Recording Mechanism where the flash produces tighter range during recognition.
Element 21H describes the Protect Anything Human Key 3D Audio Video Color Band Encryption De-Encryption Security System with H3DVARV 3D Human Video Audio Stereo Viewing and Recording Mechanism where then the final numbers are compared with wavelength Fourier wave form 3-D analysis, audio fingerprint, video fingerprint, and a 100% match is obtained for identification.

The 21I describes the Protect Anything Human Key 3D Audio Video Color Band Encryption De-Encryption Security System with H3DVARV 3D Human Video Audio Stereo Viewing and Recording Mechanism where the wavelength data is created into encrypted numbers, stored in database and then decrypted for identification.

Element 21J describes the Protect Anything Human Key 3D Audio Video Color Band Encryption De-Encryption Security System with H3DVARV 3D Human Video Audio Stereo. Viewing and Recording Mechanism is utilized with mobile device, laptop or computer.
Element 21K describes the Protect Anything Human Key 3D Audio Video Color Band Encryption De-Encryption Security System with H3DVARV 3D Human Video Audio Stereo Viewing and Recording Mechanism where is utilizing in bank ATM with 3D cams and 3D Stereo Microphones.

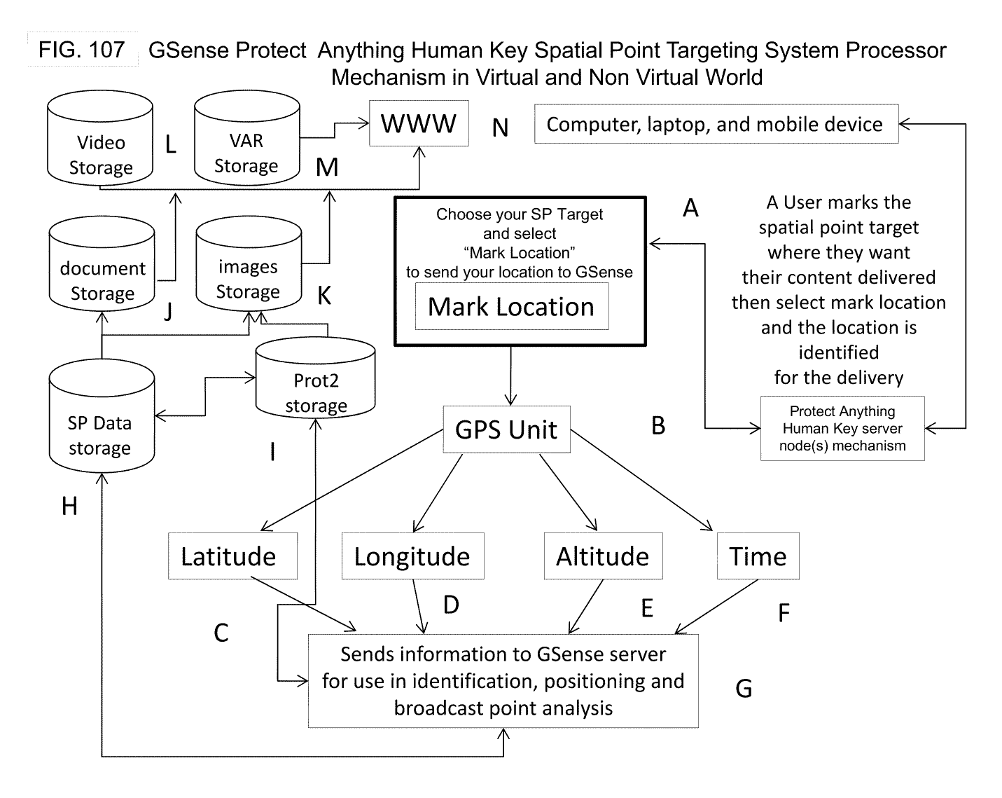

Now referring to FIG. 107, element 83A describes GSense Protect Anything Spatial Point Targeting System Processor Mechanism and shows where A user marks the spatial point target, or targets where they want their content delivered to then selects “Mark Location” and the location is identified for the delivery where you Choose your SP Target and select “Mark Location” to send your location to GSense on a Computer, laptop, and mobile device and that location is locked into the mechanism for broadcast delivery by Latitude, Longitude, Altitude, and Time coordinates.

Element 83B describes GSense Protect Anything Spatial Point Targeting System Processor Mechanism and shows where the GPS Unit in Computer, laptop, and mobile device is used to get spatial point coordinates of the actual position of the device for locking into a delivery point for content by Latitude, Longitude, Altitude, and Time coordinates with Degrees, Minutes, and Seconds coordinates.
Element 83C describes GSense Protect Anything Spatial Point Targeting System Processor Mechanism and shows the Latitude coordinate.
Element 83D describes GSense Protect Anything Spatial Point Targeting System Processor Mechanism and shows the Longitude coordinate.
Element 83E describes GSense Protect Anything Spatial Point Targeting System Processor Mechanism and shows the Altitude coordinate.
Element 83F describes GSense Protect Anything Spatial Point Targeting System Processor Mechanism and shows the Time coordinate.
Element 83G describes GSense Protect Anything Spatial Point Targeting System Processor Mechanism and shows where the GPS delivery spatial point target is set for content by Latitude, Longitude, Altitude, and Time coordinates with Degrees, Minutes, and Seconds coordinates sends information to GSense server for use in identification, positioning and broadcast point analysis.
Element 83H describes GSense Protect Anything Spatial Point Targeting System Processor Mechanism and shows the GSense Protect Anything Spatial Point data storage mechanism.
Element 83I describes GSense Protect Anything Spatial Point Targeting System Processor Mechanism and shows the GSense Protect Anything Prot2 Spatial Point data storage mechanism.
Element 83J describes GSense Protect Anything Spatial Point Targeting System Processor Mechanism and shows the GSense Protect Anything document storage mechanism.
Element 83K describes GSense Protect Anything Spatial Point Targeting System Processor Mechanism and shows the GSense Protect Anything images storage mechanism.
Element 83L describes GSense Protect Anything Spatial Point Targeting System Processor Mechanism and shows the GSense Protect Anything video storage mechanism.
Element 83M describes GSense Protect Anything Spatial Point Targeting System Processor Mechanism and shows the GSense Protect Anything virtual augmented reality storage mechanism.
Element 83N describes GSense Protect Anything Spatial Point Targeting System Processor Mechanism and shows the WWW or World Wide Web.

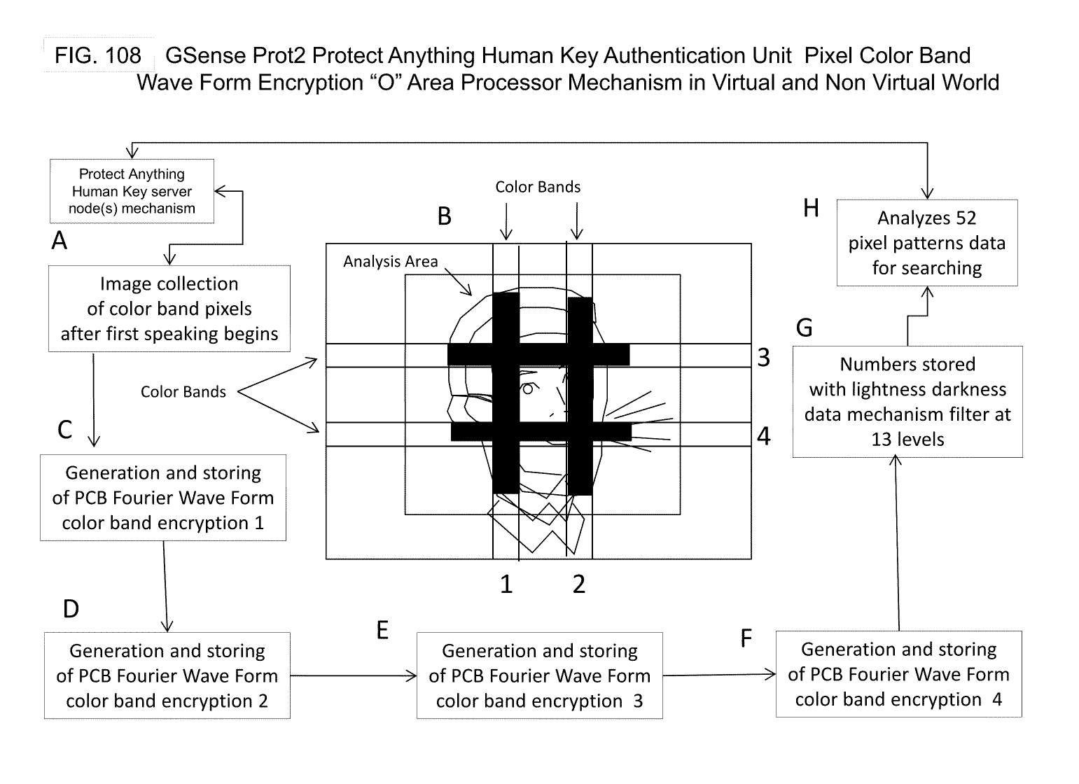

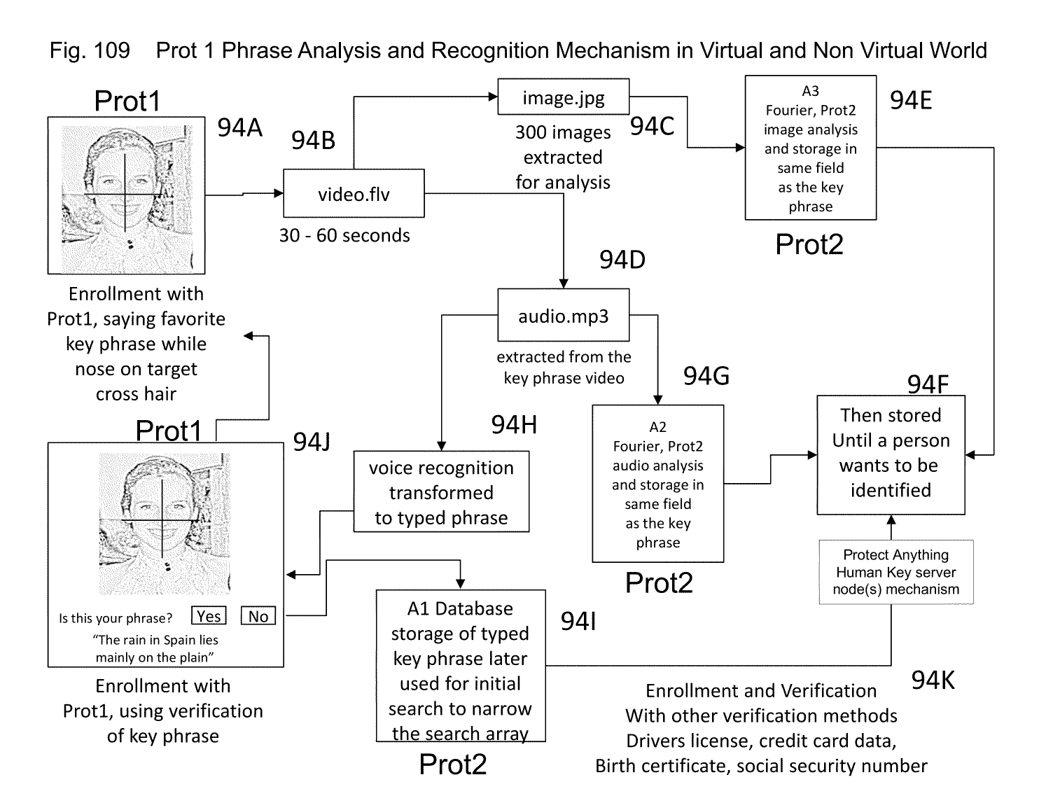

Now referring to FIG. 108, element 88A describes GSense Prot2 Protect Anything Human Key Authentication Unit Pixel Color Band Fourier wave form Encryption “O” Area Processor Mechanism and shows where the Image collection of color band pixels begins after first audio speaking phrase begins.

Element 88B describes GSense Prot2 Protect Anything Human Key Authentication Unit Pixel Color Band Fourier wave form Encryption “O” Area Processor Mechanism and shows where analysis Area Color Bands begins.
Element 88C describes GSense Prot2 Protect Anything Human Key Authentication Unit Pixel Color Band Fourier wave form Encryption “O” Area Processor Mechanism and shows the Generation and storing of PCB Fourier wave form color band encryption 1.
Element 88D describes GSense Prot2 Protect Anything Human Key Authentication Unit Pixel Color Band Fourier wave form Encryption “O” Area Processor Mechanism and shows the Generation and storing of PCB Fourier wave form color band encryption 2.
Element 88E describes GSense Prot2 Protect Anything Human Key Authentication Unit Pixel Color Band Fourier wave form Encryption “O” Area Processor Mechanism and shows the Generation and storing of PCB Fourier wave form color band encryption 3.
Element 88F describes GSense Prot2 Protect Anything Human Key Authentication Unit Pixel Color Band Fourier wave form Encryption “O” Area Processor Mechanism and shows the Generation and storing of PCB Fourier wave form color band encryption 4.
Element 88G describes GSense Prot2 Protect Anything Human Key Authentication Unit Pixel Color Band Fourier wave form Encryption “O” Area Processor Mechanism and shows where the data numbers are stored with lightness darkness data mechanism filter are aggregated at 13 levels.
Element 88H describes GSense Prot2 Protect Anything Human Key Authentication Unit Pixel Color Band Fourier wave form Encryption “O” Area Processor Mechanism and shows where mechanism analyzes 52 pixel patterns image data for searching.

FIG. 94 is a block diagram illustrating a method and mechanism and mechanism for phrase analysis and human recognition as part of an embodiment of the present invention.

Element 94A is a block diagram illustrating an enrollment method and mechanism with Prot1, saying favorite key phrase while nose is on target cross hair of screen from cam.
Element 94B is a block diagram illustrating an extraction of a video.flv that is the length of 30 to 60 seconds.
Element 94C is a block diagram illustrating an extraction of 300 images for analysis from the key phrase video.
Element 94D is a block diagram illustrating an extraction of audio from the key phrase video.
Element 94E is a block diagram illustrating a Fourier, Prot2, transformation from image.jpg file for analysis and storage in the same field as the key phrase for further processing.
Element 94F is a block diagram illustrating that the data is then stored in a database until a person wants to be identified.
Element 94G is a block diagram illustrating a Fourier, Prot2, transformation from audio.mp3 file for analysis and storage in the same field as the key phrase for further processing.
Element 94H is a block diagram illustrating a voice recognition mechanism that takes voice and converts it to typed phrase.
Element 94I is a block diagram illustrating a database storage mechanism of typed key phrase that is later used for the initial search, to narrow the search array.
Element 94J is a block diagram illustrating the Prot1 mechanism where a user is asked to say a phrase then verify that the typed phrase is the one that was said by the user yes or no and enrollment begins when the user presses yes and all of the audio, video, image, transformations of data, and the text data is stored for future comparison and identification.
Element 94K is a block diagram illustrating the enrollment and verification with other verification method and mechanisms that can be added to the enrollment mechanism like driver's license, credit card data, birth certificate, and social security number.

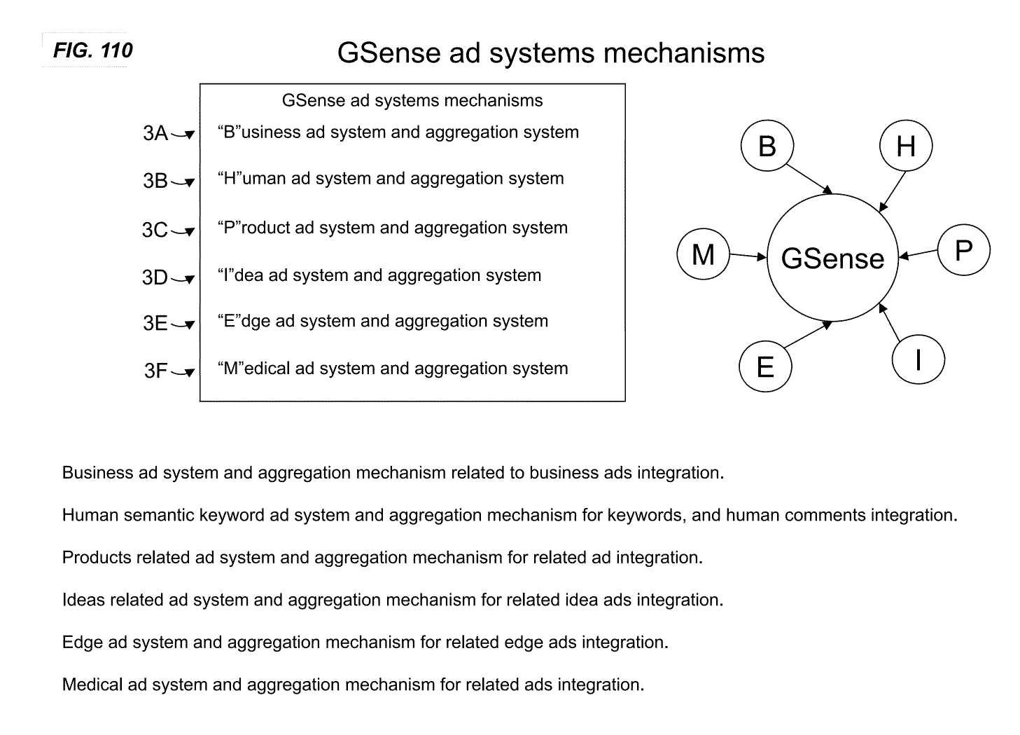

Now referring to FIG. 110, element 3-3A describes the GSense advertising systems mechanism with the “B.” business advertising system aggregation system mechanism, the business advertising system and aggregation mechanism related to business advertising integration.

Element 3-3B describes the GSense advertising systems mechanism with the “H.” business advertising system and aggregation system mechanism, the human semantic keyword advertising system and aggregation mechanism for keywords, and human contents integration.
Element 3-3C describes the GSense advertising systems mechanism with the “P.” product advertising system and aggregation system mechanism, the products related advertising system and aggregation mechanism for related advertising integration.
Element 3-3D describes the GSense advertising systems mechanism with the “I” idea advertising system and aggregation system mechanism, the ideas related advertising system and aggregation mechanism for related idea advertising integration.
Element 3-3 E. describes the GSense advertising systems mechanism with the “E.” edge advertising system and aggregation system mechanism, the edge advertising system and aggregation mechanism for related edge advertising integration.
Element 3-3F describes the GSense advertising systems mechanism with the “M.” medical advertising system and aggregation system mechanism, the medical advertising system and aggregation mechanism for related advertising integration.

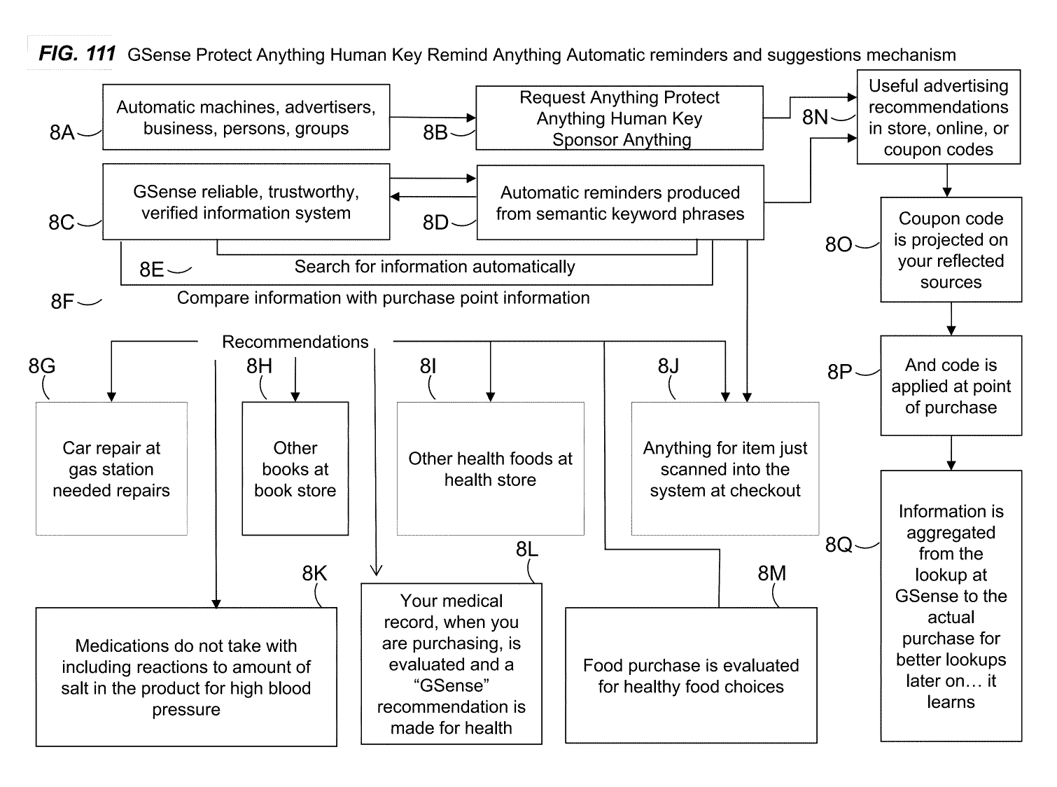

Now referring to FIG. 111, element 8-8A describes the mechanism of GSense functions automatic machines, advertisers, businesses, persons, groups can become Request Anything, Protect Anything Human Key Human Key response or anything members.

Element 8-8B describes the mechanism of GSense functions where Request Anything, Protect Anything Human Key Human Key, Sponsor Anything businesses, can get useful advertising recommendations de and store online or coupon codes.
Element 8-8C describes mechanism of GSense functions demonstrating the GSense reliable, trustworthy, verified information system providing automatic reminders.
Element 8-8D describes mechanism of GSense functions such as automatic reminders produce from semantic keyword phrases flowing to useful advertising recommendations.
Element 8-8E describes mechanism of GSense functions where you can search for information automatically.
Element 8-8F describes mechanism of GSense functions where you can compare information with point of purchase information.
Element 8-8G describes mechanism of GSense functions where you can get recommendations for car repair gas station people in it that needs repair.
Element 8-8H describes mechanism of GSense functions where you can get recommendations for other books went shopping at a bookstore and at point-of-purchase automatically.
Element 8-8I describes mechanism of GSense functions where all your purchasing in a health food store can be related to other health food items that are in your point-of-purchase bag and you can get a recommendation of related goods.
Element 8-8J describes mechanism of GSense functions where any item anything that is scanned into the system and check out can give recommendations for anything related to those items so that you can possibly add to other products.
Element 8-8K describes mechanism of GSense functions where you can get recommendations for medications like do not take with including reactions to amount of salt in the product like blood pressure, helps maintain good health.
Element 8-8L describes mechanism of GSense functions where as you purchase things it's added to your medical record or Journal or my medical Journal and is evaluated with the GSense engine and the GSense recommendation is made for good health.
Element 8-8M describes mechanism of GSense functions where point-of-purchase food items are evaluated for healthy food choices through the GSense engine and recommendations are made best choices.
Element 8-8N describes mechanism of GSense functions where useful advertising recommendations from the GSense engine provided in store, online or with coupon codes.
Element 8-8O describes mechanism of GSense functions where the coupon code is projected on reflected sources notifying you of discounts through the GSense engine.
Element 8-8P describes mechanism of GSense functions where the coupon code is applied automatically at point-of-purchase.
Element 8-8Q describes mechanism of GSense function where information is aggregated from the lookup at GSense to the actual purchase for better lookups later on . . . . It learns.

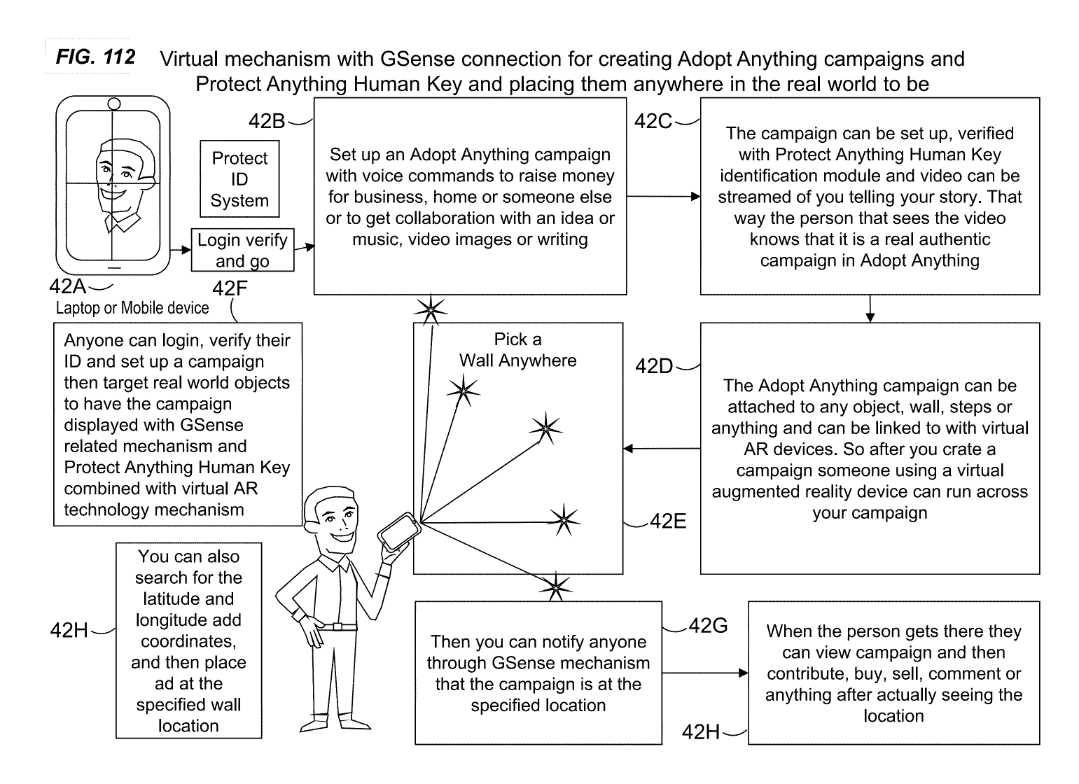

Now referring to FIG. 112, element 42-42A describes Virtual mechanism with GSense connection for creating Ado[t Anything campaigns and Protect Anything Human Key Server Cloud and placing them anywhere in the real world to be discovered and shows a mobile device WebCam and microphone crosshairs used for the protect ID system.

Element 42-42B describes Virtual mechanism with GSense connection for creating Ado[t Anything campaigns and Protect Anything Human Key Server Cloud and placing them anywhere in the real world to be discovered and shows the login and verify and go set up and Adopt Anything campaign or any campaign with voice commands to raise money for business, home where someone else or to get collaboration with an idea or music, video, images or writing.
Element 42-42C describes Virtual mechanism with GSense connection for creating Ado[t Anything campaigns and Protect Anything Human Key Server Cloud and placing them anywhere in the real world to be discovered and shows the campaign can be set up verify with protected identification module video can be streamed of you telling us your story that would a person that sees to video knows that it is a real authentic campaign in Adopt Anything campaign or any campaign.
Element 42-42D describes Virtual mechanism with GSense connection for creating Ado[t Anything campaigns and Protect Anything Human Key Server Cloud and placing them anywhere in the real world to be discovered and shows the Adopt Anything campaign or any campaign can be attached to any object, all, steps or anything and can be linked to with virtual augmented reality devices or mobile phones laptops goggles glasses so after you create a campaign someone using a virtual augmented reality device can run across your campaign.
Element 42-42E describes Virtual mechanism with GSense connection for creating Ado[t Anything campaigns and Protect Anything Human Key Server Cloud and placing them anywhere in the real world to be discovered and shows where you can pick a wall anywhere and lock into any specific spatial point.
Element 42-42F describes Virtual mechanism with GSense connection for creating Ado[t Anything campaigns and Protect Anything Human Key Server Cloud and placing them anywhere in the real world to be discovered and shows anyone can login, verify their ID and set up a campaign then target real world objects to have the campaign displayed with GSense related mechanism and Protect Anything Human Key combined with virtual augmented reality technology mechanism.
Element 42-42G describes Virtual mechanism with GSense connection for creating Ado[t Anything campaigns and Protect Anything Human Key Server Cloud and placing them anywhere in the real world to be discovered and shows then you can notify anyone through GSense mechanism that the campaign is at the specified location.
Element 42-42H describes Virtual mechanism with GSense connection for creating Ado[t Anything campaigns and Protect Anything Human Key Server Cloud and placing them anywhere in the real world to be discovered and shows when the person gets fair they can do campaign and then contribute, buy, sell, comment or anything after actually seeing the location.
Element 42-42I describes Virtual mechanism with GSense connection for creating Ado[t Anything campaigns and Protect Anything Human Key Server Cloud and placing them anywhere in the real world to be discovered and shows you can also search for the latitude and longitude added coordinates, and then place add at the specified wall location.

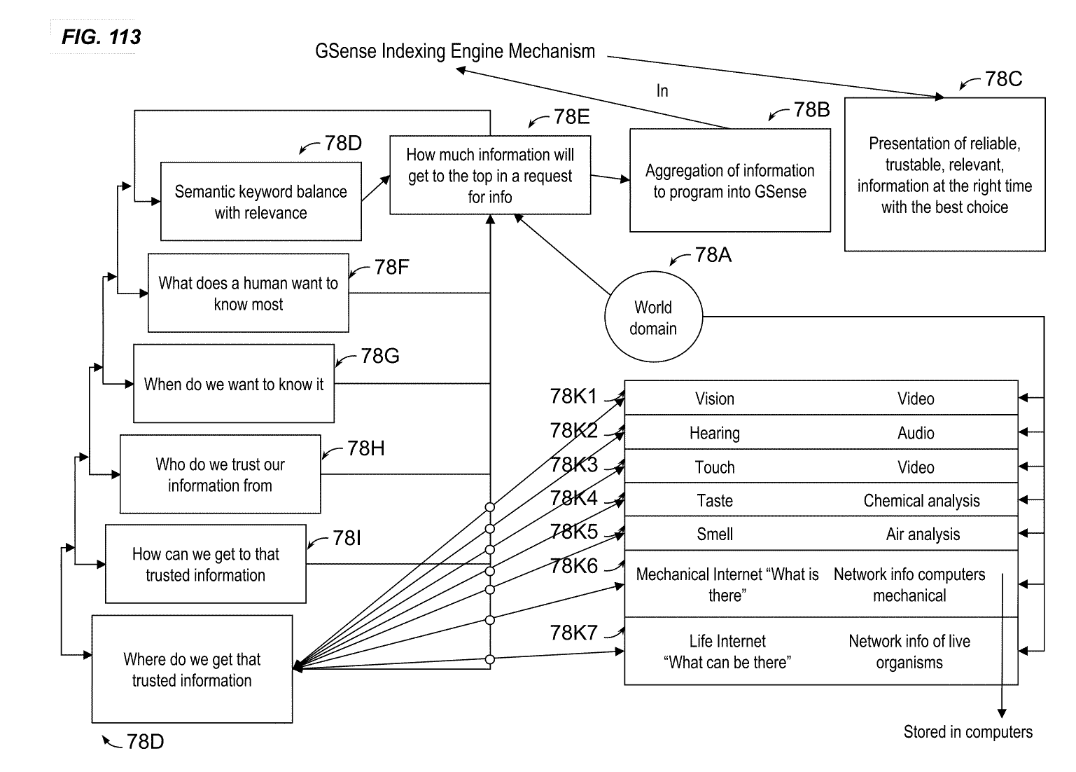

Now referring to FIG. 113, element 78-78A describes GSense Engine and mechanism and shows how world domains connect with GSense engine.

Element 78-78B describes GSense Engine and mechanism and shows the aggregation of information to programmed into the GSense engine mechanism.
Element 78-78C describes GSense Engine and mechanism and shows how information flows out from the GSense engine mechanism for presentation of reliable, trustable, relevant information at the right time with the best choice for decision-making.
Element 78-78D describes GSense Engine and mechanism and shows how semantic keyword balances with relevance in the GSense engine.
Element 78-78E describes GSense Engine and mechanism and shows how much information will get to the top of the list in a request for information.
Element 78-78F describes GSense Engine and mechanism and shows questions are asked and fulfilled like what does a human one to know about most?
Element 78-78G describes GSense Engine and mechanism and shows questions are asked and fulfilled like when do we want to know it?
Element 78-78H describes GSense Engine and mechanism and shows questions are asked and fulfilled like who do we trust our information from?
Element 78-78I describes GSense Engine and mechanism and shows questions are asked and fulfilled like how can we get instantly automatically to that trust information?.
Element 78-78J describes GSense Engine and mechanism and shows questions are asked and fulfilled like where do we get that trusted information automatically?.
Element 78-78K1 describes GSense Engine and mechanism and shows vision information utilizing video aggregation, analysis, storage, and information distribution.
Element 78-78K2 describes GSense Engine and mechanism and shows hearing information utilizing audio aggregation, analysis, storage and information distribution.
Element 78-78K3 describes GSense Engine and mechanism and shows touch information utilizing sensors aggregation, analysis, storage and information distribution.
Element 78-78K4 describes GSense Engine and mechanism and shows taste information utilizing chemical analysis sensors aggregation, analysis, storage and information distribution.
Element 78-78K5 describes GSense Engine and mechanism and shows smell information utilizing chemical analysis of gases sensors aggregation, analysis, storage and information distribution.
Element 78-78K6 describes GSense Engine and mechanism and shows the mechanical internet “what is there” information utilizing network information from mechanical computers stored in computers aggregation, analysis, storage and information distribution.
Element 78-78K7 describes GSense Engine and mechanism and shows life internet what can be there and is there at this moment information utilizing network info of live organisms aggregation, analysis, storage and information distribution.

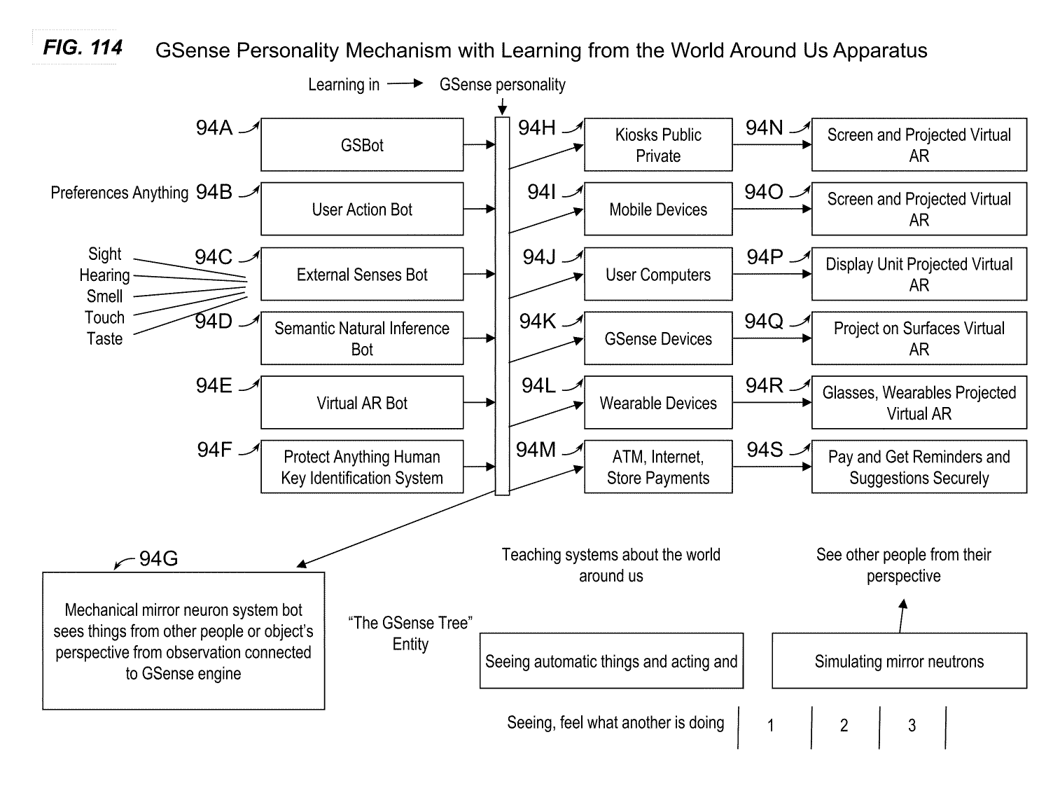

Now referring to FIG. 114, element 94-94A describes the GSense Personality Mechanism with Learning from the World Around Us Apparatus and shows the GS bot learning into the GSense personality.

Element 94-94B describes the GSense Personality Mechanism with Learning from the World Around Us Apparatus and shows the user actions bot learning into the GSense personality.
Element 94-94C describes the GSense Personality Mechanism with Learning from the World Around Us Apparatus and shows the external senses bot with sight, hearing, smell, touch, and taste learning into the GSense personality.
Element 94-94D describes the GSense Personality Mechanism with Learning from the World Around Us Apparatus and shows the semantic natural inference bot learning into the GSense personality.
Element 94-94E describes the GSense Personality Mechanism with Learning from the World Around Us Apparatus and shows the virtual augmented reality bot learning into the GSense personality.
Element 94-94F describes the GSense Personality Mechanism with Learning from the World Around Us Apparatus and shows the Protect Anything Human Key identification system managing learning into the GSense personality.
Element 94-94G describes the GSense Personality Mechanism with Learning from the World Around Us Apparatus and shows the mechanical mirror neuron system bot that sees things from other people or objects perspective from observation connected to the Life Internet and the GSense engine learning into the GSense personality.
Element 94-94H describes the GSense Personality Mechanism with Learning from the World Around Us Apparatus and shows kiosks public or private getting data from the GSense personality.
Element 94-94I describes the GSense Personality Mechanism with Learning from the World Around Us Apparatus and shows mobile devices getting data from the GSense personality.
Element 94-94J describes the GSense Personality Mechanism with Learning from the World Around Us Apparatus and shows user computers getting data from the GSense personality.
Element 94-94K describes the GSense Personality Mechanism with Learning from the World Around Us Apparatus and shows projection devices getting data from the GSense personality.
Element 94-94L describes the GSense Personality Mechanism with Learning from the World Around Us Apparatus and shows wearable devices getting data from the GSense personality.
Element 94-94M describes the GSense Personality Mechanism with Learning from the World Around Us Apparatus and shows bank ATMs Internet stores payments getting data from the GSense personality.
Element 94-94N describes the GSense Personality Mechanism with Learning from the World Around Us Apparatus and shows screen and projected virtual augmented reality data from kiosks public or private data from the GSense personality.
Element 94-94O describes the GSense Personality Mechanism with Learning from the World Around Us Apparatus and shows screen and projected virtual augmented reality data from mobile devices data from the GSense personality.
Element 94-94P describes the GSense Personality Mechanism with Learning from the World Around Us Apparatus and shows screen display unit and projected virtual augmented reality data from user computers with data from the GSense personality.
Element 94-94Q describes the GSense Personality Mechanism with Learning from the World Around Us Apparatus and shows screen and projected virtual augmented reality data on surfaces from projectors with data from the GSense personality.
Element 94-94R describes the GSense Personality Mechanism with Learning from the World Around Us Apparatus and shows glasses, wearables and projected virtual augmented reality data from wearable devices with data from the GSense personality.

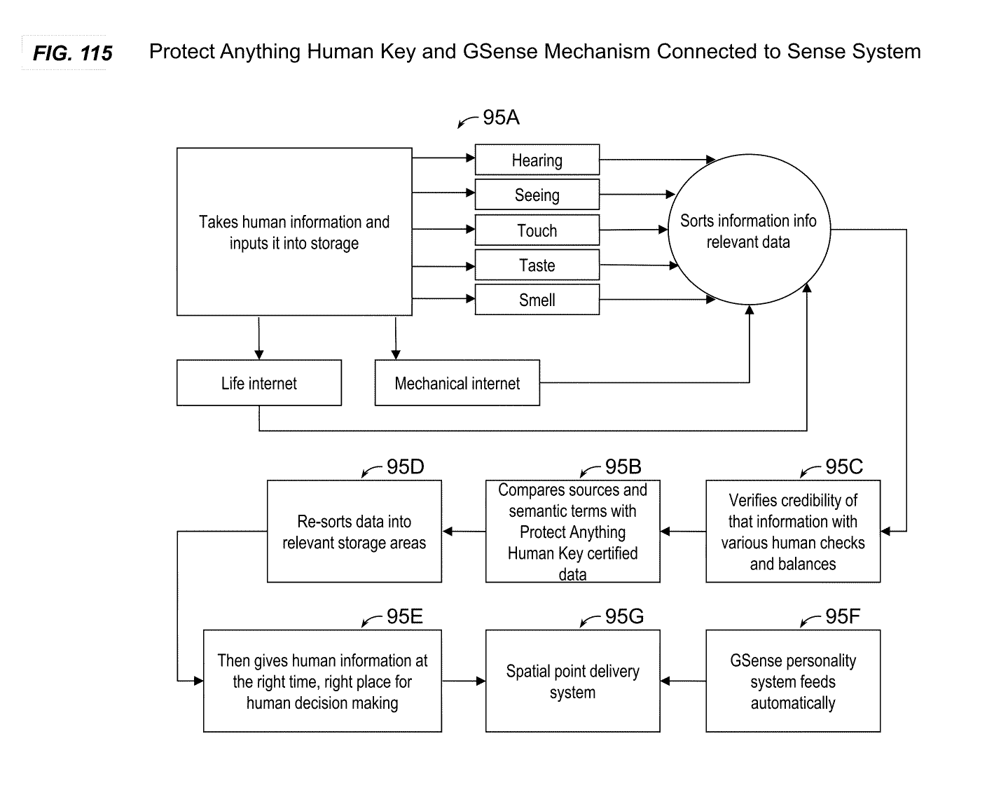

Now referring to FIG. 115, element 95-95A describes how Protect Anything Human Key and GSense mechanism is connected to the sense system and shows how the system takes human information in implicit into storage the mechanism takes hearing, seeing, touching, taste, smell, life Internet, the mechanical Internet and sorts all information into relevant data areas.

Element 95-95B describes how Protect Anything Human Key and GSense mechanism is connected to the sense system and shows where the mechanism compares sources and semantic terms with Protect Anything Human Key certified data.
Element 95-95C describes how Protect Anything Human Key and GSense mechanism is connected to the sense system and shows where the mechanism verifies the credibility of that information with various human checks and balances built-in to be mechanism automatically.
Element 95-95D describes how Protect Anything Human Key and GSense mechanism is connected to the sense system and shows where the mechanism sorts again the data into relevant storage areas.
Element 95-95E describes how Protect Anything Human Key and GSense mechanism is connected to the sense system and shows the system then gives human information at the right time, right place for enhancing human decision making.
Element 95-95F describes how Protect Anything Human Key and GSense mechanism is connected to the sense system and shows that the GSense personality system feeds the relevant information automatically.
Element 95-95G describes how Protect Anything Human Key and GSense mechanism is connected to the sense system and shows that relevant information can be targeted with the spatial point delivery system mechanism.

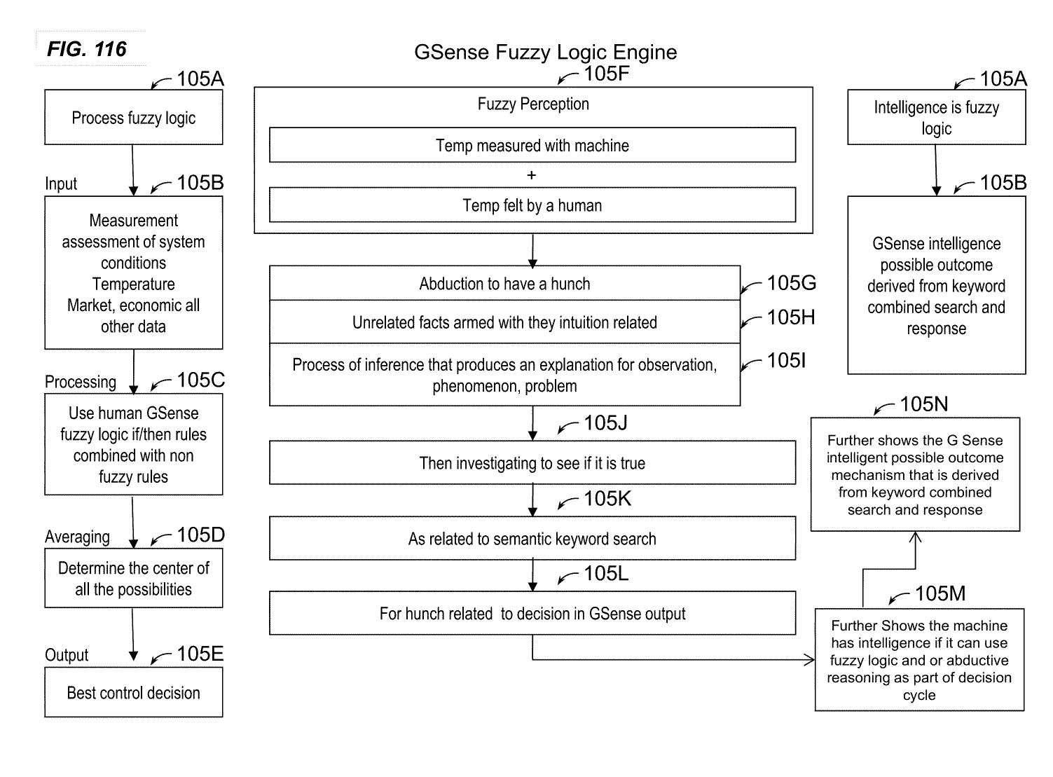

Now referring to FIG. 116, element 105-105A describes GSense Abductive Fuzzy Logic Engine and shows process fuzzy logic abduction.

Element 105-105B describes GSense Abductive Fuzzy Logic Engine and shows input mechanism for measurement, assessment of system conditions, temperature, market economic and all of the data mechanism.
Element 105-105C describes GSense Abductive Fuzzy Logic Engine and shows processing mechanism with human GSense using fuzzy logic abductive reasoning if then rules combined with non-fuzzy rules mechanism.
Element 105-105D describes GSense Abductive Fuzzy Logic Engine and shows the averaging mechanism that determines the center of all possibilities.
Element 105-105E describes GSense Abductive Fuzzy Logic Engine and shows the output mechanism with the best control decision generated.
Element 105-105F describes GSense Abductive Fuzzy Logic Engine and shows fuzzy adductive perception mechanism with comparison example of temperature measured with a machine plus temperature felt by human.
Element 105-105G describes GSense Abductive Fuzzy Logic Engine and shows the adductive mechanism that gives the ability of the machine to have hunch.
Element 105-105H describes GSense Abductive Fuzzy Logic Engine and shows unrelated facts mechanism to have a hunch armed with intuition.
Element 105-105I describes GSense Abductive Fuzzy Logic Engine and shows the inference process mechanism that produces some explanation for the observation, phenomenon or the problem.
Element 105-105I describes GSense Abductive Fuzzy Logic Engine and shows the investigation engine mechanism to test to see if hypothesis is true.
Element 105-105K describes GSense Abductive Fuzzy Logic Engine and shows where the hunch is related to any semantic keyword search.
Element 105-105L describes GSense Abductive Fuzzy Logic Engine and shows where the hunch is related to any previous decisions in GSense output mechanism engine.
Element 105-105M describes GSense Adductive Fuzzy Logic Engine and shows the machine has intelligence if it can use fuzzy logic and or abductive reasoning as part of decision cycle.
Element 105-105N describes GSense Adductive Fuzzy Logic Engine and shows the GSense intelligent possible outcome mechanism that is derived from keyword combined search and response.

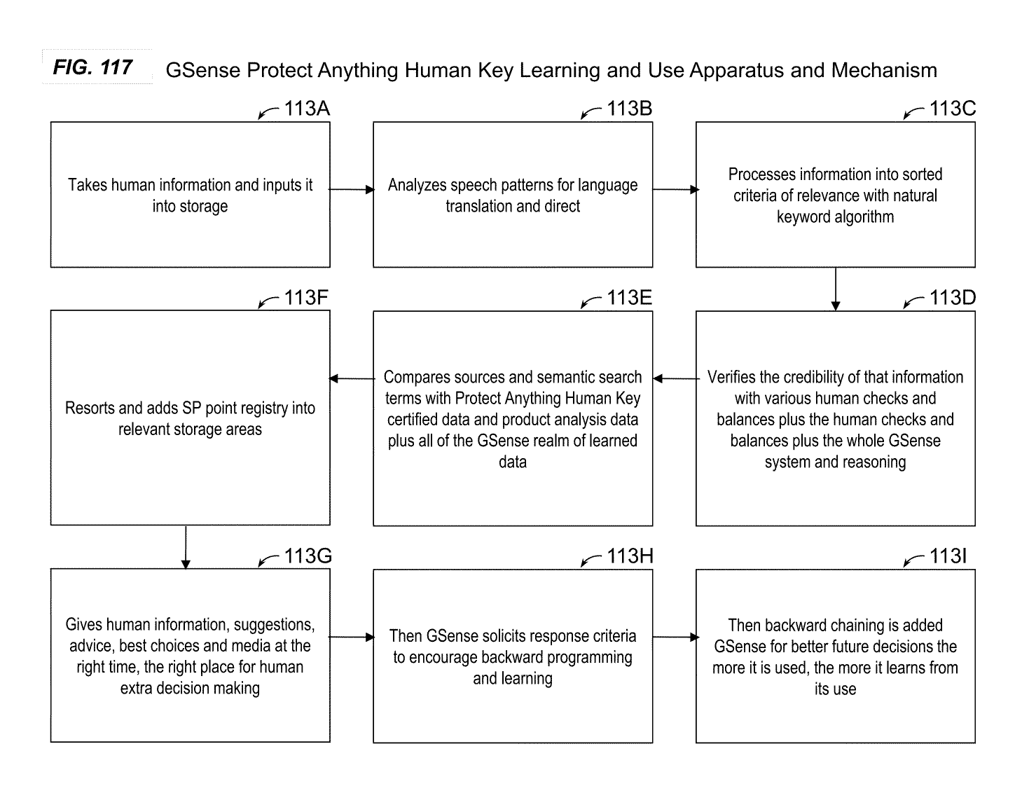

Now referring to FIG. 117, element 113-113A describes GSense learning and use apparatus mechanism and shows where GSense takes human information and inputs it into storage.

Element 113-113B describes GSense learning and use apparatus mechanism and shows where GSense analyzes speech patterns for language translation and dialect.
Element 113-113C describes GSense learning and use apparatus mechanism and shows where GSense processes information into sorted criteria of relevance with natural keyword algorithm.
Element 113-113D describes GSense learning and use apparatus mechanism and shows GSense verifies the credibility of that information with various human checks and balances plus the whole GSense system and reasoning engine.
Element 113-113E describes GSense learning and use apparatus mechanism and shows GSense compares sources and semantic search terms with Protect Anything Human Key certified data and product analysis data plus all of the GSense realm of learned data.
Element 113-113F describes GSense learning and use apparatus mechanism and shows where then GSense re-sorts and adds SP target point registry into relevant storage areas.
Element 113-113G describes GSense learning and use apparatus mechanism and shows where GSense gives human information, suggestion, proposal, advice, best choices and media at the right time, right place for human extra decision making.
Element 113-113H describes GSense learning and use apparatus mechanism and shows where then GSense solicits response criteria to encourage backwards programming and learning.
Element 113-113I describes GSense learning and use apparatus mechanism and shows where backward chaining is added to GSense mechanism for better future decisions the more it is used to more it learns from its use.

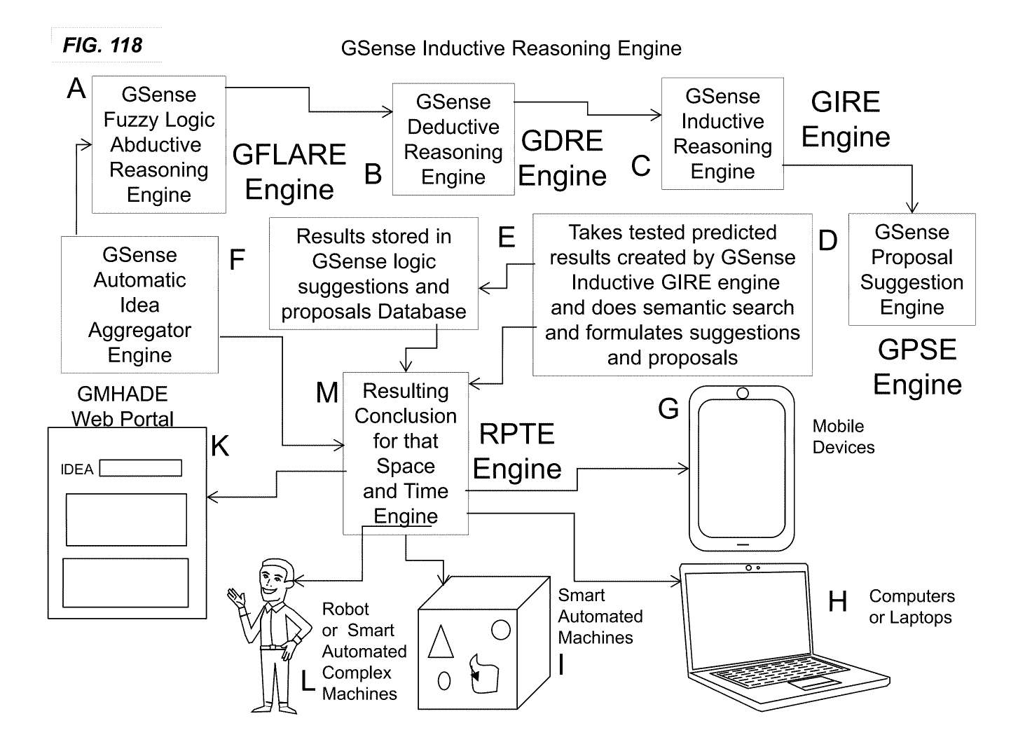

Now referring to FIG. 118, element 129-A describes GSense Proposal Suggestion Engine and shows GSense fuzzy logic deductive reasoning engine.

Element 129-B describes GSense Proposal Suggestion Engine and shows GSense deductive reasoning engine.
Element 129-C describes GSense Proposal Suggestion Engine and shows GSense inductive reasoning engine.
Element 129-D describes GSense Proposal Suggestion Engine and shows GSense proposal suggestion engine.
Element 129-E describes GSense Proposal Suggestion Engine and shows that the GSense proposal suggestion engine takes tested predicted results from the GSense inductive reasoning engine and a semantic search and formulates and creates suggestions and proposals.
Element 129-F describes GSense Proposal Suggestion Engine and shows results are stored in GSense logic suggestions and proposals database unit.
Element 129-G describes GSense Proposal Suggestion Engine and shows suggestions and proposals are then sent to mobile devices.
Element 129-H describes GSense Proposal Suggestion Engine and shows suggestions and proposals are then sent to laptop computer.
Element 129-I describes GSense Proposal Suggestion Engine and shows suggestions and proposals are then sent to automated smart machines.
Element 129-J describes GSense Proposal Suggestion Engine and shows suggestions and proposals are automatically sent to smart automated complex machines and robots.
Element 129-K describes GSense Proposal Suggestion Engine and shows suggestions and proposals automatically sent to GSense manual hypothesis aggregator and display engine.
Element 129-L describes GSense Proposal Suggestion Engine and shows suggestions and proposals are automatically sent to GSense automatic idea aggregator engine.
Element 129-M describes GSense Proposal Suggestion Engine and shows the GSense resulting place time engine.

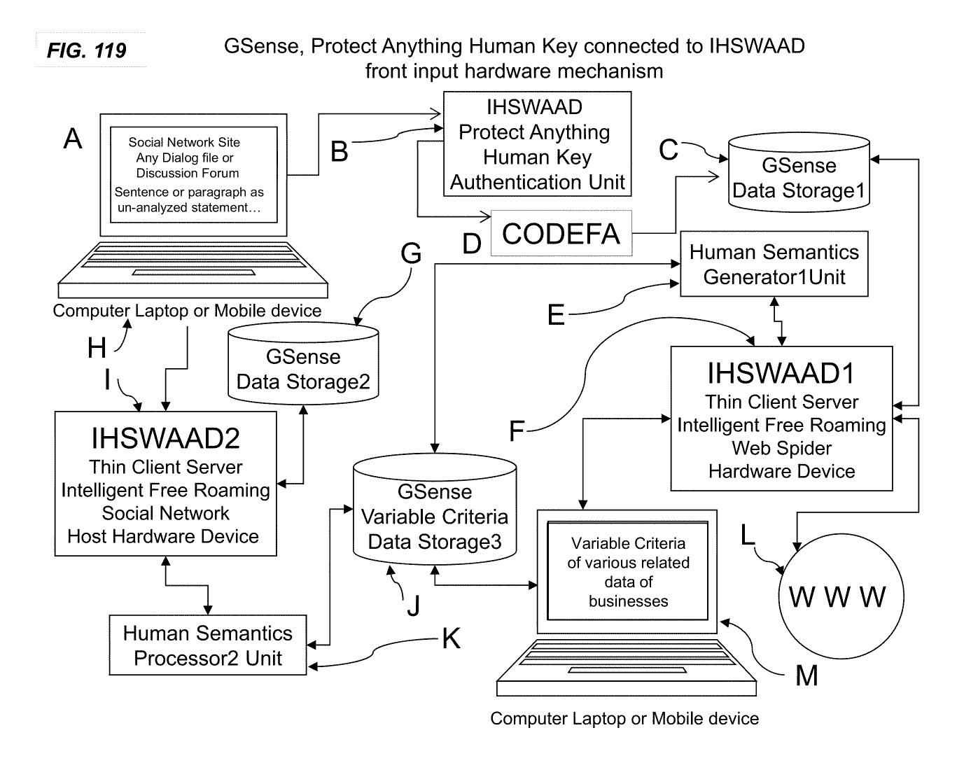

Now referring to FIG. 119, element 141-A describes GSense, Protect Anything Human Key connected to IHSWAAD hardware mechanism front input mechanism where data is input or aggregated from social networking site or any dialog file or discussion forum and a sentence or paragraph is entered as an un-analyzed statement from a computer, laptop, or mobile device for processing.

Element 141-B describes GSense, Protect Anything Human Key connected to IHSWAAD hardware mechanism front input mechanism where data is input or aggregated through the IHSWAAD Protect Anything Human Key Authentication Unit and/or raw into the IHSWAAD2 Thin Client Server Intelligent Free Roaming Social Network Host Hardware Device from a computer, laptop, or mobile device for processing.
Element 141-C describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing to the CODEFA encryption processing unit to the GSense Data Storage 1.
Element 141-D describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing through CODEFA Prot 1 security encryption processor.
Element 141-E describes GSense, Protect Anything Human Key connected to IHSWAAD hardware mechanism front input mechanism where data is input into the Human Semantics Generator 1 Unit for keyword phrase analysis, intelligent pattern matching and processing.
Element 141-F describes GSense, Protect Anything Human Key connected to IHSWAAD hardware mechanism front input mechanism where data is input and/or aggregated from WWW to the IHSWAAD1 Thin Client Server Intelligent Free Roaming Web Spider Hardware Device and a sentence or paragraph is entered as an un-analyzed statement from a computer, laptop, or mobile device for processing by the system.
Element 141-G describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Data Storage2.
Element 141-H describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing.
Element 141-I describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing IHSWAAD2 Thin Client Server Intelligent Free Roaming Social Network Host Hardware Device.
Element 141-J describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing GSense Variable Criteria Data Storage3.
Element 141-K describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Human Semantics Processor2 Unit.
Element 141-L describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing from the WWW.
Element 141-M describes GSense, Protect Anything Human Key connected to IHSWAAD hardware mechanism front input mechanism where data is input from social networking site or any dialog file or discussion forum and a sentence or paragraph is entered as an un-analyzed statement from a computer, laptop, or mobile device for processing Variable Criteria of various related data of businesses.

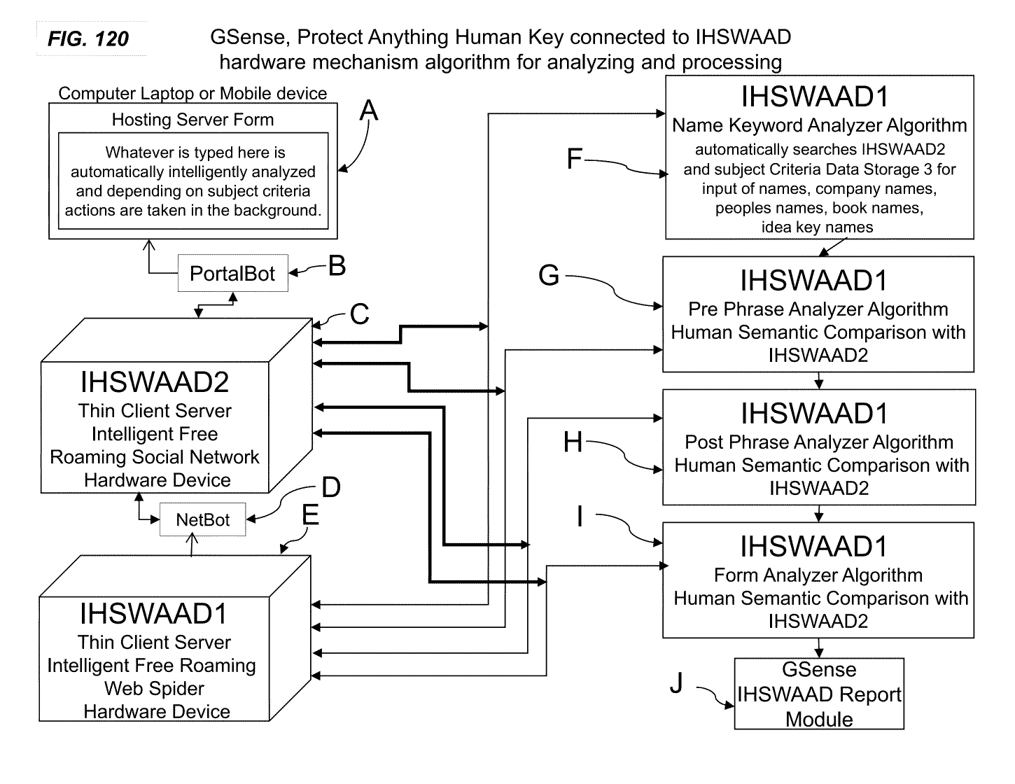

Now referring to FIG. 120, element 143-A describes GSense, Protect Anything Human Key connected to IHSWAAD hardware mechanism algorithm for analyzing and processing related information and shows Hosting Server Form input from Computer Laptop or Mobile device Whatever is typed here is automatically intelligently analyzed and depending on subject criteria actions are taken in the background.

Element 143-B describes GSense, Protect Anything Human Key connected to IHSWAAD hardware mechanism algorithm for analy and processing related information and shows PortalBot.
Element 143-C describes GSense, Protect Anything Human Key connected to IHSWAAD hardware mechanism algorithm for analyzing and processing related information and shows IHSWAAD2 Thin Client Server Intelligent Free Roaming Social Network Hardware Device.
Element 143-D describes GSense, Protect Anything Human Key connected to IHSWAAD hardware mechanism algorithm for analyzing and processing related information and shows NetBot.
Element 143-E describes GSense, Protect Anything Human Key connected to IHSWAAD hardware mechanism algorithm for analyzing and processing related information and shows IHSWAAD1 Thin Client Server Intelligent Free Roaming Web Spider Hardware Device.
Element 143-F describes GSense, Protect Anything Human Key connected to IHSWAAD hardware mechanism algorithm for analyzing and processing related information and shows IHSWAAD1 Name Keyword Analyzer Algorithm automatically searches IHSWAAD2 and subject Criteria Data Storage 3 for input of names, company names, peoples names, book names, idea key names.
Element 143-G describes GSense, Protect Anything Human Key connected to IHSWAAD hardware mechanism algorithm for analyzing and processing related information and shows IHSWAAD1 Pre Phrase Analyzer Algorithm Human Semantic Comparison with IHSWAAD2.
Element 143-H describes GSense, Protect Anything Human Key connected to IHSWAAD hardware mechanism algorithm for analyzing and processing related information and shows IHSWAAD1 Post Phrase Analyzer Algorithm Human Semantic Comparison with IHSWAAD2.
Element 143-I describes GSense, Protect Anything Human Key connected to IHSWAAD hardware mechanism algorithm for analyzing and processing related information and shows IHSWAAD1 Form Analyzer Algorithm Human Semantic Comparison with IHSWAAD2.
Element 143-J describes GSense, Protect Anything Human Key connected to IHSWAAD hardware mechanism algorithm for analyzing and processing related information and shows GSense IHSWAAD Report Module.

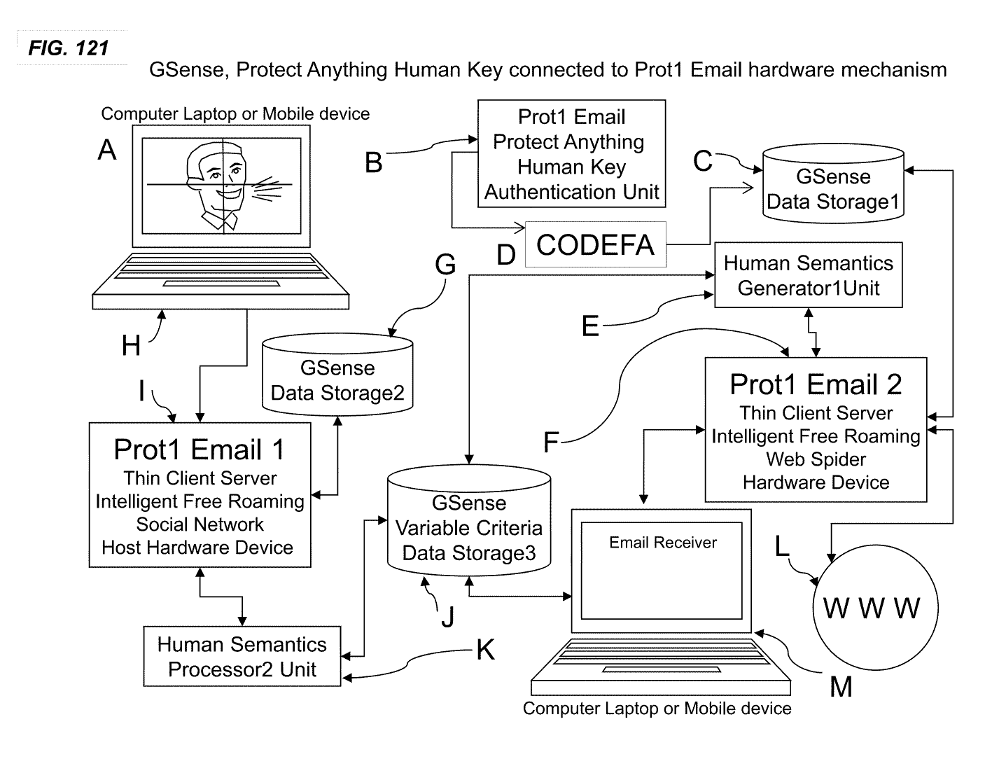

Now referring to FIG. 121, element 150-A describes GSense, Protect Anything Human Key connected to Prot1 Email hardware mechanism and shows the Computer Laptop or Mobile device.

Element 150-B describes GSense, Protect Anything Human Key connected to Prot1 Email hardware mechanism and shows the Prot1 Email Protect Anything Human Key Authentication Unit.
Element 150-C describes GSense, Protect Anything Human Key connected to Prot1 Email hardware mechanism and shows the GSense Data Storage1.
Element 150-D describes GSense, Protect Anything Human Key connected to Prot1 Email hardware mechanism and where the Protect Anything CODEFA mechanism provides storage, security; human key and tracking features are used.
Element 150-E describes GSense, Protect Anything Human Key connected to Prot1 Email hardware mechanism and shows the Human Semantics Generator) Unit.
Element 150-F describes GSense, Protect Anything Human Key connected to Prot1 Email hardware mechanism and shows the Prot1 Email 2 Thin Client Server Intelligent Free Roaming Web Spider Hardware Device.
Element 150-G describes GSense, Protect Anything Human Key connected to Prot1 Email hardware mechanism and shows the GSense Data Storage2.
Element 150-H describes GSense, Protect Anything Human Key connected to Prot1 Email hardware mechanism and shows the Computer Laptop or Mobile device.
Element 150-I describes GSense, Protect Anything Human Key connected to Prot1 Email hardware mechanism and shows the Prot1 Email 1 Thin Client Server Intelligent Free Roaming Social Network Host Hardware Device.
Element 150-J describes GSense, Protect Anything Human Key connected to Prot1 Email hardware mechanism and shows the GSense Variable Criteria Data Storage3.
Element 150-K describes GSense, Protect Anything Human Key connected to Prot1 Email hardware mechanism and shows the Human Semantics Processor2 Unit.
Element 150-L describes GSense, Protect Anything Human Key connected to Prot1 Email hardware mechanism and shows where the W W W or World Wide Web is used for data aggregation and comparison analysis methods
Element 150-M describes GSense, Protect Anything Human Key connected to Prot1 Email hardware mechanism and shows where the Email Receiver Computer Laptop or Mobile device.

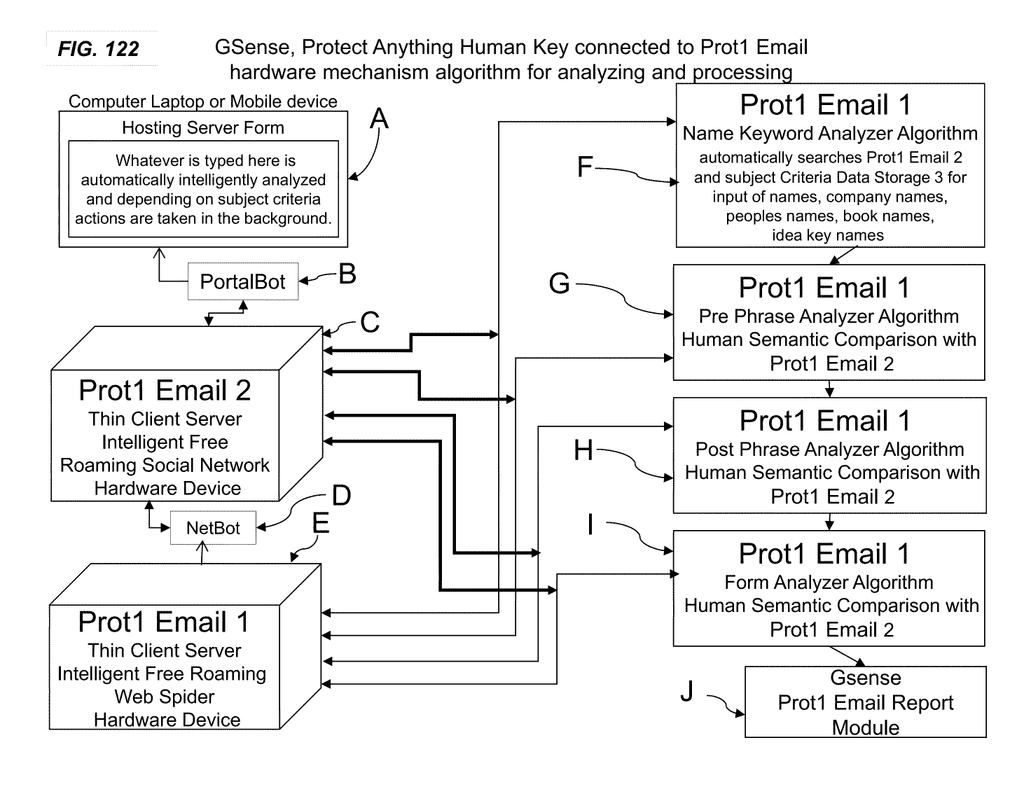

Now referring to FIG. 122, element 152-A describes GSense, Protect Anything Human Key connected to Prot1 Email hardware mechanism algorithm for analyzing and processing email data and shows the Computer Laptop or Mobile device Hosting Server Form Whatever is typed here is automatically intelligently analyzed and depending on subject criteria actions are taken in the background.

Element 152-BA describes GSense, Protect Anything Human Key connected to Prot1 Email hardware mechanism algorithm for analyzing and processing email data and shows the Portal Bot.

Element 152-C describes GSense, Protect Anything Human Key connected to Prot1 Email hardware mechanism algorithm for analyzing and processing email data and shows the Prot1 Email 2 Thin Client Server Intelligent Free Roaming Social Network Hardware Device.
Element 152-D describes GSense, Protect Anything Human Key connected to Prot1 Email hardware mechanism algorithm for analyzing and processing email data and shows the Net Bot.
Element 142-E describes GSense, Protect Anything Human Key connected to Prot1 Email hardware mechanism algorithm for analyzing and processing email data and shows the Prot1 Email 1 Thin Client Server Intelligent Free Roaming Web Spider Hardware Device.
Element 152-F describes GSense, Protect Anything Human Key connected to Prot1 Email hardware mechanism algorithm for analyzing and processing email data and shows the Prot1 Email 1 Name Keyword Analyzer Algorithm automatically searches Prot1 Email 2 and subject Criteria Data Storage 3 for input of names, company names, peoples names, book names, idea key names.
Element 152-G describes GSense, Protect Anything Human Key connected to Prot1 Email hardware mechanism algorithm for analyzing and processing email data and shows the Prot1 Email 1 Pre Phrase Analyzer Algorithm Human Semantic Comparison with Prot1 Email 2.
Element 152-H describes GSense, Protect Anything Human Key connected to Prot1 Email hardware mechanism algorithm for analyzing and processing email data and shows the Prot1 Email 1 Post Phrase Analyzer Algorithm Human Semantic Comparison with Prot1 Email 2.
Element 152-I describes GSense, Protect Anything Human Key connected to Prot1 Email hardware mechanism algorithm for analyzing and processing email data and shows the Prot1 Email 1 Form Analyzer Algorithm Human Semantic Comparison with Prot1 Email 2.
Element 152-J describes GSense, Protect Anything Human Key connected to Prot1 Email hardware mechanism algorithm for analyzing and processing email data and shows the GSense Prot1 Email Report Module.

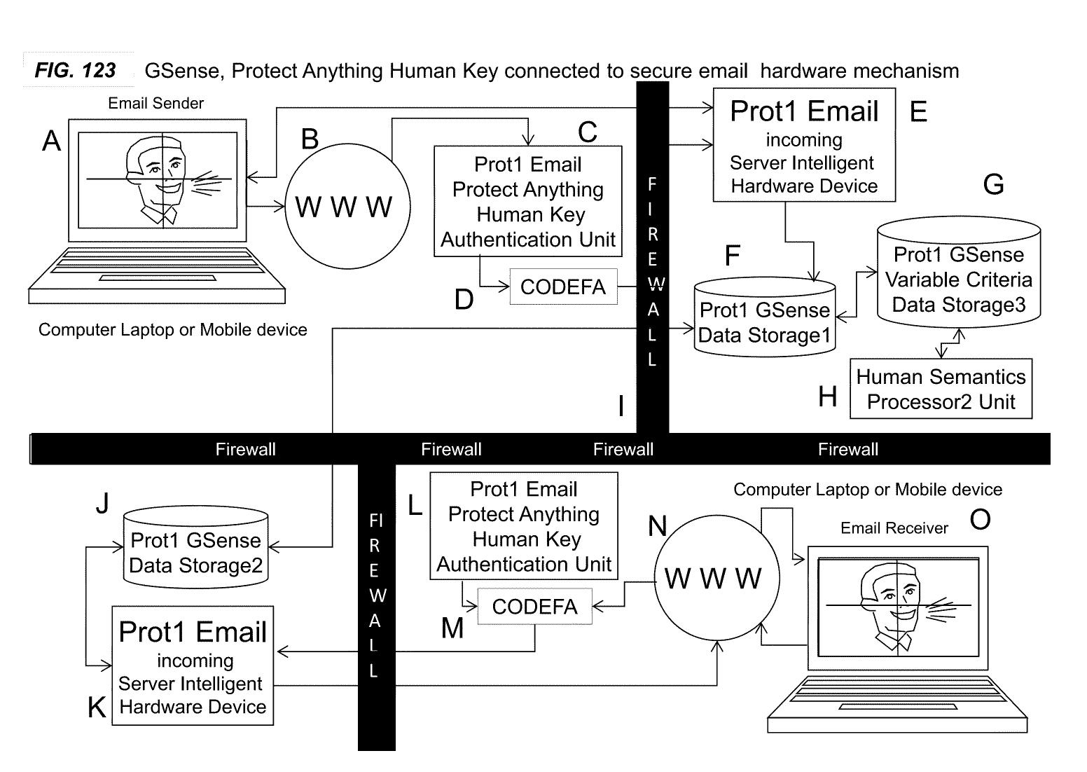

Now referring to FIG. 123, element 153-A describes GSense, Protect Anything Human Key connected to secure email hardware mechanism for analyzing and processing secure encrypted email data and shows the Email Sender Computer Laptop or Mobile device.

Element 153-B describes GSense, Protect Anything Human Key connected to secure email hardware mechanism for analyzing and processing secure encrypted email data and shows the W W W or World Wide Web is used for data aggregation and comparison analysis methods.
Element 153-C describes GSense, Protect Anything Human Key connected to secure email hardware mechanism for analyzing and processing secure encrypted email data and shows the Prot1 Email Protect Anything Human Key Authentication Unit.
Element 153-D describes GSense, Protect Anything Human Key connected to secure email hardware mechanism for analyzing and processing secure encrypted email data and shows the Protect Anything CODEFA mechanism provides storage, security, human key and tracking features.
Element 153-E describes GSense, Protect Anything Human Key connected to secure email hardware mechanism for analyzing and processing secure encrypted email data and shows the Prot1 Email incoming Server Intelligent Hardware Device.
Element 153-F describes GSense, Protect Anything Human Key connected to secure email hardware mechanism for analyzing and processing secure encrypted email data and shows the Prot1 GSense Data Storage 1.
Element 153-G describes GSense, Protect Anything Human Key connected to secure email hardware mechanism for analyzing and processing secure encrypted email data and shows the Prot1 GSense Variable Criteria Data Storage3.
Element 153-H describes GSense, Protect Anything Human Key connected to secure email hardware mechanism for analyzing and processing secure encrypted email data and shows the Human Semantics Processor2 Unit.
Element 153-I describes GSense, Protect Anything Human Key connected to secure email hardware mechanism for analyzing and processing secure encrypted email data and shows the firewall.
Element 153-J describes GSense, Protect Anything Human Key connected to secure email hardware mechanism for analyzing and processing secure encrypted email data and shows the Prot1 GSense Data Storage2.
Element 153-K describes GSense, Protect Anything Human Key connected to secure email hardware mechanism for analyzing and processing secure encrypted email data and shows the Prot1 Email incoming Server Intelligent Hardware Device.
Element 153-L describes GSense, Protect Anything Human Key connected to secure email hardware mechanism for analyzing and processing secure encrypted email data and shows the Prot1 Email Protect Anything Human Key Authentication Unit.
Element 153-M describes GSense, Protect Anything Human Key connected to secure email hardware mechanism for analyzing and processing secure encrypted email data and shows the Protect Anything CODEFA mechanism provides storage, security, human key and tracking features.
Element 153-N describes GSense, Protect Anything Human Key connected to secure email hardware mechanism for analyzing and processing secure encrypted email data and shows the W W W or World Wide Web is used for data aggregation and comparison analysis methods.
Element 153-O describes GSense, Protect Anything Human Key connected to secure email hardware mechanism for analyzing and processing secure encrypted email data and shows the Computer Laptop or Mobile device Email Receiver.

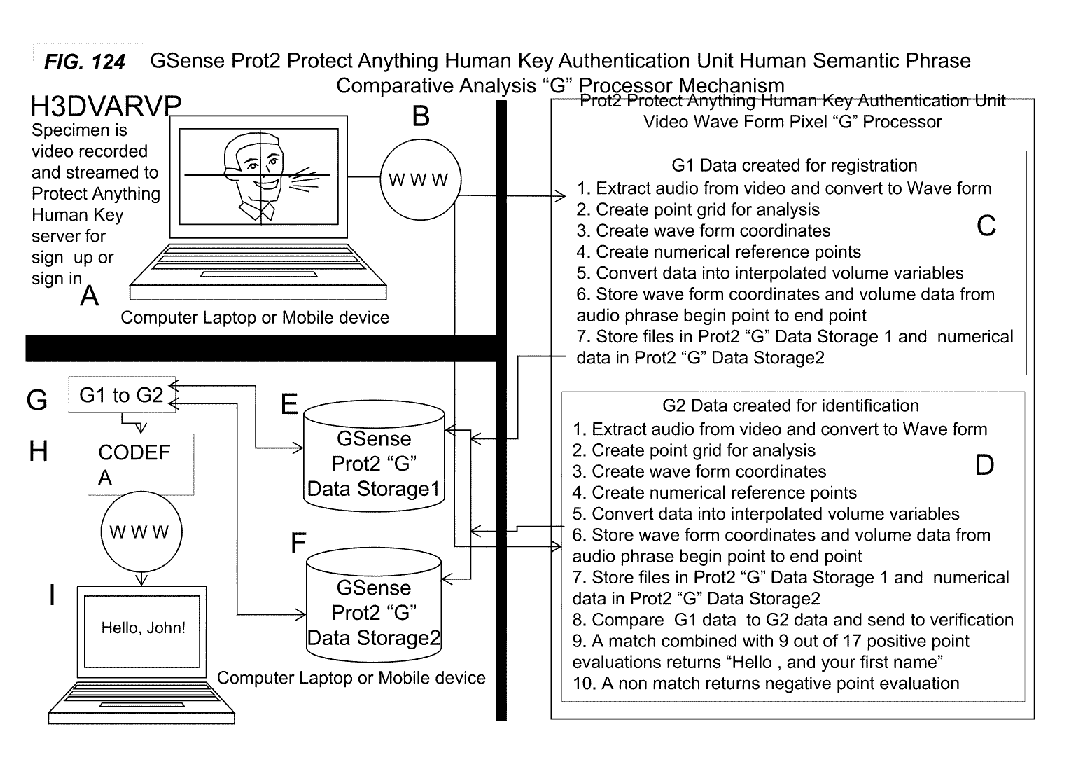

Now referring to FIG. 124, element 160-A describes GSense Prot2 Protect Anything Human Key Authentication Unit Human Semantic Phrase Comparative Analysis “G” Processor Mechanism with H3DVARV 3D Human Video Audio Stereo Viewing and Recording Mechanism and shows where the Specimen video is recorded and streamed to Protect Anything Human Key server for sign up or sign in Computer Laptop or Mobile device

Element 160-B describes GSense Prot2 Protect Anything Human Key Authentication Unit Human Semantic Phrase Comparative Analysis “G” Processor Mechanism and shows where the W W W or World. Wide Web is used for data aggregation and comparison analysis methods.
Element 160-C describes GSense Prot2 Protect Anything Human Key Authentication Unit Human Semantic Phrase Comparative Analysis “G” Processor Mechanism and where the Prot2 Protect Anything Human Key Authentication Unit Video Wave Form Pixel “G” Processor G1 Data created for registration, 1. Extracts audio from video and converts to Wave form, 2. Creates point grid for analysis, 3. Creates wave form coordinates, 4. Creates numerical reference points, 5. Converts data into interpolated volume variables, 6. Stores wave form coordinates and volume data from audio phrase begin point to end point, 7. Stores files in Prot2 “G” Data Storage 1 and numerical data in Prot2 “G” Data Storage2.
Element 160-D describes GSense Prot2 Protect Anything Human Key Authentication Unit Human Semantic Phrase Comparative Analysis “G” Processor Mechanism and shows where the Prot2 Protect Anything Human Key Authentication Unit Video Wave Form Pixel “G” Processor G2 Data created for identification, 1. Extracts audio from video and converts to Wave form, 2. Creates point grid for analysis, 3. Creates wave form coordinates, 4. Creates numerical reference points, 5. Converts data into interpolated volume variables, 6. Stores wave form coordinates and volume data from audio phrase begin point to end point, 7. Stores files in Prot2 “G” Data Storage 1 and numerical data in Prot2 “G” Data Storage 2, 8. Compares G1 data to G2 data and send to verification, 9. Where a match combined with 9 out of 16 positive point evaluations returns “Hello, and your first name”, 10. Where a non match returns negative point evaluation.
Element 160-E describes GSense Prot2 Protect Anything Human Key. Authentication Unit Human Semantic Phrase Comparative Analysis “G” Processor Mechanism and shows the GSense Prot2 “G” Data Storage1.
Element 160-F describes GSense Prot2 Protect Anything Human Key Authentication Unit Human Semantic Phrase Comparative Analysis “G” Processor Mechanism and shows the GSense Prot2 “G” Data Storage2.
Element 160-G describes GSense Prot2 Protect Anything Human Key Authentication Unit Human Semantic Phrase Comparative Analysis “G” Processor Mechanism and shows where the G1 to G2 Pattern matching and Comparison Processor Mechanism analyzes the data utilizing one or all of these analysis mechanisms including maximum distance analysis, mean distance analysis, mathematical error/data fit analysis, average color matrix analysis, fractal dimensions comparisons analysis, Fourier descriptors analysis, brightness interpolation comparison analysis, octal dump conversion analysis, vector overlay pattern analysis, audio wave form pattern analysis, and audio converted to image comparative analysis.
Element 160-H describes GSense Prot2 Protect Anything Human Key Authentication Unit Human Semantic Phrase Comparative Analysis “G” Processor Mechanism and shows the Protect Anything CODEFA mechanism that provides storage, security, human key and tracking features.
Element 160-I describes GSense Prot2 Protect Anything Human Key Authentication Unit Human Semantic Phrase Comparative Analysis “G” Processor Mechanism and shows where the W W W or World Wide Web is used for data aggregation and comparison analysis methods Hello, John! Computer Laptop or Mobile device.

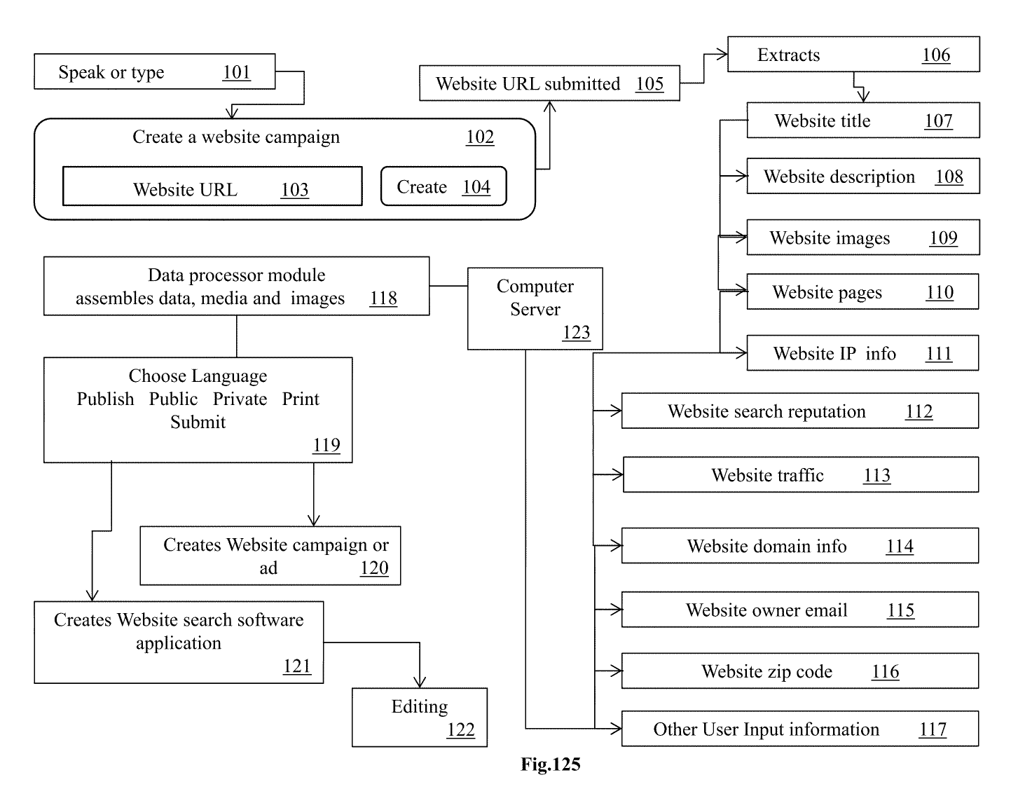

Now referring to FIG. 125 a flow chart illustrating the transformation of a website to a campaign is shown. A user would first speak or type 101 into a computer or equivalent device running the software executing the method, which ties the software comprising the process steps to a computer for execution. The graphical user interface (GUI) is a website campaign manager 102 located on/at a website URL 103. A user creates a campaign 104 and submits their website URL 105. The system of the present invention then extracts 106 from the URL, the website title 107, description 108, images 109, pages 110, IP information 111, the search reputation 112, traffic 113, domain information 114, owner's email 115, zip code 116, and any other information input by the user 117. Zip codes 116 are extracted from a search made of the administrator of the domain name, through a “WHOIS” search. Reputation 112 is obtained from third party providers of free, global web metrics.

A data processor module 118, running on a computer or equivalent machine, assembles the extracted information on a computer server 123. The system provides a language selection option where the final product can be created using one or more languages and then published, publically or privately, printed, and submitted for creation 119.

Finally, a website campaign or advertisement is created 120 along with a complementary website search software application 121 which can later be edited 122.

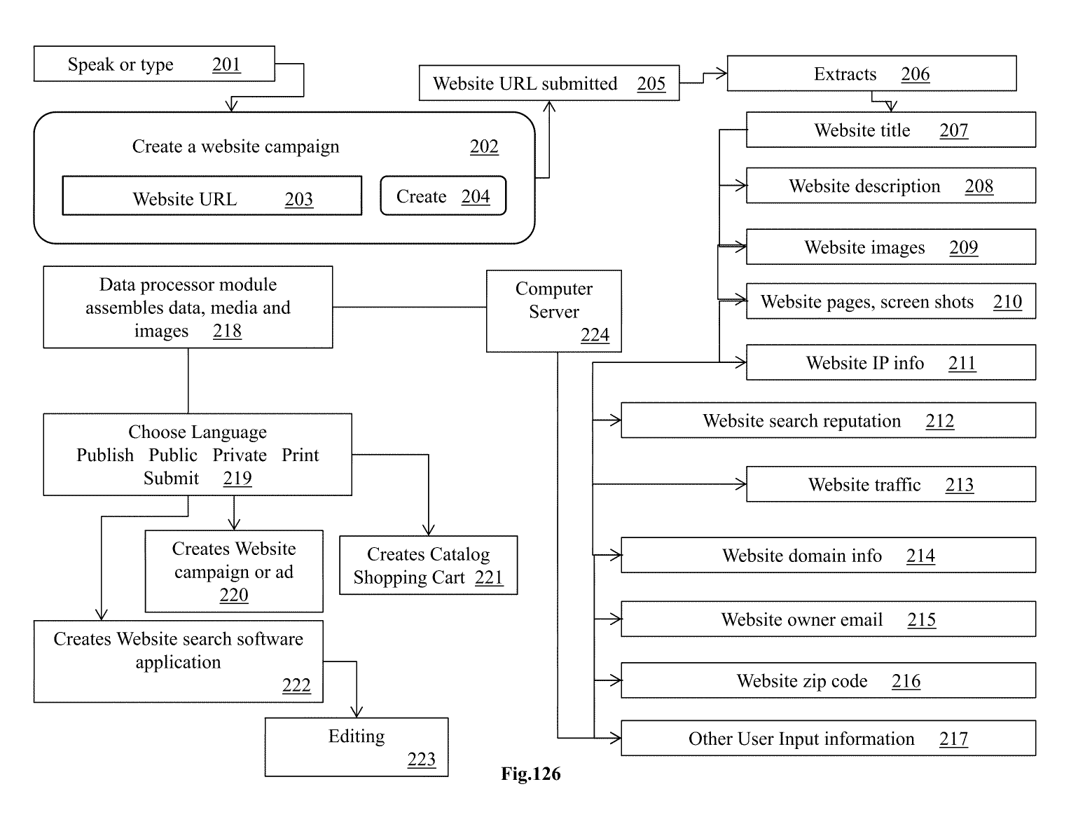

FIG. 126 is a flow chart illustrating the transformation of a website to an advertisement or plurality of advertisements. A user would first speak or type 201 into a computer or equivalent device running the software executing the method, which ties the software comprising the process steps to a computer for execution. The graphical user interface (GUI) is a website campaign manager 202 located on/at a website URL 203. A user creates a campaign 204 and submits their website URL 205. The system of the present invention then extracts 206 from the URL, the website title 207, description 208, images 209, pages and screen shots 210, IP information 211, the search reputation 212, traffic 213, domain information 214, owner's email 215, zip code 216, and any other information input by the user 217. Zip codes 216 are extracted from a search made of the administrator of the domain name, through a “WHOIS” search. Reputation 212 is obtained from third party providers of free, global web metrics.

A data processor module 218, running on a computer or equivalent machine, assembles the extracted information on a computer server 224. The system provides a language selection option where the final product can be created using one or more languages and then published, publically or privately, printed, and submitted for creation 219.

Finally, a website campaign or advertisement is created 220 along with a catalog and shopping cart 221 and a complementary website search software application 222, which can later be edited 223.

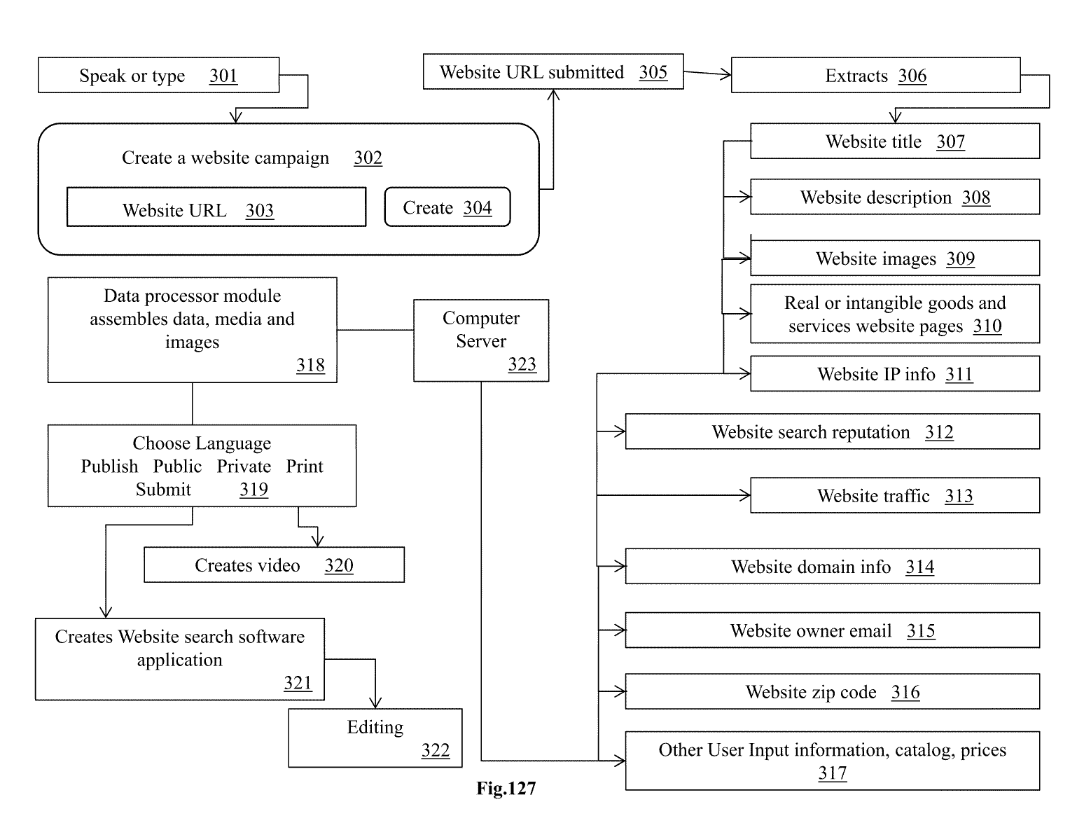

FIG. 127 is a flow chart illustrating the transformation of website to a video. A user would first speak or type 301 into a computer or equivalent device running the software executing the method, which ties the software comprising the process steps to a computer for execution. The graphical user interface (GUI) is a website campaign manager 302 located on/at a website URL 303. A user creates a campaign 304 and submits their website URL 305. The system of the present invention then extracts 306 from the URL, the website title 307, description 308, images 309, real or intangible good and services website pages 310, IP information 311, the search reputation 312, traffic 313, domain information 314, owner's email 315, zip code 316, and any other information input by the user 317. Zip codes 316 are extracted from a search made of the administrator of the domain name, through a “WHOIS” search. Reputation 312 is obtained from third party providers of free, global web metrics.

A data processor module 318, running on a computer or equivalent machine, assembles the extracted information on a computer server 323. The system provides a language selection option where the final product can be created using one or more languages and then published, publically or privately, printed, and submitted for creation 319.

Finally, a video is created 320 along with a complementary website search software application 321 which can later be edited 322.

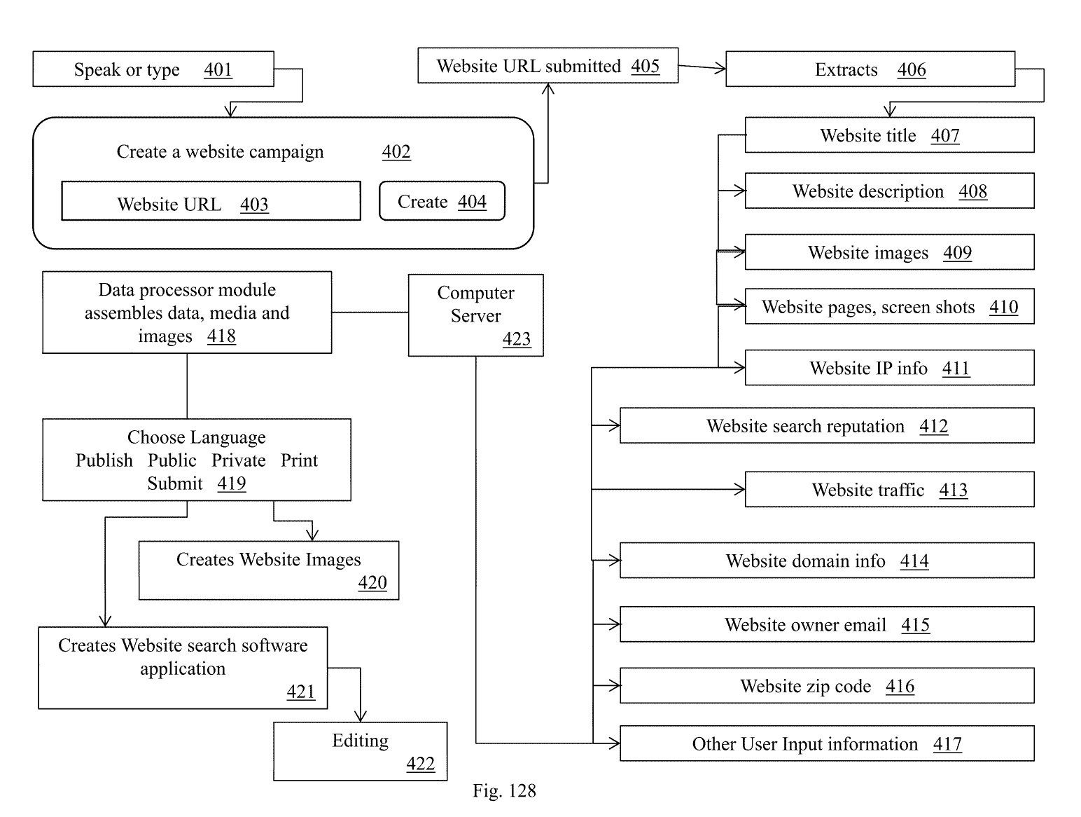

FIG. 128 is a flow chart illustrating the transformation of a website to one or more images. A user would first speak or type 401 into a computer or equivalent device running the software executing the method, which ties the software comprising the process steps to a computer for execution. The graphical user interface (GUI) is a website campaign manager 402 located on/at a website URL 403. A user creates a campaign 404 and submits their website URL 405. The system of the present invention then extracts 406 from the URL, the website title 407, description 408, images 409, pages and screen shots 410, IP information 411, the search reputation 412, traffic 413, domain information 414, owner's email 415, zip code 416, and any other information input by the user 417. Zip codes 416 are extracted from a search made of the administrator of the domain name, through a “WHOIS” search. Reputation 412 is obtained from third party providers of free, global web metrics.

A data processor module 418, running on a computer or equivalent machine, assembles the extracted information on a computer server 423. The system provides a language selection option where the final product can be created using one or more languages and then published, publically or privately, printed, and submitted for creation 419.

Finally, one or more website images are created 420 along with a complementary website search software application 421 which can later be edited 422.

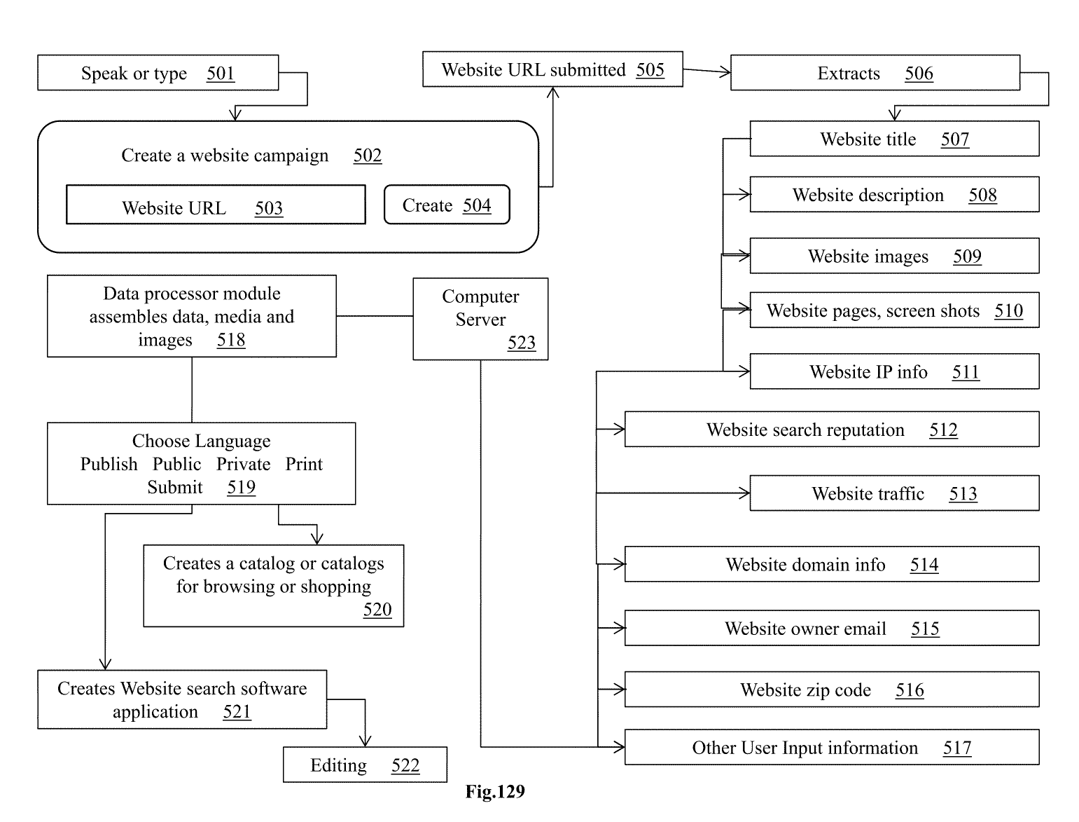

FIG. 129 is a flow chart illustrating the transformation of a website to one or more catalogs. A user would first speak or type 501 into a computer or equivalent device running the software executing the method, which ties the software comprising the process steps to a computer for execution. The graphical user interface (GUI) is a website campaign manager 502 located on/at a website URL 503. A user creates a campaign 504 and submits their website URL 505. The system of the present invention then extracts 506 from the URL, the website title 507, description 508, images 509, pages and screen shots 510, IP information 511, the search reputation 512, traffic 513, domain information 514, owner's email 515, zip code 516, and any other information input by the user 517. Zip codes 516 are extracted from a search made of the administrator of the domain name, through a “WHOIS” search. Reputation 512 is obtained from third party providers of free, global web metrics.

A data processor module 518, running on a computer or equivalent machine, assembles the extracted information on a computer server 523. The system provides a language selection option where the final product can be created using one or more languages and then published, publically or privately, printed, and submitted for creation 519.

Finally, one or more catalogs are created for browsing or shopping 520 along with a complementary website search software application 521 which can later be edited 522.

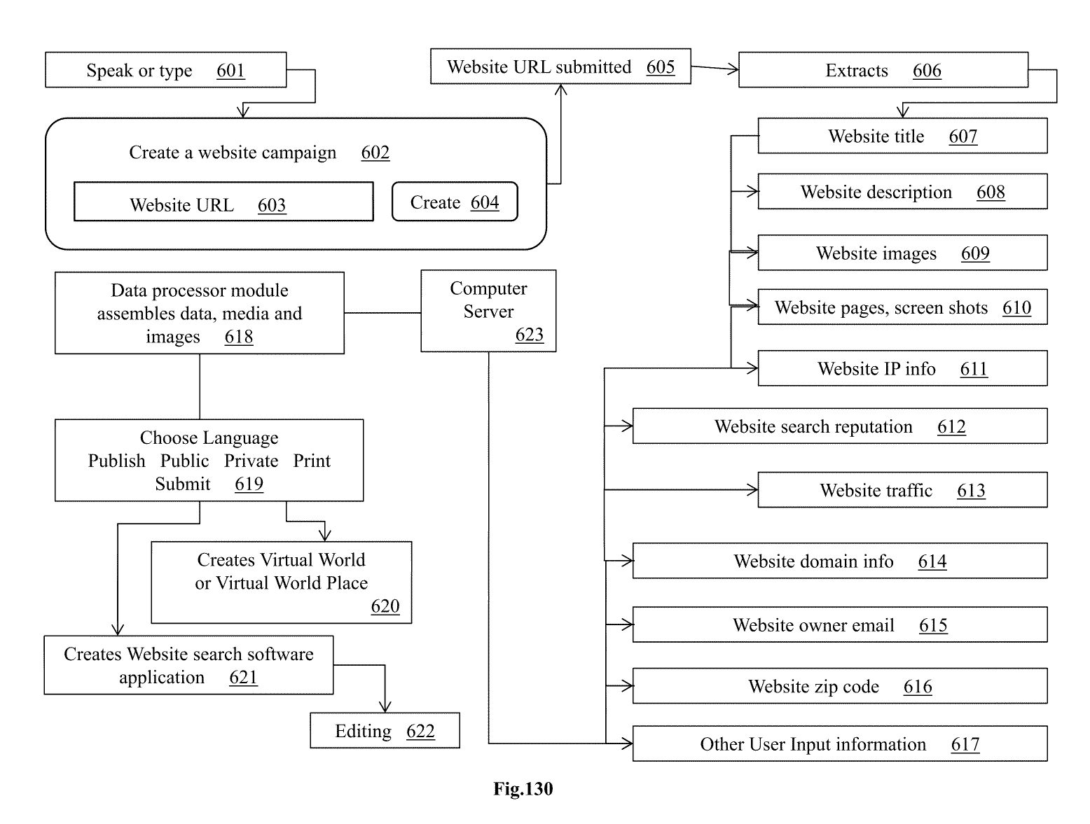

FIG. 130 is a flow chart illustrating the transformation of a website for use in a virtual world or place. A user would first speak or type 601 into a computer or equivalent device running the software executing the method, which ties the software comprising the process steps to a computer for execution. The graphical user interface (GUI) is a website campaign manager 602 located on/at a website URL 603. A user creates a campaign 104 and submits their website URL 605. The system of the present invention then extracts 606 from the URL, the website title 607, description 608, images 609, pages and screen shots 610, IP information 611, the search reputation 612, traffic 613, domain information 614, owner's email 615, zip code 616, and any other information input by the user 617. Zip codes 616 are extracted from a search made of the administrator of the domain name, through a “WHOIS” search. Reputation 612 is obtained from third party providers of free, global web metrics.

A data processor module 618, running on a computer or equivalent machine, assembles the extracted information on a computer server 623. The system provides a language selection option where the final product can be created using one or more languages and then published, publically or privately, printed, and submitted for creation 619.

Finally, one or more virtual worlds or virtual world places is created 620 along with a complementary website search software application 621 which can later be edited 622.

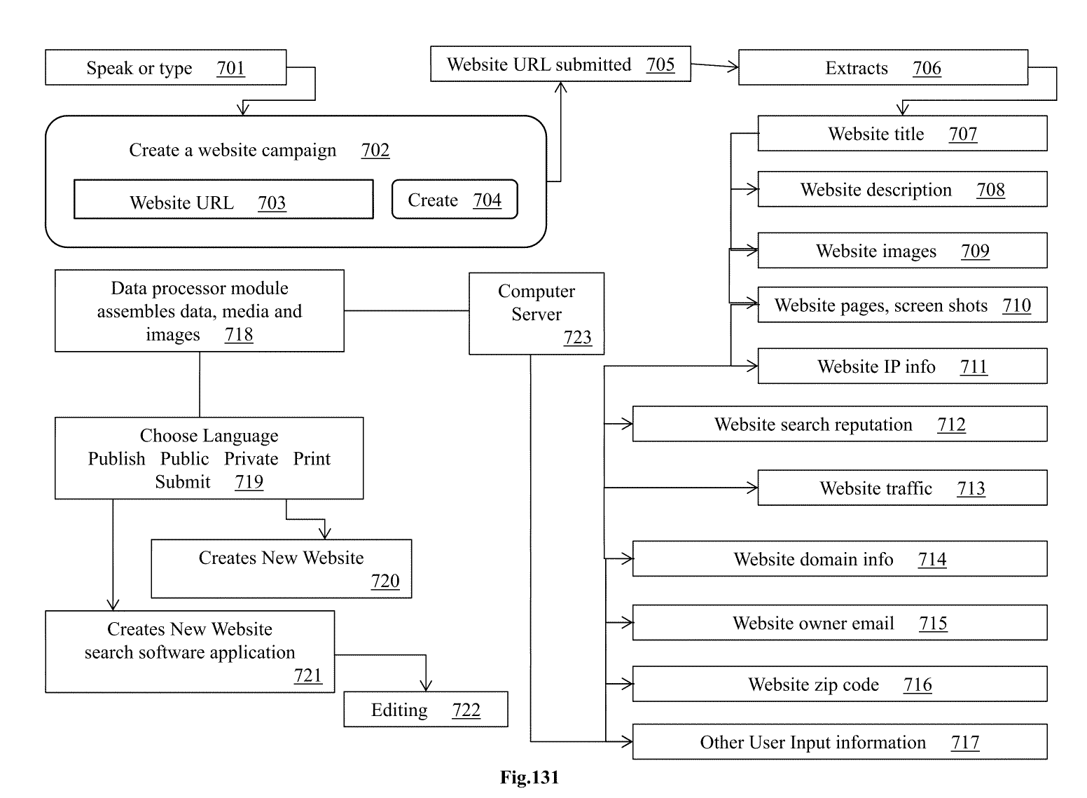

FIG. 131 is a flow chart illustrating a transformation of a website to another website for design, functionality, or profitability. A user would first speak or type 701 into a computer or equivalent device running the software executing the method, which ties the software comprising the process steps to a computer for execution. The graphical user interface (GUI) is a website campaign manager 702 located on/at a website URL 703. A user creates a campaign 704 and submits their website URL 705. The system of the present invention then extracts 706 from the URL, the website title 707, description 708, images 709, pages and screen shots 710, IP information 711, the search reputation 712, traffic 713, domain information 714, owner's email 715, zip code 716, and any other information input by the user 717. Zip codes 716 are extracted from a search made of the administrator of the domain name, through a “WHOIS” search. Reputation 712 is obtained from third party providers of free, global web metrics.

A data processor module 718, running on a computer or equivalent machine, assembles the extracted information on a computer server 723. The system provides a language selection option where the final product can be created using one or more languages and then published, publically or privately, printed, and submitted for creation 719.

Finally, one or more new websites are created 720 along with a complementary website search software application 721 which can later be edited 722.

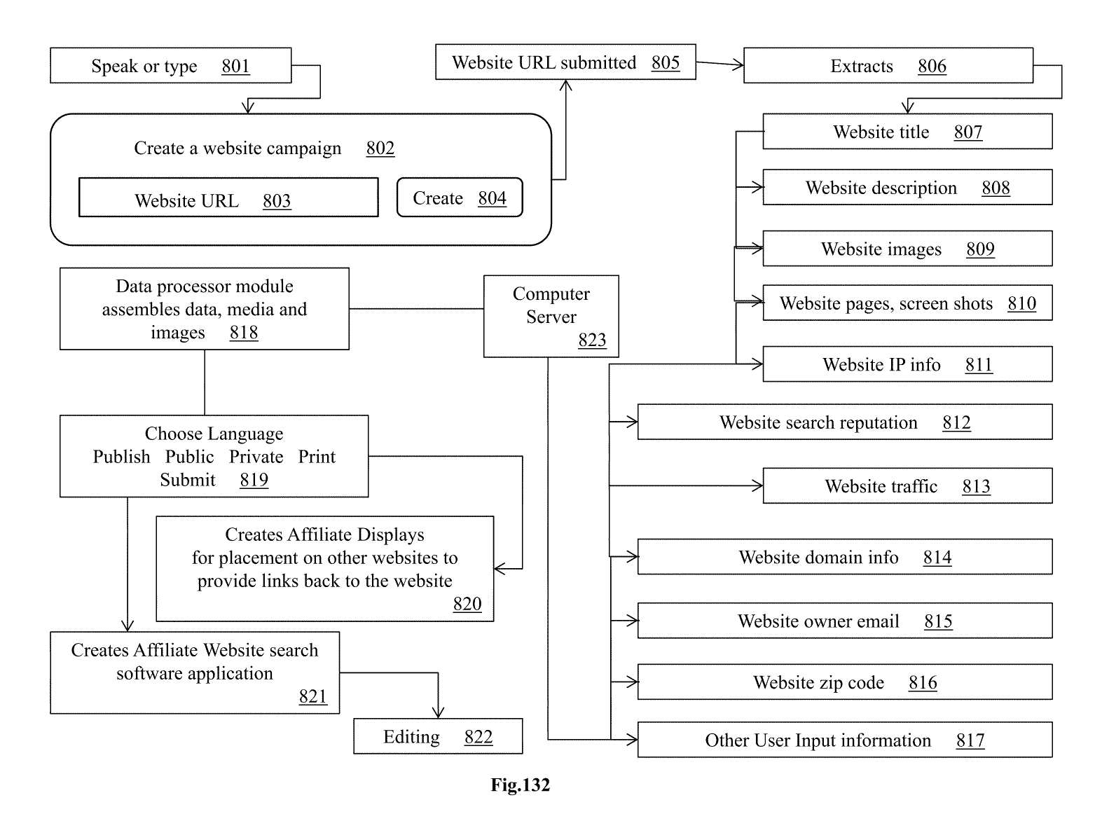

FIG. 132 is a flow chart illustrating transformation of website to affiliate software application and process. A user would first speak or type 801 into a computer or equivalent device running the software executing the method, which ties the software comprising the process steps to a computer for execution. The graphical user interface (GUI) is a website campaign manager 802 located on/at a website URL 803. A user creates a campaign 804 and submits their website URL 805. The system of the present invention then extracts 806 from the URL, the website title 807, description 808, images 809, pages and screen shots 810, IP information 811, the search reputation 812, traffic 813, domain information 814, owner's email 815, zip code 816, and any other information input by the user 817. Zip codes 816 are extracted from a search made of the administrator of the domain name, through a “WHOIS” search. Reputation 812 is obtained from third party providers of free, global web metrics.

A data processor module 818, running on a computer or equivalent machine, assembles the extracted information on a computer server 823. The system provides a language selection option where the final product can be created using one or more languages and then published, publically or privately, printed, and submitted for creation 819.

Finally, one or more affiliate displays for placement on other websites to provide links back to the website are created 820 along with a complementary website search software application 821 which can later be edited 822.

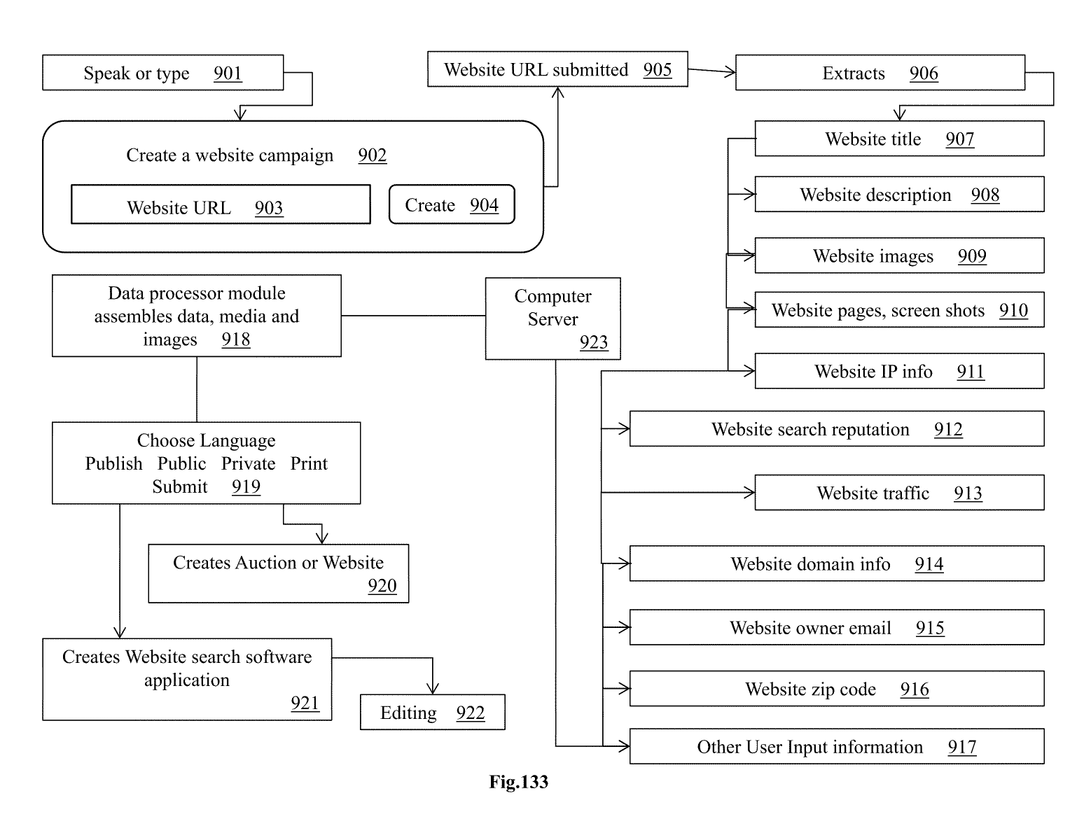

FIG. 133 is a flow chart illustrating the transformation of a website to an auction or sales site. A user would first speak or type 901 into a computer or equivalent device running the software executing the method, which ties the software comprising the process steps to a computer for execution. The graphical user interface (GUI) is a website campaign manager 902 located on/at a website URL 903. A user creates a campaign 904 and submits their website URL 905. The system of the present invention then extracts 906 from the URL, the website title 907, description 908, images 909, pages and screen shots 910, IP information 911, the search reputation 912, traffic 913, domain information 914, owner's email 915, zip code 916, and any other information input by the user 917. Zip codes 916 are extracted from a search made of the administrator of the domain name, through a “WHOIS” search. Reputation 912 is obtained from third party providers of free, global web metrics.

A data processor module 918, running on a computer or equivalent machine, assembles the extracted information on a computer server 923. The system provides a language selection option where the final product can be created using one or more languages and then published, publically or privately, printed, and submitted for creation 919.

Finally, one or more affiliate displays for placement on other websites to provide links back to the website auction or websites are created 920 along with a complementary website search software application 921 which can later be edited 922.

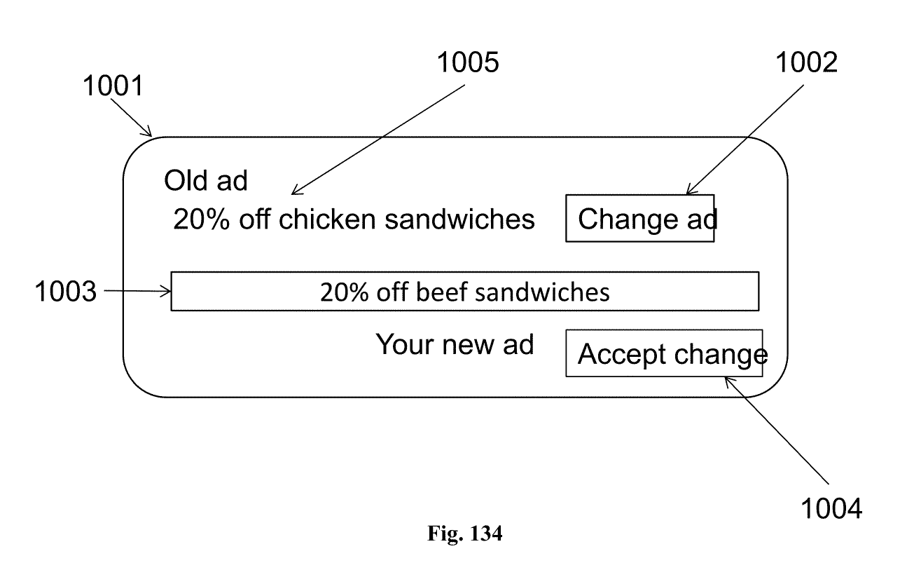

FIG. 134 is an advertising or campaign editor front end for image, media, and text data illustrating a window 1001 for proposing and accepting a substituted advertisement 1003. The old advertisement 1005, are current one running, is displayed and a change button 1002 is presented for a user to initiate a change. An accept button 1004 is presented for a user to accept the new advertisement 1003 from which the old advertisement 1005 is to be changed. The campaign or ad offer is embedded in the QR code. The offer can be changed at any time, for testing and variable pricing campaigns. Thus, if a business runs out of an item a different item can be substituted easily and quickly.

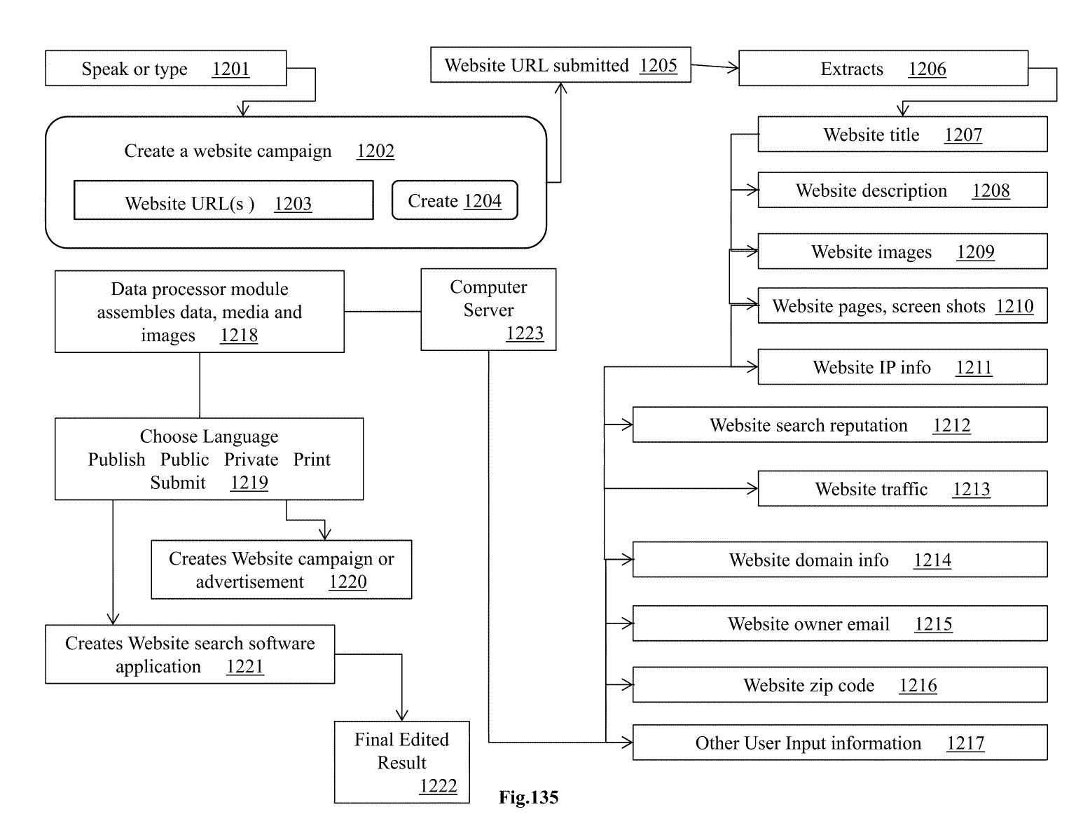

FIG. 135 is a flow chart illustrating a website URL submitter form. A user would first speak or type 1201 into a computer or equivalent device running the software executing the method, which ties the software comprising the process steps to a computer for execution. The graphical user interface (GUI) is a website campaign editor front end 1202 located on/at one or more website URLs 1203. A user creates a campaign 1204 and submits their website URL 1205. The system of the present invention then extracts 1206 from the URL, the website title 1207, description 1208, images 1209, pages and screen shots 1210, IP information 1211, the search reputation 1212, traffic 1213, domain information 1214, owner's email 1215, zip code 1216, and any other information input by the user 1217. Zip codes 1216 are extracted from a search made of the administrator of the domain name, through a “WHOIS” search. Reputation 1212 is obtained from third party providers of free, global web metrics.

A data processor module 1218, running on a computer or equivalent machine, assembles the extracted information on a computer server 1223. The system provides a language selection option where the final product can be created using one or more languages and then published, publically or privately, printed, and submitted for creation 1219.

Finally, one or more website campaigns or advertisements are created 1220 along with a complementary website search software application 1221 which can later be edited 1222.

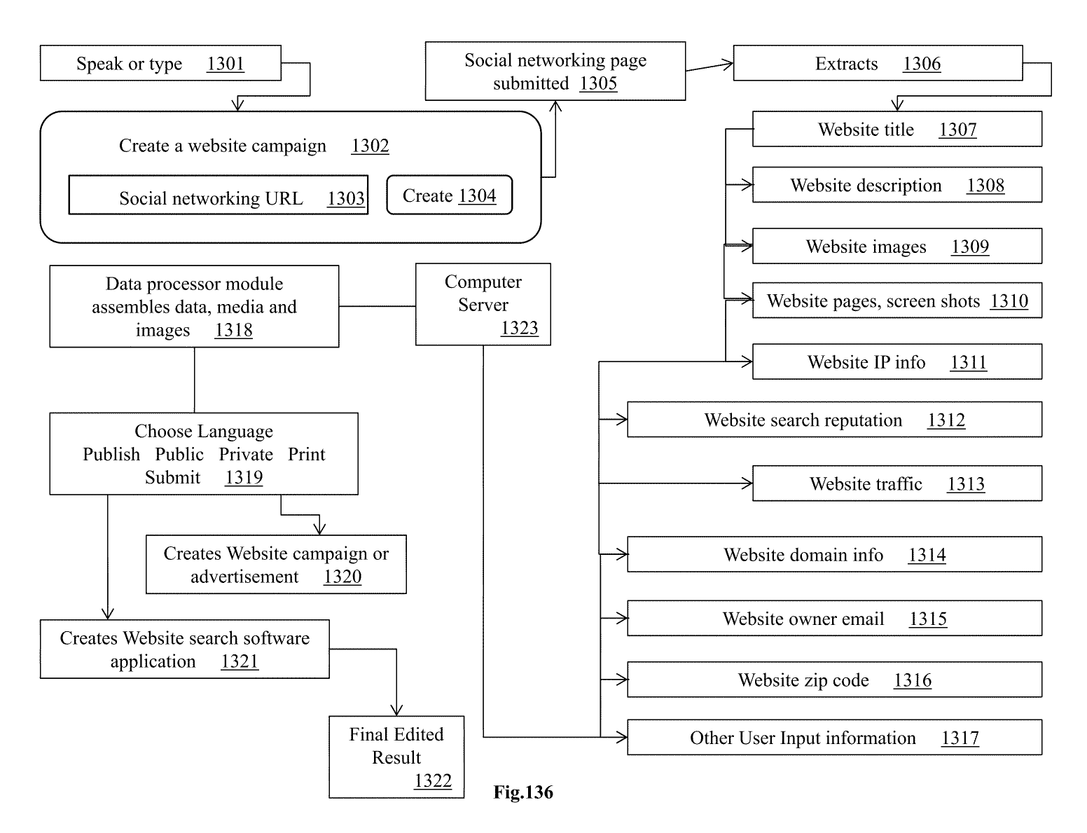

FIG. 136 is a flow chart illustrating the transformation of social networking pages to one or more advertisements. A user would first speak or type 1301 into a computer or equivalent device running the software executing the method, which ties the software comprising the process steps to a computer for execution. The graphical user interface (GUI) is a website campaign editor front end 1302 located on/at a social networking URL 1303. A user creates a campaign 1304 and submits their social networking page 1305. The system of the present invention then extracts 1306 from the URL, the website title 1307, description 1308, images 1309, pages and screen shots 1310, IP information 1311, the search reputation 1312, traffic 1313, domain information 1314, owner's email 1315, zip code 1216, and any other information input by the user 1317. Zip codes 1316 are extracted from a search made of the administrator of the domain name, through a “WHOIS” search. Reputation 1312 is obtained from third party providers of free, global web metrics.

A data processor module 1318, running on a computer or equivalent machine, assembles the extracted information on a computer server 1323. The system provides a language selection option where the final product can be created using one or more languages and then published, publically or privately, printed, and submitted for creation 1319.

Finally, one or more website campaigns or advertisements are created 1320 along with a complementary website search software application 1321 which can later be edited 1322.

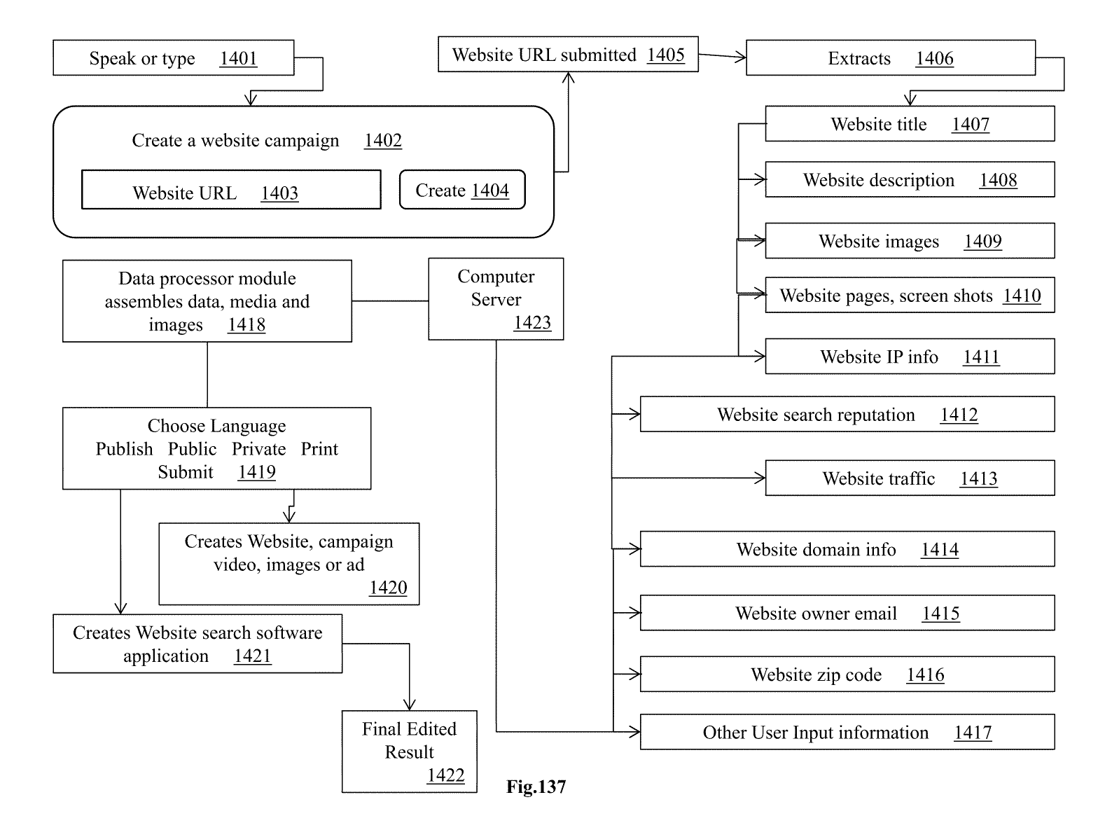

FIG. 137 is a flow chart illustrating the transformation of one or more words to a website, campaign, advertisement, or video. A user would first speak or type 1401 into a computer or equivalent device running the software executing the method, which ties the software comprising the process steps to a computer for execution. The graphical user interface (GUI) is a website campaign editor front end 1402 located on/at a website URL 1403. A user creates a campaign 1404 and submits their website URL 1405. The system of the present invention then extracts 1406 from the URL, the website title 1407, description 1408, images 1409, pages and screen shots 1410, IP information 1411, the search reputation 1412, traffic 1413, domain information 1414, owner's email 1415, zip code 1416, and any other information input by the user 1417. Zip codes 1416 are extracted from a search made of the administrator of the domain name, through a “WHOIS” search. Reputation 1412 is obtained from third party providers of free, global web metrics.

A data processor module 1418, running on a computer or equivalent machine, assembles the extracted information on a computer server 1423. The system provides a language selection option where the final product can be created using one or more languages and then published, publically or privately, printed, and submitted for creation 1419.

Finally, one or more websites, campaigns, videos, images, or advertisements are created 1420 along with a complementary website search software application 1421 which can later be edited 1422.

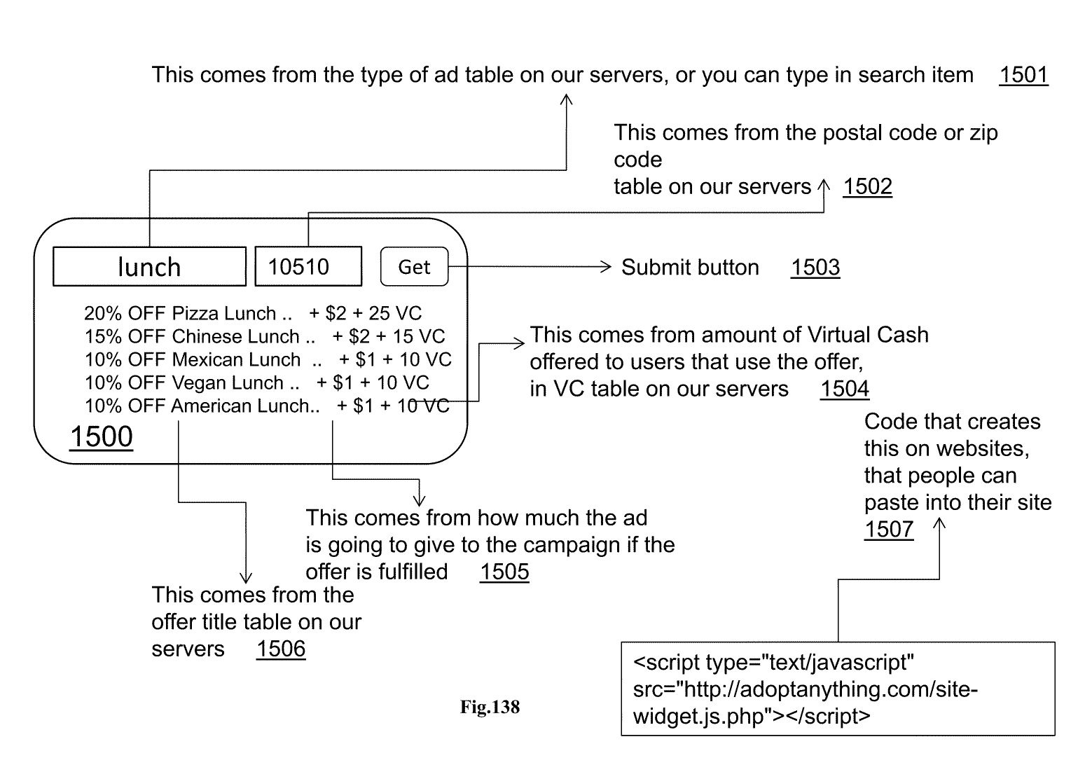

FIG. 138 is an illustration of the website search software application module 1500 of the present invention. The website search software application module 1500 is generated either by tables on the servers of the present invention or by the entry of a search item 1501. The postal or zip code is generated by a table located within the server. When a submit button 1503 is selected, a search is performed based on the type of ad 1501 and postal code 1502 entered. Results are then generated from the title table in the system server 1506, and the price for each offer is determined by how much the advertisement is going to give the associated campaign 1505. The amount of virtual cash offered to a user for using the advertisement is also generated by a table within the server 1504. The system also generates code that can be pasted into other websites 1507.

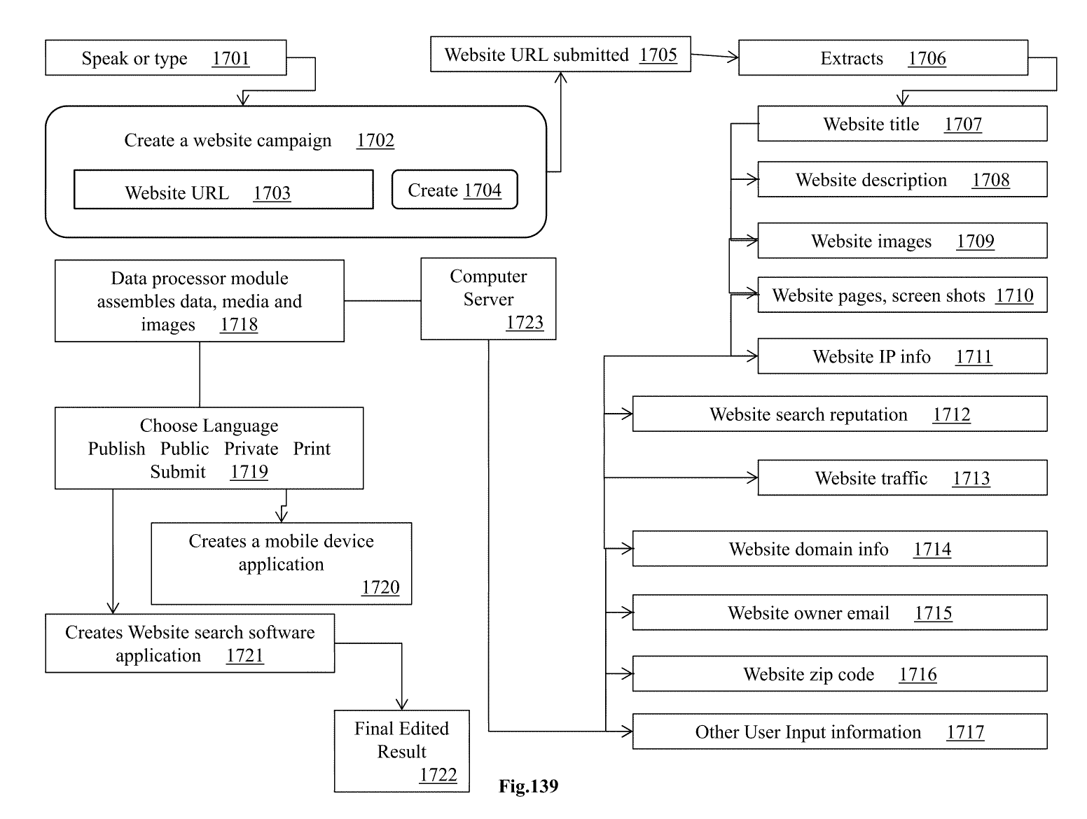

FIG. 139 is a flow chart illustrating the transformation of a website to a mobile device application. A user would first speak or type 1701 into a computer or equivalent device running the software executing the method, which ties the software comprising the process steps to a computer for execution. The graphical user interface (GUI) is a website campaign editor front end 1702 located on/at a website URL 1703. A user creates a campaign 1704 and submits their website URL 1705. The system of the present invention then extracts 1706 from the URL, the website title 1707, description 1708, images 1709, pages and screen shots 1710, IP information 1711, the search reputation 1712, traffic 1713, domain information 1714, owner's email 1715, zip code 1716, and any other information input by the user 1717. Zip codes 1716 are extracted from a search made of the administrator of the domain name, through a “WHOIS” search. Reputation 1712 is obtained from third party providers of free, global web metrics.

A data processor module 1718, running on a computer or equivalent machine, assembles the extracted information on a computer server 1723. The system provides a language selection option where the final product can be created using one or more languages and then published, publically or privately, printed, and submitted for creation 1719.

Finally, one or more mobile device applications are created 1720 along with a complementary website search software application 1721 which can later be edited 1722.

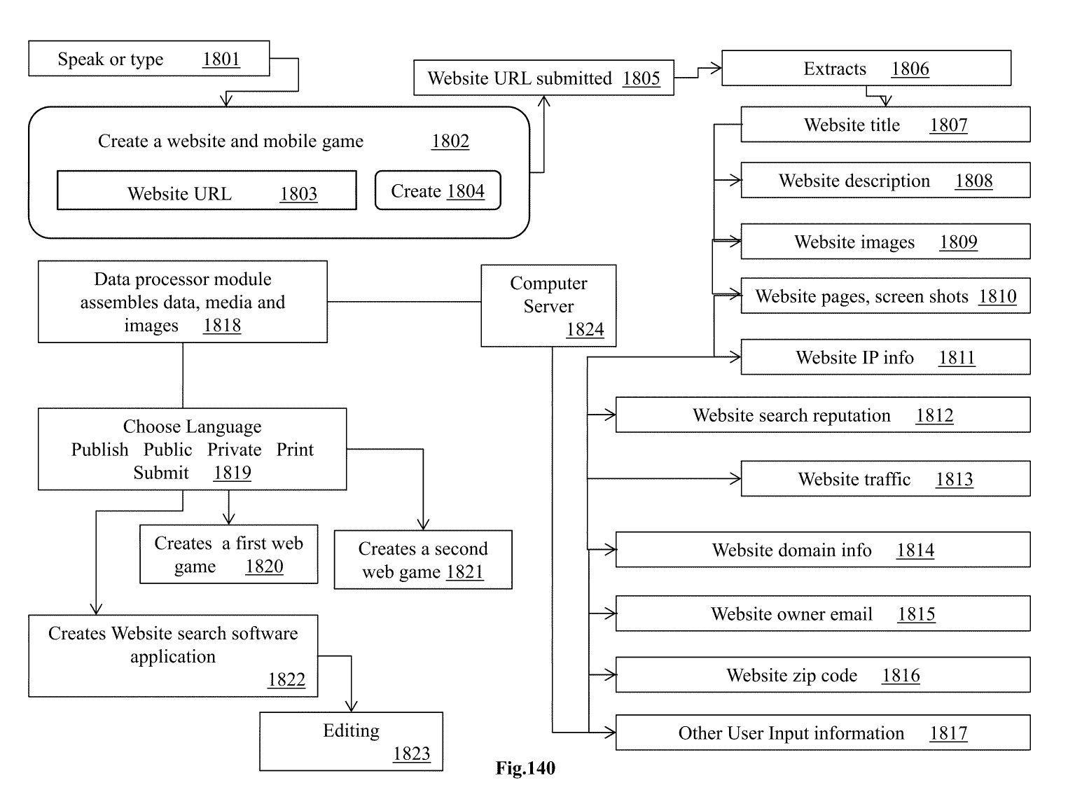

FIG. 140 is a flow chart illustrating the transformation of a website to a game. A user would first speak or type 1801 into a computer or equivalent device running the software executing the method, which ties the software comprising the process steps to a computer for execution. The graphical user interface (GUI) is a website campaign editor front end 1802 located on/at a website URL 1803. A user creates a campaign 1804 and submits their website URL 1805. The system of the present invention then extracts 1806 from the URL, the website title 1807, description 1808, images 1809, pages and screen shots 1810, IP information 1811, the search reputation 1812, traffic 1813, domain information 1814, owner's email 1815, zip code 1816, and any other information input by the user 1817. Zip codes 1816 are extracted from a search made of the administrator of the domain name, through a “WHOIS” search. Reputation 1812 is obtained from third party providers of free, global web metrics.

A data processor module 1818, running on a computer or equivalent machine, assembles the extracted information on a computer server 1824. The system provides a language selection option where the final product can be created using one or more languages and then published, publically or privately, printed, and submitted for creation 1819.

Finally, a first web game is created 1820, a second web game is created 1821 along with a complementary website search software application 1822 which can later be edited 1823.

Now referring to FIG. 140, exemplary screen shots of a website campaign page created by the method of the present invention are shown. Website meta tag information 1901 is displayed on the created website campaign screen. A screenshot of the homepage with a website description form the meta tag information and/or about us page 1902 is also shown in this example. Additionally, thumbnail images 1903 that link to other website pages of the website can be shown on the campaign page.

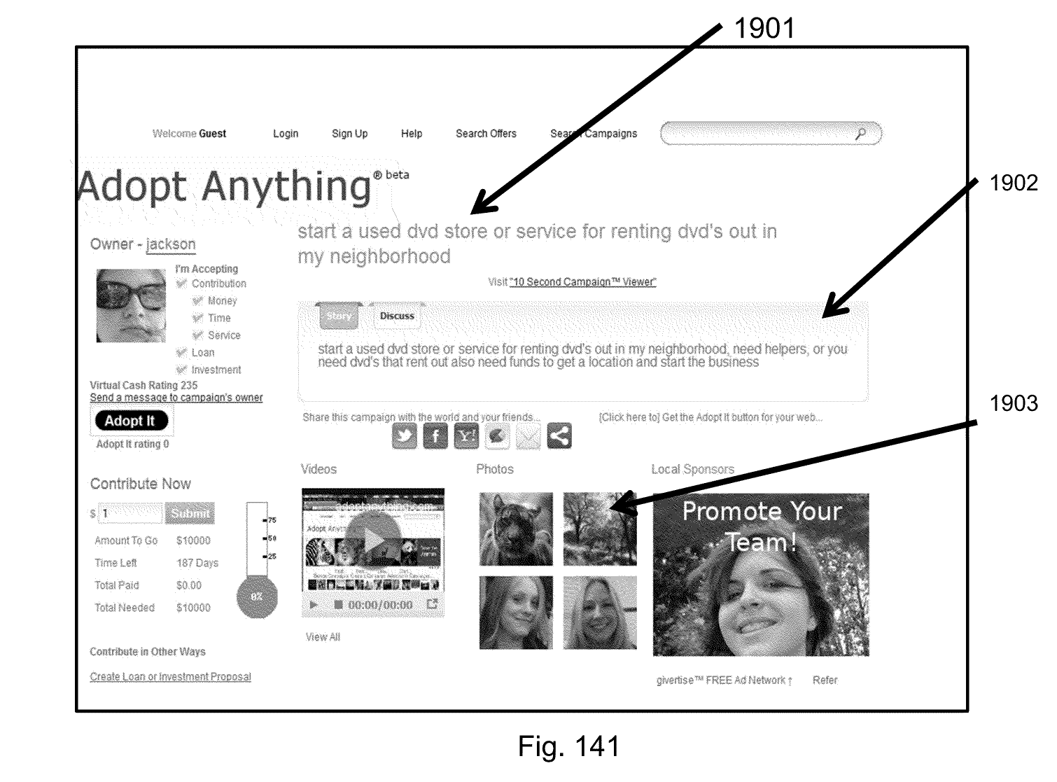

The present invention teaches a user advertising creator module as shown in FIG. 141. An automated machine advertising creator system 800 is comprised of an administration advertising creator system 801 that is embedded into a campaign system 802, or can be run independently on websites 803 or in mobile or static applications 804 that allows uploads 813 with protected intellectual property registration utilizing attachment and encoding intellectual property to the Human Key, and/or a QR code, as a reference for tracking and identification 814. There are multiple functions for taking orders 805, uploading advertisement images 806, adding text advertisements and information807, tracking views and clicks through to offers 808, and links on a website 809, enabling advertisements to be connected to users' campaigns 810, and that sales or transactions from advertisements, must benefit a designated campaign 811 or plurality of campaigns 812.

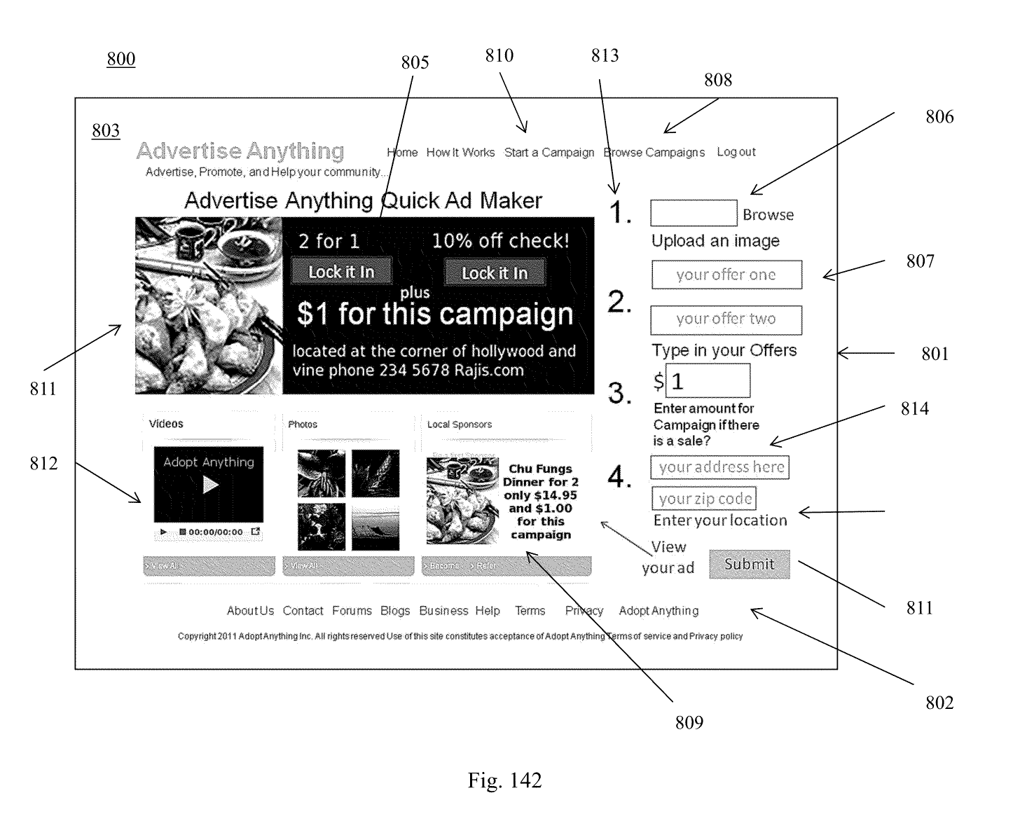

Now referring to FIG. 142, the method for determining an incentive value is described. In a first step 1501 a software module for determining the value of a campaign first takes into consideration the value of offers, video and image content, as well as story design 1502. This is then combined with the performance value of the offers, views, click through, and other statistics 1503 and the value of the contribution as related to the offer or incentive and how many contributions have been received over a set time frame 1504. The valuation engine then stores this information in the database 1505 and determines a valuation.

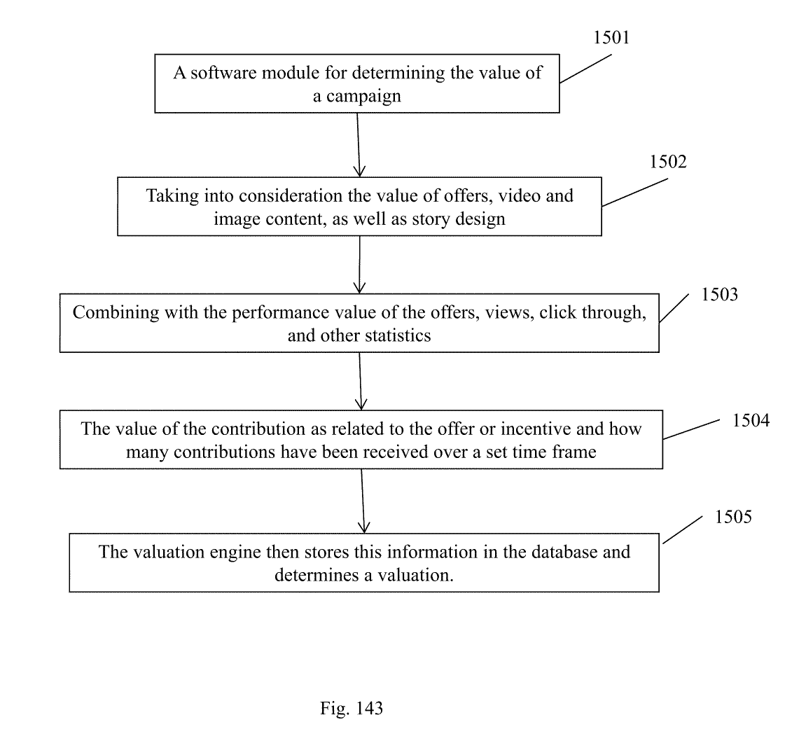

Now referring to FIG. 143, one embodiment of the advertisement creator module is shown. In this embodiment, the advertisement creator creates sponsor advertisements 1801 and sends them to campaigns 1802, video arrays 1803, blogs 1804, websites 1805, print media 1806, billboards 1807, mobile phone apps 1808, coupon books, 1809, consumer emails 1810, search engines 1811, and press releases 1812. The advertisement creator module 1801 can also track historical data 1813, places advertisements up for auction 1814, and interact with the payment module 1701.

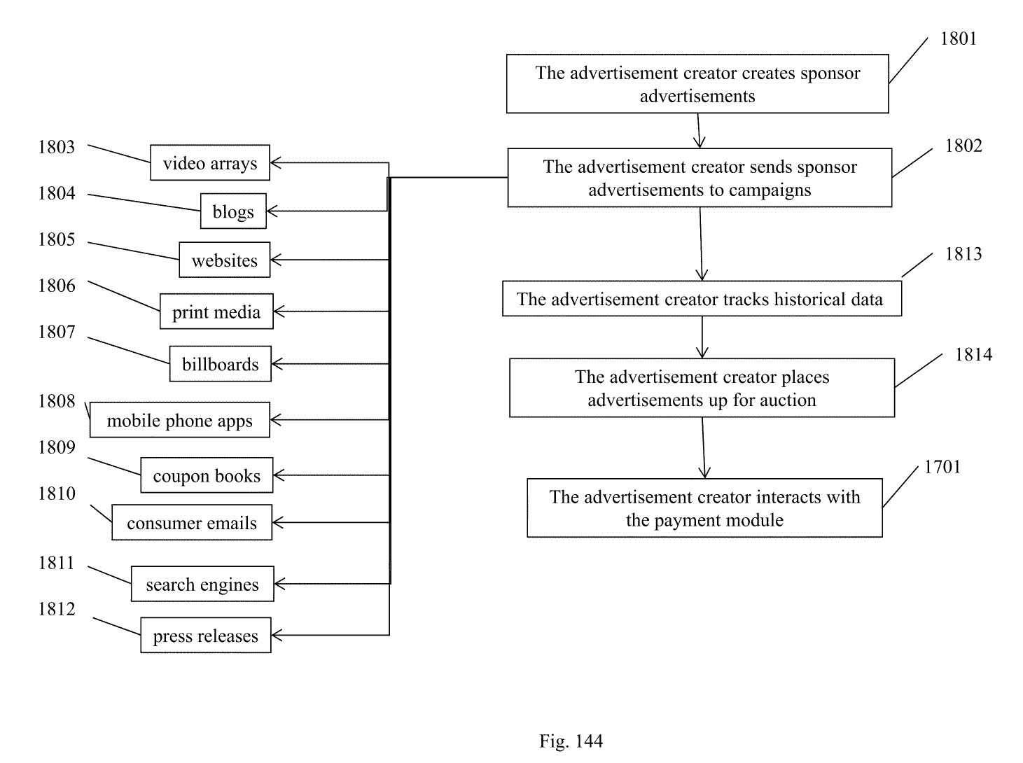

The current present invention is an apparatus for connecting a human key identification to objects and content or identification, tracking, delivery, advertising, and marketing. Now referring to FIG. 144, a plurality mechanisms integrally working as one system is explained. An Independent Clearing House Agent (ICHA) server 101 is connected to a human key server 102 and a Solar Panel Wind Turbine Communications Server 103. The human key server 102 is connected to a translation server 104 and universal virtual world (UVW) server 105 for the management of a plurality of methods and mechanism integrally working as one system 106. A virtual world airport (VWA) server 107 is connected to a Mobile, Handheld, and Independent Device Application Development (MHIDAD) server 108 which in turn communicates with an illumination transformer audio video manager interactive server transmitter (ITAVMIST 109 which communicates with a Virtual Cash Virtual Currency (VCVC) server 110.

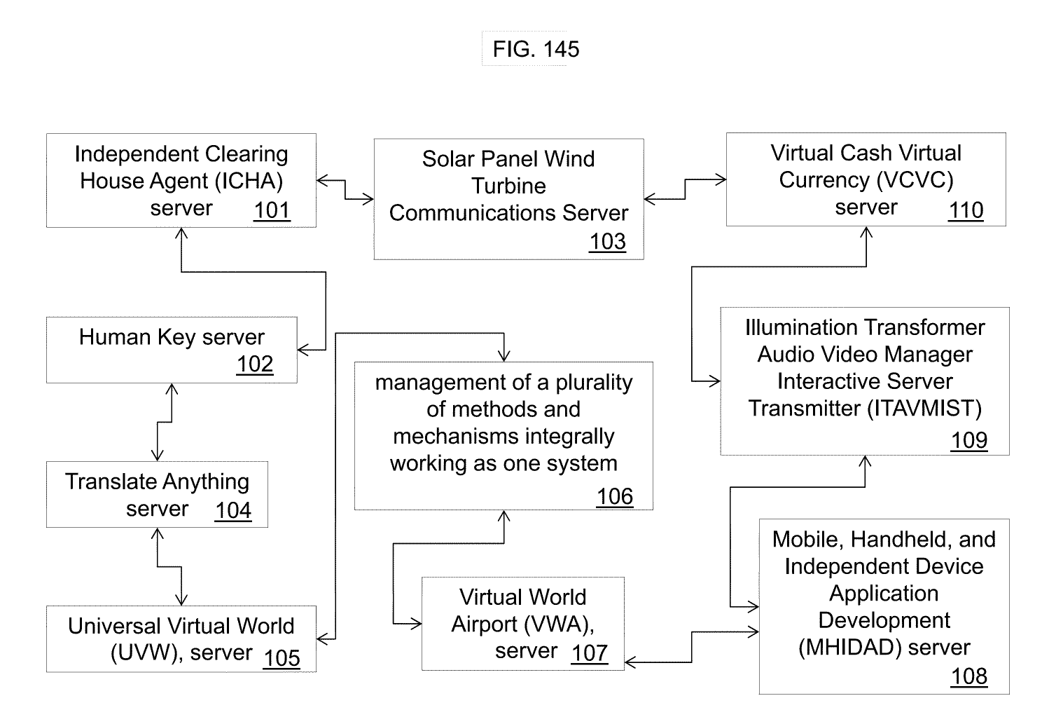

Now referring to FIG. 145, Mobile, Handheld, and Independent Device Application Development (MHIDAD) servers 101 transform and process information 102 and manage content creations 103 and collaboration of mobile phones and handheld applications 104 that can be bought, sold, or used securely within all servers 105. All servers in the invention system are linked together in a single system for managing property in a virtual or non virtual world 106.

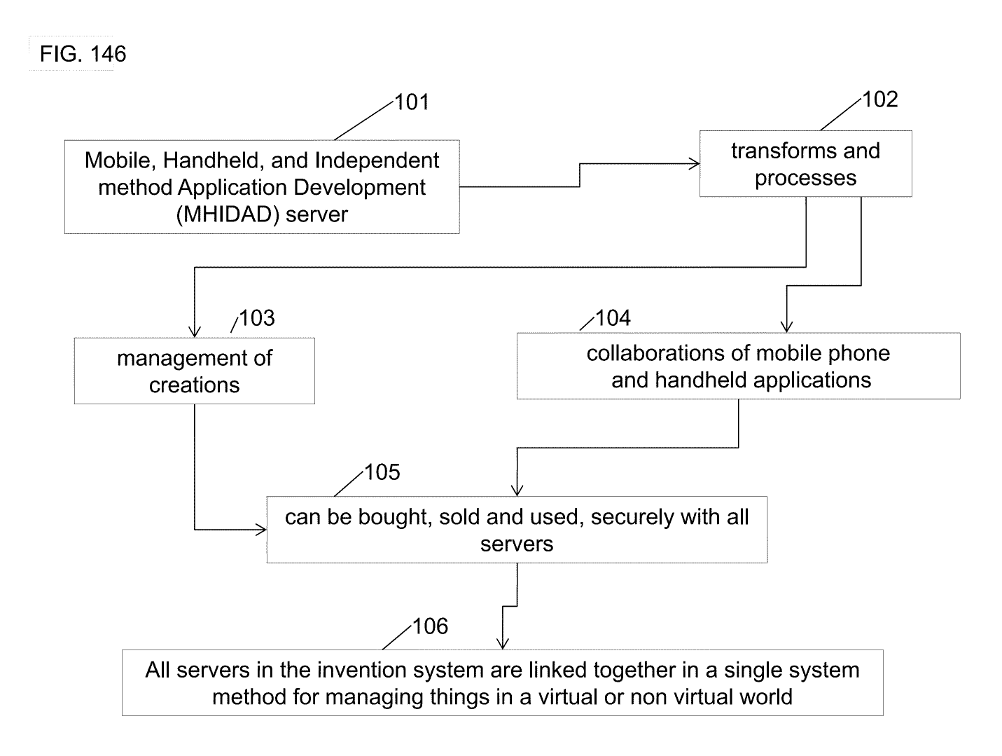

Now referring to FIG. 146, the method of IP property protection using a human key in a virtual and non-virtual world is illustrated. First an Intellectual Property Protection campaign begins 201. The human key server 202 provides authentication and identification services to the campaign started in step 201 by accessing protection databases 203. Upon beginning a campaign, information databases 204 are accessed and a conversion of the campaign into a numerical valuation begins 205. The process then proceeds to calculate who is needed value, time frame, value, a fair value share for investment by investor value, individual or group buying selling value, estimated ROI value, request for pricing value and buying, selling participation in step 206. This numerical determination is then stored in step 207 and implementation of the campaign begins 208.

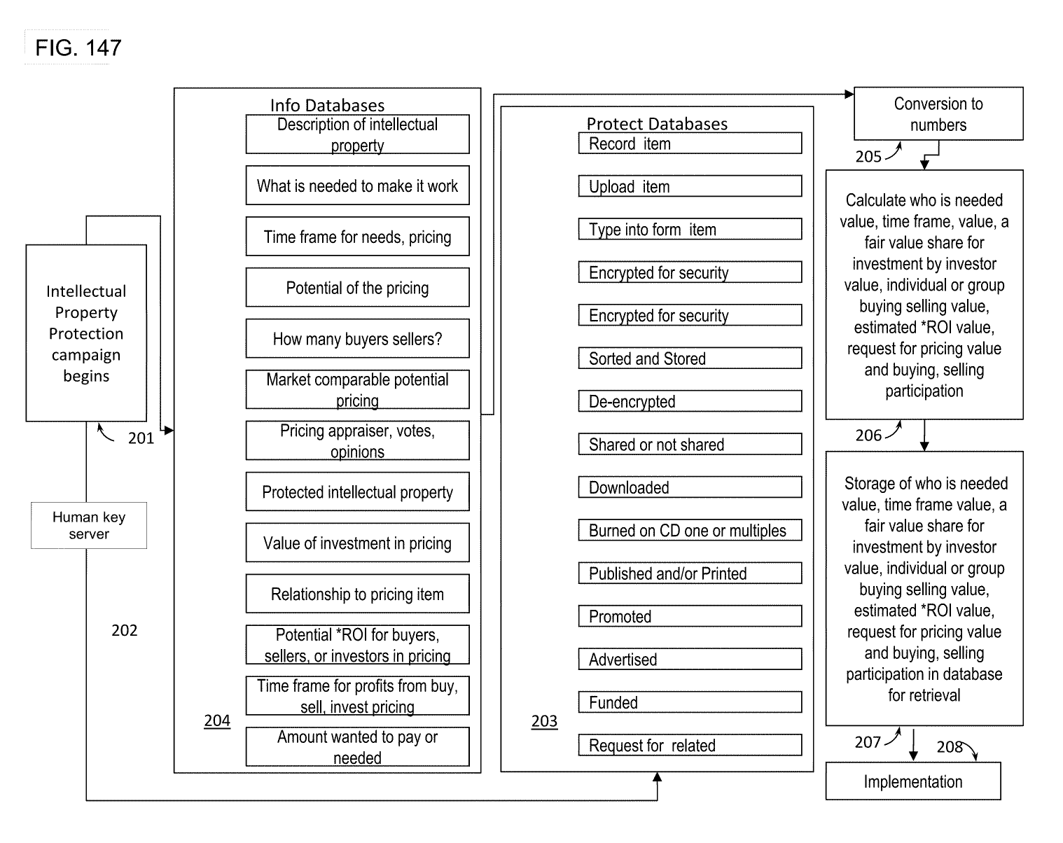

Now referring to FIG. 147, the human key audio video fingerprint identification process is shown. A user 602 first speaks and is recorded with video and audio into a laptop, smartphone, tablet computer, or other electronic device 601 that can record audio and video using a camera 603 and microphone 604. A phrase is spoken 605 and matched to a previously recorded phrase 606. The human key server 607 verifies the phrase and provides confirmation 608 by stating “Good day, a user are now registered and protected in the system” 609. Then it says “please sign in, say your phrase now . . . ” Then the person says, while looking in cam, “Today is the first day of the rest of my life” 610. Then the computer says “A user is successfully logged in” 611. Then a user can use your computer or service or machine or pay something 612.

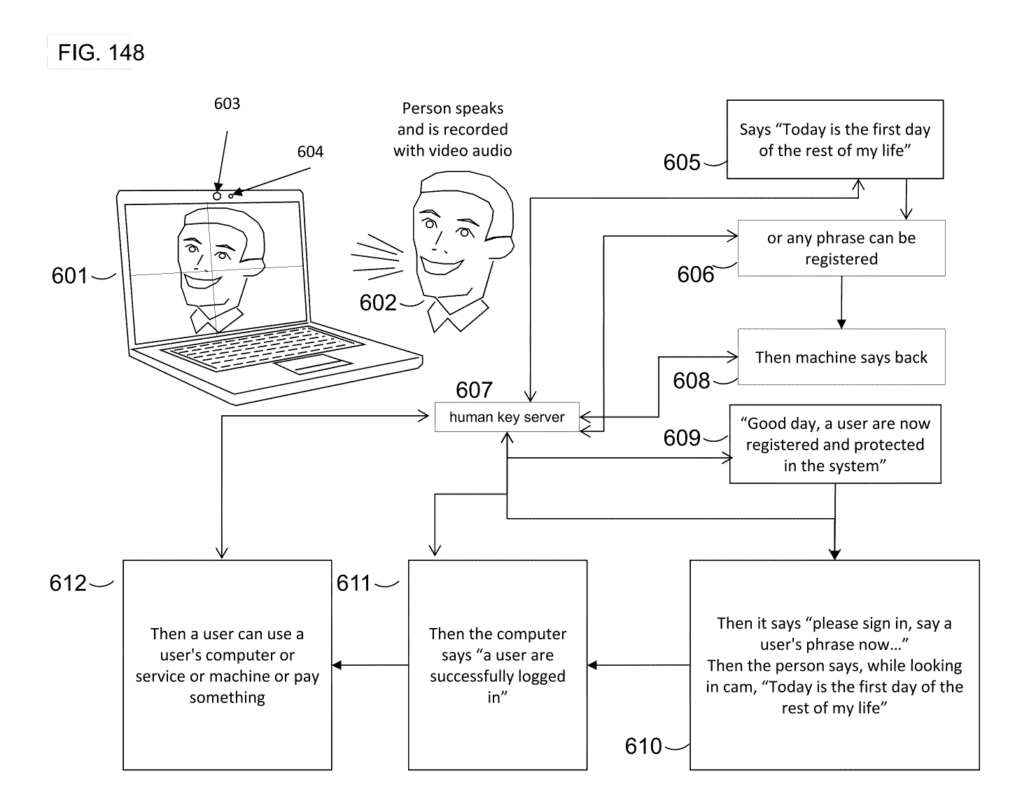

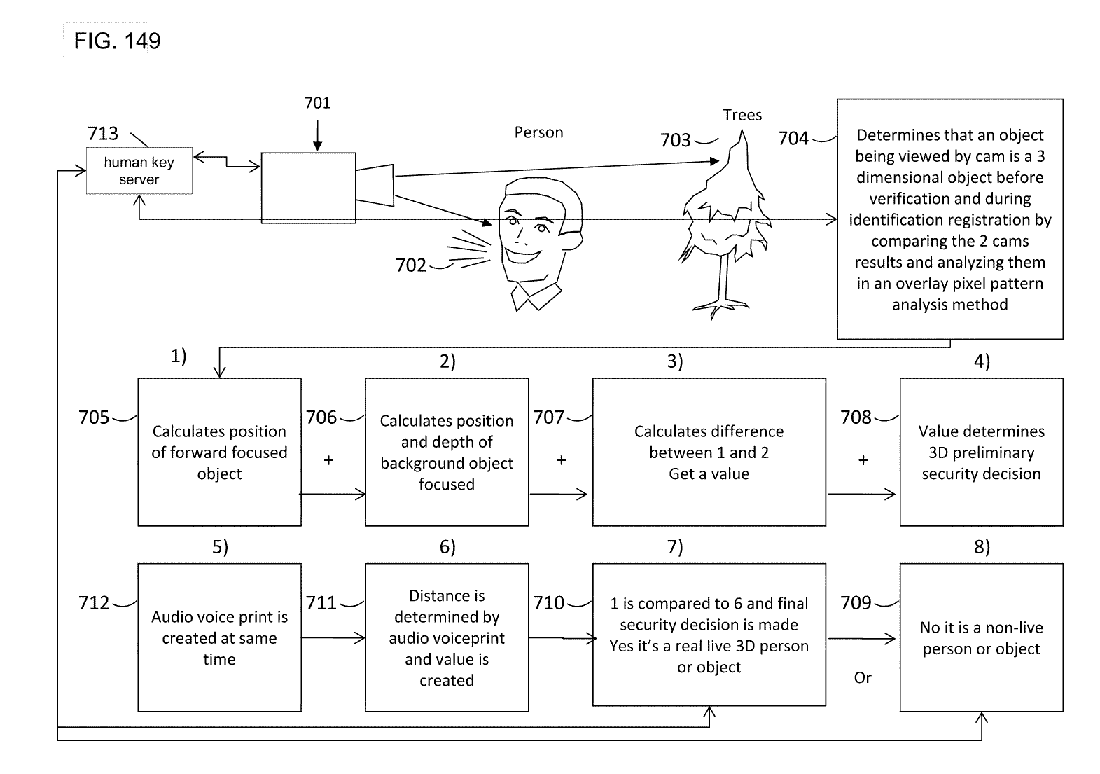

Now referring to FIG. 148, the method for human key 3D identification is shown. First a 3D camera 701 recording a person 702 and background images 703 determines that an object being viewed by cam is a 3 dimensional object before verification and during identification registration by comparing the 2 cams results and analyzing them in an overlay pixel pattern analysis method 704. The first step Calculates position of forward focused object 705. The next step Calculates position and depth of background object focused 706. The next step Calculates difference between 1 and 2 and determines a value 707. The Value determines 3D preliminary security decision 708. An Audio voice print is created at same time 712. Distance is determined by audio voiceprint and value is created 711. position of forward focused object 705 is compared to the Distance is determined by audio voiceprint 711 and final security decision is made 710, Yes it's a real live 3D person or object or No it is a non-live person or object 709. This information is then stored in the human key server 713.

In another embodiment of the present invention, the method from FIG. 148 can also be used for payment transactions where the person or individual is the credit card. In this embodiment the human key server collects 3D auto and video as described in FIG. 148 and then determines that the user is who was registered in system with a bank or other money holding system. Then person says “pay bill”, “pay”, or “get money” and the human key system knows who a user are with verification of 3D audio, 3D video, and phrase analysis, and 3D security test and “pays a bill” or “pays” online purchase or “gives cash at ATM”. Every time a user day “pay bill” or “pay” or “get money” the system learns from your voice print compared to your video print. Every time a user says “pay bill” or “pay” or “get money” the system learns from your voice print compared to your video print. The system has security human key chaotic event module for emergency needs. This method can be combined with PIN number, mobile dongle, or fingerprint retina scan technology.

In another embodiment, virtual cash currency can be used by the method and system of the present invention. Applications that are created by outside creators, have virtual cash virtual currency (VCVC) connections, and are charged a royalty fee for sales of applications. Properties built in the virtual cash virtual currency (VCVC) world have valuations attached to a human key, and valuations of the properties are updated periodically as traffic, interest, and viewers increase around that properties area, and at least one spot of the property, is required to be allocated for promotions and advertising. The only way to get virtual cash virtual currency (VCVC) in the device is by purchasing content, properties, objects, or services from a user that is registered with a royalty agreement in the system, and that purchase, gives the purchaser an equal amount of virtual cash virtual currency (VCVC) to the actual price paid at an independent clearing house. The virtual cash virtual currency (VCVC) is used for all promotions and advertising in the system, so for an advertiser to advertise in the system they need to purchase content from an outside clearing house and then the advertiser gets a specified amount of virtual cash virtual currency (VCVC) to use in the system. virtual cash virtual currency (VCVC) is paid to a registered user for any content added to the content bank, idea bank, or intellectual property bank, automatic promotions are added to the payment package for promoting sales, collaborations, reviews, and assistance with services, manufacturing, further promotions, editing, and packaging, transactions. All methods and devices are attached to the human key for tracking, security, and identification. To purchase anything in the system a user are required to have virtual cash virtual currency (VCVC) and when a user register in the system a virtual bank account is setup and websites, and virtual entry points can charge a certain amount of (VCVC) for a user to be able to enter. The virtual cash virtual currency (VCVC) is used in a listings guide for valuations of properties, content, objects, and entities, continuously in the system for immediate availability and value determination of properties.

The virtual cash virtual currency (VCVC) method and device is used for valuations of content uploaded into the system, and is displayed when content is stored, so that a work of art, writing, photograph, movie, video, song, idea gets a certain amount of virtual cash virtual currency (VCVC) when it is added to the system. A certain amount of royalties are automatically attached to the content, and attached to the human key for security, identification, tracking, and transactions. All content, and contracts dependent upon content are secured, attached, and signed by the user's human key, and cosigned by the virtual cash virtual currency (VCVC) Intelligent Virtual Private Currency Server node system device administrator human key. A Virtual World design center device, and Virtual creative lab device attached to the human key for architects, or want to be architects, and designers to create their designs, display them, transact them, find professional users to bring them to life, or just test them to see the validity of the design.

An applications store device for open source applications related to the virtual cash virtual currency (VCVC) virtual world device, for use with purchases made utilizing virtual cash virtual currency (VCVC) virtual world currency, in a virtual world or non virtual world, where a user can list, package, protect, request a sponsor, collaboration, sale or investor, market with shared advertising and revenue or promote is also taught by the present invention. Virtual World Payments, Currency, Money, Credit, Debit, Buying, Selling, protection, Privacy, Trading, and Barter can be done within a no charge to join, or a fee to join, system, where even smaller percentage is paid for rights on goods related to content indefinitely, so if a content is sold many times over the years, the system operators will continually get a percentage of every sale made for the content promoted in the virtual cash virtual currency (VCVC) device platform system. A percentage of the royalties paid when content is sold is paid to the system operators, and where a larger percentage if the sales royalties are a onetime rights sale, and smaller percentage is paid to the systems operators if royalty rights are charged for every sale of goods related to the content for a longer time such as 10 years. A virtual world bot agent for making automatic deals involving content in virtual world with attached human key universal wallet, that can work in any virtual world, or non virtual world wide web, buy additional promotion with virtual cash virtual currency (VCVC) virtual world currency where a virtual world transaction exchange, and management area for pricing content submitted, is provided in the system, and a universal tool kit for making designs for packaging, and creating virtual world contracts, is included in.

A Virtual World transaction exchange device attached to the human key device, for users to create, manage, and market transactions in the virtual world is also taught. Transactions can be uploaded to the real world and deals are controlled by users, and the system gets only a percentage of the deal made, unless another agreement is recorded for the transaction by the user(s) in the system. A Virtual World witness device attached to the human key device, for a user to have an authorized record for, check writing, check cashing, agreements, contracts, proposals, signing of documents, legal and medical transactions, procedure and records. A Virtual World Adopt Anything device attached to the human key device, for creating, managing and fulfilling Adopt Anything Campaigns, in a virtual or non virtual world. A Virtual World rights management device attached to the human key device, for content management of promotions, marketing, and collaboration needs, and rights can be paid with virtual cash virtual currency (VCVC). A Virtual World Resume device attached to the human key device for users to manage, upload, create, store, and distribute their resumes in video, text, image, or 3D virtual world projection, to any spatial point target, or virtual world space. A Virtual World Future Goods or Services device attached to a human key where a user(s) can list, shop and trade future user goods, services, and/or skills at a specified future time, for financial help, loans, virtual cash virtual currency (VCVC), medical services, or any variation of help. A Virtual World try out product device attached to the human key device for users to be able to try out products, services, or ideas, in a user's own space, the virtual world, or in real world stores, or at point of purchase, or point of display, and additionally a method and device for a user to get virtual cash virtual currency (VCVC) for trying out things in the Virtual World or real world.

In another embodiment, Color Band Encryption De-Encryption can be used for identification and authentication. A user 801 speaks into electronic device 802 equipped with a microphone 803 and 3D cameras 804. The cameras 804 target the tip of the nose of the user 801. The human key server 805 performs 17 pattern matching and processor tests and routines and Creates pixel color band array converted to position numbers 808. The audio and video can also be captured by mobile devices 806 or an ATM machine 807. Wavelength data is created into encrypted numbers, stored in database and then de-encrypted for identification 809. Then final number is compared with “wavelength Fourier Wave Form”, “3D Analysis”, “Audio Fingerprint”, “Video Fingerprint” and a 100% match is obtained for identification 810. Flash produces tighter range 811. Shades of lightness or darkness always in the same live range 812.

In yet another embodiment of the present invention, an Artificial Neuron Processor device (GANPM), that is made up of a sensory device for responding to stimulus, of touch, sound, and light, temperature, contained in a liquid for the purpose of cooling, communication, noise reduction and chemical stimulations of the device. The device communicates information and data of reactions to stimulus directly to the Main processor, and/or the other Artificial Neuron Processor devices for decisions, in recognition of objects, spatial distances, positions, human faces, and human words. The device transformation of stimulus from Artificial Neuron Processor devices (GANPM) and/or Artificial Neuron Processor device Arrays (GANPMA), for visual and audio identification, by utilizing processes, where a plurality of Artificial Neuron Processor devices, each having their own stimulation reactions tasks preprogrammed, are used for the purpose of the device reacting to stimulus, independent of each other device, and furthermore are not affected by each other's separate programmed stimulus task, or response firing from stimulus, and furthermore in the event that the independent Artificial Neuron Processor device fires, after reacting to having been stimulated by some stimulus, the firing of the neuron, is instantly communicated to, and causes a reaction in the main processor, and furthermore where each Artificial Neuron Processor device can have a plurality of independent stimulus processes programmed into it, so it can multitask, and communicate with the main processor and other Artificial Neuron Processor devices (GANPM), but not be affected by other Artificial Neuron Processor device units. All devices can work in a Virtual World(s) and/or non virtual world(s), in digital computers, and/or Quantum computers, and/or Neuron Computers and/or online or offline. All devices can be attached to the human key, for identification, programming, and security. The Artificial Neuron Processor device (GANPM), can be used in the human key device system, as a 22nd redundancy check device for identification of a human, a plurality of humans, or an object or a plurality of objects, throughout the system and all the devices

In another embodiment of the present invention an incentive device for utilizing points, and discounts with scanning, capabilities for matching with products can be incorporated into the method. The first step is to scan to see if the product has a rebate, discount, coupon, or Virtual Cash incentive that can be used in the current purchase being considered. The device is connected to the human key for identification. A user has to simply scan the product with their mobile phone, hand held, or any device enabled with product registration scanning capabilities, to see the discount, other offers, Adopt Anything or Collaboration Group Buy Sell incentive campaigns. A user then purchases and gets the incentive, discount, coupon, or information. The purchase is then charged to the user's Human key, or a user is the card account.

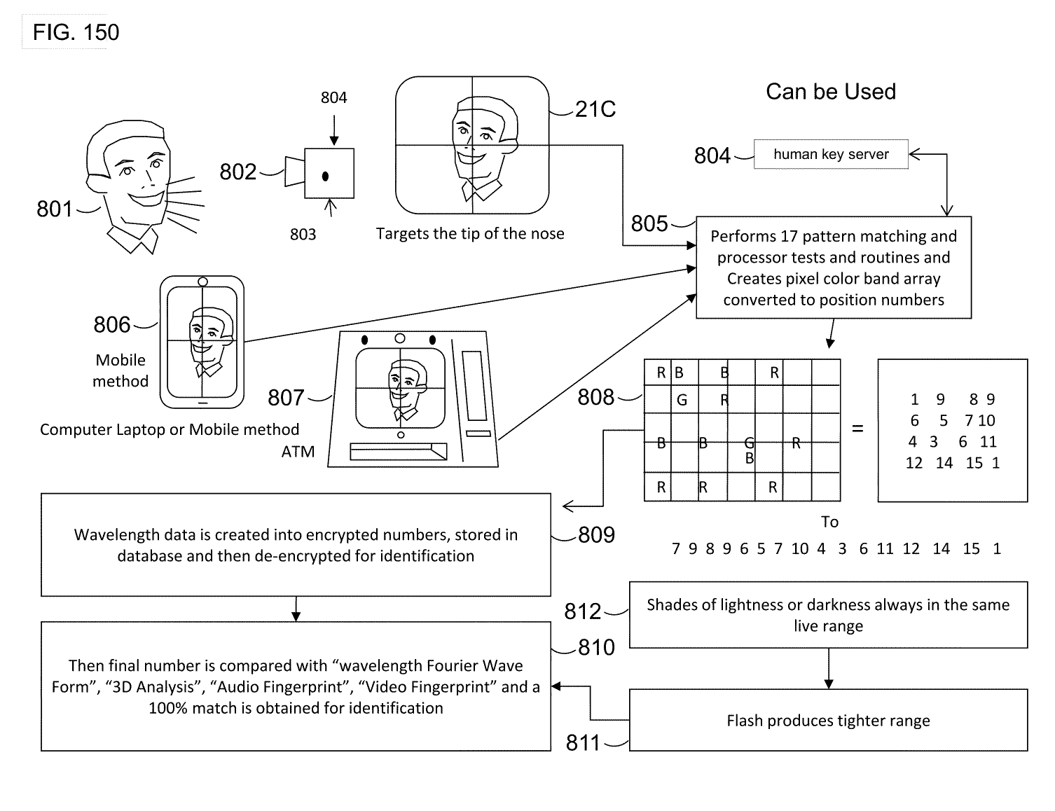

Now referring to FIG. 150, the method for the identification process of the present invention is shown. A user first speaks to create an audio voice print 901. Cam streams video images and creates video print 902. Video data is converted to color band calculated pattern to numbers 903. All is registered in database with special interpolation algorithm as a digital fingerprint 904. Next the user speaks a phrase and creates an audio voiceprint login 905. The cam streams video images and creates a video print 906. Video data is converted to color band calculated pattern to numbers 907. All is compared to database of pre-registered audio video prints digital fingerprint and if it is a match then a user get hello “Sam” your name 908. The human key knows who a user is 909 on the human key server 911. The processing of all information is at the main server at human key so there are no slowdowns on the thin client systems like mobile or laptops 910.

The human key can be attached to anything such as consignments, specific individuals in a corporation, object or devices for users in a virtual world, Virtual Purchases, Individual Steel Vaults, Virtual Vaults, or any vault, or bank account in a Virtual World, real world purchases, sales transactions, loans; layaway of products and/or services for spreading payments out over a period of time; credits or debits transactions, barters or trades transactions; spoken transactions; collaborative applications, with a project calendar; and anything can be attached to the human key by corporations, entities, governments, for profit or non-profit, schools, groups, individuals.

The present invention can also process data into intelligent data utilizing a reminder algorithm. Date is entered via text, audio, or video input and identified and authenticated by a human key server. The data can then be displayed, searched, sent to, or set as a reminder and displayed on a computer, or other electronic mobile device.

In yet another embodiment, a method and device for transforming ITAVMIST virtual free space projection display into a multi touch screen free space display device is taught by the present invention. The changes in intersecting infrared laser points aggregated by the ITAVMIST device, records, processes, transforms and creates the information needed for further tracking the touched areas in real time. With the processing and transformations in the servers, the touched areas can be utilized as a control device for the free space display utilizing the transformed pixel points affected by touching the free space pixel area and in applications designed for that purpose, such as scrolling through a gallery of images in free space by just touching the free space projection and sliding your finger along a path, to scroll to the next image.

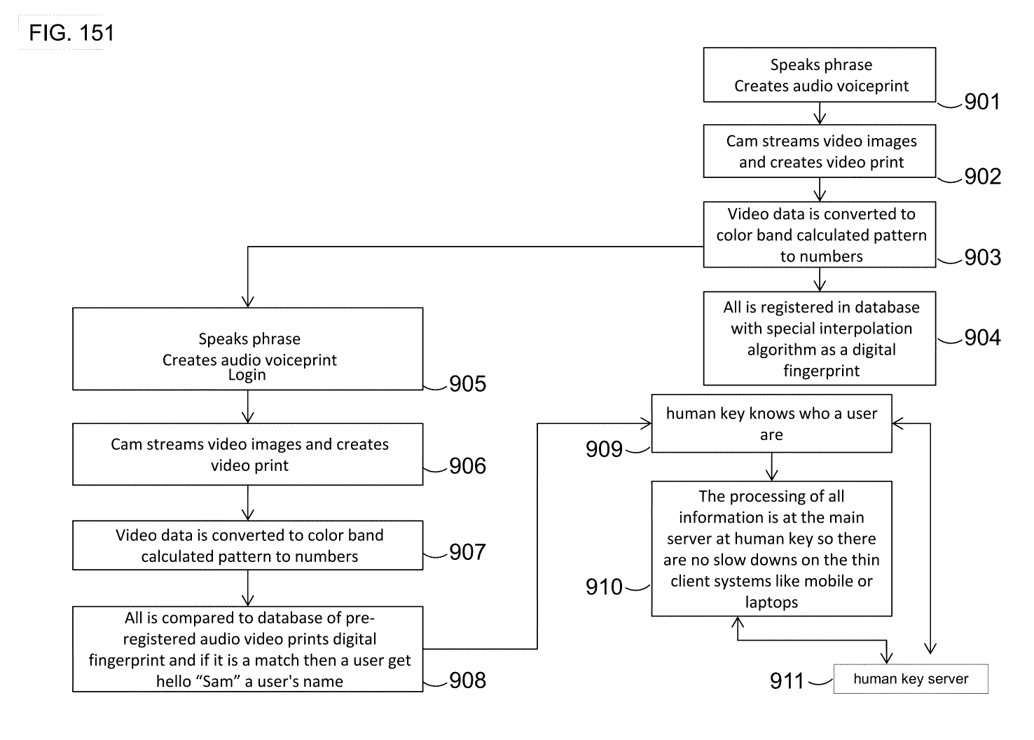

Now referring to FIG. 151, the method for speaking and publishing storage and distribution device with human key device is shown. In the first step, a user 1002 uses a computer or mobile electronic device to access the human key server 1008 for validation and identification 1001. Once validated and identified a user can record anything and it will be attached to your human key identity 1002. Then a user can send it knowing that the place a user send it to will know that your identity is real 1003. It can be stored in the system's human key repository under their ID account 1004. It can be typed from your audio speech instantly 1005. Text can be created from your images, music or video files 1006. It can be made public or private as a verified item for people to access and use 1007.

The human key server can places sponsor ads in search engines, press releases, campaigns videos, blogs, articles, websites, in print media, magazines, books, billboards, coupon books or mobile applications or emails. By using the human key for place the ads, a secure payment system, tracking and advertisement creation and placement system is created.

The method also teaches a rating system where a user, using the same audio and video authentication process, access the system where certified and authenticated ratings can be provided, stored, and utilized. In one embodiment, the rating system and provide a plurality of colored shields corresponding to the level of authentication and certification of a user as well as providing an indicator if they are open or close to accepting licensing of their property. The first color of the shield would identify if a user is registered and identified, a second color of the shield who signal that a user is registered, identified, and authenticated, while a third shield color would signal that a user was registered, identified, authenticated, and certified. A colored bar associated with the shield image would use a first color to signal a user is open to licensing and a second color to signal a user is closed to licensing.

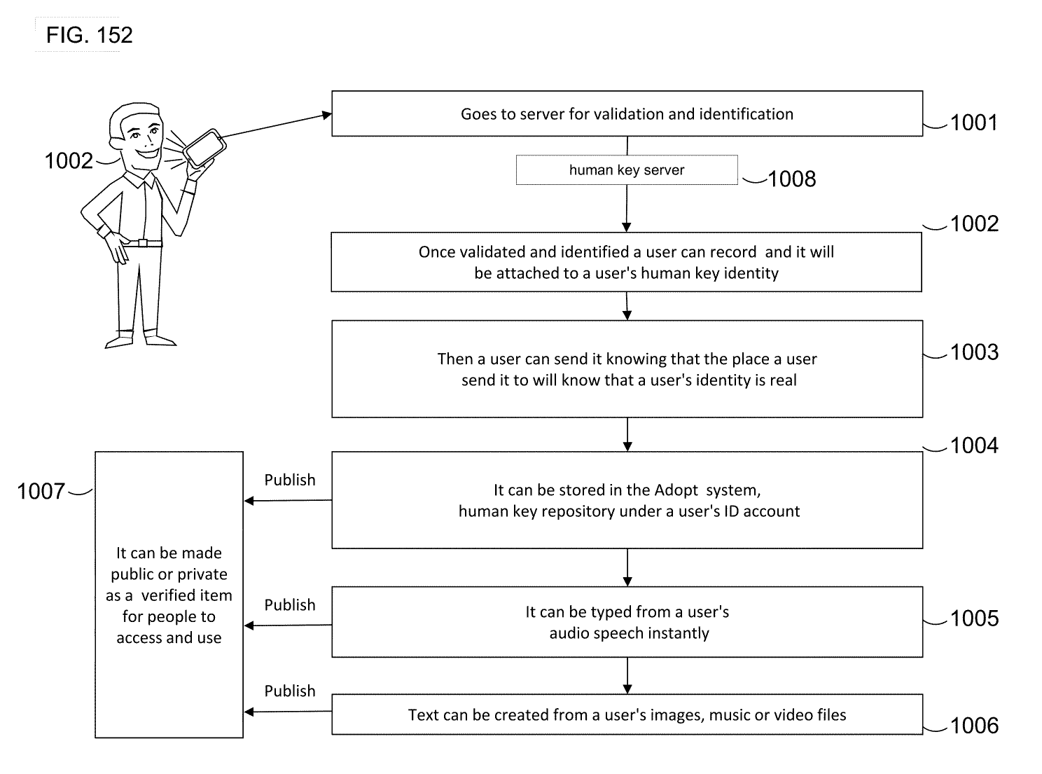

Now referring to FIG. 152, an indexing process is shown. A world domain 1101 is connected to a human key server 1102. In order to determine how much information will get to the top in a request for info 1103 a series of questions are asked: Where do we get that trusted information 1104 and access databases 1112; How can we get to that trusted information 1105; Who do we trust our information from 1106; When do we want to know it 1107; What does a human want to know most 1108; and Semantic keyword balance with relevance 1109. The indexing process then aggregated the information 1110 and the presence is reliable trustable, relevant, information at the right time with the best choice 1111.

In another embodiment a Virtual and Non Virtual World Franchises system attached to the human key list franchises to be bought or sold. A user can manage, track and transact royalties paid to original franchise business or store; create independent ownership contracts, and agreements; list and test potential franchise schemes and find interest in group ownership transactions; and manage all aspects of the creation, and running of franchises, including using virtual cash virtual currency (VCVC) for franchise fees, in the virtual world and non virtual world.

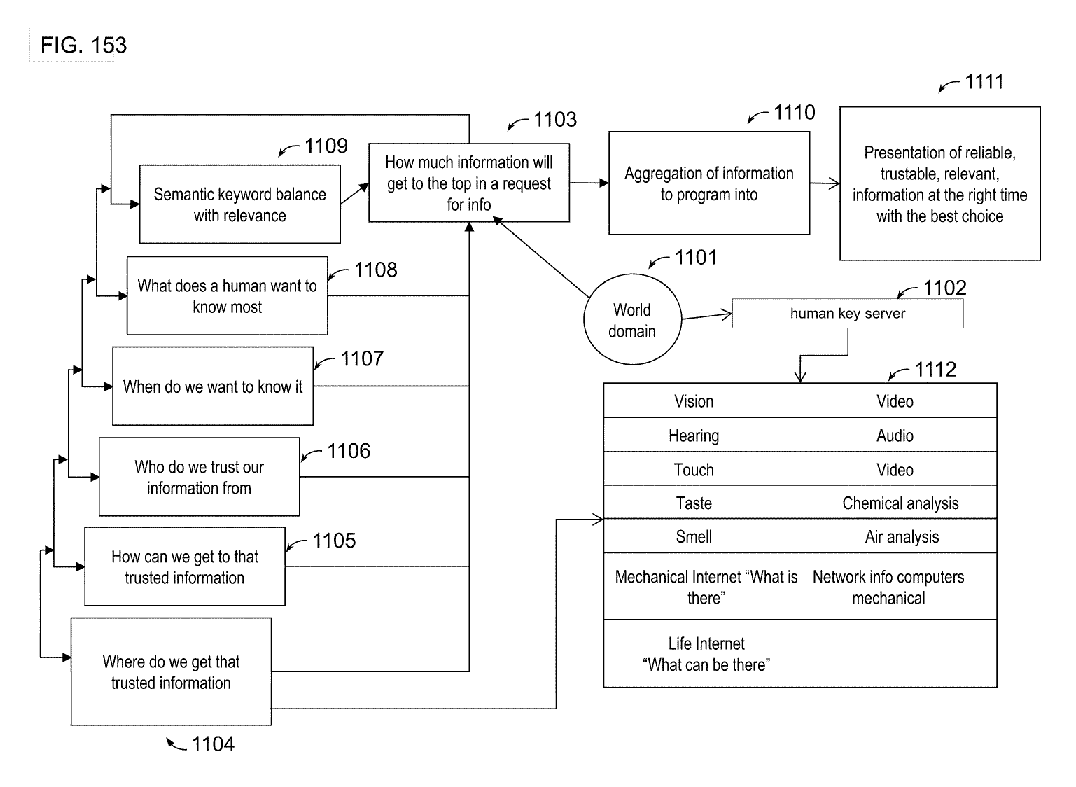

Now referring to FIG. 153 the human key is connected to a sense system which takes human information and inputs it into storage 1201 via a life interne 1206 and mechanical interne 1205. Sense input 1202 is stored in relevant databases 1203 connected to the human key 1204. The human key server 1204 Verifies credibility of that information with various human checks and balances 1209; Compares sources and semantic terms with human key certified data 1208; Re-sorts data into relevant storage areas 1207; Then gives human information at the right time, right place for human decision making 1210 Spatial point delivery system 1211; and feeds a personality system automatically 1212.

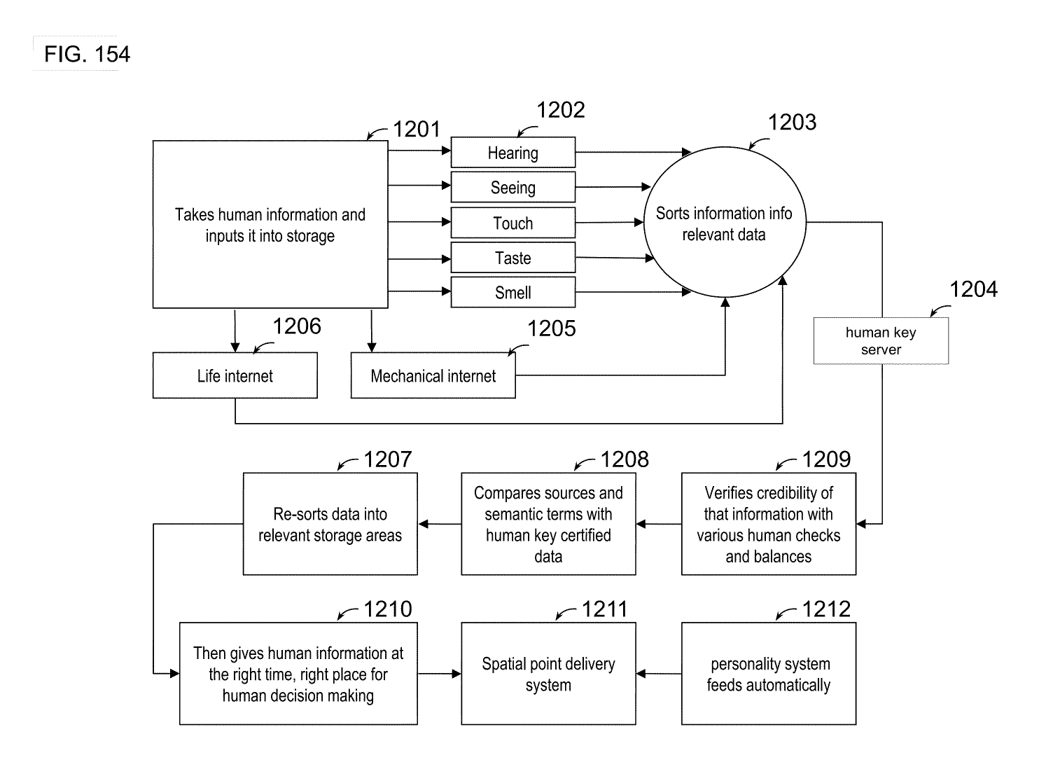

FIG. 154 illustrates an Open Source Clearing House Software device in Virtual and Non Virtual World. First open source clearing house software is provided 1401, for anyone to create an auction, website, virtual world place, store, directory, listing area clearing house with ability to charge a fee for services rendered in selling properties, real estate, content, objects, services, and convert real world sales into virtual cash virtual currency (VCVC) virtual world currency, automatically at the moment of purchase and payment 1402. AN open source platform applications creator is provided, for creating applications to work outside and within the area of operations 1403 and is connected to the human key server 1404 for promotion, traffic building, gaming, store purchases, sales, packaging, marketing, with content distribution, and delivery network from virtual cash virtual currency (VCVC) server node, with a semantic evaluation for a content provider to give reminders of when to get an editor, service person, professional marketer, publisher, music promoter, or any other expert for promotions of a user's content, or providing remind anything recommendations connected through the request anything system and device for assistance after a user's content is uploaded and secured with the human key 1405.

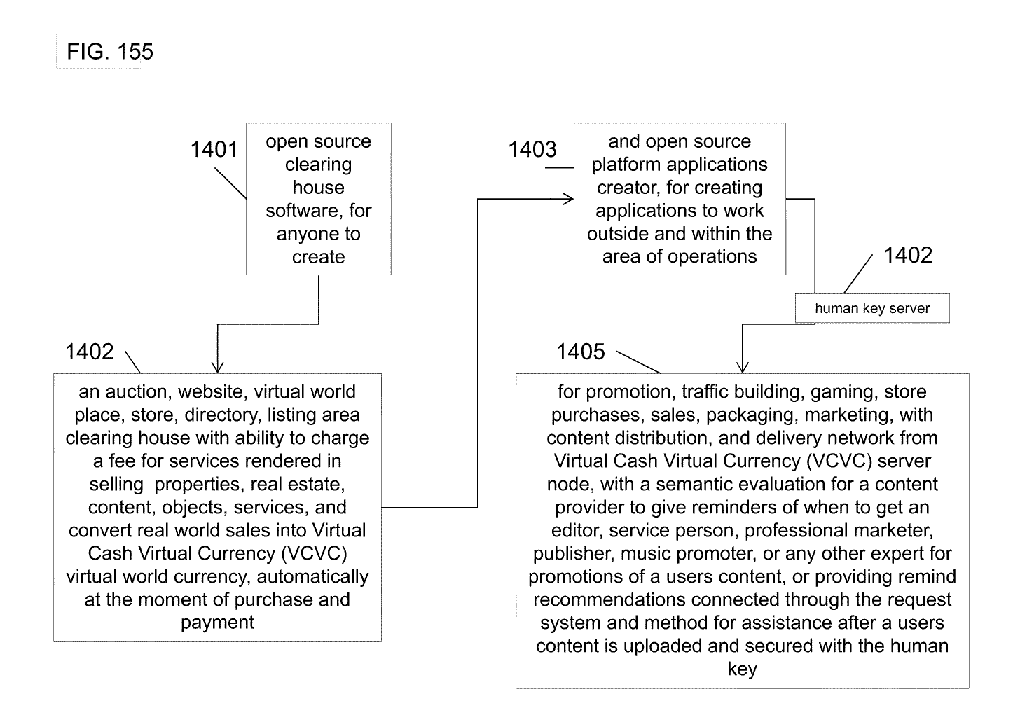

Now referring to FIG. 155, the phrase analysis and recognition method is shown. Enrollment begins with, saying favorite key phrase while nose on target cross hair 1701. A 30-60 second video is created 1702 and 300 images 1703 and audio 1711 are extracted for analysis. A Fourier, image analysis and storage in same field as the key phrase 1704 then stored until a person wants to be identified 1705 in the human key server 1706. A Fourier, audio analysis and storage in same field as the key phrase 1707. Voice recognition transforms the key phrase to a typed phrase 1708. A database storage of the typed key phrase later used for initial search to narrow the search array 1709. Enrollment can also be used by using verification of the key phrase 1710. Enrollment and Verification with other verification methods such as a driver's license, credit card data, Birth certificate, and social security number can also be performed.

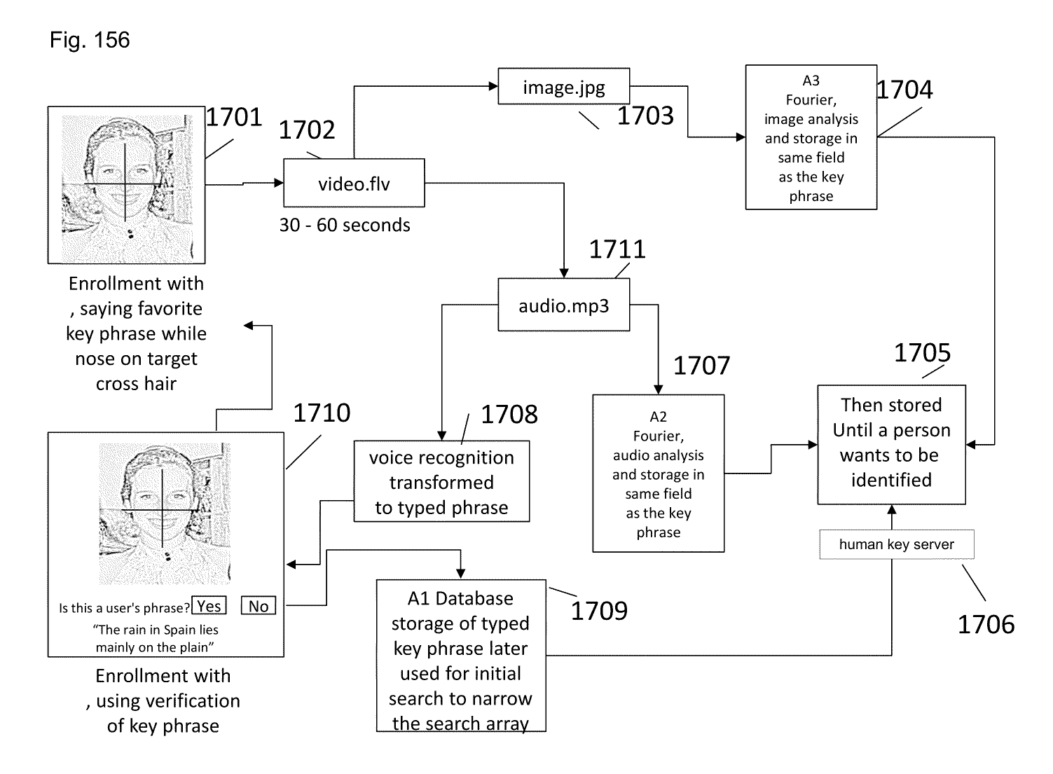

Now referring to FIG. 156, a human key additional multiple encryption audio single words, numbers, music, tones, phrases, human gestures, smells, tastes, symbols, authentication method is shown. Protect Anything Human key Multiple Levels of Encryption 2101. A user says a user's pass phrase first 2002. Then a user is prompted with would a user like an additional encryption phrase 2003 or a user can add additional encryptions 2004. Then when a user want to buy, bid or participate in group or individual purchasing a user say a user's additional pass phrase or other human sense sound, taste, touch, smell, image 2005. The protection server 2006 either approves 2007 or disapproves 2008 after receiving input from multiple human keys 2009 and the human key server 2010.

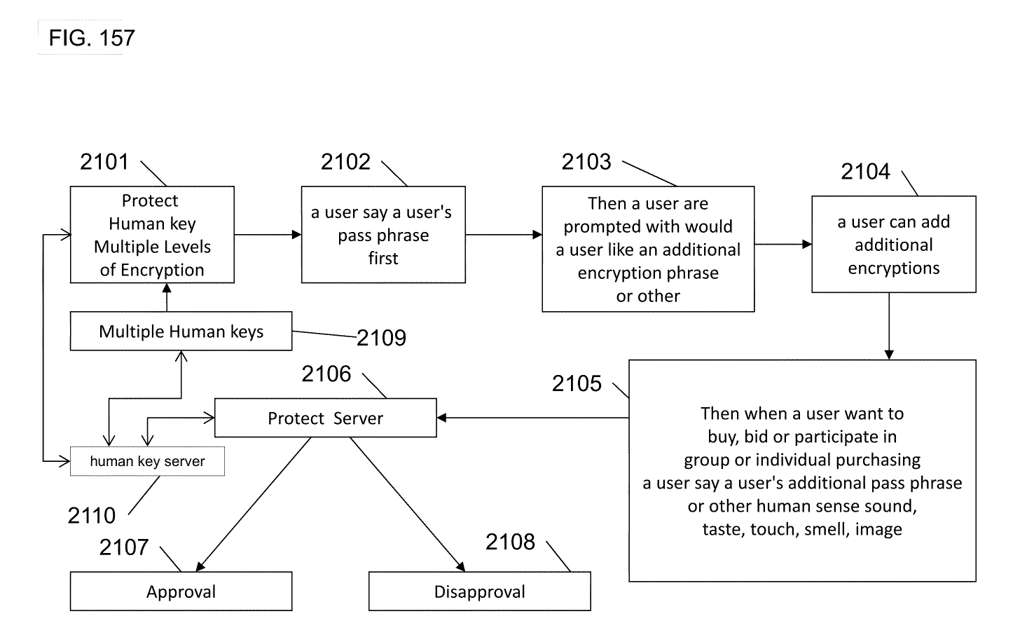

FIG. 157 illustrates the Virtual and Non Virtual World Product, Content Registry method taught by the present invention. A Virtual World product and content managerial method, attached to the human key method, where a user, business, or intelligent machine, individually or in a plurality can, register and manage products, or content, and can upload, download, or link to a store, or storage area for products, or content, and additionally can broadcast, or shout out through the network for experts, services, or manufacturers to get proposals to assist in bringing a product(s) or content(s) to life, or promoting and marketing products, the method can also enable a user to do Virtual World testing of possibilities with products, or content, and track any actions involving products and content, and users can buy, sell or trade products and content, and can send it to an Independent Clearing House Agent (ICHA) for marketing, trading, sales or promotions 2301. A user can search for (VCVC) prices, of products, services, content, objects, and experiences throughout the entirety of a network controlled by, virtual cash virtual currency (VCVC) related areas Virtual Cash currency can be transferable directly to another human key user, in trade for anything of value, through an independent clearing house outside of the system 2302 where a user can create or manage their adopt anything, profile, sponsorship, and campaign in the system 2303. A user can create, and/or participate in, or sponsor a tour of anything, sampling of products, visiting things or places, create product sampling, pay people to sample products, with Virtual Cash currency throughout the system and method 2304. A user, business, or intelligent machine, individually or in a plurality can create or manage their products, or content registered for marketing, promotions, trading, buying, selling, auctioning and bartering in the system 2305. When user uploads content the system appraises the content and the user is automatically given Virtual Cash currency equal to the appraisal value determined by the system, and (VGC) is automatically deposited into the users Virtual Cash bank account, and furthermore comprising a Buy Sell Anything groups method for aggregating and merging users together in a virtual world to get a better price on products, services and properties 2306.

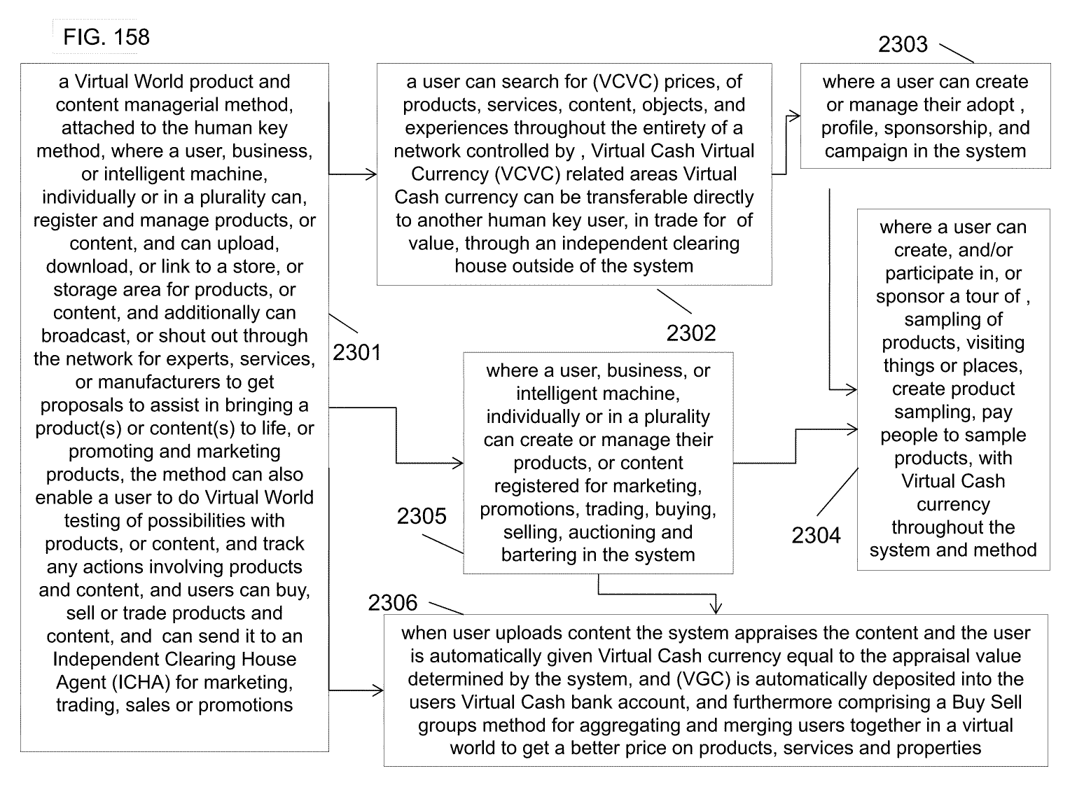

Now referring to FIG. 158, an Illumination Transformer Audio Video Manager Interactive Server Transmitter (ITAVMIST) Stereo 3D infrared pixel point facial distance, audio voice print identification method is shown. A human key server 3401 and ITAVMIST server 3402 are connected to a recording device 3403 comprised of an IR Laser, and left and right cameras for recording a person 3404. Distance is determined by IR laser of pixel points on selected facial pattern with nose as main focal point and values are created 3405. Locates human face in space managed by method, takes sampling, analyses and then determines that an object being viewed by cam is a 3 dimensional human live object before verification and during identification registration 3406. Locates human face in space managed by method, takes sampling, analyses, and then determines that an object being viewed by cam is a 3 dimensional human live object before verification and during identification registration 3407. Calculates all pixel values distances calibrated within facial surface area, omitting eyes area and Gets values and stores 3408. Calculates position and depth of facial background object focused 3409. Calculates position of forward focused object at the tip of nose 3410. Question is asked by system, “Hi name” or “who are a user a user are not enrolled”, then for enrolment Audio voice print is created at same time, from answer or phrase 3411. Distance is also determined by audio voice print and value is created 3412. All data is compared and final security decision is made yes identification is secured or identified, and person is managed and tracked in space for services, and assistance 3413. No it is a non-live person or object, or a security risk 3414.

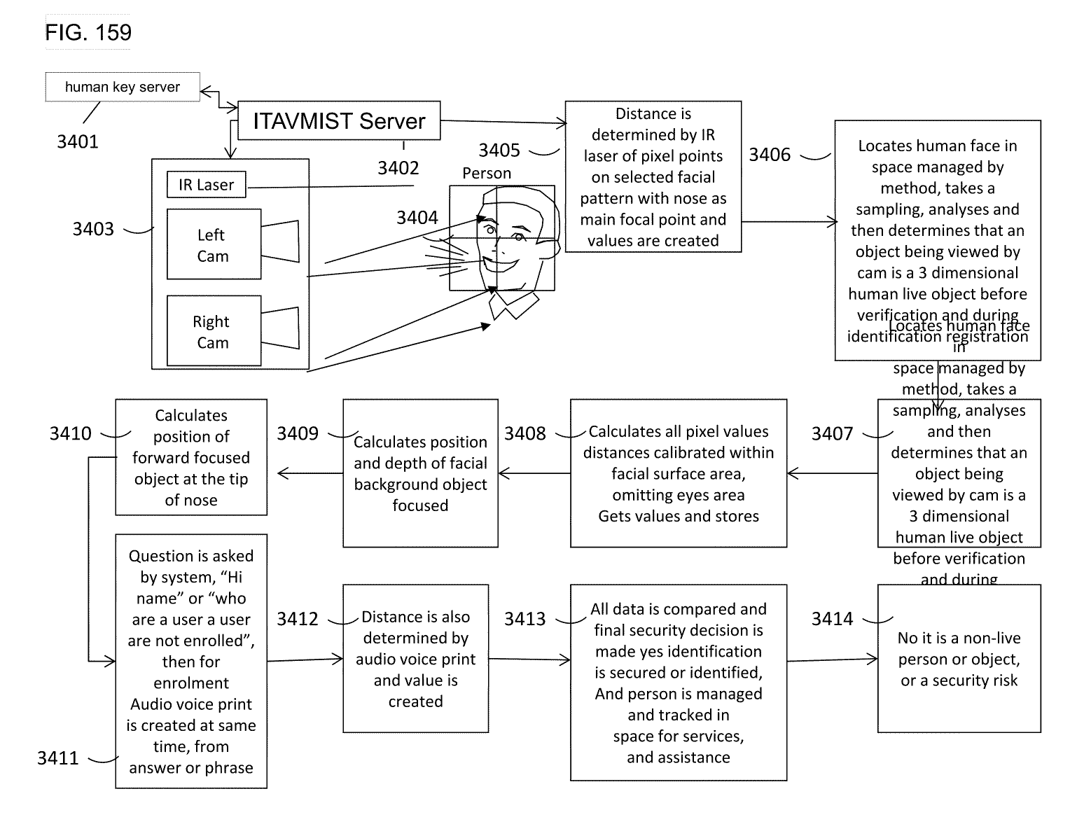

FIG. 159 illustrates a Virtual News, Promotions, and Advertising in Virtual Cash method. A secure place that keeps out unregistered collaborators utilizing Protect Human key 3701 comprising: instant Activity News Virtual Vine method 3702; instant feedback 3703 where a user pays for advertising with manufactures items or content 3705. A user registers in the system 3706, uploads content 3708, an appraisal is processed within minutes or delayed for human evaluation 3709. A suggested retail value and amount of virtual cash is paid to the uploader 3710. Virtual and non-virtual world places to do for collaborations are provided 3712. Incentives are provided 3713 to get stores traffic 3714. New and voting results are reported 3715 using virtual focus groups 3716 and virtual cash websites 3717 to turn virtual cash into currency or products for clearing house fulfillment 3718.

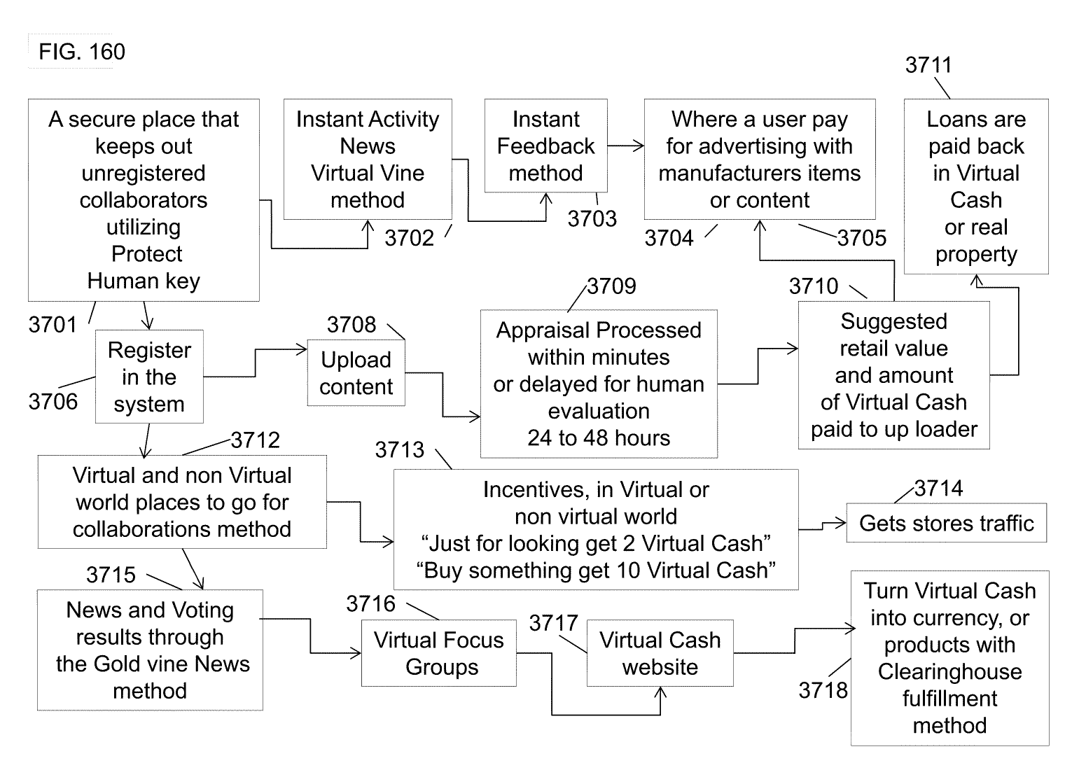

FIG. 160 illustrates the Translate Fourier transformation method taught by the present invention. A translation server 4101 takes a spoken phrase 4102 recorded with a microphone and stored 4103 as an audio file 4104 and transforms it into frequencies date using a Fourier fast transform (FFT) 4105. Patterns are created 4106 and data is stored in FFT for later calculations 4107.

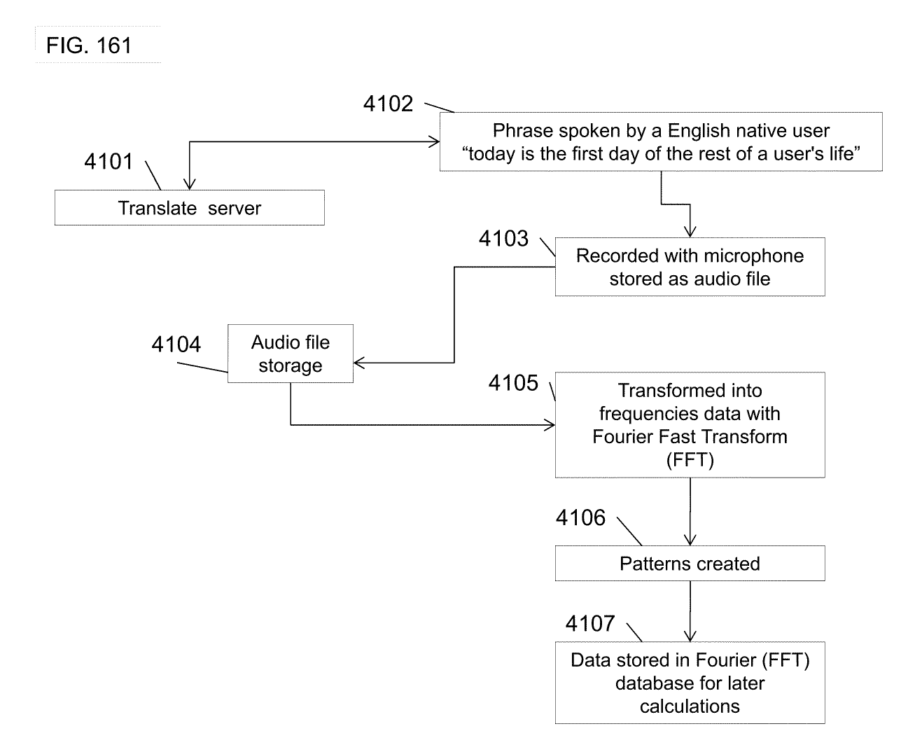

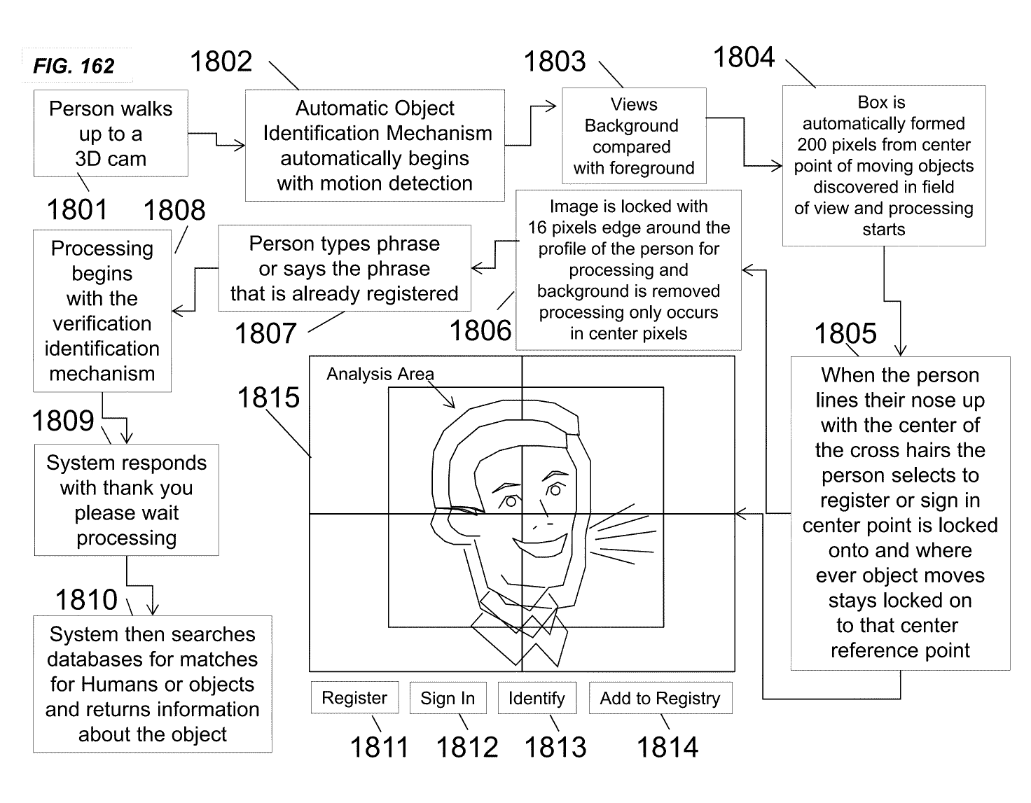

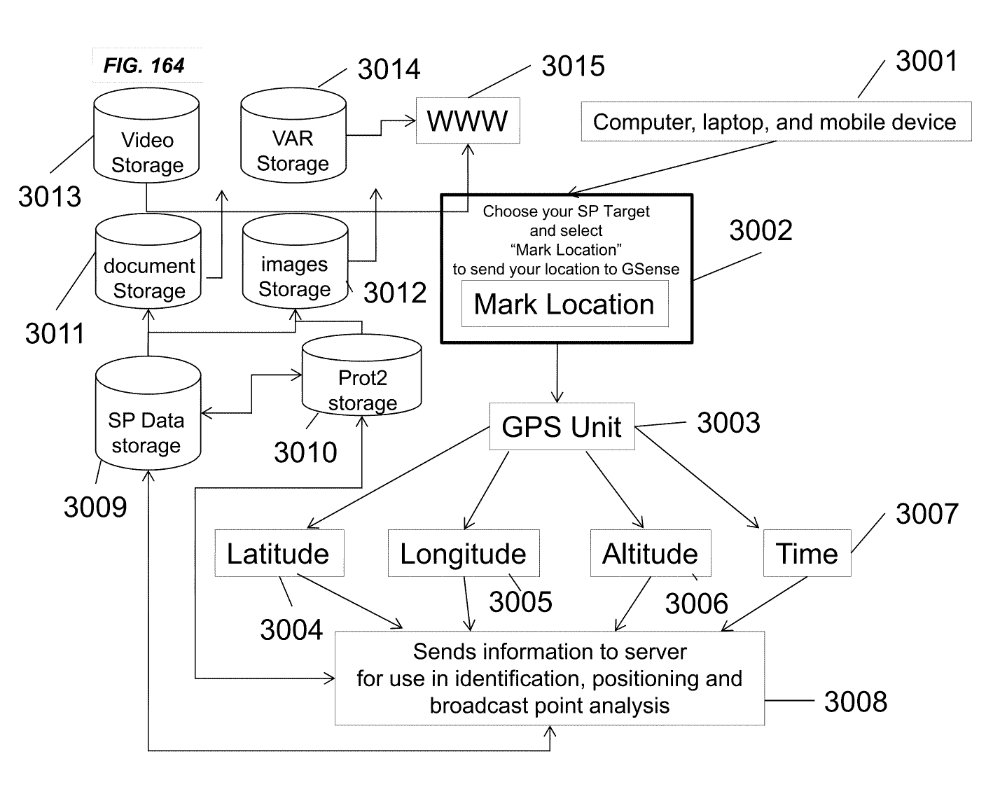

Now referring to FIGS. 161-164, the verification method of the present invention is disclosed. First, a person approaches a 3D camera or uses a 3D camera integrated into a thin client device such as a smartphone, pad computer, laptop, pc, or equivalent device 1801. Automatic Object Identification automatically begins with motion detection 1802. The background is compared with the foreground 1803. A box is automatically formed 200 pixels from center point of moving objects discovered in field of view and processing starts 1804. When the person lines their nose up with the center of the cross hairs in the analysis area 1811, the person selects to register 1811 or sign in 1812 center point is locked onto and where ever object moves stays locked on to that center reference point 1805. Additionally a user could add an item to their registry 1814, or identify an item 1813 by making either of those selections and continuing the process. The image is locked with 16 pixels edge around the profile of the person for processing and background is removed processing only occurs in center pixels 1806. Next, the user types a phrase or says the phrase that is already registered 1807. Processing begins with the verification and identification of the submitted phrase 1808. The system may provide a message while processing occurs 1809. Finally the system searches the database for matches and return information about the object 1810.

In identification of a human object the method needs to have protection from a user making a 3D model and putting it before the ATM and the system needs to be able to identify a live human object versus a fake human object, so this aspect would determine what the object is. The way to identify live humans, is that they are fluid not static and three dimensional, and with spatial reference points calculated in the background, a machine can identify fluid or static object.

FIGS. 161-164 illustrate the until pixel color band wave form encryption process. First an image collection of color band pixels occurs after the first phrase is spoken 1901. Color bands 1909, 1910, 1911, and 1912 and the analysis areas 1902 are determined. A first generation and storing of pixel color band (PCB) wave form occurs in a first encryption 1903 and is repeated for four encryption cycles 1904, 105, and 1906. Numbers stored with lightness and darkness values is filtered at 13 levels 1907 and pixels patterns data is analyzed for searching 1908.

Next the image captured from the video input analysis area 2009 is converted to grayscale 2001 and to black and while with only edge lines 2002. Pixels are generated and stored again 2003. Evaluation distance variables around eyes and nose are determined 2010. Points are measured and compared in the registration images extracted 2007 and 2008, as compared to the sign in extracted images for positive identification and target points for other tests and pixel comparisons 2004. Data stored from registration is compared to sign in during an evaluation step. Data is compared to determine if it is from the same human or object 2005. Results are generated and provided 2006. Points are measured and compared in the registration images extracted 2007 and 2008, as compared to the sign in extracted images 2010 for positive identification and target points for other tests and pixel comparisons 2011. A match combined with 9 out of 17 positive point evaluations returns “Hello, and a user first name”. A non match returns negative point evaluation.

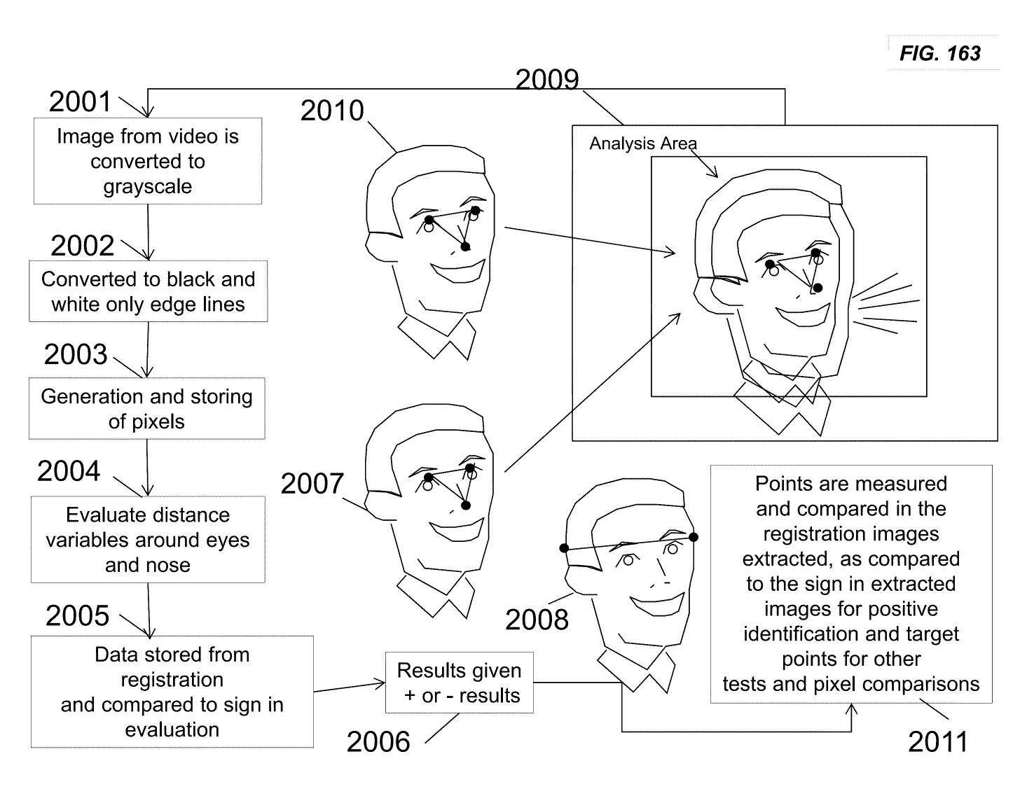

Now referring to FIG. 163, Using a mobile device 3001, a user marks the spatial point target where they want their content delivered then selects mark location and the location is identified for the delivery 3002 by a GPS unit 3303 within the mobile device that records time 3007, altitude 3006, longitude 3005, and latitude 3004. This information is sent to the system server for use in identification, positioning, and broadcasting point analysis 3008. Data is stored in databases 3009 and 3010. Documents and images are stored in separate databases 3011 and 3012 while video and VAR information are stored separately in their own databases 3013 and 3014 for transmission via the Internet or world wide web 3014.

The method and various embodiments taught by the present invention are set to run and/or are executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention. The method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. The present invention can be adapted to any situation where specific performances are measured and published. The performances are not limited to sports or financial markets. The method of the present invention can be used for or adapted to any measureable performance to create the basic contest or game taught by the present invention and embodiment by the examples given and anticipated first applications of the method.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for executing a series of instructions on a computer system, the method comprising:
registering a user and property account in a computer system;
creating and attaching human identification keys to the registered users account;
creating and attaching object identification keys to the registered users property account;
creating and attaching bank accounts to the registered users account;
creating aggregated data, and media from stored databases, or real time life events utilizing a module;
creating a website search software application either from tables on the server, from aggregated data or by the entry of a search item utilizing a module;
creating a Fractional opportunity, utilizing a Fractional Request Module;
providing taking a real or intangible property and dividing it into a plurality of pieces for the purpose of monetizing, creating liquidity, collaborating, sharing and making payments;
providing the ability to create a divisible, divided second property from a real or intangible first property, for the purpose of creating liquidity, monetizing it, or creating greater value for the piece or pieces;
providing the ability to create an assembled second property from a real or intangible first property, or a plurality of first properties for the purpose of creating liquidity, monetizing it, or creating greater value for a piece or pieces;
creating Publicity for created or re-purposed properties utilizing a Self Publishing Publicity module;
sharing a Fractional opportunity with users in a network;
creating a Fair Value utilizing a module; that calculates the amount of money that something is worth, the price or cost of something, in a fair way to all users;
creating a Fair Share opportunity utilizing a module, that calculates a portion belonging to, due to, or contributed by an individual or group;
creating a Fair Deal utilizing a module, that calculates how to give (something or an amount of something) to someone, to buy and sell as a business, and additionally to reach or try to reach a state of acceptance or reconciled agreement from users in a network about real tangible or intangible object transactions;
creating a Fair Price utilizing a module, that calculates the amount of money that you pay for something or that something costs, and calculates the thing that is lost, damaged, or given up in order to get or do something, and additionally calculates the amount of money needed to persuade users in a network to do something, and additionally calculates the quantity of one thing that is exchanged or demanded in barter or sale for another thing, and additionally calculates the amount of money given or set as consideration for the sale of a specified thing all in a fair way to the users in the network;
creating a Fair Placement utilizing a module, that calculates putting something in a particular place, and finding an appropriate place for someone to live, work, or learn, or placing an object, advertisement, or website in a strategic location for best possible results, in a fair way to users in a network;
creating a Micro Share Request utilizing a module, that calculates small shares of things, objects, real or intangible properties and makes an offer for a user in a network, for a fraction of the original item;
creating a Fractional Request utilizing a module, that calculates separating components of a transaction, real or intangible property, or object through differences, determined by using modules in the system to create potential and actual deals, suggestions, motivations, or incentive to play, and potential and actual transactions;
creating requests utilizing a module asking for collaborations related to the dividing of properties in a network for the benefit of the individual users in a network;
providing the ability to create a new property by transforming other properties utilizing modules;
providing the ability to take an original property and transforming it into a new property utilizing a module;
providing the ability to transform Fractional Objects divided pieces of real or intangible properties and original properties into a currency, or currencies utilizing a module;
utilizing modules that work within software, a computer processor, or System on Chip integrated circuit, in a virtual world network, and/or non virtual network.

2. The method of claim 1, further comprising the steps of:
creating a Change Request Search utilizing a module, that allows users to search to change other users content, objects, real or intangible properties, and/or to find previously transformed properties utilizing functions, including:
creating Random and/or Specified, (or user generated) Generating Objects utilizing a module that utilizes a digital semantic agent for aggregation of potential images, videos, shapes, ideas, and structures to create and modify old properties into new properties;
creating Random and/or Specified, (or user generated) Subjects, Thoughts and Goals utilizing a module that aggregates data for modifications of properties;
creating Random and/or Specified, Facts utilizing a module that aggregates facts for use in modifications of properties;
creating Random and/or Specified, (or user generated) Emotional information utilizing a module, that aggregates how a user feels at the moment of modification of properties;
creating Random and/or Specified, (or user generated) Current News utilizing a module, that aggregates news for modifications of properties;
creating Random and/or Specified, (or user generated) Potential Negative Results utilizing a module, that calculates adverse reactions to the changed property;
creating Random and/or Specified, (or user generated) Potential Positive Results utilizing a module that calculates beneficial reactions to the changed property, and sends this to the request module;
creating Random and/or Specified, (or user generated) Provocative Keywords, Images, and Videos utilizing a module that that converts graphical objects and keywords into text, sentences, and phrases;
creating Random and/or Specified, (or user generated) Provocative Keywords, Images, and Videos utilizing a module that converts text, sentences, and phrases into other text, images and videos.

3. The method of claim 2, further comprising the steps of:
providing the dividing of a property or intangible property into a plurality of parts, shares, pieces, or units;
providing the transforming a real or intangible property into unique one of a kind pieces, units, shares, or fractions.

4. The method of claim 2, further comprising the steps of:
providing attachment of object identification keys to each divided piece of property;
providing certification, with labeling that each piece created is unique, and the only unique piece deriving from property divided;
providing and attaching human key identification, or plurality of human key identifications of rightful owner or owners to real or intangible properties, or pieces of those properties.

5. The method of claim 2, further comprising the steps of:
providing a system for the transformed, recorded, and/or documented real or intangible pieces of property to be exchanged, transacted, traded, lent, pledged, and/or donated, sold, bought, securitized and/or used as collateral in a network.

6. The method of claim 2, further comprising the steps of:
providing a system allowing users to protect, share or exchange properties through a computer network, or outside a computer network with authorization through a computer;
providing a system that creates one or more files at the time of registration of an object, or divided pieces of an object in a network, that represent for identification a real or intangible property and identifies the users who own a real or intangible property or pieces of real or intangible properties;
providing the ability in the system network for protecting, sharing, storing, accessing, authenticating, certifying, the electronic file use in the network;
providing attachment of the electronic files to one or more other files;
providing for tracking of the electronic files in a computer network.

7. The method of claim 2, further comprising the steps of:
providing a network collaborative system;
providing the ability to share and divide or create fractional part of a first protected property between one or more users or between a plurality of rightful property owners;
providing creating a second property based upon a first protected property;
providing the allowing of one or more rightful users or non-rightful owners, to create an original real or intangible property;
providing the ability for a plurality of rightful owners or non-rightful owners, to collaborate, and create a real or intangible property;
providing the system for re-purposing real or intangible property, and the system for monetizing it by transforming and creating individual pieces.

8. The method of claim 2, further comprising the steps of:
providing a system allowing users with permission of owners of properties, or allowing users the ability to seek permission of owners of properties, to;
re-purpose;
reformat;
change;
modify;
transform;
alter; or
make new an existing real or intangible property or properties.

9. The method of claim 2, further comprising the steps of:
providing a digital semantic agent for determining and creating real or intangible property pieces;
providing a digital semantic agent for creating a human key and an object key at time of registration for identification of newly created real or intangible property pieces;
providing a digital semantic agent for determining and creating sharing of real or intangible property pieces;
providing a digital semantic agent for determining and creating real or intangible property pieces image files;
providing a digital semantic agent for determining and creating image files with color band rating and identification for real or intangible property pieces;
providing a digital semantic agent for communicating a request for participation in the marketing, sharing, and collaborations involving real or intangible property pieces.

10. The method of claim 2, further comprising the steps of:
providing a distributed block chain to independently verify the chain of ownership of any shared piece created from real or intangible properties transformed into a fraction of the original property;
providing a distributed block chain live tracking to independently verify the transactions of buying, selling, trading, bartering, with fair value or market value amounts set of any shared piece created from real or intangible properties transformed into a fraction of the original property in the network system;
providing a distributed block chain recording of any activities related to changing, transforming, altering valuations, or destruction of any shared piece created from real or intangible properties transformed into a fraction of the original property in a system network;
providing a shared fractional payment platform;
providing a digital semantic agent for creating;
color band currencies from divided pieces;
a rating attached to divided pieces;
the conversion of pieces into currencies at time of registration;
color band requests for participation;
monetary values attached to requests at the time of dividing pieces;
providing a negotiation digital semantic agent for negotiations on requested newly created properties.

11. The method of claim 2, further comprising the steps of:
providing an exchange where individual pieces that are a fraction of a real or intangible property can be traded, exchanged, lent, bartered, sold, donated, purchased, insured, and pledged as a consideration for real or intangible property;
providing where individual pieces that are a fraction of a real or intangible property can be transformed and exchanged as virtual currency or real currency.
providing a digital semantic agent for creating liquidity for single or a plurality of real or intangible properties;

12. The method of claim 2, further comprising the steps of:
providing a valuation digital semantic agent for the purpose of establishing the value of a real or intangible property;
providing a system for allowing individuals or groups of individuals to bid on the initial transformed and created pieces of real or intangible properties with or without utilizing digital semantic agent.

13. The method of claim 2, further comprising the steps of:
providing a deal creation system;
providing a human key security and identification attached to deals that are created;
providing a color rating system with special encrypted color currency for each and every deal;
providing where at the time the deal is created, and done, it instantly can be traded in an exchange;
providing brand-able currency at the time a deal is registered in the system;
providing where created deals can be traded against block chain, or outside block chain.

14. The method of claim 2, further comprising the steps of:
providing the creation of a non existing property;
providing the step of breaking the non existing property into fractions or pieces;
providing a platform and search engine for selling the created fractions or pieces;
providing a platform and search engine for selling fractions or pieces to create an existing real or intangible property;
providing a platform and search engine for recombining, and creating combined real or intangible property pieces to create new properties.

15. The method of claim 2, further comprising the steps of:
providing a request digital semantic agent for participation in dividing real or intangible properties into fractions or pieces that can be transacted;
providing a request digital semantic agent for service providers, manufacturers, sellers and suppliers for purchase of products and service transactions, related at the time of creation or transformation into fractions or pieces created of real or intangible properties.

16. The method of claim 2, used in gaming platforms for enhancing the gaming experience and providing a digital semantic agent for creating a request for participation video with the aggregated data and media.

17. The method of claim 2, wherein the user can bid for placement throughout the network and outside the network, creating an auction or sales website with the aggregated data, and media.

18. The method of claim 2, wherein advertisements can click through to catalogs and split products offers, providing editing advertisements or campaigns images, media and text data, utilizing the aggregated data, and media.

19. The method of claim 2, wherein includes the following steps;
campaigns and incentives can have split funded, and fractional contributions, loans and investments;
determining semantically where loans are and where to put money;
arranging investment and fractional loan pools;
generating valuations of loan rates and investment rates;
selecting between fractional divided funding and conventional funding;
electing beneficiaries of the funding; and
transforming a website, based on the submitted URL, in to a campaign, advertisement, media product, or catalog utilizing the aggregated data, and media.

20. The method of claim 2, and further comprising the steps of
participating in a free barter exchange;
providing semantic keyword finding of potential offers;
reminding the user of potential barters that can be arranged; and
creating a social network advertisement utilizing the aggregated data, and media;
providing and creating a social network feed as a request for participation, of users.

21. The method of claim 2, and further comprising the steps of;
making flexible offers to campaigns for placement, collaborations, and promotions, that can change based upon inventory of a tangible or intangible product or service;
adjusting the discount, rebate, or incentive that can change in price; and
publishing merchandise to a web page or a catalog utilizing the aggregated data, and media.

22. The method of claim 2, and further comprising the steps of;
transforming requests for real or intangible property re-purposing, participations, or divided properties into other tangible, transact-able properties.

23. The method of claim 2, and further comprising the steps of;
registration of search-able request information from users in a network;
transforming requests for real or intangible property re-purposing, participations, or divided properties into collaborations;
transforming ownership from one state into another ownership state;
providing a search engine for “I Need” or “I am Willing to Do” requests;
transforming requests into QR codes at the time of registration;
providing color bands to requests created in the system;
providing color bands to responses to requests in the system;
providing color band branding to QR codes to match divided currencies and registered properties in the system.

24. The method of claim 2 further comprising the steps of;
transforming data, files, user input into an automatic registration for;
collaborations;
participation;
supplying products or services;
providing knowledge or expertise;
providing user curators of requests, search engines, divisions of real or intangible properties in a network, or outside of a network;
providing the ability for human users to change properties, and request applications of those changes to the rightful owner of the properties or altered properties;
transforming properties in a network with a non human digital semantic agent user;
providing a bid on a request, function in the network;
providing a non human digital semantic agent to re-purpose video, audio, and text from;
spoken word;
text entered in a search engine;
video entered and uploaded in a search system;
images entered or registered in a search engine;
files or data in real time from a mobile device, or computer;
providing a request function to suggest to the rightful owner the request re-purposed, for mutual rewards by users in the network.

25. The method of claim 2 further comprising the steps of;
transforming pieces of properties re-purposed into currency;
providing where beneficiaries are created at the time of registration or re-purposing of properties in the system;
providing beneficiaries linked at registration or re-purposing to a human identification key;
providing where representatives and proxies are linked to properties;
providing voting, feedback and labeling of properties, or re-purposed divided properties in a network in the system, at the time of registration or re-purposing, or requesting participation.
